(19) United States
(12) Patent Application Publication
(10) Pub. No.: US 2025/0301229 A1
(43) Pub. Date: Sep. 25, 2025

(54) CONTROL DEVICE, IMAGING APPARATUS, CONTROL METHOD, AND PROGRAM

(71) Applicant: FUJIFILM Corporation, Tokyo (JP)

(72) Inventor: Masato FUJII, Saitama (JP)

(73) Assignee: FUJIFILM Corporation, Tokyo (JP)

(21) Appl. No.: 19/086,091

(22) Filed: Mar. 20, 2025

(30) Foreign Application Priority Data
Mar. 25, 2024 (JP) 2024-048559
Mar. 25, 2024 (JP) 2024-048571
Mar. 25, 2024 (JP) 2024-048573

(51) Int. Cl. H04N 23/73

(52) U.S. Cl. CPC H04N 23/73

(57) ABSTRACT

A control device including a processor. The processor performs control of acquiring plural divisional exposures determined based on a change time needed to change a transmittance of an electronic dimmer filter mounted to an imaging apparatus from a first transmittance to a second transmittance capable of realizing a target exposure of the imaging apparatus, and, the target exposure, applying the plural divisional exposures for exposures of plural frames obtained by imaging with the imaging apparatus performed at least within the change time.

### CROSS-REFERENCE TO RELATED APPLICATIONS

This application claims priority under 35 USC 119 from Japanese Patent Application No. 2024-048559 filed on Mar. 25, 2024, Japanese Patent Application No. 2024-048571 filed on Mar. 25, 2024, and Japanese Patent Application No. 2024-048573 filed on Mar. 25, 2024, the disclosures of which are incorporated herein by reference in their entireties.

### BACKGROUND

### Technical Field

The present disclosure relates to a control device, an imaging apparatus, a control method, and a program.

### Related Art

In an imaging apparatus disclosed in Japanese Patent Application Laid-Open (JP-A) No. 2023-121787, an exposure condition is set based on a characteristic of a transmittance control element. The imaging apparatus disclosed in JP-A No. 2023-121787 includes a processor. In the imaging apparatus disclosed in JP-A No. 2023-121787, the processor calculates a first exposure condition range based on photometry of the imaging apparatus, and in a case in which the first exposure condition range is not included in a second exposure condition range where an acquired control range of the transmittance control element is applicable, the processor changes the exposure condition of the imaging apparatus such that the calculated first exposure condition range is included in the second exposure condition range.

An imaging apparatus disclosed in JP-A No. 2020-034590 includes an element that controls a light transmittance amount, and a photoreceptor element that receives light transmitted through the element that controls the light transmittance amount. The imaging apparatus of JP-A No. 2020-034590 includes a calculation section that estimates a time needed for a decolor process to control the light transmittance amount of the element, and a sensitivity of the photoreceptor element is raised in cases in which the estimated time for the decoloring process by the calculation section has exceeded a threshold value.

JP-A No. 2005-045648 discloses an exposure control method for an imaging apparatus including an imaging lens with an aperture opening, a solid-state imaging device, plural exposure adjustment means, a means to determine a brightness of an imaging subject, and an exposure control means to control the plural exposure adjustment means according to a brightness of the imaging subject so as to obtain a target exposure value.

In the imaging apparatus described in JP-A No. 2005-045648, the plural exposure adjustment means includes a first exposure adjustment means to adjust an exposure amount by causing an ND filter to intrude into the aperture opening, as well as a second exposure adjustment means. The second exposure adjustment means is configured by at least one out of an exposure adjustment means to adjust the exposure amount by adjusting the opening surface area of the aperture opening, an exposure adjustment means to adjust the exposure amount by adjusting an electronic shutter speed of the solid-state imaging device, or an exposure adjustment means that controls the exposure amount by controlling an amplification gain of an image signal obtained from the solid-state imaging device.

In an exposure control method of the imaging apparatus of JP-A No. 2005-045648, when the brightness of the imaging subject is less than a specific level, the first exposure adjustment means is controlled such that the first exposure adjustment means is maintained in an ND filter completely open state, this being a state in which the ND filter does not impinge on the aperture opening at all, and when the brightness of the imaging subject is the specific level or greater, the first exposure adjustment means is maintained in an ND filter completely closed state, this being a state in which the ND filter impinges on the entire region of the aperture opening. Moreover, in the exposure control method of the imaging apparatus of JP-A No. 2005-045648, when the first exposure adjustment means is in a state transition between the ND filter completely open state and the ND filter completely closed state, the second exposure adjustment means is controlled such that an exposure change amount is generated in the second exposure adjustment means of a size to cancel out the exposure change amount accompanying the state transition of the first exposure adjustment means.

In an imaging apparatus disclosed in International Publication (WO) No. 2021/193814, an exposure condition is set based on a characteristic of a transmittance control element. The imaging apparatus of International Publication (WO) No. 2021/193814 includes a processor, and the processor calculates a first exposure condition range based on photometry of the imaging apparatus. In cases in which the first exposure condition range is not included in a second exposure condition range where an acquired control range of the transmittance control element is applicable, the exposure condition of the imaging apparatus is changed such that the calculated first exposure condition range is included in the second exposure condition range. Moreover, during imaging the processor controls exposure in a second exposure condition range using the transmittance control element.

An imaging apparatus disclosed in JP-A No. 2018-198403 includes an ND filter section, a first exposure determination means, a second exposure determination means, and a control means. In the imaging apparatus of JP-A No. 2018-198403, the ND filter section includes an ND filter having plural densities, and the density of the ND filter inserted onto the optical path is changeable. The first exposure determination means uses exposure control when imaging an imaging subject, and determines a first exposure control value including a density of the ND filter. The second exposure determination means determines a second exposure control value that includes a density of the ND filter different to the first exposure control value. The control means controls the second exposure determination means, and controls the exposure when imaging the imaging subject based on the exposure control value determined by the first exposure determination means or the second exposure determination means. The first exposure control value has a greater number of densities of the changeable ND filter section than the second exposure control value. The control means switches the first exposure control value to the second exposure control value at a predetermined timing.

In the imaging apparatus of JP-A No. 2005-045648, the plural exposure adjustment means include a first exposure adjustment means to adjust an exposure amount by causing an ND filter to intrude into the aperture opening, as well as a second exposure adjustment means. The second exposure adjustment means is configured by at least one out of an exposure adjustment means to adjust the exposure amount by adjusting the opening surface area of the aperture opening, an exposure adjustment means to adjust the exposure amount by adjusting an electronic shutter speed of a solid-state imaging device, or an exposure adjustment means that controls the exposure amount by controlling an amplification gain of an image signal obtained from the solid-state imaging device.

In the exposure control method of the imaging apparatus of JP-A No. 2005-045648, when the brightness of the imaging subject is less than a specific level, the first exposure adjustment means is controlled such that the first exposure adjustment means is maintained in an ND filter completely open state, this being a state in which the ND filter does not impinge on the aperture opening at all, and when the brightness of the imaging subject is the specific level or greater, the first exposure adjustment means is maintained in an ND filter completely closed state, this being a state in which the ND filter impinges on the entire region of the aperture opening. Moreover, in the exposure control method of the imaging apparatus of JP-A No. 2005-045648, when a state transition of the first exposure adjustment means occurs between the ND filter completely open state and the ND filter completely closed state, the second exposure adjustment means is controlled such that an exposure change amount is generated in the second exposure adjustment means of a size to cancel out the exposure change amount accompanying the state transition of the first exposure adjustment means.

An imaging apparatus disclosed in JP-A No. 2013-157688 includes an exposure state determination means, an exposure control means, an ND filter, and an ND control means. In the imaging apparatus of JP-A No. 2013-157688, the exposure state determination means determines an exposure state. The exposure control means adjusts exposure according to the exposure state. The ND filter is able to be inserted into or removed from an optical path to adjust the exposure. The ND control means determines whether or not to execute insertion or removal of the ND filter based on a specific condition during video imaging. Furthermore, the exposure control means adjusts the exposure using the ND filter in cases in which the specific condition is satisfied, and adjusts the exposure without using the ND filter in cases in which the specific condition is not satisfied.

An imaging apparatus disclosed in JP-A No. 2017-009952 includes an optical means for forming an image of an imaging subject, a first dimmer means that is able to adjust an amount of light by changing the size of an aperture opening present on an optical axis of the optical means so as to change an adjustment range according to focal length, a second dimmer means that is present on the optical axis of the optical means and able to adjust an amount of transmitted light by changing a transmittance with a courser adjustment performance than an adjustment resolution of the first dimmer means, and a control means that controls operation of the first and second dimmer means so as to make the exposure appropriate during imaging. In the imaging apparatus of JP-A No. 2017-009952, the control means adjusts the amount of light using the first dimmer means and the second dimmer means in cases in which the possible range of light amount adjustment of the first dimmer means is wider than that of the second dimmer means, and adjusts the amount of light using the first dimmer means in cases in which the possible range of light amount adjustment of the first dimmer means is narrower than that of the second dimmer means.

International Publication (WO) No. 2017/061169 discloses an imaging apparatus capable of switching between a liquid crystal photochromatic element and clear glass.

### SUMMARY

A first group of exemplary embodiments according to the present disclosure provide a control device, an imaging apparatus, a control method, and a program that are capable of suppressing a brightness between plural frames obtained by imaging performed with an imaging apparatus from suddenly changing accompanying switching of a transmittance of an electronic dimmer filter.

A second group of exemplary embodiments according to the present disclosure provide a control device, an imaging apparatus, a control method, and a program that are capable of holding a constant brightness of plural frames obtained by imaging performed with an imaging apparatus even while an aperture is being driven.

A third group of exemplary embodiments according to the present disclosure provide a control device, an imaging apparatus, a control method, and a program that are capable of suppressing a brightness from suddenly changing between plural frames in the course of attaining a target exposure for an exposure of plural frames obtained by being imaged with an imaging apparatus while switching between one state or the other state from out of an in-use state in which an electronic dimmer filter mounted to the imaging apparatus is used and a non-use state in which the electronic dimmer filter is not used.

In the first group of exemplary embodiments according to the present disclosure, a first aspect according to the present disclosure is a control device including a processor. The processor performs control of acquiring plural divisional exposures determined based on a change time needed to change a transmittance of an electronic dimmer filter mounted to an imaging apparatus from a first transmittance to a second transmittance capable of realizing a target exposure of the imaging apparatus and the target exposure, and applying the plural divisional exposures for exposures of plural frames obtained by imaging performed with the imaging apparatus at least within the change time.

In the first group of exemplary embodiments according to the present disclosure, a second aspect according to the present disclosure is the control device according to the first aspect, wherein the plural frames are obtained by the imaging being performed based on a preset frame rate, a number of frames of the plural frames is determined based on the change time and the preset frame rate, and the plural divisional exposures are determined based on the target exposure and the number of frames.

In the first group of exemplary embodiments according to the present disclosure, a third aspect according to the present disclosure is the control device according to the first aspect or the second aspect, wherein in cases in which the change time has exceeded a first threshold value, from out of the plural divisional exposures, the divisional exposures of a course of changing from the first transmittance to the second transmittance are adjusted based on plural ideal transmittances determining a course of an ideal change from the first transmittance to the second transmittance with the change time of the first threshold value or lower, and based on plural first realistic transmittances determining a course of a realistic change from the first transmittance to the second transmittance with the change time of the first threshold value or lower.

In the first group of exemplary embodiments according to the present disclosure, a fourth aspect according to the present disclosure is the control device according to the third aspect, wherein the first threshold value is a value determined based on an ideal wait time to change from the first transmittance to the second transmittance.

In the first group of exemplary embodiments according to the present disclosure, a fifth aspect according to the present disclosure is the control device according to the third aspect or the fourth aspect, wherein in cases in which the change time has exceeded the first threshold value a third transmittance is determined between the first transmittance and the second transmittance to make the change time the first threshold value or lower, and the plural first realistic transmittances are determined based on the first transmittance and the third transmittance.

In the first group of exemplary embodiments according to the present disclosure, a sixth aspect according to the present disclosure is the control device according to the fifth aspect, wherein for cases in which the change time exceeds the first threshold value and also a number of times a state arises in which a disparity between the first transmittance and the second transmittance lies within a preset range has continued for a specific number of times, the first threshold value is a value larger than a value set at a current point in time.

In the first group of exemplary embodiments according to the present disclosure, a seventh aspect according to the present disclosure is the control device according to the sixth aspect, wherein for cases in which the change time exceeds the first threshold value and also a number of times a state arises in which the disparity lies within the preset range has continued for the specific number of times, the first threshold value is a value determined based on plural of the change times obtained within the specific number of times.

In the first group of exemplary embodiments according to the present disclosure, an eighth aspect according to the present disclosure is the control device according to the fifth aspect, wherein in cases in which the change time exceeds the first threshold value and also a number of times a state arises in which the disparity between the first transmittance and the second transmittance lies within the preset range has continued for a specific number of times, the plural divisional exposures is maintained.

In the first group of exemplary embodiments according to the present disclosure, a ninth aspect according to the present disclosure is the control device according to any aspect of the fifth aspect to the eighth aspect, wherein the plural first realistic transmittances determine a course of changing from the first transmittance and the second transmittance for cases of changing from the first transmittance to the second transmittance via the third transmittance with the change time of the first threshold value or lower.

In the first group of exemplary embodiments according to the present disclosure, a tenth aspect according to the present disclosure is the control device according to any aspect of the fifth aspect to the ninth aspect, wherein in cases in which the change time exceeds the first threshold value and also a first maximum disparity, which is a largest disparity between the plural ideal transmittances and the plural first realistic transmittances, has exceeded a preset disparity, from out of the plural divisional exposures, the divisional exposures in a course of changing from the first transmittance to the second transmittance are adjusted based on the plural ideal transmittances, and plural second realistic transmittances determining a course of changing from the first transmittance to the second transmittance via plural mid transmittances with the change time of the first threshold value or lower, and a second maximum disparity, which is a largest disparity between the plural mid transmittances and the plural ideal transmittances, is smaller than the first maximum disparity.

In the first group of exemplary embodiments according to the present disclosure, an eleventh aspect according to the present disclosure is the control device according to the tenth aspect, wherein in cases in which the first maximum disparity exceeds the preset disparity and also a transmittance change time, which is a time needed to change from the first transmittance to the third transmittance, is less than a second threshold value, from out of the plural divisional exposures, the divisional exposures of a course of changing from the first transmittance to the second transmittance are adjusted based on the plural ideal transmittances and the plural second realistic transmittances.

In the first group of exemplary embodiments according to the present disclosure, a twelfth aspect according to the present disclosure is the control device according to any aspect from the third aspect to the eleventh aspect, wherein from out of the plural divisional exposures, adjustment for the divisional exposures in the course of changing from the first transmittance to the second transmittance is realized by at least one out of plural exposure factors defining the divisional exposures being adjusted based on a disparity between the ideal transmittance and the first realistic transmittance.

In the first group of exemplary embodiments according to the present disclosure, a thirteenth aspect according to the present disclosure is the control device according to any aspect from the third aspect to the twelfth aspect, wherein in cases in which the change time is the first threshold value or lower the transmittance is changed based on the plural ideal transmittances.

In the first group of exemplary embodiments according to the present disclosure, a fourteenth aspect according to the present disclosure is the control device according to any aspect from the third aspect to the thirteenth aspect, wherein in cases in which the change time is the first threshold value or lower, the plural divisional exposures correspond to the plural ideal transmittances.

In the first group of exemplary embodiments according to the present disclosure, a fifteenth aspect according to the present disclosure is the control device according to any aspect from the third aspect to the fourteenth aspect, wherein the plural ideal transmittances change monotonously between the first transmittance and the second transmittance.

In the first group of exemplary embodiments according to the present disclosure, a sixteenth aspect according to the present disclosure is the control device according to any aspect from the third aspect to the fifteenth aspect, wherein in cases in which the change time is the first threshold value or lower, the plural divisional exposures change monotonously from the divisional exposure corresponding to the first transmittance through to the target exposure.

In the first group of exemplary embodiments according to the present disclosure, a seventeenth aspect according to the present disclosure is the control device according to any aspect from the third aspect to the sixteenth aspect, wherein the imaging apparatus includes a movable aperture, and in cases in which a drive time of the aperture when driving the aperture to realize the target exposure exceeds the first threshold value, the first threshold value is a value of the drive time or greater.

In the first group of exemplary embodiments according to the present disclosure, an eighteenth aspect according to the present disclosure is an imaging apparatus including the control device according to any aspect from the first aspect to the seventeenth aspect, and an image sensor employed in the imaging.

In the first group of exemplary embodiments according to the present disclosure, a nineteenth aspect according to the present disclosure is a control method including performing control of acquiring plural divisional exposures determined based on a change time needed to change a transmittance of an electronic dimmer filter mounted to an imaging apparatus from a first transmittance to a second transmittance capable of realizing a target exposure of the imaging apparatus and the target exposure, and applying the plural divisional exposures for exposures of plural frames obtained by imaging performed with the imaging apparatus at least within the change time.

In the first group of exemplary embodiments according to the present disclosure, a twentieth aspect according to the present disclosure is a program that causes a computer to execute processing including performing control of acquiring plural divisional exposures determined based on a change time needed to change a transmittance of an electronic dimmer filter mounted to an imaging apparatus from a first transmittance to a second transmittance capable of realizing a target exposure of the imaging apparatus and the target exposure, and applying the plural divisional exposures for exposures of plural frames obtained by imaging performed with the imaging apparatus within at least the change time.

In a second group of exemplary embodiments according to the present disclosure, a first aspect according to the present disclosure is a control device including a processor. Based on a transmittance of an electronic dimmer filter mounted to an imaging apparatus including a movable aperture and on a drive time of the aperture, the processor controls exposures of plural frames obtained by imaging performed with the imaging apparatus.

In the second group of exemplary embodiments according to the present disclosure, a second aspect according to the present disclosure is the control device according to the first aspect, wherein the processor controls exposures of the plural frames by applying plural divisional exposures determined according to a relationship between a change time needed to change the transmittance from a first transmittance to a second transmittance able to realize a target exposure of the imaging apparatus and a drive time of the aperture by application for the exposures of the plural frames.

In the second group of exemplary embodiments according to the present disclosure, a third aspect according to the present disclosure is the control device according to the second aspect, wherein first control is performed in cases in which the change time and the drive time have exceeded a first threshold value, and the first control is control to make the change time within the drive time, and is control to apply plural first divisional exposures determined based on a realistic change time, which is a time to realistically change from the first transmittance to the second transmittance, and the drive time by application to exposures of the plural frames as the plural divisional exposures.

In the second group of exemplary embodiments according to the present disclosure, a fourth aspect according to the present disclosure is the control device according to the second aspect or the third aspect, wherein a second control is performed in cases in which the change time and/or the drive time is a first threshold value or lower, and the second control is control to apply plural second divisional exposures determined based on an ideal change time, which is a time to ideally change from the first transmittance to the second transmittance, and the drive time, by application to exposures of the plural frames as the plural divisional exposures.

In the second group of exemplary embodiments according to the present disclosure, a fifth aspect according to the present disclosure is the control device according to the second aspect, wherein a first control is performed in cases in which a disparity between the change time and the drive time has exceeded a second threshold value, and the first control is control to make the change time within the drive time, and is control to apply plural first divisional exposures determined based on a realistic change time, which is a time to realistically change from the first transmittance to the second transmittance, and the drive time by application to exposures of the plural frames as the plural divisional exposures.

In the second group of exemplary embodiments according to the present disclosure, a sixth aspect according to the present disclosure is the control device according to the second aspect or the fifth aspect, wherein second control is performed in cases in which a disparity between the change time and the drive time is a second threshold value or lower, and the second control is control to apply plural second divisional exposures determined based on an ideal change time, which is a time to ideally change from the first transmittance to the second transmittance, and the drive time, by application to exposures of the plural frames as the plural divisional exposures.

In the second group of exemplary embodiments according to the present disclosure, a seventh aspect according to the present disclosure is the control device according to any aspect of the third aspect to the sixth aspect, wherein the plural first divisional exposures are determined based on a frame number determined on the basis of a first frame number, which is a frame number corresponding to the realistic change time, and of a second frame number, which is a frame number corresponding to the drive time, and on the target exposure.

In the second group of exemplary embodiments according to the present disclosure, an eighth aspect according to the present disclosure is the control device according to the seventh aspect, wherein the plural first divisional exposures are determined based on plural first realistic transmittances determining a course of realistically changing from the first transmittance to the second transmittance within the realistic change time, on an aperture value of the aperture, and on a sensitivity and/or shutter speed set in the imaging apparatus to match the target exposure.

In the second group of exemplary embodiments according to the present disclosure, a ninth aspect according to the present disclosure is the control device according to the eighth aspect, wherein in cases in which the change time and the drive time have exceeded a third threshold value, a third transmittance is determined between the first transmittance and the second transmittance to make the change time within the drive time, and the plural first realistic transmittances are determined based on the first transmittance and the third transmittance.

In the second group of exemplary embodiments according to the present disclosure, a tenth aspect according to the present disclosure is the control device according to the eighth aspect, wherein in cases in which a disparity between the change time and the drive time have exceeded a fourth threshold value, a third transmittance is determined between the first transmittance and the second transmittance to make the change time within the drive time, and the plural first realistic transmittances are determined based on the first transmittance and the third transmittance.

In the second group of exemplary embodiments according to the present disclosure, a eleventh aspect according to the present disclosure is the control device according to the fourth aspect or the sixth aspect, wherein the plural second divisional exposures are determined based on a frame number determined on the basis of a third frame number, which is a frame number corresponding to the ideal change time, and of a fourth frame number, which is a frame number corresponding to the drive time, and on the target exposure.

In the second group of exemplary embodiments according to the present disclosure, a twelfth aspect according to the present disclosure is the control device according to the eleventh aspect, wherein the plural second divisional exposures are determined based on plural ideal transmittances determining a course of an ideal change from the first transmittance to the second transmittance within the ideal change time, on an aperture value of the aperture, and on a sensitivity and/or shutter speed set in the imaging apparatus to match the target exposure.

In the second group of exemplary embodiments according to the present disclosure, a thirteenth aspect according to the present disclosure is the control device according to any aspect from the second aspect to the twelfth aspect, wherein in cases in which the change time and the drive time have exceeded a fifth threshold value, and also a first disparity, which is a disparity between a fourth transmittance and the second transmittance to make the change time within the drive time, has exceeded a preset disparity, the divisional exposures of a course of changing from the first transmittance to the second transmittance from out of the plural divisional exposures are determined based on plural second realistic transmittances determined a course of changing from the first transmittance to the second transmittance via plural mid transmittances with the change time within the drive time, a maximum disparity, which is a largest disparity between the plural mid transmittances and the second transmittance, is smaller than the first disparity.

In the second group of exemplary embodiments according to the present disclosure, a fourteenth aspect according to the present disclosure is the control device according to any aspect from the second aspect to the twelfth aspect, wherein in cases in which a disparity between the change time and the drive time has exceeded a sixth threshold value and also a first disparity, which is a disparity between a fourth transmittance and the second transmittance to make the change time within the drive time, has exceeded a preset disparity, the divisional exposures of a course of changing from the first transmittance to the second transmittance from out of the plural divisional exposures are determined based on plural second realistic transmittances determining a course of changing from the first transmittance to the second transmittance via plural mid transmittances with the change time within the drive time, and a maximum disparity, which is a largest disparity between the plural mid transmittances and the second transmittance, is smaller than the first disparity.

In the second group of exemplary embodiments according to the present disclosure, a fifteenth aspect according to the present disclosure is the control device according to the thirteenth aspect, wherein in cases in which the change time and the drive time have exceeded a seventh threshold value, the first disparity has exceeded the preset disparity, and also a transmittance change time that is time needed to change from the first transmittance to the fourth transmittance is less than an eighth threshold value, the divisional exposures of a course of changing from the first transmittance to the second transmittance from out of the plural divisional exposures are determined based on the plural second realistic transmittances.

In the second group of exemplary embodiments according to the present disclosure, a sixteenth aspect according to the present disclosure is the control device according to the fourteenth aspect, wherein in cases in which a disparity between the change time and the drive time has exceeded a ninth threshold value, the first disparity has exceeded the preset disparity, and also a transmittance change time that is time needed to change from the first transmittance to the fourth transmittance is less than a tenth threshold value, the divisional exposures of a course of changing from the first transmittance to the second transmittance from out of the plural divisional exposures are determined based on the plural second realistic transmittances.

In the second group of exemplary embodiments according to the present disclosure, a seventeenth aspect according to the present disclosure is the control device according to the fifteenth aspect or the sixteenth aspect, wherein the plural first divisional exposures are determined based on a frame number determined on a basis of a fifth frame number, which is a frame number needed to change from the first transmittance to the second transmittance via the plural second realistic transmittances, and of a sixth frame number, which is a frame number corresponding to the drive time, and based on the target exposure.

In the second group of exemplary embodiments according to the present disclosure, an eighteenth aspect according to the present disclosure is the control device according to the seventeenth aspect, wherein the plural first divisional exposures are determined based on plural third realistic transmittances determining a course of changing from the first transmittance to the second transmittance via the plural mid transmittances with the change time within the drive time, on an aperture value of the aperture, and on a sensitivity and/or shutter speed set in the imaging apparatus to match the target exposure.

In the second group of exemplary embodiments according to the present disclosure, a nineteenth aspect according to the present disclosure is the control device according to any aspect from the second aspect to the eighteenth aspect, wherein in cases in which the transmittance is not able to track changes in aperture value of the aperture, exposures of the plural frames are determined based on the first transmittance and the drive time.

In the second group of exemplary embodiments according to the present disclosure, a twentieth aspect according to the present disclosure is the control device according to any aspect from the second aspect to the nineteenth aspect, wherein in cases in which the transmittance is not able to track changes in aperture value of the aperture and also a change amount of the aperture value is a first preset change amount or lower, exposures of the plural frames are determined based on the first transmittance and the drive time.

In the second group of exemplary embodiments according to the present disclosure, a twenty-first aspect according to the present disclosure is the control device according to any aspect of the second aspect to the twentieth aspect, wherein in cases in which a change amount of the aperture value has exceeded a second preset change amount due to the aperture value being updated while exposures of the plural frames are being controlled, exposures of the plural frames are updated by a method according to trackability of the transmittance with respect to a disparity between the aperture value prior to update and the aperture value post update.

In the second group of exemplary embodiments according to the present disclosure, a twenty-second aspect according to the present disclosure is the control device according to any aspect from the first aspect to the twenty-first aspect, wherein the plural frames are obtained by the imaging performed based on a preset frame rate.

In the second group of exemplary embodiments according to the present disclosure, a twenty-third aspect according to the present disclosure is an imaging apparatus including the control device according to any aspect from the first aspect to the twenty-second aspect, and an image sensor employed in the imaging.

In the second group of exemplary embodiments according to the present disclosure, a twenty-fourth aspect according to the present disclosure is a control method including, based on a transmittance of an electronic dimmer filter mounted to an imaging apparatus including a movable aperture and on a drive time of the aperture, controlling exposures of plural frames obtained by imaging performed with the imaging apparatus.

In the second group of exemplary embodiments according to the present disclosure, a twenty-fifth aspect according to the present disclosure is a program that causes a computer to execute processing including, based on a transmittance of an electronic dimmer filter mounted to an imaging apparatus including a movable aperture and on a drive time of the aperture, controlling exposures of plural frames obtained by imaging performed with the imaging apparatus.

In a third group of exemplary embodiments according to the present disclosure, a first aspect according to the present disclosure is a control device including a processor. The processor performs control of, in cases in which there is switching from one to the other from out of an in-use state in which an electronic dimmer filter mounted to an imaging apparatus is used or a non-use state in which the electronic dimmer filter is not used, acquiring a target exposure of the imaging apparatus after switching, and monotonously changing exposures of plural frames obtained by imaging performed by the imaging apparatus at least in a switching time needed for switching from the one to the other by changing toward the target exposure.

In the third group of exemplary embodiments according to the present disclosure, a second aspect according to the present disclosure is the control device according to the first aspect, wherein plural divisional exposures determined based on a first frame number, which is a frame number corresponding to the switching time, and on the target exposure are applied for exposures of the plural frames.

In the third group of exemplary embodiments according to the present disclosure, a third aspect according to the present disclosure is the control device according to the first aspect or the second aspect, wherein the plural divisional exposures are changed monotonously is sequence applied for the exposures of the plural frames.

In the third group of exemplary embodiments according to the present disclosure, a fourth aspect according to the present disclosure is the control device according to the second aspect or the third aspect, wherein the divisional exposures are determined based on the target exposure, an exposure currently set on the imaging apparatus, a proportion with respect to the frame of a range where the electronic dimmer filter has an effect on the frame, and a remaining frame number corresponding to a remaining time until completion of the switching.

In the third group of exemplary embodiments according to the present disclosure, a fifth aspect according to the present disclosure is the control device according to any aspect from the second aspect to the fourth aspect, wherein the plural frames are obtained by the imaging performed based on a preset frame rate, and the first frame number is determined based on the switching time and the preset frame rate.

In the third group of exemplary embodiments according to the present disclosure, a sixth aspect according to the present disclosure is the control device according to any aspect from the second aspect to the fifth aspect, wherein in cases in which a change amount of brightness of an imaging subject has exceeded a reference change amount while the plural divisional exposures are being applied in sequence for the exposures of the plural frames, the target exposure is updated, and the plural divisional exposures are updated based on a second frame number, which is a frame number corresponding to a remaining time until completion of the switching, and on the updated target exposure.

In the third group of exemplary embodiments according to the present disclosure, a seventh aspect according to the present disclosure is the control device according to any aspect from the second aspect to the sixth aspect, wherein in cases in which a change instruction to change the target exposure has been given from outside while the plural divisional exposures are being applied in sequence for the exposures of the plural frames, the target exposure is updated, and the plural divisional exposures are updated based on a third frame number, which is a frame number corresponding to a remaining time until completion of the switching, and on the updated target exposure.

In the third group of exemplary embodiments according to the present disclosure, an eighth aspect according to the present disclosure is the control device according to any aspect from the first aspect to the seventh aspect, wherein in cases in which the target exposure lies outside an exposure range trackable by the switching, a notification or alarm is given that the target exposure lies outside the exposure range.

In the third group of exemplary embodiments according to the present disclosure, a ninth aspect according to the present disclosure is the control device according to any aspect from the first aspect to the eighth aspect, wherein in cases in which the target exposure lies outside an exposure range trackable by the switching, the exposure currently set on the imaging apparatus is maintained in a condition that a cancel instruction to cancel the switching has been given from outside.

In the third group of exemplary embodiments according to the present disclosure, a tenth aspect according to the present disclosure is the control device according to any aspect from the first aspect to the tenth aspect, wherein in the in-use state the electronic dimmer filter is inserted onto an optical path of the imaging apparatus, and in the non-use state the electronic dimmer filter is removed from the optical path.

In the third group of exemplary embodiments according to the present disclosure, an eleventh aspect according to the present disclosure is the control device according to the tenth aspect, wherein the imaging apparatus includes a translucent filter having optical path equivalent to an optical path length of the electronic dimmer filter, the electronic dimmer filter and the translucent filter are inserted and removed selectively from the optical path, in the in-use state the electronic dimmer filter is inserted onto the optical path and the translucent filter is removed from the optical path, and in the non-use state the translucent filter is inserted onto the optical path and the electronic dimmer filter is removed from the optical path.

In the third group of exemplary embodiments according to the present disclosure, a twelfth aspect according to the present disclosure is an imaging apparatus including the control device according to any aspect from the first aspect to the eleventh aspect, and an image sensor employed in the imaging.

In the third group of exemplary embodiments according to the present disclosure, a thirteenth aspect according to the present disclosure is a control method including performing control of, in cases in which there is switching from one to the other from out of an in-use state in which an electronic dimmer filter mounted to an imaging apparatus is used or a non-use state in which the electronic dimmer filter is not used, acquiring a target exposure of the imaging apparatus after switching, and monotonously changing exposures of plural frames obtained by imaging performed by the imaging apparatus at least in a switching time needed for switching from the one to the other by changing toward the target exposure.

In the third group of exemplary embodiments according to the present disclosure, a fourteenth aspect according to the present disclosure is a program that causes a computer to execute processing including performing control of, in cases in which there is switching from one to the other from out of an in-use state in which an electronic dimmer filter mounted to an imaging apparatus is used or a non-use state in which the electronic dimmer filter is not used, acquiring a target exposure of the imaging apparatus after switching, and monotonously changing exposures of plural frames obtained by imaging performed by the imaging apparatus at least in a switching time needed for switching from the one to the other by changing toward the target exposure.

### BRIEF DESCRIPTION OF THE DRAWINGS

Exemplary embodiments of the present disclosure will be described in detail based on the following figures, wherein:

FIG. 1 is a schematic configuration diagram illustrating an example of an overall configuration of an imaging apparatus;

FIG. 2 is a schematic configuration diagram illustrating an example of a hardware configuration of an optical system and an electrical system of an imaging apparatus;

FIG. 3 is a schematic diagram illustrating an example of a mode in which a brightness of frames is changed monotonously by changing a transmittance of an electronic ND filter within a target frame number;

FIG. 4 is a schematic diagram illustrating an example of a mode in which a transmittance of an electronic ND filter has been changed to achieve a target exposure, but the target exposure was not attained within the target frame number (namely, the change of the transmittance of the electronic ND filter was late for the target frame number);

FIG. 5 is a block diagram illustrating an example of a mode of operation of a system controller;

FIG. 6 is a schematic diagram illustrating an example of part of processing content of exposure control processing performed by a processor;

FIG. 7 is a schematic diagram illustrating an example of part of processing content of exposure control processing performed by a processor;

FIG. 8 is a schematic diagram illustrating an example of part of processing content of exposure control processing performed by a processor;

FIG. 9 is a schematic diagram illustrating an example of part of processing content of exposure control processing performed by a processor;

FIG. 10 is a schematic diagram illustrating an example of part of processing content of exposure control processing performed by a processor;

FIG. 11A is a flowchart illustrating an example of a flow of exposure control processing according to a first exemplary embodiment;

FIG. 11B is a continuation of the flowchart illustrated in FIG. 11A;

FIG. 12A is a flowchart illustrating an example of a flow of exposure control processing according to a second exemplary embodiment;

FIG. 12B is a continuation of the flowchart illustrated in FIG. 12A;

FIG. 12C is a continuation of the flowchart illustrated in FIG. 12A;

FIG. 13A is a flowchart illustrating an example of a flow of exposure control processing according to a third exemplary embodiment;

FIG. 13B is a continuation of the flowchart illustrated in FIG. 13A;

FIG. 14A is a flowchart illustrating an example of a flow of exposure control processing according to a fourth exemplary embodiment;

FIG. 14B is a continuation of the flowchart illustrated in FIG. 14A;

FIG. 14C is a continuation of the flowchart illustrated in FIG. 14B;

FIG. 14D is a continuation of the flowchart illustrated in FIG. 14B and FIG. 14C;

FIG. 15 is a configuration diagram illustrating an example of part of the processing content of exposure control processing according to a fourth exemplary embodiment performed by a processor;

FIG. 16 is a flowchart illustrating an example of a flow of exposure control processing according to a fifth exemplary embodiment;

FIG. 17 is a schematic diagram illustrating an example of changes of transmittance and changes of aperture value for a case in which a current aperture value is changed to a target aperture value before reaching a target frame number with the brightness of plural frames also being held constant;

FIG. 18 is a schematic diagram illustrating an example of changes of transmittance and changes of aperture value for a case in which transmittance of an electronic ND filter is changed but the change of transmittance of the electronic ND filter was late for a target frame number;

FIG. 19 is a block diagram illustrating an example of a mode of operation of a system controller;

FIG. 20 is a schematic diagram illustrating an example of part of processing content of exposure control processing performed by a processor in cases in which an aperture value is fixed;

FIG. 21 is a schematic diagram illustrating an example of part of processing content of exposure control processing performed by a processor in cases in which an aperture value is fixed;

FIG. 22 is a schematic diagram illustrating an example of part of processing content of exposure control processing performed by a processor in cases in which an aperture value is fixed;

FIG. 23 is a schematic diagram illustrating an example of part of processing content of exposure control processing performed by a processor in cases in which an aperture value is fixed;

FIG. 24 is a schematic diagram illustrating an example of part of processing content of exposure control processing performed by a processor in cases in which an aperture value is fixed;

FIG. 25 is a schematic diagram illustrating an example of part of processing content of exposure control processing performed by a processor in cases in which an aperture value is changed and a change portion of the aperture value is not trackable with an electronic ND filter;

FIG. 26 is a schematic diagram illustrating an example of part of processing content of exposure control processing performed by a processor in cases in which an aperture value is changed and a change portion of the aperture value is not trackable with an electronic ND filter;

FIG. 27 is a schematic diagram illustrating an example of part of processing content of exposure control processing performed by a processor in cases in which an aperture value is changed and a change portion of the aperture value is not trackable with an electronic ND filter;

FIG. 28 is a schematic diagram illustrating an example of part of processing content of exposure control processing performed by a processor in cases in which an aperture value is changed and a change portion of the aperture value is trackable with an electronic ND filter;

FIG. 29 is a schematic diagram illustrating an example of conditions when first control or second control are performed in cases in which an aperture value is changed and a change portion of the aperture value is trackable with an electronic ND filter;

FIG. 30 is a schematic diagram illustrating an example of content of first control;

FIG. 31 is a schematic diagram illustrating an example of content of first control;

FIG. 32 is a schematic diagram illustrating an example of content of first control;

FIG. 33 is a schematic diagram illustrating an example of content of first control;

FIG. 34 is a schematic diagram illustrating an example of content of first control;

FIG. 35 is a schematic diagram illustrating an example of content of second control;

FIG. 36 is a schematic diagram illustrating an example of content of second control;

FIG. 37 is a schematic diagram illustrating an example of content of second control;

FIG. 38 is a schematic diagram illustrating an example of content of second control;

FIG. 39 is a schematic diagram illustrating an example of content of second control;

FIG. 40A is a flowchart illustrating an example of a flow of exposure control processing according to a seventh exemplary embodiment;

FIG. 40B is a continuation of the flowchart illustrated in FIG. 40A;

FIG. 40C is a continuation of the flowchart illustrated in FIG. 40B;

FIG. 40D is a continuation of the flowchart illustrated in FIG. 40A;

FIG. 40E is a continuation of the flowchart illustrated in FIG. 40A;

FIG. 40F is a continuation of the flowchart illustrated in FIG. 40E;

FIG. 40G is a continuation of the flowchart illustrated in FIG. 40E;

FIG. 41 is a flowchart illustrating an example of a flow of exposure control processing according to an eighth exemplary embodiment;

FIG. 42A is a flowchart illustrating an example of a flow of exposure control processing according to a ninth exemplary embodiment;

FIG. 42B is a continuation of the flowchart illustrated in FIG. 42A;

FIG. 42C is a flowchart illustrating an example of a flow of exposure control processing according to the ninth exemplary embodiment;

FIG. 42D is a continuation of the flowchart illustrated in FIG. 42C;

FIG. 42E is a flowchart illustrating an example of a flow of exposure control processing according to the ninth exemplary embodiment;

FIG. 42F is a continuation of the flowchart illustrated in FIG. 42E;

FIG. 43A is a flowchart illustrating an example of a flow of exposure control processing according to a tenth exemplary embodiment;

FIG. 43B is a continuation of the flowchart illustrated in FIG. 43A;

FIG. 43C is a continuation of the flowchart illustrated in FIG. 43A;

FIG. 44 is a schematic diagram illustrating an example of a change mode of plural predicted transmittances containing plural mid transmittances;

FIG. 45 is a flowchart illustrating a modified example of a flow of exposure control processing according to each exemplary embodiment;

FIG. 46 is a schematic diagram illustrating an example of a change mode of an ND region;

FIG. 47 is a block diagram illustrating an example of a mode of operation of a system controller;

FIG. 48 is a schematic diagram illustrating an example of part of processing content of exposure control processing performed by a processor;

FIG. 49 is a schematic diagram illustrating an example of part of processing content of exposure control processing performed by a processor;

FIG. 50 is a flowchart illustrating an example of exposure control processing according to an eleventh exemplary embodiment;

FIG. 51 is a schematic diagram illustrating an example of a mode of calculating plural divisional exposures applied for exposures of a 0^{th} frame to a 5^{th} frame of frames contained in plural frames obtained by performing live-view image imaging, and of setting the plural divisional exposures;

FIG. 52A is a flowchart illustrating an example of a flow of exposure control processing according to a twelfth exemplary embodiment;

FIG. 52B is a continuation of the flowchart illustrated in FIG. 52A;

FIG. 53A is a flowchart illustrating an example of exposure control processing according to a thirteenth exemplary embodiment;

FIG. 53B is a continuation of the flowchart illustrated in FIG. 53A;

FIG. 54A is a flowchart illustrating an example of exposure control processing according to a fourteenth exemplary embodiment;

FIG. 54B is a continuation of the flowchart illustrated in FIG. 54A;

FIG. 54C is a continuation of the flowchart illustrated in FIG. 54B; and

FIG. 55 is a flowchart illustrating an example of exposure control processing according to a fifteenth exemplary embodiment.

### DETAILED DESCRIPTION

Description follows regarding examples of exemplary embodiments of a control device, an imaging apparatus, a control method, and a program according to the present disclosure, with reference to the appended drawings.

A first group of exemplary embodiments according to the present disclosure are exemplary embodiments that provide a control device, an imaging apparatus, a control method, and a program that are capable of suppressing a brightness between plural frames obtained by imaging performed with an imaging apparatus from suddenly changing accompanying switching of a transmittance of an electronic dimmer filter, and description follows regarding a first to a sixth exemplary embodiment as examples thereof. A second group of exemplary embodiments according to the present disclosure are exemplary embodiments that provide a control device, an imaging apparatus, a control method, and a program that are capable of holding a constant brightness of plural frames obtained by imaging performed with an imaging apparatus even while an aperture is being driven, and description follows regarding a seventh to a tenth exemplary embodiment as examples thereof. Moreover, a third group of exemplary embodiments according to the present disclosure are exemplary embodiments that provide a control device, an imaging apparatus, a control method, and a program that are capable of suppressing a brightness from suddenly changing between plural frames in the course of attaining a target exposure for an exposure of plural frames obtained by being imaged with an imaging apparatus while switching between one state or the other state from out of an in-use state in which an electronic dimmer filter mounted to the imaging apparatus is used and a non-use state in which the electronic dimmer filter is not used, and description follows regarding an eleventh to a fifteenth exemplary embodiment as examples thereof.

First the terminology employed in the following description will be explained.

CPU indicates an abbreviation for “Central Processing Unit”. GPU indicates an abbreviation for “Graphics Processing Unit”. GPGPU indicates an abbreviation for “General-purpose computing on graphics processing units”. APU indicates an abbreviation for “Accelerated Processing Unit”. TPU indicates an abbreviation for “Tensor processing unit”. NVM indicates an abbreviation for “Non-volatile memory”. RAM indicates an abbreviation for “Random Access Memory”. IC indicates an abbreviation for “Integrated Circuit”. ASIC indicates an abbreviation for “Application Specific Integrated Circuit”. PLD indicates an abbreviation for “Programmable Logic Device”. FPGA indicates an abbreviation for “Field-Programmable Gate Array”. SoC indicates an abbreviation for “System-on-a-chip”. SSD indicates an abbreviation for “Solid State Drive”. USB indicates an abbreviation for “Universal Serial Bus”. EEPROM indicates an abbreviation for “Electrically Erasable and Programmable Read Only Memory”. I/F indicates an abbreviation for “Interface”. UI indicates an abbreviation for “User Interface”. CMOS indicates an abbreviation for “Complementary Metal Oxide Semiconductor”. CCD indicates an abbreviation for “Charge Coupled Device”. fps indicates an abbreviation for “Frames per second”. MF indicates an abbreviation for “Manual Focus”. AF indicates an abbreviation for “Auto Focus”. AE indicates an abbreviation for “Auto Exposure”. ND indicates an abbreviation for “Neutral Density”. EL indicates an abbreviation for “Electro Luminescence”.

In the following description, a number-appended processor (hereinafter simply referred to as “processor”) may be configured by a single physical or virtual processing unit, or may be configured by a combination of plural physical or virtual processing units. A processor may also be configured from a single type of processing unit, or may be configured from a combination of plural types of processing unit. Examples of such processing units include a CPU, a GPU, a GPGPU, an APU, a TPU, or the like.

In the following description, a number-appended memory is memory such as RAM or the like where information is stored temporarily, and is employed as working memory by a processor.

In the following description, a number-appended storage is a single or plural non-volatile storage device(s) that store various programs, various parameters, and the like. Examples of non-volatile storage devices include flash memory, a magnetic disk, a magnetic tape, or the like. Another example of storage includes cloud storage.

In the following exemplary embodiments, a number-appended external I/F is employed for exchange of various information between plural inter-connected devices. An example of an external I/F is a USB interface. A communication I/F including a communication processor and an antenna or the like may be employed as the external I/F. The communication I/F is employed for communication between plural computers. Examples of a communication standard employed for the communication I/F include wireless communication standards such as 5G, Wi-Fi (registered trademark), Bluetooth (registered trademark), or the like.

In the following exemplary embodiments “A and/or B” means the same as “at least one out of A or B”. Namely, “A and/or B” may be A alone, may be B alone, or may be a combination of A and B. Moreover, in the present specification, when the expression “and/or” is employed to connect three or more items then similar logic to that of “A and/or B” should be applied.

### First Exemplary Embodiment

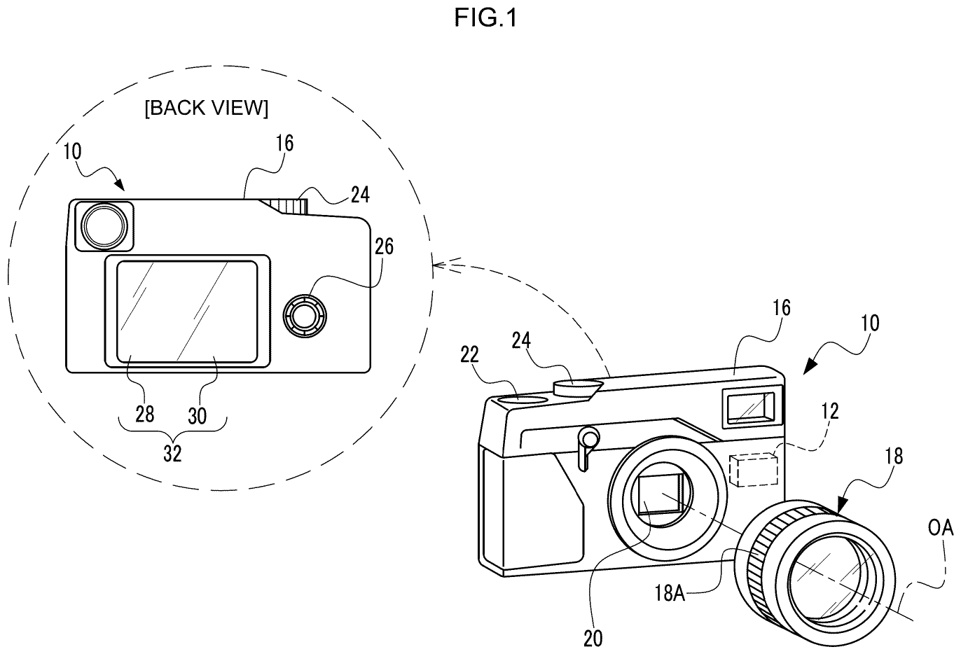

As illustrated in the example in FIG. 1, an imaging apparatus 10 is an apparatus for imaging an imaging subject, and includes a system controller 12, an imaging apparatus body 16, and an interchangeable lens 18. The imaging apparatus 10 is an example of an “imaging apparatus” according to the present disclosure, and the system controller 12 is an example of a “control device” and a “computer” according to the present disclosure. The system controller 12 is built-in to the imaging apparatus body 16 and performs overall control of the imaging apparatus 10. The interchangeable lens 18 is interchangeably mounted to the imaging apparatus body 16. A focus ring 18A is provided to the interchangeable lens 18. The focus ring 18A is operated by a user or the like of the imaging apparatus 10 (hereinafter simply referred to as “user” when the user is performing focus adjustment manually for an imaging subject using the imaging apparatus 10.

The example illustrated in FIG. 1 illustrates an example of an interchangeable lens type of digital camera as the imaging apparatus 10, however, this is merely an example thereof, and a fixed lens type of digital camera may be employed therefor. Moreover, the present disclosure is applicable to a smart device, a wearable terminal, a cinema camera, a television broadcast video camera, surveillance video camera, an endoscope, a cell examination device, an ophthalmological examination device, a surgical microscope, or the like. A smart device, a wearable terminal, a cinema camera, a television broadcast video camera, surveillance video camera, an endoscope, a cell examination device, an ophthalmological examination device, a surgical microscope, or the like are examples of an “imaging apparatus” according to the present disclosure.

An image sensor 20 is provided to the imaging apparatus body 16. The image sensor 20 is an example of an “image sensor” according to the present disclosure. The image sensor 20 is a CMOS image sensor. The image sensor 20 images an imaging subject that is a subject of imaging. When the interchangeable lens 18 has been mounted to the imaging apparatus body 16, light of an imaging subject, which is light representing an imaging subject, passes through the interchangeable lens 18 and forms an image on the image sensor 20, and image data representing an image of the imaging subject is generated by the image sensor 20.

Although in the present first exemplary embodiment a CMOS image sensor is given as an example of the image sensor 20, the present disclosure is not limited thereto and, for example, the present disclosure encompasses configurations in which the image sensor 20 is a variety of other types of image sensors, such as a CCD image sensor or the like.

A release button 22 and a dial 24 are provide on an upper face of the imaging apparatus body 16. The dial 24 is operated when setting an imaging related operation mode, a replay related operation mode, or the like, and an imaging mode, a replay mode, and a setting mode are selectively set as the operation mode on the imaging apparatus 10 by operating the dial 24. The imaging mode is an operation mode on the imaging apparatus 10 for performing imaging. Imaging is implemented by operating a mechanical shutter (omitted in the drawings) and/or an electronic shutter (omitted in the drawings). The replay mode is an operation mode to replay images (for example still images and/or video images) that have been obtained by recording imaging in the imaging mode. The setting mode is an operation mode to set the imaging apparatus 10, such as when setting various setting values employed in control related to imaging.

The release button 22 functions as an imaging preparation instruction section and an imaging instruction section, and is able to detect two steps of press operation, an imaging preparation instruction state and an imaging instruction state. For example, the imaging preparation instruction state indicates a state pressed from a standby position to a midway position (for example, a half-press position), and the imaging instruction state indicates a state pressed past the midway position to a final press position (for example, a full-press position). Depending on the configuration of the imaging apparatus 10, the imaging preparation instruction state may be a state in which a finger of a user has contacted the release button 22, and the imaging instruction state may be a state in which the finger of the operating user has transitioned from the state contacting the release button 22 to a state separated therefrom.

An instruction key 26 and a touch panel display 32 are provided on a back face of the imaging apparatus body 16.

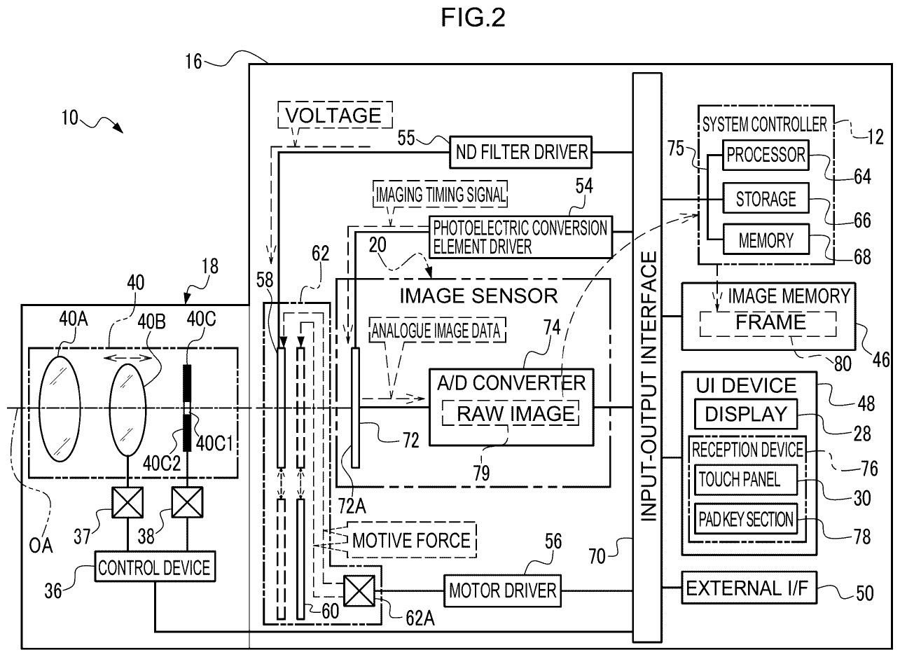

The touch panel display 32 includes a display 28 and a touch panel 30 (see also FIG. 2). Examples of the display 28 include an EL display (for example, an organic EL display or an inorganic EL display). The display 28 may be various other types of display other than an EL display, such as a liquid crystal display or the like.

The display 28 displays an image and/or text information and the like. When the imaging apparatus 10 is in imaging mode, the display 28 is employed to display imaging using live-view images, namely live-view images obtained by performing continuous imaging. Reference here to “live-view images” indicates a video image for display based on image data obtained by being imaged with the image sensor 20. The imaging performed to obtain live-view images (hereafter also referred to as “live-view image imaging”) is, for example, performed based on a frame rate of 60 fps. 60 fps is merely an example thereof, and the frame rate may be less than 60 fps (for example 30 fps), and may be a frame rate exceeding 60 fps (for example 180 fps).

When an instruction for still image imaging is given to the imaging apparatus 10 through the release button 22, the display 28 is employed to display still images obtained by performing still image imaging. The display 28 is also employed to display a replay image or the like when the imaging apparatus 10 is in replay mode. Furthermore, when the imaging apparatus 10 is in setting mode, the display 28 is employed to display various menus of a selectable menu screen, and is also employed to display a setting screen for setting various setting values and the like employed for control related to imaging.

The touch panel 30 is a transmission touch panel, and is superimposed on the surface of a display area of the display 28. The touch panel 30 receives instructions from a user (for example, an imaging preparation instruction and/or an imaging instruction or the like) by detecting contact of a finger, stylus pen, or the like on an instruction body.

In the present first exemplary embodiment, although an example of the touch panel display 32 is given for an outer touch panel display in which the touch panel 30 is superimposed on the surface of the display area of the display 28, this is merely an example thereof. For example, an on-cell or in-cell touch panel display is applicable as the touch panel display 32.

The instruction key 26 receives various instructions. Reference here to “various instructions” indicates, for example, an instruction to display a menu screen, an instruction to select one or more menu, an instruction to confirm selected content, an instruction to erase selected content, and various instructions such as to zoom in, zoom out, move on a frame, or the like. These instructions may be performed by the touch panel 30.

As in the example illustrated in FIG. 2, the image sensor 20 includes a photoelectric conversion element 72. The photoelectric conversion element 72 includes a photoreception surface 72A. The photoelectric conversion element 72 is disposed inside the imaging apparatus body 16 such that a center of the photoreception surface 72A is aligned with an optical axis OA (see FIG. 1). The photoelectric conversion element 72 includes plural photosensitive pixels arranged in a matrix pattern, with the photoreception surface 72A formed by the plural photosensitive pixels. Each of the photosensitive pixels includes a microlens (omitted in the drawings). Each of the photosensitive pixels is a physical pixel including a photodiode (omitted in the drawings), and performs photoelectric conversion on received light and outputs an electrical signal corresponding the amount of received light.

In the plural photosensitive pixels, a color filter (omitted in the drawings) of red (R), green (G), or blue (B) is arranged in a matrix pattern using a preset pattern array (for example, a Bayer array, a G stripe R/G total checkered pattern, an X-trans (registered trademark) array, a honeycomb array, or the like).

The interchangeable lens 18 includes an imaging lens 40. The imaging lens 40 includes an object lens 40A, a variable magnification lens 40B, and a movable aperture 40C. The movable aperture 40C is an example of a “movable aperture” according to the present disclosure.

The object lens 40A, the variable magnification lens 40B, and the aperture 40C are arranged along the optical axis OA in the sequence of the object lens 40A, the variable magnification lens 40B, and the aperture 40C from the imaging subject side (object side) through to the imaging apparatus body 16 side (image side).

The interchangeable lens 18 includes a control device 36, a first actuator 37, and a second actuator 38. The control device 36 performs overall control of the interchangeable lens 18 according to instructions from the imaging apparatus body 16. The control device 36 is, for example, a device including a computer equipped with a CPU, NVM, RAM, and the like. The RAM of the control device 36 is employed as a working memory temporarily stored with various information. In the control device 36, the CPU performs overall control of the imaging lens 40 by reading programs as required from the NVM, and by executing various read programs in the RAM.

Note that although a device including a computer is given as an example of the control device 36, this is merely an example thereof, and a device including an ASIC, an FPGA, and/or a PLD may be employed therefor. A device implemented by, for example, combining a hardware configuration and a software configuration may be employed as the control device 36.

The first actuator 37 includes a variable magnification slide mechanism (omitted in the drawings) and a variable magnification motor (omitted in the drawings). The variable magnification lens 40B is attached to the variable magnification slide mechanism so as to be able to slide along the optical axis OA. The variable magnification motor is connected to the variable magnification slide mechanism, and the variable magnification slide mechanism moves the variable magnification lens 40B along the optical axis OA by operating under receipt of motive force of the variable magnification motor.

The second actuator 38 includes a motive force transmission mechanism (omitted in the drawings) and an aperture motor (omitted in the drawings). The aperture 40C includes an opening 40C1, and is an aperture having a variable size of the opening 40C1. The opening 40C1 is, for example, formed from plural blades of a diaphragm blade 40C2. The plural blades of the diaphragm blade 40C2 are coupled to the motive force transmission mechanism. The aperture motor is also connected to the motive force transmission mechanism, and the motive force transmission mechanism transmits the motive force of the aperture motor to the plural blades of the diaphragm blade 40C2. The plural blades of the diaphragm blade 40C2 change the size of the opening 40C1 by operating under receipt of motive force transmitted from the motive force transmission mechanism. The aperture 40C adjusts an exposure by changing the size of the opening 40C1.

The variable magnification motor and the aperture motor are connected to the control device 36, with the driving of each of the variable magnification motor and the aperture motor being controlled by the control device 36. Note that a stepping motor is employed as an example of the variable magnification motor and the aperture motor in the present first exemplary embodiment. Accordingly, the variable magnification motor and the aperture motor operate synchronized to a pulse signal under a command from the control device 36. Although an example is given here in which the variable magnification motor and the aperture motor are provided to the interchangeable lens 18, this is merely an example thereof, and it is sufficient as long as at least one out of the variable magnification motor or the aperture motor may be provided to the imaging apparatus body 16. The configuration elements and/or the operation method of the interchangeable lens 18 may be changed as required.

In the imaging apparatus 10, either a MF mode or an AF mode is selectively set according to an instruction given to the imaging apparatus body 16 when in the imaging mode. The MF mode is an operation mode to align focus manually. In the MF mode, for example, a focal point is adjusted by the focus ring 18A or the like being operated by a user, and by the variable magnification lens 40B being moved along the optical axis OA by a movement amount corresponding an operation amount of the focus ring 18A or the like.

In the AF mode, the focal point is adjusted by the imaging apparatus body 16 computing a focused position according to a distance to the imaging subject, and moving the variable magnification lens 40B toward the computed focused position. The focused position indicates a position on the optical axis OA of the variable magnification lens 40B in a focused state.

In the imaging apparatus 10, a manual exposure mode and an AE mode are selectively set according to instructions given to the imaging apparatus body 16 when in the imaging mode. The manual exposure mode is an operation mode to adjust the exposure manually. The AE mode is an operation mode to set the exposure automatically.

The imaging apparatus body 16 includes the image sensor 20, the system controller 12, an image memory 46, a UI device 48, an external I/F 50, a photoelectric conversion element driver 54, an ND filter driver 55, a motor driver 56, and an input-output interface 70. The image sensor 20 includes the photoelectric conversion element 72 and an A/D converter 74.

The system controller 12, the image memory 46, the UI device 48, the external I/F 50, the photoelectric conversion element driver 54, the ND filter driver 55, the motor driver 56, and the A/D converter 74 are connected to the input-output interface 70. The control device 36 of the interchangeable lens 18 is also connected to the input-output interface 70.

The system controller 12 includes a processor 64, storage 66, and memory 68. The processor 64 is an example of a “processor” according to the present disclosure.

The processor 64, the storage 66, and the memory 68 are inter-connected through a bus 75, and the bus 75 is connected to the input-output interface 70. Note that although, for simplicity in the drawings, the example illustrated in FIG. 2 is of a single bus as the bus 75, there may be plural busses. The bus 75 may be a serial bus, and may be a parallel bus including a data bus, an address bus, a control bus, or the like.

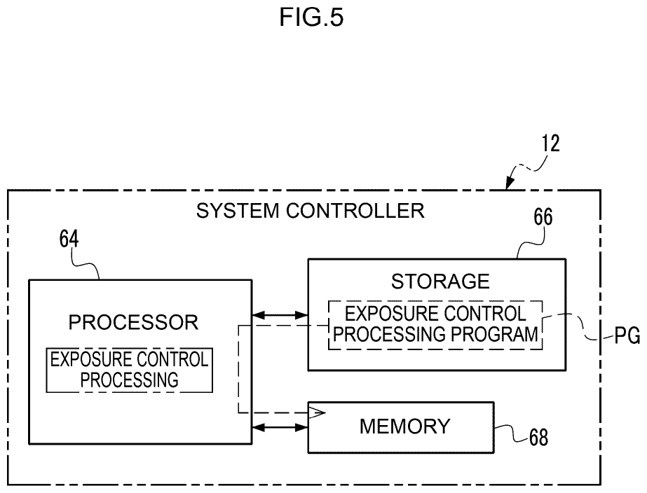

The storage 66 is a computer readable non-transitory storage medium, and is stored with various parameters and various programs. An exposure control processing program PG (see FIG. 5), described later, is included in the various programs. An EEPROM is an example of the storage 66. The memory 68 temporarily stores various information, and is employed as a working memory. RAM is an example of the memory 68.

The processor 64 reads a required program from the storage 66, and executes the read program in the memory 68. The processor 64 performs overall control of the imaging apparatus 10 according to the program being executed in the memory 68. Namely, in the example illustrated in FIG. 2, the image memory 46, the UI device 48, the external I/F 50, the photoelectric conversion element driver 54, the ND filter driver 55, the motor driver 56, the control device 36, and the like are controlled by the system controller 12.

The photoelectric conversion element driver 54 is connected to the photoelectric conversion element 72. According to an instruction from the processor 64, the photoelectric conversion element driver 54 supplies the photoelectric conversion element 72 with an imaging timing signal stipulating a timing of imaging to be performed by the photoelectric conversion element 72. The photoelectric conversion element 72 performs reset, light-exposure, and electrical signal output according to the imaging timing signal supplied from the photoelectric conversion element driver 54. A vertical synchronizing signal and a horizontal synchronizing signal are examples of the imaging timing signal.

The imaging subject light incident to the imaging lens 40 is formed as an image on the photoreception surface 72A by the imaging lens 40 when the interchangeable lens 18 has been mounted to the imaging apparatus body 16. Under control of the photoelectric conversion element driver 54, the photoelectric conversion element 72 performs photoelectric conversion of the imaging subject light received by the photoreception surface 72A, and outputs an electrical signal according to the amount of the imaging subject light to the A/D converter 74 as analogue image data representing the imaging subject light. Specifically, the A/D converter 74 reads analogue image data by single frame unit and for each horizontal line from the photoelectric conversion element 72 using a light-exposure sequence reading method.

The A/D converter 74 generates a RAW image 79 by digitalizing the analogue image data. The RAW image 79 is an image in which R pixels, G pixels, and B pixels are arrayed in a mosaic pattern.

The processor 64 acquires the RAW image 79 from the A/D converter 74, and performs image processing on the acquired RAW image 79.

Frames 80 are stored in the image memory 46. The frames 80 are images obtained by image processing being performed on the RAW image 79 by the processor 64.

The UI device 48 includes the display 28, and the processor 64 displays various information on the display 28. The UI device 48 also includes a reception device 76. The reception device 76 includes the touch panel 30 and a pad key section 78. The pad key section 78 is configured from plural pad keys including the instruction key 26 (see FIG. 1). The processor 64 operates according to various instructions received by the touch panel 30.

The external I/F 50 exchanges various information with devices present externally to the imaging apparatus 10 (hereafter referred to as “external devices”). The external devices (omitted in the drawings) such as a smart device, a personal computer, a server, USB memory, a memory card, and/or a printer and the like are directly or indirectly connected to the external I/F 50. The external I/F 50 is connected to a network (omitted in the drawings). The external I/F 50 exchanges information between a communication device (omitted in the drawings) such as a server on the network, and the system controller 12. For example, the external I/F 50 transmits information from the system controller 12 to the communication device over the network as required. The external I/F 50 also receives information transmitted from the communication device, and outputs the received information to the system controller 12 via the input-output interface 70.

The imaging apparatus 10 includes an electronic ND filter 58 and a clear glass 60. The electronic ND filter 58 is an example of an “electronic dimmer filter” according to the present disclosure. The electronic ND filter 58 and the clear glass 60 are installed in the imaging apparatus body 16. The electronic ND filter 58 and the clear glass 60 are disposed further to the imaging subject side than the photoreception surface 72A. The electronic ND filter 58 and the clear glass 60 are disposed in the sequence of the electronic ND filter 58 and the clear glass 60 from the imaging subject side through to the image side. Note that although an example is given here of an embodiment in which the electronic ND filter 58 and the clear glass 60 are installed to the imaging apparatus body 16, this is merely an example thereof, and at least the electronic ND filter 58 from out of the electronic ND filter 58 and the clear glass 60 may be installed to the interchangeable lens 18.

The electronic ND filter 58 is an electronic variable light-reduction filter that employs a material including a liquid crystal molecule changed in orientation by application of a voltage. The electronic ND filter 58 adjusts the amount of light that the electronic ND filter 58 transmits by changing the transmittance thereof across the board by application of a voltage. The transmittance of the electronic ND filter 58 is seamlessly changeable. Accordingly, for example, in cases in which an aperture value is maintained, a target exposure (for example, an exposure of the imaging apparatus 10 appropriate for the brightness of the imaging subject) is realized while a depth of field of the imaging subject is maintained as is by the transmittance of the electronic ND filter 58 being changed. Moreover, when the aperture value is maintained, the brightness of the frames 80 can be made to be a target brightness while the depth of field of the imaging subject is maintained by the transmittance of the electronic ND filter 58 being changed. Moreover, for example, in cases in which the aperture value is being changed, a constant exposure is able to be maintained even while the aperture value is being changed by the transmittance of the electronic ND filter 58 being changed so as to complement an amount of increase/decrease in exposure accompanying a change to the aperture value.

The ND filter driver 55 is connected to the electronic ND filter 58. The ND filter driver 55 controls the transmittance of the electronic ND filter 58 by applying a voltage to the electronic ND filter 58 according to instructions from the system controller 12.

The clear glass 60 is a translucent glass plate. An example of such a translucent glass plate is a transparent glass plate. The optical path length of the clear glass 60 is the same as the optical path length of the electronic ND filter 58. Note that although an example is given here of the clear glass 60, a transparent glass plate is merely an example, and the present disclosure encompasses configurations with a difference in optical path equivalent to a difference of optical path of the electronic ND filter 58, and translucent filters (for example, having a difference in optical path the same as the difference in optical path of the electronic ND filter 58, and a semi-transparent glass plate). Note that in the present first exemplary embodiment, the clear glass 60 is an example of a “translucent filter” according to the present disclosure.

The imaging apparatus 10 includes a shift mechanism 62. The shift mechanism 62 is installed to the imaging apparatus body 16. The shift mechanism 62 includes a motor 62A. A stepping motor is an example of the motor 62A. The shift mechanism 62 shifts the electronic ND filter 58 and the clear glass 60 in a direction intersecting with the optical axis OA by transmitting motive force generated by the motor 62A to the electronic ND filter 58 and the clear glass 60.

The motor driver 56 is connected to the motor 62A, and the motor 62A operates under control of the motor driver 56 according to instructions of the system controller 12. The motor 62A is mechanically connected to the electronic ND filter 58 and the clear glass 60 through plural gears. Under control of the motor driver 56 according to instructions of the system controller 12, the motor 62A imparts a motive force to the electronic ND filter 58 and the clear glass 60, and thereby selectively inserts the electronic ND filter 58 and the clear glass 60 into the optical path, or removes the electronic ND filter 58 and the clear glass 60 from the optical path.

Namely, in an in-use state in which the electronic ND filter 58 is being used (hereinafter simply referred to as a “in-use state”), the electronic ND filter 58 is inserted into the optical path, and the clear glass 60 is removed from the optical path. However, in a non-use state in which the electronic ND filter 58 is not being used (hereinafter simply referred to as a “non-use state”), the clear glass 60 is inserted into the optical path, and the electronic ND filter 58 is removed from the optical path. Note that in the present first exemplary embodiment, an example of the in-use state is given as a state in which the electronic ND filter 58 is used inside an effective pixel region of the photoelectric conversion element 72 (in other words, a state in which the electronic ND filter 58 imparts an effect to a range of the frame 80 displayed on the display 28).

The plural gears mechanically connecting the motor 62A to the electronic ND filter 58 and the clear glass 60 impart a motive force in a rotation direction of the motor 62A to the electronic ND filter 58, and impart a motive force in the opposite direction to the rotation direction of the motor 62A to the clear glass 60. For example, in cases in which a forward motive force is generated by the motor 62A, a forward motive force is imparted to the electronic ND filter 58, and a reverse motive force is imparted to the clear glass 60. Moreover, in cases in which a rearward motive force is generated by the motor 62A, a forward motive force is imparted to the clear glass 60, and a reverse motive force is imparted to the electronic ND filter 58. In this way, one out of the electronic ND filter 58 or the clear glass 60 is inserted into the optical path by the motive force of the motor 62A being imparted to the electronic ND filter 58 or the clear glass 60, and the other thereof is removed from the optical path. The optical path length of the electronic ND filter 58 and the optical path length of the clear glass 60 are the same as each other, and the clear glass 60 is inserted into the optical path even when the electronic ND filter 58 is removed from the optical path, with this meaning that the same optical path length is maintained to cases in which the electronic ND filter 58 is inserted into the optical path.

For example, due to the optical path length of the electronic ND filter 58 and the optical path length of the clear glass 60 being the same as each other, and due to the clear glass 60 being inserted into the optical path when the electronic ND filter 58 is in a non-use state removed from the optical path, the same optical path length is maintained to cases in which the electronic ND filter 58 is inserted into the optical path. Moreover, the electronic ND filter 58 is inserted into the optical path when the clear glass 60 is removed from the optical path when in the in-use state, and so the same optical path length is maintained to cases in which the clear glass 60 is inserted into the optical path.

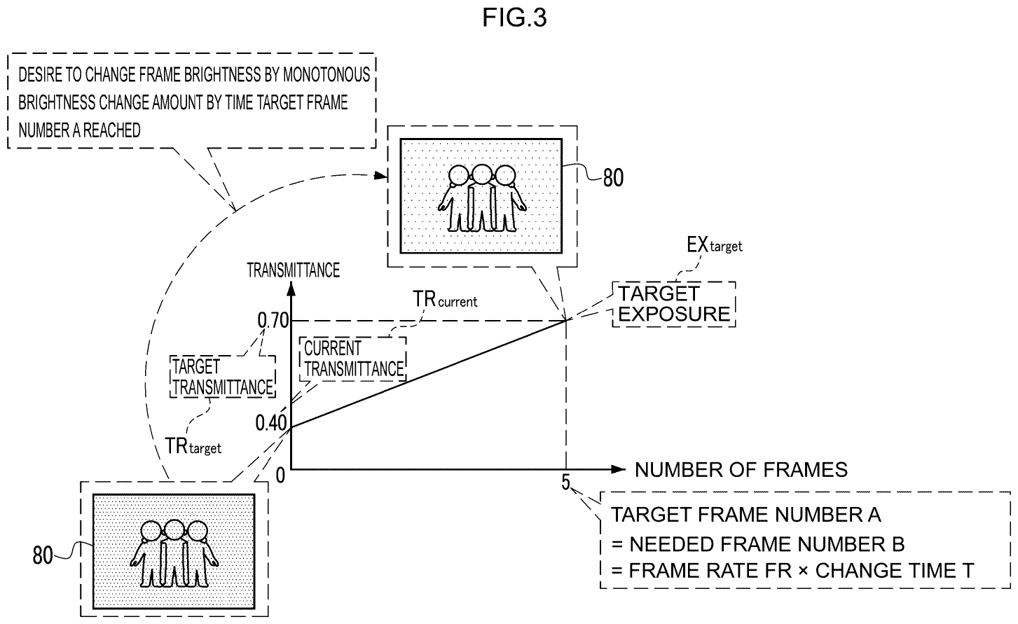

However, as in the example illustrated in FIG. 3, in cases in which plural frames 80 are obtained by performing live-view image imaging in AE mode, in the course of changing from the current frame 80 to a frame 80 a target frame number A later, preferably the brightness of the frames 80 is changed by a monotonous brightness change amount, instead of there being a sudden change to the brightness between plural frames 80. To achieve this, there is a need to appropriately set the exposure applied to each of the plural frames 80.

In the present first exemplary embodiment, the electronic ND filter 58 is installed to the imaging apparatus 10, and so the exposure applied to the frames 80 is determined according to the transmittance of the electronic ND filter 58, the aperture value of the aperture 40C (namely the F number), the shutter speed (for example, the shutter speed of a mechanical shutter when a mechanical shutter is employed, or the shutter speed of an electronic shutter when an electronic shutter is employed), and the sensitivity of the photoelectric conversion element 72 (for example, the ISO sensitivity). For example, the transmittance of the electronic ND filter 58 is controlled to control the exposure of the frame 80 while the aperture value of the aperture 40C (hereinafter simply referred to as “aperture value”), the shutter speed, and the sensitivity of the photoelectric conversion element 72 (hereinafter simply referred to as “sensitivity”) are all in a fixed state.

When the transmittance of the electronic ND filter 58 is changed from a current transmittance TR_{current}, which is the transmittance of the electronic ND filter 58 at a timing when the imaging apparatus 10 has started exposure calculation, to a target transmittance TR_{target}, enabling realization of a target exposure EX_{target} to make the brightness of the frame 80 a target brightness, a change time T, which is a time needed to change from the current transmittance TR_{current} to the target transmittance TR_{target}, differs depending on a relationship between the current transmittance TR_{current} and the target transmittance TR_{target}. When the transmittance of the electronic ND filter 58 is changed from the current transmittance TR_{current} to the target transmittance TR_{target} by a monotonous change amount, a difference in brightness between the frames 80 also changes monotonously therewith. If the target frame number A matches a needed frame number B, which is the number of frames needed during the course of change time T (=(the frame rate FR employed in live-view image imaging)×(the change time T)), then the transmittance of the electronic ND filter 58 attains the target transmittance TR_{target} at the point in time when the target frame number A of frames 80 have been obtained, and the target exposure EX_{target} is also achieved in accordance therewith.

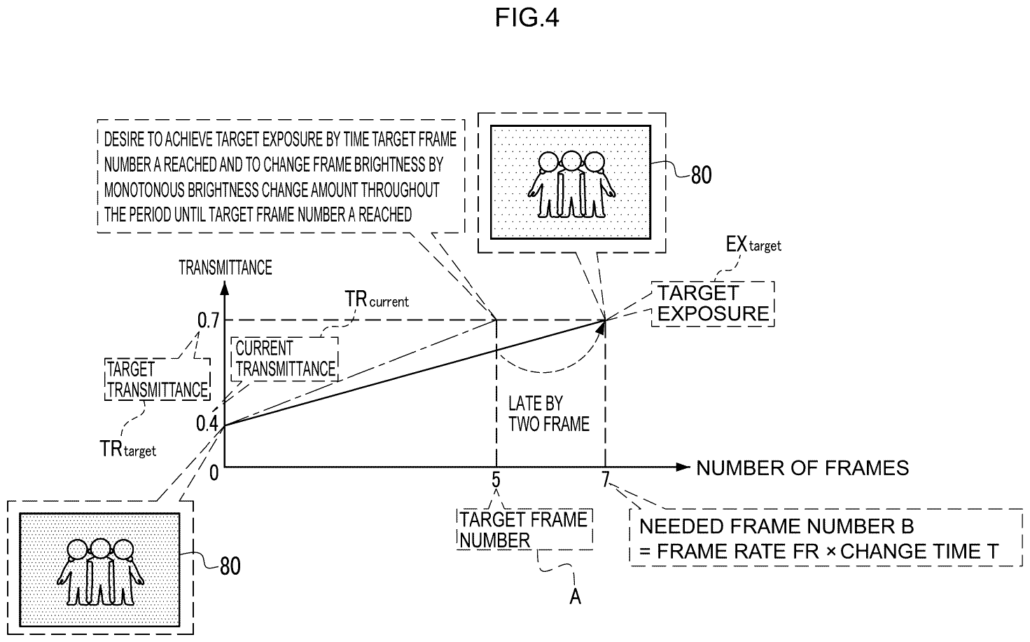

However, depending on the relationship between the current transmittance TR_{current} and the target transmittance TR_{target}, sometimes the needed frame number B exceeds the target frame number A, as illustrated in the example of FIG. 4, and in such cases the transmittance of the electronic ND filter 58 does not attain the target transmittance TR_{target} at the point in time when the target frame number A of frames 80 is obtained, with a delay in achieving the target exposure EX_{target}. In the example illustrated in FIG. 4, attaining the target transmittance TR_{target} and achieving the target exposure EX_{target} are delayed by two frames from the target frame number A.

Thus in the present first exemplary embodiment, exposure control processing is performed by the processor 64, as illustrated in the example of FIG. 5, in order to achieve the target exposure EX_{target} by the target frame number A, and to change the brightness of the frames 80 by a monotonous brightness change amount until reaching the target frame number A. An exposure control processing program PG is stored in the storage 66. The exposure control processing program PG is an example of a “program” according to the present disclosure. The processor 64 reads the exposure control processing program PG from the storage 66, and executes the read exposure control processing program PG in the memory 68. Exposure control processing is implemented by the processor 64 executing the exposure control processing program PG. Description follows regarding an example of the exposure control processing.

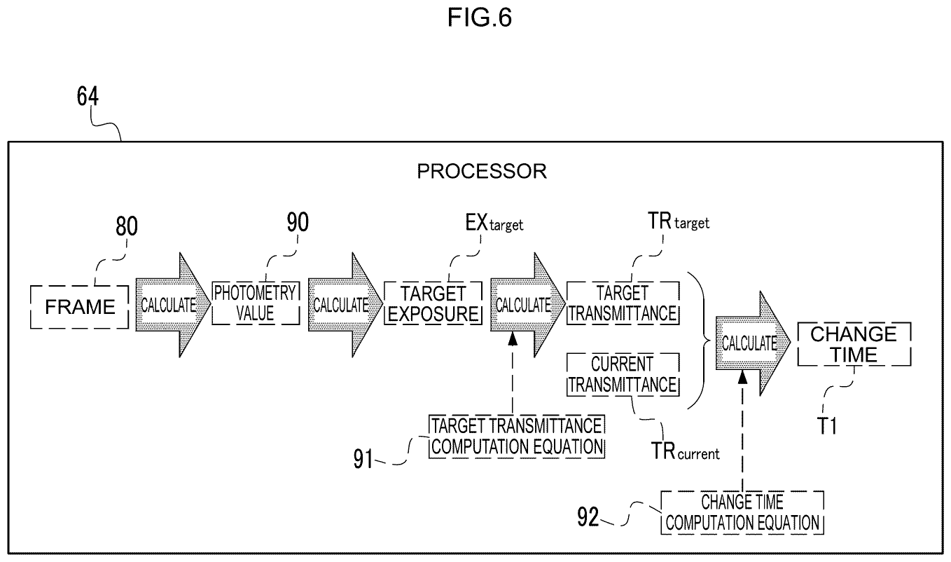

FIG. 6 to FIG. 10 illustrate an example of content of the exposure control processing performed by the processor 64. First, as illustrated in the example of FIG. 6, when a start timing for exposure calculation has been reached, the processor 64 calculates a photometry value 90 indicating an imaging subject brightness based on the frames 80 obtained by performing live-view image imaging. Note that the photometry value 90 may be measured by an exposure meter (omitted in the drawings).

Based on the photometry value 90, the processor 64 calculates the target exposure EX_{target} as an exposure such that the brightness of the frame 80 employed for calculation of the photometry value 90 is a target brightness. The processor 64 calculates the target transmittance TR_{target} corresponding to the target exposure EX_{target}, namely calculates the target transmittance TR_{target} capable of realizing the target exposure EX_{target}.

For example, the target transmittance TR_{target} is calculated based on the shutter speed, aperture value, and sensitivity set on the imaging apparatus 10 at the current point in time, and on the target exposure EX_{target}. The calculation of the target transmittance TR_{target} is performed using a target transmittance computation equation 91. The target transmittance computation equation 91 is a computation equation having the shutter speed, aperture value, sensitivity, and target exposure EX_{target} as independent variables, and having the target transmittance TR_{target} as a dependent variable.

The processor 64 acquires the transmittance set for the electronic ND filter 58 at the current point in time, namely, the current transmittance TR_{current}. The processor 64 then uses a change time computation equation 92 to calculate a change time T1, which is a time needed for changing from the acquired current transmittance TR_{current} to the calculated target transmittance TR_{target}. The change time computation equation 92 is a computation equation having the target transmittance TR_{target} and the current transmittance TR_{current} as independent variables, and having the change time T1 as a dependent variable. In the present first exemplary embodiment, the target exposure EX_{target} is an example of a “target exposure” according to the present disclosure, the current transmittance TR_{current} is an example of a “first transmittance” according to the present disclosure, and the target transmittance TR_{target} is an example of a “second transmittance” according to the present disclosure.

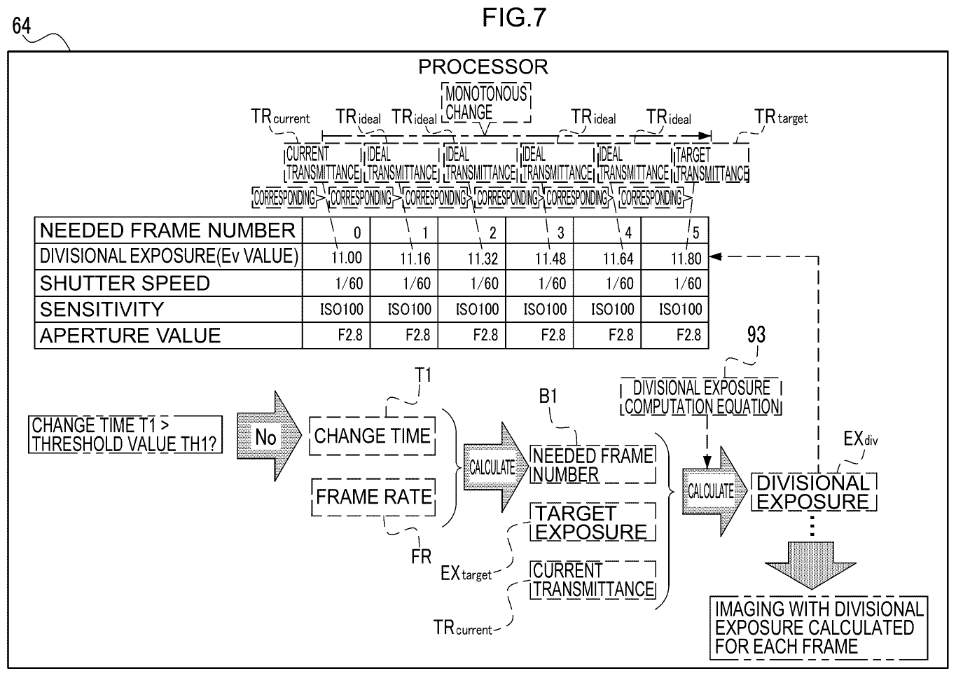

As illustrated in the example of FIG. 7, the processor 64 determines whether or not the change time T1 has exceeded a threshold value TH1. In the present first exemplary embodiment, the threshold value TH1 is an example of a “first threshold value” according to the present disclosure. The threshold value TH1 is a value determined based on an ideal wait time for changing the transmittance of the electronic ND filter 58 from the current transmittance TR_{current} to the target transmittance TR_{target} (in other words, an ideal time as a time to achieve the target exposure EX_{target} from when the exposure calculation start timing was reached under the condition of the aperture value, shutter speed, and sensitivity being fixed). The threshold value TH1 may be a fixed value, and may be a variable value changed according to given instructions or various conditions. An example of the threshold value TH1 is an upper limit value of an ideal wait time for changing the transmittance of the electronic ND filter 58 from the current transmittance TR_{current} to the target transmittance TR_{target}. The upper limit value of the ideal wait time for changing the transmittance of the electronic ND filter 58 from the current transmittance TR_{current} to the target transmittance TR_{target} is merely an example, and the upper limit value may be a lower value within a permissible range. The threshold value TH1 may be a time decided by a user, may be a time decided according to a type of the imaging mode, and may be a time specified within a range from a few percent to several tens of percent of a maximum time obtained from a table in which times to change the transmittance of the electronic ND filter 58 are determined (for example, a time equivalent to 50% of a maximum time obtained from a table in which times to change the transmittance of the electronic ND filter 58 are determined).

In cases in which the change time T1 has not exceeded the threshold value TH1 (in other words, cases in which a magnitude relationship “change time T1<threshold value TH1” is satisfied), namely, cases in which the time needed to change the transmittance of the electronic ND filter 58 from the current transmittance TR_{current} to the target exposure EX_{target} falls within the ideal time, the processor 64 calculates a needed frame number B1, which is the number of frames needed during the course of the change time T1, based on the change time T1 and the frame rate FR (for example, a frame rate equivalent to the above frame rate). For example, the needed frame number B1 is calculated by “(change time T1)×(frame rate FR)”.

The processor 64 acquires plural divisional exposures EX_{div} based on the target exposure EX_{target} and the change time T1. Acquiring the plural divisional exposures EX_{div} is realized by calculating the plural divisional exposures EX_{div} based on the target exposure EX_{target} and the needed frame number B1. Calculation of the plural divisional exposures EX_{div} is performed using a divisional exposure computation equation 93. The divisional exposure computation equation 93 is a computation equation having the current transmittance TR_{current}, the target exposure EX_{target}, and the needed frame number B1 as independent variables, and having the plural divisional exposures EX_{div} as a dependent variable. The plural divisional exposures EX_{div} are a number of individual divisional exposures EX_{div} equivalent the needed frame number B1.

The plural divisional exposures EX_{div} change monotonously from the divisional exposures EX_{div} corresponding to the current transmittance TR_{current} through to the target exposure EX_{target}. For example, the plural divisional exposures EX_{div} change linearly from the divisional exposures EX_{div} corresponding to the current transmittance TR_{current} through to the target exposure EX_{target}. Note that although an example is given here of a linear change, the change may be an exponential function change, and may be a monotonous change.

The plural divisional exposures EX_{div} correspond to a current transmittance TR_{current}, plural ideal transmittance TR_{ideal}, and a target transmittance TR_{target} determining a course of an ideal change from the current transmittance TR_{current} to the target transmittance TR_{target} (for example, during the course of changing by a constant change amount from the current transmittance TR_{current} to the target transmittance TR_{target}). In the example illustrated in FIG. 7, the current transmittance TR_{current} corresponds to the needed frame number B1 “0”, the ideal transmittances TR_{ideal} correspond to the respective needed frame number B1 “1”, “2”, “3”, and “4”, and the target transmittance TR_{target} corresponds to the needed frame number B1 “5”. The transmittance of the electronic ND filter 58 changes based on the current transmittance TR_{current}, the plural ideal transmittances TR_{ideal}, and the target transmittance TR_{target}. The current transmittance TR_{current}, the plural ideal transmittances TR_{ideal}, and the target transmittance TR_{target} are changed monotonously from the current transmittance TR_{current} through to the target transmittance TR_{target}. In the example illustrated in FIG. 7, the current transmittance TR_{current}, the plural ideal transmittances TR_{ideal}, and the target transmittance TR_{target} are changed monotonously from the needed frame numbers B1 “0” through to “5”.

The monotonous change of the exposure of the frames 80 from the divisional exposure EX_{div} corresponding to the current transmittance TR_{current} through to the target exposure EX_{target} is implemented by monotonously changing the current transmittance TR_{current}, the plural ideal transmittances TR_{ideal}, and the target transmittance TR_{target} from the current transmittance TR_{current} through to the target transmittance TR_{target} in a fixed state of the shutter speed, aperture value, and/or sensitivity. An example of monotonously changing the current transmittance TR_{current}, the plural ideal transmittances TR_{ideal}, and the target transmittance TR_{target} from the current transmittance TR_{current} through to the target transmittance TR_{target}, is an example in which the current transmittance TR_{current}, the plural ideal transmittances TR_{ideal}, and the target transmittance TR_{target} are changed by a constant change amount between the frames 80 from the current transmittance TR_{current} through to the target transmittance TR_{target} (for example, a linear change amount, or an exponential function change amount).

The processor 64 performs control to apply plural divisional exposures EX_{div} for the exposures of the plural frames 80 obtained by performing live-view image imaging in the change time T1. For example, the processor 64 controls to perform imaging with a corresponding divisional exposure EX_{div} set for each of the frames. Setting of the divisional exposures EX_{div} means, for example, setting a transmittance for the electronic ND filter 58 capable of realizing the divisional exposure EX_{div} in a state in which the shutter speed, aperture value, and/or sensitivity are maintained as they are. Namely, the transmittance of the electronic ND filter 58 is controlled so as to perform live-view image imaging at the calculated divisional exposure EX_{div} for each of the frames 80 while maintaining the shutter speed, aperture value, and/or sensitivity as they are.

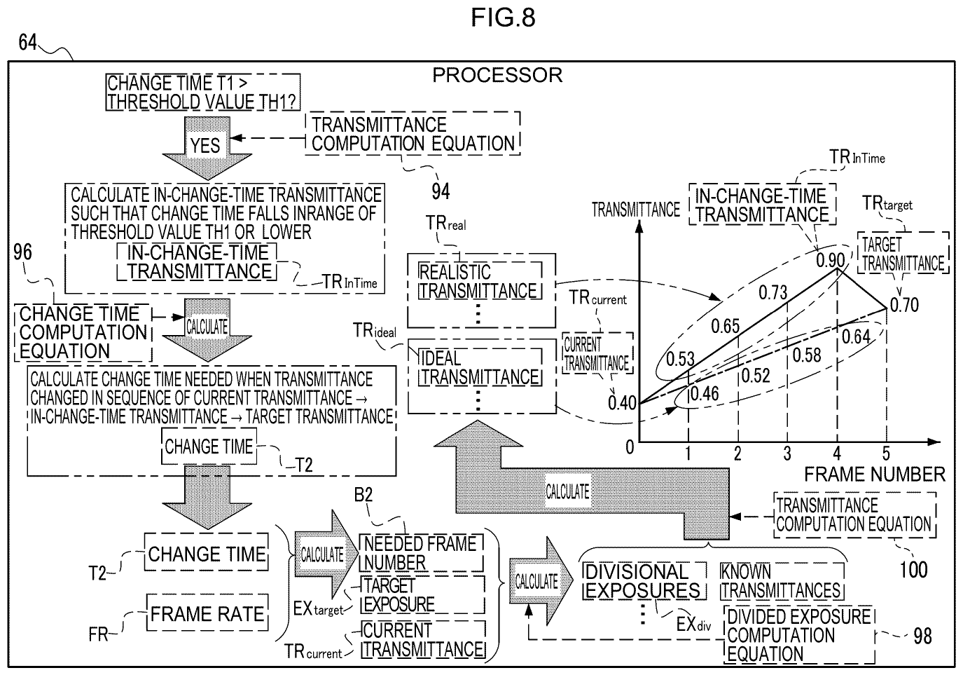

On the other hand, as illustrated in the example of FIG. 8, in cases in which the change time T1 has exceeded the threshold value TH1, namely in cases in which the time needed for change from the current transmittance TR_{current} to the target exposure EX_{target} does not fall within the ideal time, the processor 64 uses a transmittance computation equation 94 to calculate, as the transmittance of the electronic ND filter 58, an in-change-time transmittance TR_{InTime}, which is a transmittance for which the change time T1 falls in a range of the threshold value TH1 or lower. The transmittance computation equation 94 is a computation equation having the change time T1, the threshold value TH1, the current transmittance TR_{current}, and the target transmittance TR_{target} as independent variables, and having the in-change-time transmittance TR_{InTime} as a dependent variable. In the present first exemplary embodiment, the in-change-time transmittance TR_{InTime} is an example of a “third transmittance” according to the present disclosure.

The processor 64 uses a change time computation equation 96 to calculates a change time T2, which is a time needed to change the transmittance of the electronic ND filter 58 from the current transmittance TR_{current} to the target transmittance TR_{target} via the in-change-time transmittance TR_{InTime}. The change time computation equation 96 is a computation equation having the current transmittance TR_{current}, the in-change-time transmittance TR_{InTime}, and the target transmittance TR_{target} as independent variables, and having the change time T2 as a dependent variable.

The processor 64 calculates a needed frame number B2, which is the number of frames needed during the course of the change time T2, based on the change time T2 and the frame rate FR. For example, the needed frame number B2 is calculated by “(change time T2)×(frame rate FR)”.

The processor 64 calculates plural divisional exposures EX_{div} based on the needed frame number B2, the target exposure EX_{target}, and the current transmittance TR_{current}. The calculation of the plural divisional exposures EX_{div} is performed using a divisional exposure computation equation 98. The divisional exposure computation equation 98 is a computation equation having the needed frame number B2, the target exposure EX_{target}, and the current transmittance TR_{current} as independent variables, and having the plural divisional exposures EX_{div} as dependent variables. The plural divisional exposures EX_{div} are divisional exposures EX_{div} of an individual number equivalent to the needed frame number B2.

The processor 64 calculates the plural ideal transmittances TR_{ideal} and plural realistic transmittances TRᵣₑₐₗ based on the plural divisional exposures EX_{div} and known transmittances. The known transmittances referred to here mean the current transmittance TR_{current}, the target transmittance TR_{target}, and the in-change-time transmittance TR_{InTime}. The calculation of the plural ideal transmittances TR_{ideal} and the plural realistic transmittances TRᵣₑₐₗ is performed using a transmittance computation equation 100. The transmittance computation equation 100 is a computation equation having the plural divisional exposures EX_{div}, the current transmittance TR_{current}, the target transmittance TR_{target}, and the in-change-time transmittance TR_{InTime} as independent variables, and having the plural ideal transmittances TR_{ideal} and the plural realistic transmittances TRᵣₑₐₗ as dependent variables.

The plural realistic transmittances TRᵣₑₐₗ are plural transmittances determined for the course of realistically changing the transmittance of the electronic ND filter 58 from the current transmittance TR_{current} to the target transmittance TR_{target} when the change time T2 is the threshold value TH1 or lower. Reference here to realistic change means a change of transmittance enabling the change of the transmittance of the electronic ND filter 58 from the current transmittance TR_{current} to the target transmittance TR_{target} to be achieved within the time of the threshold value TH1 or lower. In cases in which the transmittance of the electronic ND filter 58 is realistically changed, priority is given to achieving the change of the transmittance of the electronic ND filter 58 from the current transmittance TR_{current} to the target transmittance TR_{target} within the time of the threshold value TH1 or lower, and so the transmittance of the electronic ND filter 58 is not changed monotonously by a constant change amount from the current transmittance TR_{current} through to the target transmittance TR_{target}.

In cases in which live-view image imaging is performed with the change time T1 exceeding the threshold value TH1, the plural realistic transmittances TRᵣₑₐₗ are set for the electronic ND filter 58. This is because were the plural ideal transmittances TR_{ideal} to be set for the electronic ND filter 58 irrespective of the change time T1 exceeding the threshold value TH1 when live-view image imaging is performed, then change from the current transmittance TR_{current} to the target transmittance TR_{target} would not be completed within the time of the threshold value TH1 or lower.

The example illustrated in FIG. 8 indicates plural transmittances determined the course of realistically changing the transmittance of the electronic ND filter 58 from the current transmittance TR_{current} to the target transmittance TR_{target} with the change time T2 of the threshold value TH1 or lower, namely indicates, as an example of the plural realistic transmittances TRᵣₑₐₗ, plural transmittances determined the course of changing from the current transmittance TR_{current} to the target transmittance TR_{target} via the in-change-time transmittance TR_{InTime} with the change time T2 of the threshold value TH1 or lower.

In the example illustrated in FIG. 8, the in-change-time transmittance TR_{InTime} is determined to make the change time T2 between the current transmittance TR_{current} and the target transmittance TR_{target} be the threshold value TH1 or lower. The plural realistic transmittances TRᵣₑₐₗ are determined based on the current transmittance TR_{current} and the in-change-time transmittance TR_{InTime}. Namely, in the example illustrated in FIG. 8, plural transmittances to change monotonously from the current transmittance TR_{current} through to the in-change-time transmittance TR_{InTime} (for example, plural transmittances to change linearly) are determined as the plural realistic transmittances TRᵣₑₐₗ including the in-change-time transmittance TR_{InTime}.

The current transmittance TR_{current} and the plural realistic transmittances TRᵣₑₐₗ are changed monotonously from the current transmittance TR_{current} through to the in-change-time transmittance TR_{InTime}. In the example illustrated in FIG. 8, the current transmittance TR_{current} and the plural realistic transmittances TRᵣₑₐₗ are change linearly from the current transmittance TR_{current} through to the in-change-time transmittance TR_{InTime}.

The processor 64 changes the transmittance of the electronic ND filter 58 according to the current transmittance TR_{current}, the plural realistic transmittances TRᵣₑₐₗ, and the target transmittance TR_{target}. However, were the transmittance of the electronic ND filter 58 to be changed according to the current transmittance TR_{current}, the plural realistic transmittances TRᵣₑₐₗ, and the target transmittance TR_{target} while maintaining the shutter speed, aperture value, and/or sensitivity as they are, then a change in brightness between the frames 80 would be larger than cases in which the transmittance of the electronic ND filter 58 is changed according to the current transmittance TR_{current}, the plural ideal transmittance TR_{ideal}, and the target transmittance TR_{target} while the shutter speed, aperture value, and/or sensitivity are maintained as they are.

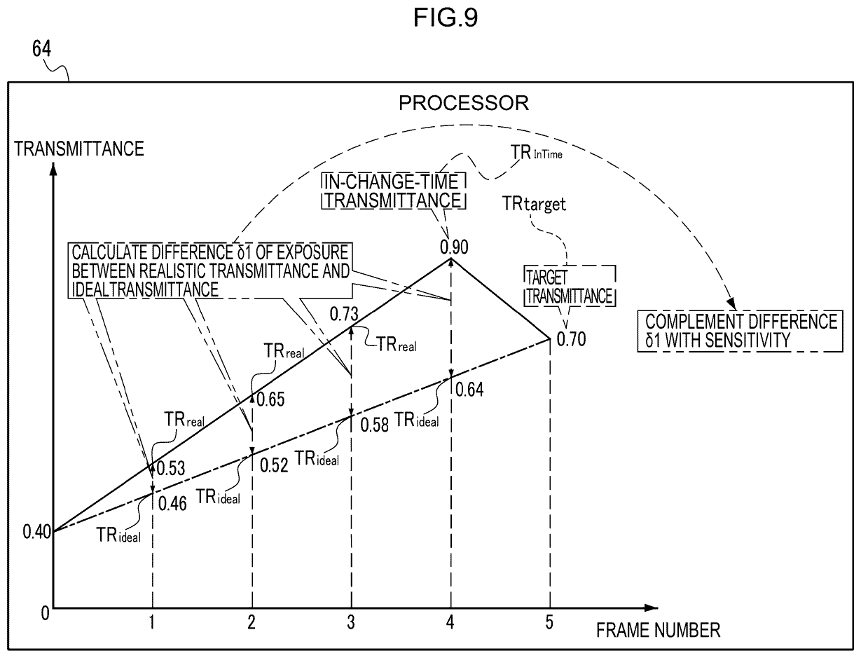

Thus in the present first exemplary embodiment, even if the transmittance of the electronic ND filter 58 changes according to the current transmittance TR_{current}, the plural realistic transmittances TRᵣₑₐₗ, and the target transmittance TR_{target}, in order to change the brightness between frames 80 at the same level as in the case where the transmittance of the electronic ND filter 58 changes according to the current transmittance TR_{current}, the plural ideal transmittances TR_{ideal}, and the target transmittance TR_{target} while maintaining the shutter speed, aperture value, and sensitivity, the processor 64 first calculates an exposure difference δ1 between the plurality of realistic transmittances TRᵣₑₐₗ and the plural ideal transmittances TR_{ideal} for each frame 80 obtained within the needed frame number B2, as shown in FIG. 9, as an example. The difference δ1 is an indicator indicating a magnitude of change in brightness between frames 80. In other words, the difference δ1 is an expression of a degree of divergence from the ideal brightness of the frames 80 (namely, an extent to which exposures realized by the realistic transmittances TRᵣₑₐₗ diverge from the exposures realized by the ideal transmittances TR_{ideal}).

The exposure is defined by the shutter speed, aperture value, and sensitivity as well as by the transmittance of the electronic ND filter 58, and so the difference δ1 can be made zero by adjusting the shutter speed, aperture value, and/or sensitivity. The processor 64 accordingly adjusts the plural divisional exposures EX_{div} corresponding to the current transmittance TR_{current}, the plural realistic transmittances TRᵣₑₐₗ, and the target transmittance TR_{target} (namely, each of the divisional exposures EX_{div} during the course of changing from the current transmittance TR_{current} to the target transmittance TR_{target}) based on the difference δ1. In other words, by complementing the difference δ1 with the shutter speed, aperture value, and/or sensitivity, the processor 64 performs adjustment to align the plural divisional exposures EX_{div} corresponding to the current transmittance TR_{current}, the plural realistic transmittances TRᵣₑₐₗ, and the target transmittance TR_{target} to the plural divisional exposures EX_{div} corresponding to the current transmittance TR_{current}, the plural ideal transmittances TR_{ideal}, and the target transmittance TR_{target}. To express this in yet another way, for each of the frames 80 contained in the needed frame number B2, the shutter speed, aperture value, and/or sensitivity are adjusted by adjustment values corresponding to the difference δ1 (for example, adjustment values determined according to the difference δ1) such that the divisional exposures EX_{div} realized by the realistic transmittances TRᵣₑₐₗ become the divisional exposures EX_{div} realized by the ideal transmittances TR_{ideal}.

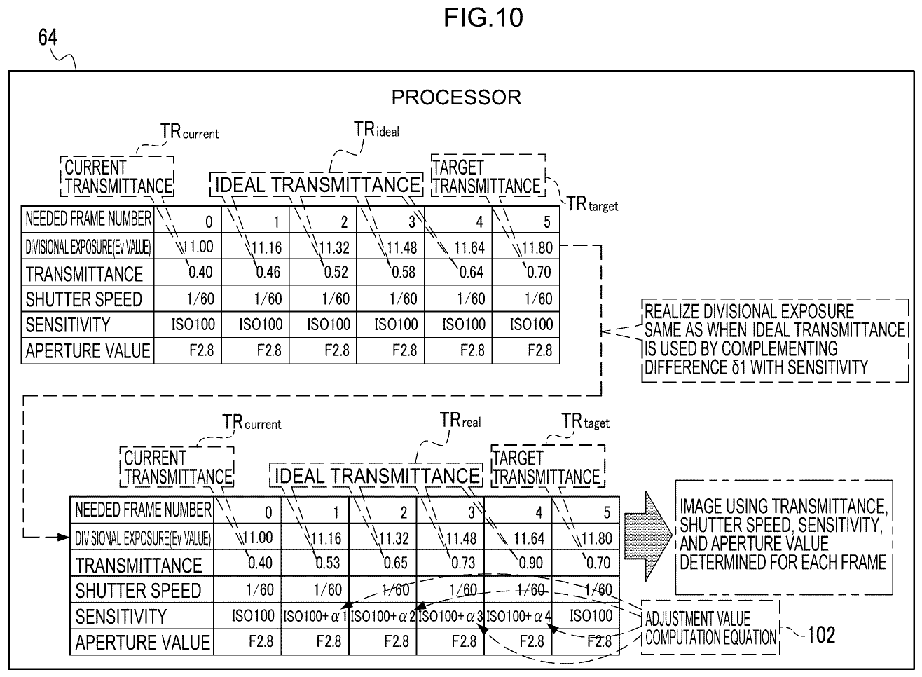

In cases in which live-view image imaging is being performed using the plural realistic transmittances TRᵣₑₐₗ as the transmittance of the electronic ND filter 58, for example, as illustrated in FIG. 10, the difference δ1 is complemented by adjusting the sensitivity of adjustment values α1 to α4 for adjusting sensitivity. Due to the sensitivity being adjusted with the adjustment values α1 to α4 according to the difference δ1 in this manner, divisional exposures EX_{div} are realized at a similar level to cases in which the plural realistic transmittances TRᵣₑₐₗ are employed as the transmittance of the electronic ND filter 58 while the shutter speed, aperture value, and/or sensitivity are maintained as they are, even though the transmittance of the electronic ND filter 58 is changed according to the current transmittance TR_{current}, the plural realistic transmittances TRᵣₑₐₗ, and the target transmittance TR_{target}.

The adjustment values α1 to α4 are each uniquely determined according to the difference δ1 calculated by frame 80 unit. For example, the adjustment values α1 to α4 are calculated by using an adjustment value computation equation 102 in which the difference δ1 is an independent variable and the adjustment values to adjust sensitivity are dependent variables. Note that although an example is given here of an embodiment for adjusting the sensitivity according to the difference δ1, this is merely an example thereof, and a configuration may be adopted in which the shutter speed and/or the aperture value is adjusted according to the difference δ1. The adjustment values of the shutter speed and/or the aperture value may be calculated by employing a computation equation similar to that of the adjustment value computation equation 102 in such cases.

In cases in which the live-view image imaging is performed in the change time T2, the processor 64 sets the imaging apparatus 10 with the sensitivity adjusted according to the difference δ1 calculated by frame 80 unit as described above, the shutter speed determined for each of the frames 80, and the aperture value determined for each of the frames 80. The processor 64 also sets the current transmittance TR_{current}, the plural realistic transmittances TRᵣₑₐₗ, and the target transmittance TR_{target} as the transmittances of the electronic ND filter 58. In live-view image imaging in the change time T2, the plural divisional exposures EX_{div} that change monotonously are accordingly applied for the exposures of the plural frames 80 by the sensitivity adjusted according to the difference δ1 calculated by frame 80 unit, the shutter speed determined for each of the frames 80, the aperture value determined for each of the frames 80, the current transmittance TR_{current}, the plural realistic transmittances TRᵣₑₐₗ, and the target transmittance TR_{target} being set in this manner.

Note that in the present first exemplary embodiment, the live-view image imaging is an example of “imaging with the imaging apparatus” according to the present disclosure. Moreover, in the present first exemplary embodiment, the change times T1 and T2 are examples of a “change time” according to the present disclosure. Moreover, in the present first exemplary embodiment, the frame rate FR is an example of a “preset frame rate” according to the present disclosure. Moreover, in the present first exemplary embodiment, the plural ideal transmittances TR_{ideal} are an example of “plural ideal transmittances” according to the present disclosure. Moreover, in the present first exemplary embodiment, the plural realistic transmittances TRᵣₑₐₗ are an example of “plural first realistic transmittances” according to the present disclosure. Moreover, in the present first exemplary embodiment, the shutter speed, aperture value, and/or sensitivity, and the transmittance of the electronic ND filter 58 are examples of “plural exposure factors” according to the present disclosure. Moreover, in the present first exemplary embodiment, the difference δ1 is an example of a “disparity between an ideal transmittance and a first realistic transmittance” according to the present disclosure.

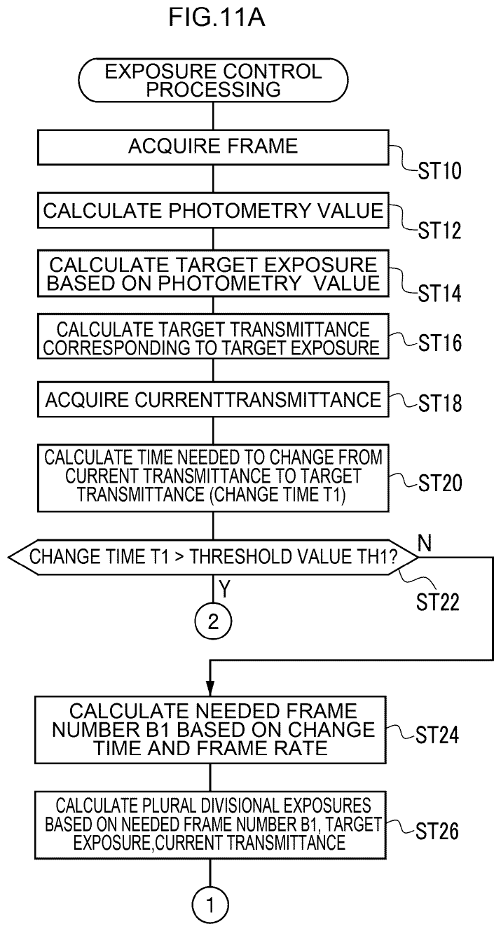

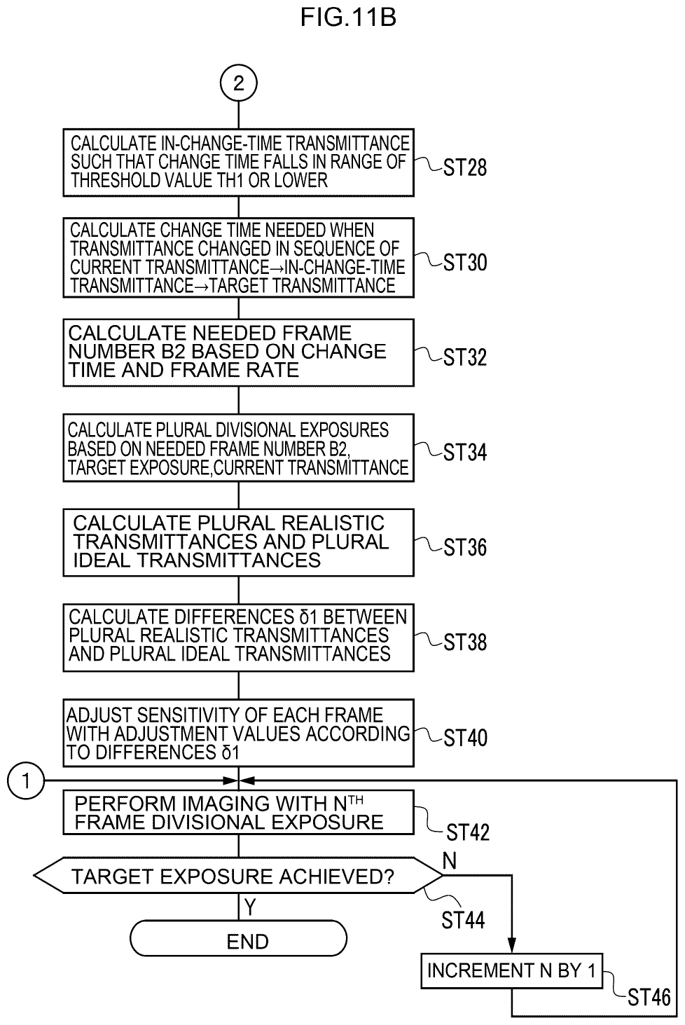

Next, description follows regarding operation of the imaging apparatus 10, with reference to FIG. 11A and FIG. 11B. In FIG. 11A and FIG. 11B, an example is illustrated of a flow of exposure control processing executed by the processor 64 under conditions in which, in cases in which an exposure calculation start timing has arrived for performing live-view image imaging in AF mode with the current transmittance TR_{current} set as the transmittance of the electronic ND filter 58 (in other words, a timing has arrived that was specified in advance as a timing to adjust the exposure of the frames 80 obtained by performing live-view image imaging). The flow of the exposure control processing illustrated in FIG. 11A and FIG. 11B is an example of a “control method” according to the present disclosure.

In the exposure control processing illustrated in FIG. 11A, firstly, at step ST10 the processor 64 acquires a frame 80 generated by performing live-view image imaging. The exposure control processing transitions to step ST12 after the processing of step ST10 has been executed.

At step ST12, the processor 64 calculates the photometry value 90 based on the frame 80 acquired at step ST10. The exposure control processing transitions to step ST14 after the processing of step ST12 has been executed.

At step ST14, based on the photometry value 90, the processor 64 calculates the target exposure EX_{target} as an exposure such that the brightness of the frame 80 employed to calculate the photometry value 90 is the target brightness. The exposure control processing transitions to step ST16 after the processing of step ST14 has been executed.

At step ST16, the processor 64 calculates the target transmittance TR_{target} corresponding to the target exposure EX_{target}. The exposure control processing transitions to step ST18 after the processing of step ST16 has been executed.

At step ST18, the processor 64 acquires the current transmittance TR_{current} set at the current point in time for the electronic ND filter 58. The exposure control processing transitions to step ST20 after the processing of step ST18 has been executed.

At step ST20, the processor 64 calculates a time needed to change the transmittance of the electronic ND filter 58 from the current transmittance TR_{current} to the target transmittance TR_{target}, namely, the change time T1. The exposure control processing transitions to step ST22 after the processing of step ST20 has been executed.

At step ST22, the processor 64 determines whether or not the change time T1 has exceeded the threshold value TH1. Negative determination is made at step ST22 and the exposure control processing transitions to step ST24 in cases in which the change time T1 has not exceeded the threshold value TH1. Affirmative determination is made at step ST22 and the exposure control processing transitions to step ST28 illustrated in FIG. 11B in cases in which the change time T1 has exceeded the threshold value TH1.

At step ST24, the processor 64 calculates the needed frame number B1 based on the change time T1 and the frame rate FR. The exposure control processing transitions to step ST26 after the processing of step ST24 has been executed.

At step ST26, the processor 64 calculates the plural divisional exposures EX_{div} based on the needed frame number B1, the target exposure EX_{target}, and the current transmittance TR_{current}. The exposure control processing transitions to step ST42 illustrated in FIG. 11B after the processing of step ST26 has been executed.

At step ST28 illustrated in FIG. 11B, based on the change time T1, the threshold value TH1, the current transmittance TR_{current}, and the target transmittance TR_{target}, the processor 64 calculates, as the transmittance of the electronic ND filter 58, the in-change-time transmittance TR_{InTime}, which is a transmittance such that the change time T1 falls within the range of the threshold value TH1 or lower. The exposure control processing transitions to step ST30 after the processing of step ST28 has been executed.

At step ST30, based on the current transmittance TR_{current}, the in-change-time transmittance TR_{InTime}, and the target transmittance TR_{target}, the processor 64 calculates the time needed to change the transmittance of the electronic ND filter 58 from the current transmittance TR_{current} to the target transmittance TR_{target} via the in-change-time transmittance TR_{InTime}, namely calculates the change time T2. The exposure control processing transitions to step ST32 after the processing of step ST30 has been executed.

At step ST32, the processor 64 calculates the needed frame number B2 based on the change time T2 and the frame rate FR. The exposure control processing transitions to step ST34 after the processing of step ST32 has been executed.

At step ST34, the processor 64 calculates the plural divisional exposures EX_{div} based on the needed frame number B2, the target exposure EX_{target}, and the current transmittance TR_{current}. The exposure control processing transitions to step ST36 after the processing of step ST34 has been executed.

At step ST36, the processor 64 calculates the plural realistic transmittances TRᵣₑₐₗ and the plural ideal transmittances TR_{ideal} based on the plural divisional exposures EX_{div}, the current transmittance TR_{current}, the target transmittance TR_{target}, and the in-change-time transmittance TR_{InTime}. The exposure control processing transitions to step ST38 after the processing of step ST36 has been executed.

At step ST38, the processor 64 calculates the exposure differences 61 between the plural realistic transmittances TRᵣₑₐₗ and the plural ideal transmittances TR_{ideal} by units of the frames 80 in the needed frame number B2. Namely, at step ST38, the exposure differences 61 between the realistic transmittances TRᵣₑₐₗ and the ideal transmittances TR_{ideal} are calculated for each of the frames 80 contained in the needed frame number B2. The exposure control processing transitions to step ST40 after the processing of step ST38 has been executed.

At step ST40, for each of the frames 80 contained in the needed frame number B2, the processor 64 adjusts the sensitivity, which is one of the exposure factors defining the divisional exposures EX_{div}, by an adjustment value according to the difference δ1. The exposure control processing transitions to step ST42 after the processing of step ST40 has been executed.

At step ST42, the processor 64 then causes the imaging apparatus 10 to perform imaging with an N^{th} frame divisional exposure EX_{div}, wherein N is a natural number having an initial value of “1”. For example, when the exposure control processing has transitioned from step ST26 to step ST42, at step ST42 the processor 64 causes the imaging apparatus 10 to perform imaging with the N^{th} frame of the divisional exposures EX_{div} from out of the plural divisional exposures EX_{div} calculated by execution of the processing of step ST26. However, in cases in which the exposure control processing has transitioned from step ST40 to step ST42, at step ST42 the processor 64 sets the imaging apparatus 10 with a sensitivity adjusted according to the difference δ1 calculated for N^{th} frame, the shutter speed determined for the N^{th} frame, and the aperture value determined for the N^{th} frame, and causes the imaging apparatus 10 to perform imaging after setting the electronic ND filter 58 to the N^{th} frame transmittance from out of the current transmittance TR_{current}, the plural realistic transmittances TRᵣₑₐₗ, and the target transmittance TR_{target}. The exposure control processing transitions to step ST44 after the processing of step ST42 has been executed.

At step ST44, the processor 64 determines whether or not the N^{th} frame exposure has attained the target exposure EX_{target}. Negative determination is made at step ST44 and the exposure control processing transitions to step ST46 in cases in which the N^{th} frame exposure has not attained the target exposure EX_{target}. At step ST46, the processor 64 increments N by “1”. The exposure control processing transitions to step ST42 after the processing of step ST46 has been executed. Affirmative determination is made at step ST44 in cases in which the N^{th} frame exposure has attained the target exposure EX_{target}, and the exposure control processing is ended.

As described above, in the imaging apparatus 10 according to the present first exemplary embodiment, plural frames 80 are obtained by performing live-view image imaging based on the frame rate FR. In cases in which the change time T1 (namely, the time needed to change the transmittance of the electronic ND filter 58 from the current transmittance TR_{current} to the target transmittance TR_{target}) does not exceed the threshold value TH1 (namely, a value determined based on an ideal wait time for change from the current transmittance TR_{current} to the target transmittance TR_{target}), the needed frame number B1 (namely, a number of frames needed during the course of the change time T1) is calculated based on the change time T1 and the frame rate FR. The plural divisional exposures EX_{div} determined based on the target exposure EX_{target} and the needed frame number B1 are then applied for the exposure of the plural frames 80 obtained by performing live-view image imaging in the change time T1.

On the other hand, in cases in which the change time T1 has exceeded the threshold value TH1, the needed frame number B2 (namely, the number of frames needed during the course of the change time T2) is then calculated based on the change time T2 (namely, the time needed to change from the current transmittance TR_{current} to the target transmittance TR_{target} via the in-change-time transmittance TR_{InTime}) and on the frame rate FR. Then the plural divisional exposures EX_{div} determined based on the target exposure EX_{target} and the needed frame number B2 are applied for the exposure of the plural frames 80 obtained by live-view image imaging performed in the change time T2.

Therefore, the imaging apparatus 10 according to the present first exemplary embodiment is able to suppress the brightness between the plural frames 80 obtained by performing live-view image imaging from suddenly changing accompanying a switch in the transmittance of the electronic ND filter 58.

Moreover, in the imaging apparatus 10 according to the present first exemplary embodiment, in cases in which the change time T1 has exceeded the threshold value TH1, the plural divisional exposures EX_{div} corresponding to the plural frames 80 in cases in which the transmittance of the electronic ND filter 58 is changed from the current transmittance TR_{current} to the target transmittance TR_{target} via the in-change-time transmittance TR_{InTime} in a state in which the shutter speed, aperture value, and/or sensitivity are fixed, are adjusted based on the plural ideal transmittances TR_{ideal} (namely, the plural transmittances determined during the course of ideally changing from the current transmittance TR_{current} to the target transmittance TR_{target}) and based on the plural realistic transmittances TRᵣₑₐₗ (namely, plural transmittances determined during the course of realistically changing the transmittance of the electronic ND filter 58 from the current transmittance TR_{current} to the target transmittance TR_{target} when the change time T2 is the threshold value TH1 or lower). The exposure of the plural frames 80 can accordingly be made to track a realistic change of the transmittance of the electronic ND filter 58 from the current transmittance TR_{current} to the target transmittance TR_{target} (namely, a change from the current transmittance TR_{current} to the target transmittance TR_{target} via the in-change-time transmittance TR_{InTime}).

Moreover, in the imaging apparatus 10 according to the present first exemplary embodiment, in cases in which the change time T1 has exceeded the threshold value TH1, the plural realistic transmittances TRᵣₑₐₗ are determined based on the current transmittance TR_{current} and the in-change-time transmittance TR_{InTime} (namely, the transmittance when the change time T1 is the threshold value TH1 or lower). The plural realistic transmittances TRᵣₑₐₗ are plural transmittances determined the course of changing from the current transmittance TR_{current} to the target transmittance TR_{target} in cases of change from the current transmittance TR_{current} to the target transmittance TR_{target} via the in-change-time transmittance TR_{InTime} when the change time T2 is the threshold value TH1 or lower. The plural divisional exposures EX_{div} corresponding to the plural frames 80 for cases in which the transmittance of the electronic ND filter 58 is changed from the current transmittance TR_{current} to the target transmittance TR_{target} via the in-change-time transmittance TR_{InTime} in a state in which the shutter speed, aperture value, and/or sensitivity are fixed are adjusted based on the plural realistic transmittances TRᵣₑₐₗ containing the in-change-time transmittance TR_{InTime} and the plural ideal transmittances TR_{ideal}. Accordingly, even in cases in which the change time T1 has exceeded the threshold value TH1, plural divisional exposures EX_{div} for the change time T1 of the threshold value TH1 or lower can be applied for the exposure of the plural frames 80 obtained by performing live-view image imaging.

In the imaging apparatus 10 according to the present first exemplary embodiment, the adjustment of the plural divisional exposures EX_{div} corresponding to the plural frames 80 for cases in which the transmittance of the electronic ND filter 58 is changed from the current transmittance TR_{current} to the target transmittance TR_{target} via the in-change-time transmittance TR_{InTime} in a state in which the shutter speed, aperture value, and/or sensitivity are fixed is implemented by the sensitivity being adjusted with the adjustment values determined according to the difference δ1 (namely, the difference of the between the realistic transmittances TRᵣₑₐₗ and the ideal transmittances TR_{ideal}). This thereby enables a brightness of plural ideal transmittances TR_{ideal} to be realized easily even when there is a gap between the realistic transmittances TRᵣₑₐₗ and the ideal transmittances TR_{ideal}. Note that although an example has been given of the sensitivity being adjusted, this is merely an example, and a configuration may be adopted in which the sensitivity, the shutter speed, and/or the aperture value is adjusted by adjustment values determined according to the difference δ1.

Moreover, in the imaging apparatus 10 according to the present first exemplary embodiment, in cases in which the change time T1 is the threshold value TH1 or lower, the transmittance of the electronic ND filter 58 is changed based on the plural ideal transmittances TR_{ideal} while the shutter speed, aperture value, and/or sensitivity are maintained as they are. This thereby enables the exposure of the plural frames 80 to easily track changes of the transmittance of the electronic ND filter 58 from the current transmittance TR_{current} to the target transmittance TR_{target} in cases in which the change time T1 is the threshold value TH1 or lower.

Moreover, in the imaging apparatus 10 according to the present first exemplary embodiment, the plural divisional exposures EX_{div} correspond to the plural ideal transmittances TR_{ideal}, in cases in which the change time T1 is the threshold value TH1 or lower. The exposure of the plural frames 80 can accordingly be made to easily track changes of the transmittance of the electronic ND filter 58 from the current transmittance TR_{current} to the target transmittance TR_{target} in cases in which the change time T1 is the threshold value TH1 or lower.

In the imaging apparatus 10 according to the present first exemplary embodiment, the plural ideal transmittances TR_{ideal} change monotonously between the current transmittance TR_{current} and the target transmittance TR_{target} in cases in which the change time T1 is the threshold value TH1 or lower. Accordingly, sudden changes to the brightness between the plural frames 80 obtained by performing live-view image imaging can be suppressed from occurring.

Moreover, in the imaging apparatus 10 according to the present first exemplary embodiment, in cases in which the change time T1 is the threshold value TH1 or lower, the plural divisional exposures EX_{div} are changed monotonously from the divisional exposure EX_{div} corresponding to the current transmittance TR_{current} through to the target exposure EX_{target}. The monotonous change of the exposure of the frames 80 from the divisional exposure EX_{div} corresponding to the current transmittance TR_{current} through to the target exposure EX_{target} is realized by changing the current transmittance TR_{current}, the plural ideal transmittances TR_{ideal}, and the target transmittance TR_{target} monotonously from the current transmittance TR_{current} through to the target transmittance TR_{target} in a state in which the shutter speed, the sensitivity, and the aperture value are fixed. This thereby enables a sudden change in brightness between the plural frames 80 obtained by performing the live-view image imaging to be suppressed from occurring.

### Second Exemplary Embodiment

In the first exemplary embodiment an example has been given of an embodiment in which the threshold value TH1 is fixed whatever time the change time T1 is, however, in the present second exemplary embodiment an embodiment will be described in which the threshold value TH1 is changed depending on the change time T1.

Note that the same reference numerals will be appended in the present second exemplary embodiment to configuration elements the same as those of the first exemplary embodiment, and explanation thereof will be omitted. The present second exemplary embodiment will be described by main differences to the first exemplary embodiment.

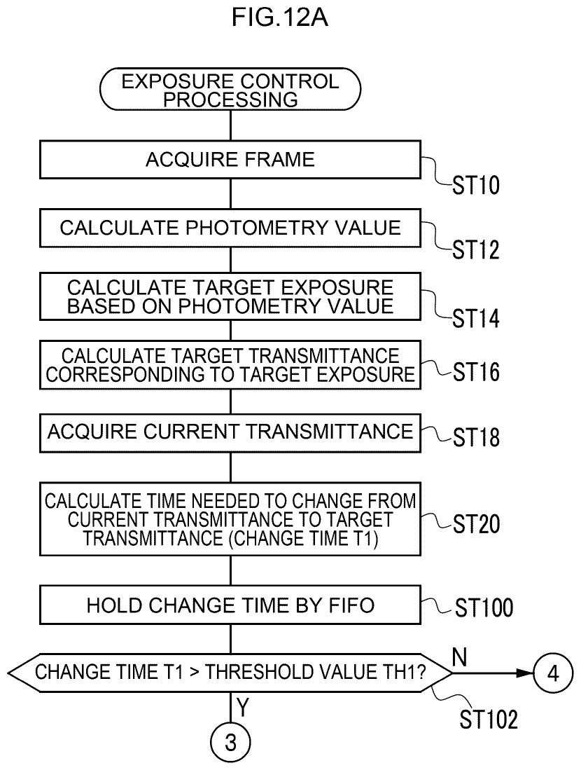

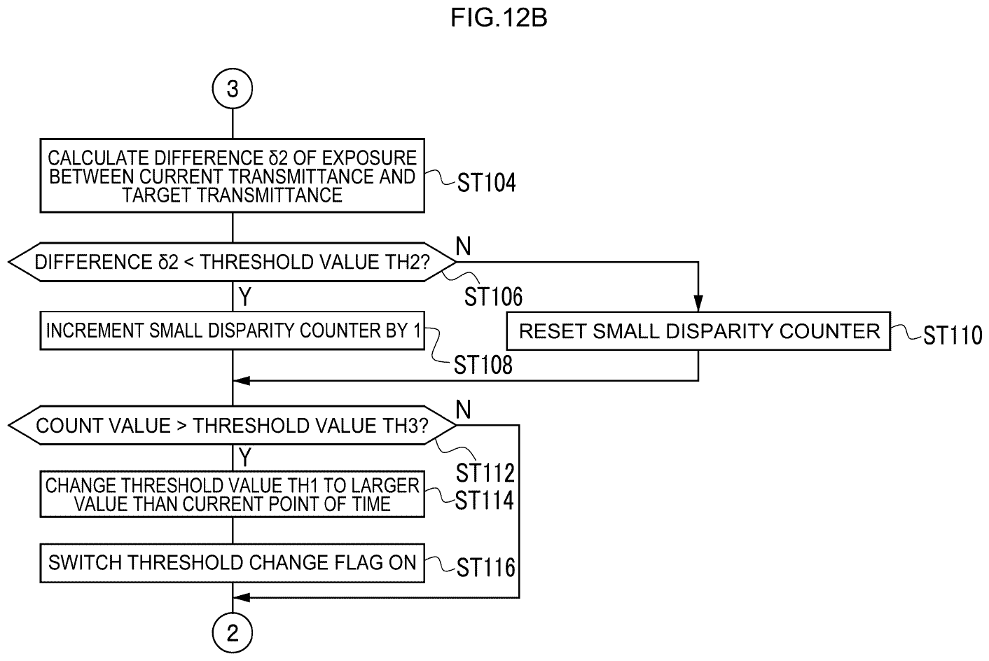

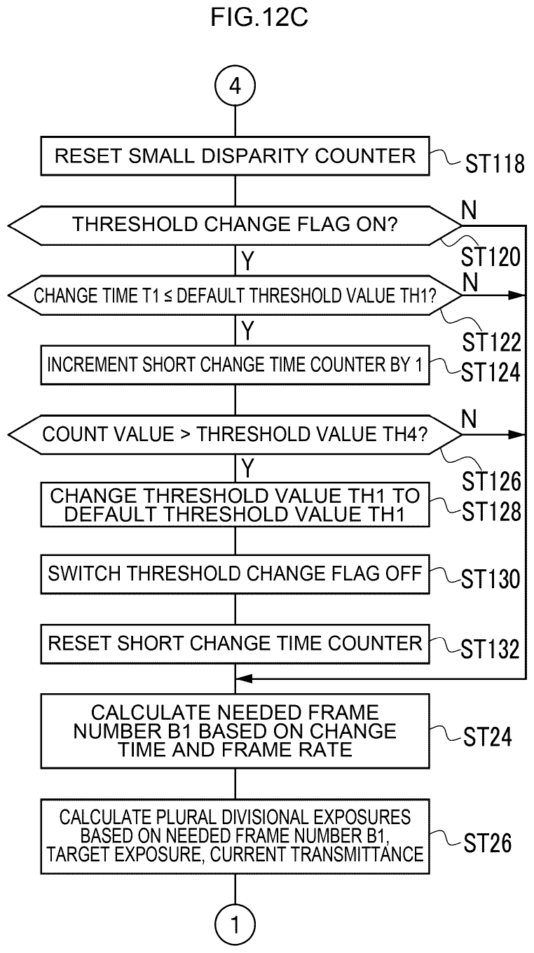

In the present second exemplary embodiment, description follows regarding an example of exposure control processing according to the present second exemplary embodiment, with reference to the flowchart illustrated in FIG. 12A to FIG. 12C. However, the flowchart illustrated in FIG. 12A to FIG. 12C contains plural steps that are duplicates of the flowchart illustrated in FIG. 11A to FIG. 11B as described in the first exemplary embodiment, and so the same step numbers are appended below to any of the plural steps contained in the flowchart illustrated in FIG. 12A to FIG. 12C that are the same as steps in the flowchart illustrated in FIG. 11A to FIG. 11B described in the first exemplary embodiment, and explanation thereof will be omitted.

The flowchart illustrated in FIG. 12A to FIG. 12C differs from the flowchart illustrated in FIG. 11A to FIG. 11B in that step ST100 to step ST132 are included instead of step ST22.

At step ST100 illustrated in FIG. 12A, the processor 64 holds the change time T1 calculated at step ST20 in the memory 68 in a FIFO manner. Plural change times T1 are held in the memory 68 as a time series. The exposure control processing transitions to step ST102 after the processing of step ST100 has been executed.

At step ST102, the processor 64 determines whether or not the latest change time T1 held in the memory 68 has exceeded the threshold value TH1. Negative determination is made at step ST102 when the latest change time T1 held in the memory 68 has not exceeded the threshold value TH1, and the exposure control processing transitions to step ST118 illustrated in FIG. 12C. Affirmative determination is made at step ST102 when the latest change time T1 held in the memory 68 has exceeded the threshold value TH1, and the exposure control processing transitions to step ST104 illustrated in FIG. 12B.

At step ST104 illustrated in FIG. 12B, the processor 64 calculates a difference δ2, which is an absolute value of a difference in exposure between the current transmittance TR_{current} and the target transmittance TR_{target} with the shutter speed, aperture value, and sensitivity in a fixed state, namely, an absolute value of difference between the exposure realized by the current transmittance TR_{current} and the exposure realized by the target transmittance TR_{target} with the shutter speed, aperture value, and sensitivity in a fixed state. The difference δ2 corresponds to an absolute value of a difference between the current transmittance TR_{current} and the target transmittance TR_{target}.

Note that although an example is given here of an embodiment to calculate an absolute value of difference, instead of the absolute value of difference a proportion thereof may be employed. Moreover, the difference δ2 corresponds to the absolute value of difference between the current transmittance TR_{current} and the target transmittance TR_{target}, and so a disparity (for example, absolute value of difference, or proportion) between the current transmittance TR_{current} and the target transmittance TR_{target} may be applied instead of the difference δ2.

At the next step ST106, the processor 64 determines whether or not the difference δ2 is less than a threshold value TH2. The threshold value TH2 is a value indicating an exposure difference to realize a change above a reference level as a change in brightness between the frames 80. An example of the exposure difference to realize a change above a reference level as a change in brightness between the frames 80 is an exposure difference when a resulting change in brightness between the frames 80 imparts a user with a visually unsettling feeling. An example of the threshold value TH2 is a value determined in advance by actual experimentation with test equipment and/or computer simulation or the like as a lower limit value of exposure difference when a resulting change in brightness between the frames 80 imparts a user with a visually unsettling feeling. The lower limit value of exposure difference when a resulting change in brightness between the frames 80 imparts a user with a visually unsettling feeling is merely an example thereof, and the lower limit value may be higher value within a permissible range. Moreover, the threshold value TH2 may be a fixed value, and may be a variable value changed according to a given instruction or various conditions. The threshold value TH2 may be a value decided by a user, and may be a value decided according to type of imaging mode.

Affirmative determination is made at step ST106 when the difference δ2 is less than the threshold value TH2, and the exposure control processing transitions to step ST108. Negative determination is made at step ST106 when the difference δ2 is not less than the threshold value TH2, and the exposure control processing transitions to step ST110.

A small disparity counter is employed in the processing of step ST108 and the processing of step ST110. The small disparity counter is a counter to measure a number of times that a state in which the disparity between the exposure realized by the current transmittance TR_{current} and the exposure realized by the target transmittance TR_{target} with the shutter speed, aperture value, and sensitivity in a fixed state has continued to be small (namely, the number of times that the determination result has continued to be “difference δ2<threshold value TH2” at step ST106). The initial count value of the small disparity counter is “0”.

At step ST108, the processor 64 increments the count value of the small disparity counter by 1. The exposure control processing transitions to step ST112 after the processing of step ST108 has been executed.

At step ST110, the processor 64 resets the count value of the small disparity counter to the initial count value. The exposure control processing transitions to step ST112 after the processing of step ST110 has been executed.

At step ST112, the processor 64 determines whether or not the count value of the small disparity counter has exceeded a threshold value TH3. The threshold value TH3 is a value determined based on a number of times possible that the number of times “difference δ2<threshold value TH2” continues to be determined at step ST106 not due to the effect of brightness of the imaging subject, but instead due to the effect of a factor other than imaging subject brightness (for example, noise). An example of the threshold value TH3 is a value determined in advance by actual experimentation with test equipment and/or computer simulation or the like as an upper limit value of a number of times possible that the number of times “difference δ2<threshold value TH2” continues to be determined at step ST106 not due to the effect of brightness of the imaging subject, but instead due to the effect of a factor other than imaging subject brightness. The upper limit value of the number of times continuation is possible not due to the effect of brightness of the imaging subject, but instead due to the effect of a factor other than imaging subject brightness, is merely an example, and the upper limit value of the number of times possible for continuation not due to the effect of brightness of the imaging subject but due to the effect of a factor other than imaging subject brightness may be a lower value within a permissible range. Moreover, the threshold value TH3 may be a fixed value, and may be a variable value changed according to a given instruction or various conditions. The threshold value TH3 may be a value decided by a user, and may be a value decided according to type of imaging mode.

Negative determination is made at step ST112 in cases in which the count value of the small disparity counter has not exceeded the threshold value TH3, and the exposure control processing transitions to step ST28 as illustrated in FIG. 11B. Affirmative determination is made at step ST112 in cases in which the count value of the small disparity counter has exceeded the threshold value TH3, and the exposure control processing transitions to step ST114.

At step ST114, the processor 64 changes the threshold value TH1 to a larger value than the value set at the current point in time. A maximum length change time is an example of the larger value than the value set at the current point in time. The maximum length change time means the maximum length of the change time T1 from out of the plural change times T1 held in the memory 68 at the current point in time. Note that the maximum length change time is merely an example, and from out of the change times T1 held in the memory 68 at the current point in time, any change time T1 larger than the threshold value TH1 at the current point in time may be employed. Moreover, the threshold value TH1 may be changed to a larger value than the value set at the current point in time based on a rule determined irrespectively to the plural change times T1 held in the memory 68 at the current point in time (for example, a rule to multiply the threshold value TH1 with a coefficient that makes the threshold value TH1 larger). Moreover, the extent to which to the threshold value TH1 is made larger may be decided according to an instruction given by a user or according to various conditions. The exposure control processing transitions to step ST116 after the processing of step ST114 has been executed.

At step ST116, the processor 64 switches ON a threshold value change flag, which is a flag to indicate that the threshold value TH1 has been changed. The exposure control processing transitions to step ST28 illustrated in FIG. 11B after the processing of step ST116 has been executed.

At step ST118 illustrated in FIG. 12C, the processor 64 resets the count value of the small disparity counter to the initial count value. The exposure control processing transitions to step ST120 after the processing of step ST118 has been executed.

At step ST120, the processor 64 determines whether or not the threshold value change flag is ON. Negative determination is made at step ST120 when the threshold value change flag is not ON, and the exposure control processing transitions to step ST24. Affirmative determination is made at step ST120 when the threshold value change flag is ON, and the exposure control processing transitions to step ST122.

At step ST122, the processor 64 determines whether or not the latest change time T1 held in the memory 68 is a default threshold value TH1 or lower. The default threshold value TH1 is a value determined in advance as a smaller value that the threshold value TH1 set at the current point in time. Negative determination is made at step ST122 when the latest change time T1 held in the memory 68 is not the default threshold value TH1 or lower, and the exposure control processing transitions to step ST24. Affirmative determination is made at step ST122 when the latest change time T1 held in the memory 68 is the default threshold value TH1 or lower, and the exposure control processing transitions to step ST124.

A short change time counter is employed in the processing of step ST124. The short change time counter is a counter that measures the number of times the determination result of “change time T1<default threshold value TH1” has continued at step ST122. The initial count value of the short change time counter is “0”.

At the step ST124, the processor 64 increments the count value of the short change time counter by 1. The exposure control processing transitions to step ST126 after the processing of step ST124 has been executed.

At step ST126, the processor 64 determines whether or not the count value of the short change time counter has exceeded a threshold value TH4. The threshold value TH4 is a value determined based on a number of times possible that the number of times “difference δ2<threshold value TH2” continues to be determined at step ST106 is not due to the effect of the imaging subject brightness, but instead due to the effect of a factor other than imaging subject brightness (for example, noise). An example of the threshold value TH4 is a value determined in advance by actual experimentation with test equipment and/or computer simulation or the like as an upper limit value of a number of times possible that the number of times “difference δ2<threshold value TH2” continues to be determined at step ST106 not due to the effect of brightness of the imaging subject, but instead due to the effect of a factor other than imaging subject brightness. The upper limit value of the number of times possible that determination continues not due to the effect of brightness of the imaging subject, but instead due to the effect of a factor other than imaging subject brightness, is merely an example, and the upper limit value of the number of times possible that determination continues not due to the effect of brightness of the imaging subject, but instead due to the effect of a factor other than imaging subject brightness, may be a lower value within a permissible range. Moreover, the threshold value TH4 may be a fixed value, and may be a variable value changed according to a given instruction or various conditions. The threshold value TH4 may be a value decided by a user, and may be a value decided according to type of imaging mode.

Negative determination is made at step ST126 in cases in which the count value of the short change time counter has not exceeded the threshold value TH4, and the exposure control processing transitions to step ST24. Affirmative determination is made at step ST126 in cases in which the count value of the short change time counter has exceeded the threshold value TH4, and the exposure control processing transitions to step ST128. The count value of the short change time counter exceeding the threshold value TH4 means that there is a high possibility that there is hardly any change to the imaging subject brightness. In such cases a configuration is preferably adopted in which, as much as possible, the processing of step ST24 and the processing of step ST26 illustrated in FIG. 12C is performed instead of the processing of step ST28 to step ST40 illustrated in FIG. 11B. This is because the processing of step ST24 and the processing of step ST26 illustrated in FIG. 12C has a fewer number of steps and a smaller processing load than the processing of step ST28 to step ST40 illustrated in FIG. 11B.

Thus in order to facilitate the exposure control processing proceeding to the processing of step ST24 and the processing of step ST26 illustrated in FIG. 11A than the processing of step ST28 to step ST40 illustrated in FIG. 11B, at step ST128 the processor 64 changes the threshold value TH1 set at the current point in time to the default threshold value TH1. The exposure control processing transitions to step ST130 after the processing of step ST128 has been executed.

At step ST130, the processor 64 switches OFF the threshold value change flag. The exposure control processing transitions to step ST132 after the processing of step ST130 has been executed.

At step ST132, the processor 64 resets the count value of the short change time counter to the initial count value thereof. The exposure control processing transitions to step ST24 after the processing of step ST132 has been executed.

Note that in the present second exemplary embodiment, the difference δ2 is an example of a “disparity between a first transmittance and a second transmittance” according to the present disclosure. Moreover, in the present second exemplary embodiment, the count value of the small disparity counter (see step ST112) is an example of a “number of times a state arises in which a disparity between the first transmittance and the second transmittance lies within a preset range” according to the present disclosure. Moreover, in the present second exemplary embodiment, the threshold value TH3 is an example of a “specific number of times” according to the present disclosure.

As described above, in the imaging apparatus 10 according to the present second exemplary embodiment, the threshold value TH1 is changed to a value larger than the value set at the current point in time in cases in which the change time T1 exceeds the threshold value TH1, and also the number of times that a state arises in which the disparity between the current transmittance TR_{current} and the target transmittance TR_{target} (a difference δ2 in the second exemplary embodiment) is falls in a preset range (is the threshold value TH2 or lower in the present second exemplary embodiment) has continued a specific number of times (cases in which the count value of the small disparity counter is greater than the threshold value TH3 in the present second exemplary embodiment). This accordingly facilitates the processing of step ST24 and the processing of step ST26 illustrated in FIG. 12C being performed instead of the processing of step ST28 to step ST40 illustrated in FIG. 11B because it is made more difficult for the change time T1 to exceed the threshold value TH1 than before the threshold value TH1 was changed. The processing of step ST24 and the processing of step ST26 illustrated in FIG. 12C has fewer steps and is able to reduce the processing load compared to the processing of step ST28 to step ST40 illustrated in FIG. 11B.

Moreover, in cases in which the change time T1 has exceeded the threshold value TH1 and also a number of times a state has arisen in which the disparity between the current transmittance TR_{current} and the target transmittance TR_{target} falls within the preset range has continued for the specific number of times (cases in which the count value of the small disparity counter is above the threshold value TH3 in the present second exemplary embodiment), the threshold value TH1 is changed to a value (for example, the maximum length change time) determined based on the change time T1 obtained while the count value of the small disparity counter exceeds the threshold value TH3. This accordingly makes it more easy to change the threshold value TH1 to a value not likely to be exceeded by the change time T1 than cases in which the user decides the value after changing the threshold value TH1 (namely, cases in which the threshold value TH1 is changed according to an instruction given by a user).

### Third Exemplary Embodiment

In the second exemplary embodiment, an example has been given of an embodiment in which, by executing the processing of step ST28 to step ST40 illustrated in FIG. 11B in cases in which the change time T1 has exceeded the threshold value TH1 and also the number of times a state has arisen in which the disparity between the current transmittance TR_{current} and the target transmittance TR_{target} falls within the preset range has continued for the specific number of times, the plural divisional exposures EX_{div} corresponding to the plural frames 80 when the transmittance of the electronic ND filter 58 is changed from the current transmittance TR_{current} to the target transmittance TR_{target} via the in-change-time transmittance TR_{InTime} with the shutter speed, aperture value, and sensitivity in a fixed state, are adjusted in sensitivity by adjustment with adjustment values determined according to the difference δ1. However, in the present third exemplary embodiment, description follows regarding an example of an embodiment in which the plural divisional exposures EX_{div} are maintained in cases in which the change time T1 has exceeded the threshold value TH1 and also the number of times a state has arisen in which the disparity between the current transmittance TR_{current} and the target transmittance TR_{target} falls within the preset range has continued the specific number of times.

Note that the same reference numerals are appended in the present third exemplary embodiment to configuration elements the same as those of the first and second exemplary embodiments, and explanation thereof will be omitted. The present third exemplary embodiment will be described mainly by differences to the second exemplary embodiment.

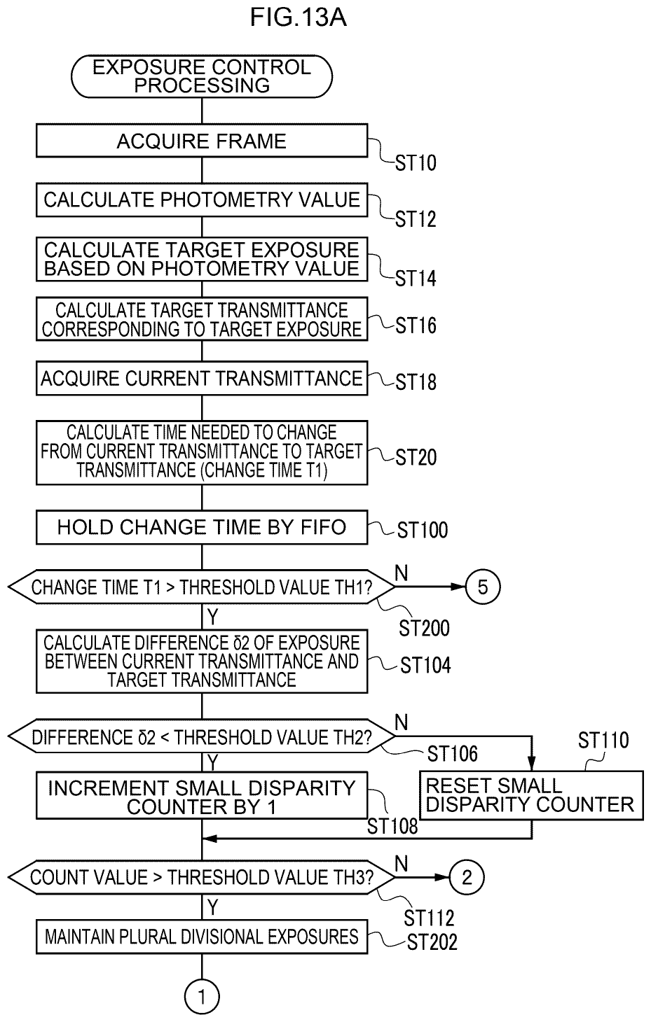

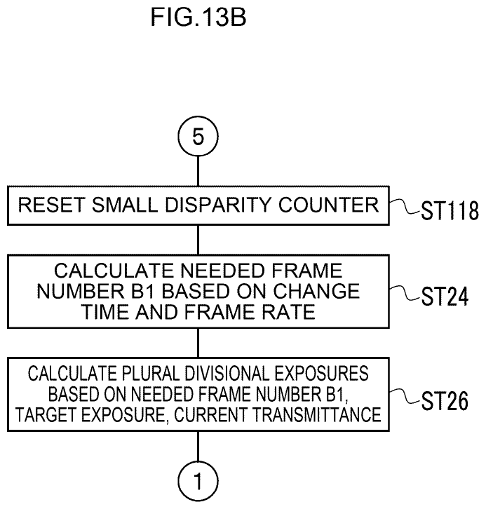

In the present third exemplary embodiment, an example of exposure control processing according to the present third exemplary embodiment will be described with reference to a flowchart illustrated in FIG. 13A and FIG. 13B. However, plural steps duplicate to those of the flowchart illustrated in FIG. 12A to FIG. 12C as described in the second exemplary embodiment are included in the flowchart illustrated in FIG. 13A and FIG. 13B, and so the same step numbers are appended to the plural steps contained in the flowchart illustrated in FIG. 13A and FIG. 13B that are the same as steps in the flowchart illustrated in FIG. 12A to FIG. 12C described in the second exemplary embodiment, and explanation thereof will be omitted.

The flowchart illustrated in FIG. 13A and FIG. 13B differs from the flowchart illustrated in FIG. 12A to FIG. 12C in the inclusion of step ST200 instead of step ST102, in the removal of step ST114 and step ST116, and in the removal of step ST120 to step ST132.

At step ST200 illustrated in FIG. 13A, the processor 64 determines whether or not the latest change time T1 held in the memory 68 has exceeded the threshold value TH1. Negative determination is made at step ST200 when the latest change time T1 held in the memory 68 has not exceeded the threshold value TH1, and the exposure control processing transitions to step ST118 illustrated in FIG. 13B. Affirmative determination is made at step ST200 when the latest change time T1 held in the memory 68 has exceeded the threshold value TH1, and the exposure control processing transitions to step ST104.

The exposure control processing transitions to step ST202 illustrated in FIG. 13B in cases in which affirmative determination has been made at step ST112 illustrated in FIG. 13A.

At step ST202, the processor 64 stores the plural divisional exposures EX_{div} that have already been calculated at the current point in time (namely, the plural divisional exposures EX_{div} already calculated by step ST34 illustrated in FIG. 11B) in a divisional exposure storage area that is a predetermined storage area in the memory 68, and thereby holds the plural divisional exposures EX_{div} that have already been calculated at the current point in time. The exposure control processing transitions to step ST42 illustrated in FIG. 11B after the processing of step ST202 has been executed.

In cases in which the exposure control processing has transitioned from the step ST202 to the step ST42 illustrated in FIG. 11i, at step ST42 illustrated in FIG. 11B, the processor 64 causes the imaging apparatus 10 to perform imaging using the N^{th} frame divisional exposure EX_{div} from out of the plural divisional exposures EX_{div} held in the divisional exposure storage area. The plural divisional exposures EX_{div} held in the divisional exposure storage area are accordingly applied for the exposures of the plural frames 80 obtained by performing live-view image imaging. The plural divisional exposures EX_{div} held in the divisional exposure storage area are the plural divisional exposures EX_{div} that have already been calculated at the current point in time (namely, the plural divisional exposures EX_{div} that have already been calculated by step ST34 illustrated in FIG. 11), and do not need the processing of step ST36 to step ST40 illustrated in FIG. 11B to be performed thereon. This means that frequent adjustment of the divisional exposure EX_{div} using the processing of step ST36 to step ST40 illustrated in FIG. 11B can be suppressed.

### Fourth Exemplary Embodiment

In the first exemplary embodiment, an example has been given of an embodiment in which the divisional exposures EX_{div} calculated as the realistic exposures are adjusted so as to be ideal divisional exposures EX_{div} by the sensitivity of each frame 80 being adjusted with adjustment values determined according to difference δ1, irrespective of the extent of the difference δ1. However, there is a possibility that noise generated accompanying sensitivity adjustment also becomes large due to the sensitivity adjustment values being larger as the difference δ1 gets larger. Moreover, due to the adjustment values being larger as the difference δ1 gets larger even for cases in which, other than sensitivity, the shutter speed and/or the aperture value is adjusted by adjustment values determined according to the difference δ1, this leads to a large physical load on the shutter and/or the aperture 40C from operation of the shutter and/or operation of the aperture 40C, with this being a potential cause of a decrease in the lifespan of the shutter and/or the aperture 40C. Thus, in the present fourth exemplary embodiment, an example of an embodiment will be described for suppressing an adjustment amount, for adjusting the sensitivity or the like to make the divisional exposures EX_{div} calculated as realistic exposure be the ideal divisional exposures EX_{div}.

Note that the same reference numerals are appended in the present fourth exemplary embodiment to configuration elements the same as those of the first exemplary embodiment, and explanation thereof will be omitted. Moreover, in the fourth exemplary embodiment, description follows regarding main differences to the first exemplary embodiment.

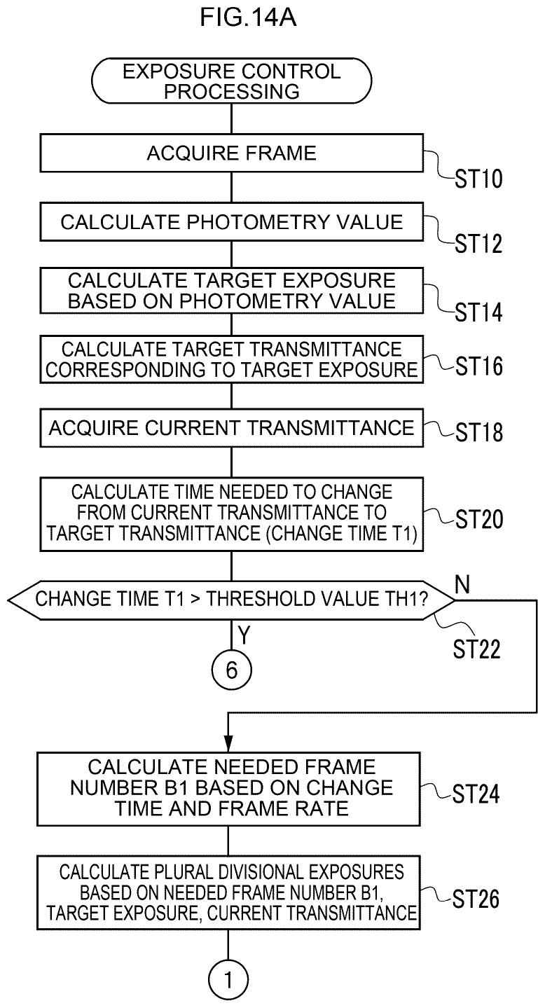

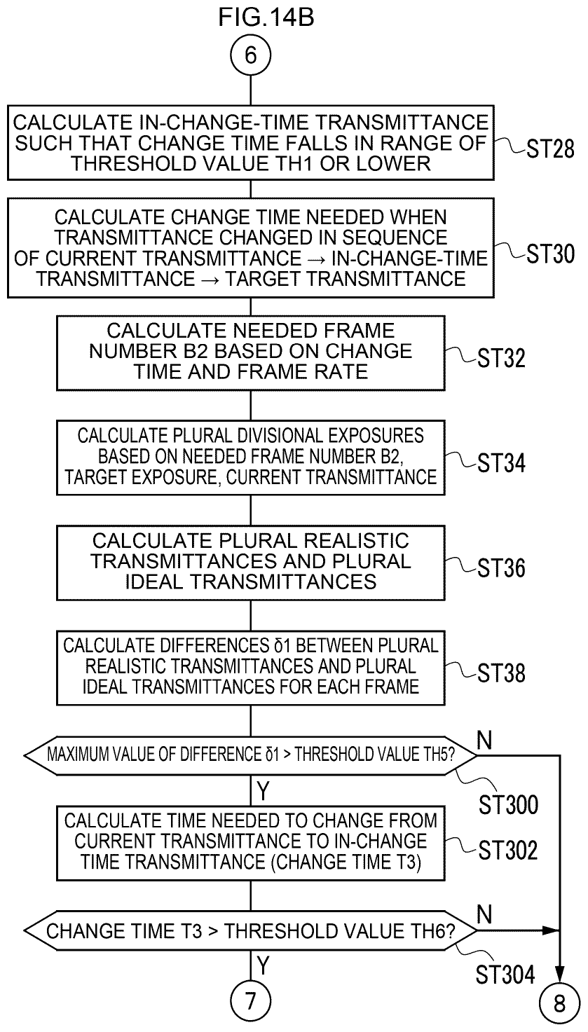

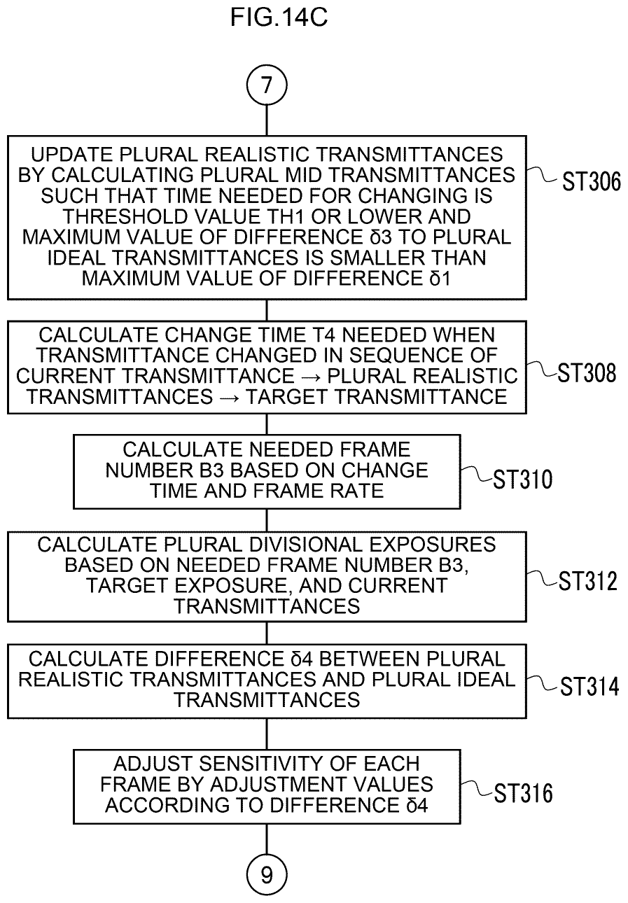

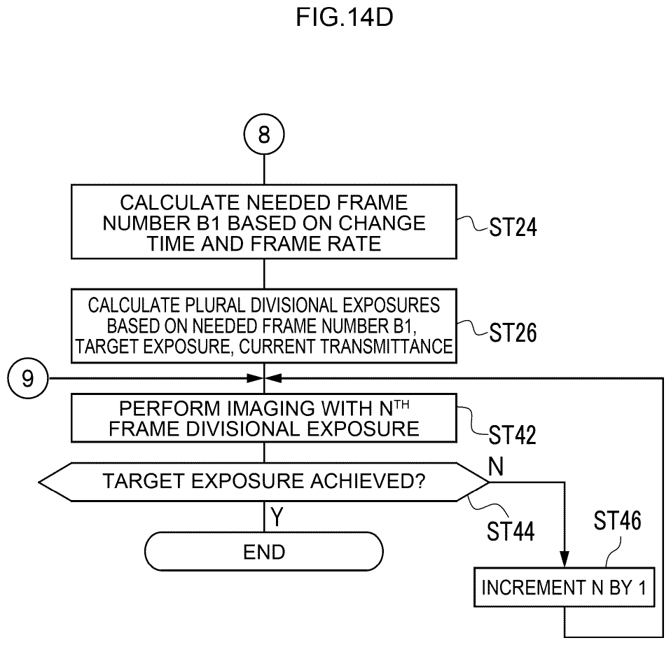

In the present fourth exemplary embodiment, description follows regarding an example of exposure control processing according to the present fourth exemplary embodiment, with reference to the flowchart illustrated in FIG. 14A to FIG. 14D. However, plural steps that are duplicates of those in the flowchart illustrated in FIG. 11A and FIG. 11B described in the first exemplary embodiment are included in the flowchart illustrated in FIG. 14A to FIG. 14D, and so from out of the plural steps contained in the flowchart illustrated in FIG. 14A to FIG. 14D, the same step numbers are appended to the same steps as in the flowchart illustrated in FIG. 11A and FIG. 11B described in the first exemplary embodiment, and explanation thereof will be omitted.

The flowchart illustrated in FIG. 14A to FIG. 14D differs from the flowchart illustrated in FIG. 11A and FIG. 11B in the inclusion of step ST300 to step ST316 instead of step ST40.

In the flowchart illustrated in FIG. 14A, the exposure control processing transitions to step ST28 illustrated in FIG. 14B after the processing of step ST22 has been executed. In the flowchart illustrated in FIG. 14B, the exposure control processing transitions to step ST300 after the processing of step ST38 has been executed.

At step ST300, the processor 64 determines whether or not a maximum value of a difference δ1 calculated at step ST38 has exceeded a threshold value TH5. The maximum value of the difference δ1 is an example of a “first maximum disparity” according to the present disclosure, and the threshold value TH5 is an example of a “preset disparity” according to the present disclosure.

When the sensitivity is adjusted by an adjustment value according to the difference δ1, the threshold value TH5 is as an example an upper limit value of the difference δ1 employed to obtain adjustment values such that a deterioration in quality due to noise or the like generated by the sensitivity being adjusted is not visually perceptible to a user. Note that the upper limit value is merely an example, and the upper limit value may be a lower value within a permissible range. Although an example is given here of an embodiment in which the sensitivity is adjusted, this is merely an example, and the threshold value TH5 is determined in a similar manner for cases in which the shutter speed and/or the aperture value is adjusted.

The threshold value TH5 may be determined in advance by experimentation with test equipment and/or computer simulation or the like as an upper limit value of the difference δ1 employed when adjustment values are obtained such that a deterioration in quality due to noise or the like generated by sensitivity being adjusted is not visually perceptible to a user. The upper limit value of the difference δ1 employed to obtain adjustment values such that a deterioration in quality due to noise or the like generated by sensitivity being adjusted is not visually perceptible to a user is merely an example. The upper limit value of the difference δ1 employed to obtain adjustment values such that a deterioration in quality due to noise or the like generated by sensitivity being adjusted is not visually perceptible to a user may be lower value within a permissible range. The threshold value TH5 may be a fixed value, and may be a variable value changed according to a given instruction or various conditions. The threshold value TH5 may be a value decided by a user, and may be a value decided according to type of imaging mode.

Negative determination is made at step ST300 when the maximum value of the difference δ1 calculated at step ST38 has not exceeded the threshold value TH5, and the exposure control processing transitions to step ST24 illustrated in FIG. 14D. Affirmative determination is made at step ST300 when the maximum value of the difference δ1 calculated at step ST38 has exceeded the threshold value TH5, and the exposure control processing transitions to step ST302.

At step ST302, the processor 64 calculates a change time T3, which is a time needed to change from the current transmittance TR_{current} to the in-change-time transmittance TR_{InTime}. The calculation of the change time T3 is performed in a similar manner to the calculation of the change time T1 and the change time T2 as described in the first exemplary embodiment. Namely, the change time T3 is calculated using a computation equation having the current transmittance TR_{current} and the in-change-time transmittance TR_{InTime} as independent variables, and having the change time T3 as a dependent variable. The exposure control processing transitions to step ST304 after the processing of step ST302 has been executed.

At step ST304, the processor 64 determines whether or not the change time T3 is less than a threshold value TH6. The change time T3 is an example of a “transmittance change time” according to the present disclosure, and the threshold value TH6 is an example of a “second threshold value” according to the present disclosure.

The threshold value TH6 is a lower limit value of the change time T3 such that, in cases in which the sensitivity is adjusted to change from the exposure realized by the current transmittance TR_{current} to the exposure realized by the in-change-time transmittance TR_{InTime}, noise generated accompanying the adjustment to sensitivity does not have an effect on the quality of the frame 80 at a visually perceptible level. The lower limit value is merely an example, and the lower limit value may be a higher value within a permissible range. Although an example is given here of an embodiment in which the sensitivity is adjusted, this is merely an example, and the threshold value TH6 may be determined in a similar manner for cases in which the shutter speed and/or the aperture value is adjusted.

The threshold value TH6 may be determined in advance by experimentation with test equipment and/or computer simulation or the like as a lower limit value to the change time T3 such that noise generated accompanying the adjustment to sensitivity, in cases in which the sensitivity is adjusted to change from the exposure realized by the current transmittance TR_{current} to the exposure realized by the in-change-time transmittance TR_{InTime}, has no effect on the quality of the frame 80 at a visually perceptible level. The lower limit value of a time at which there is a concern that noise generated accompanying the adjustment to sensitivity, when the sensitivity is adjusted to change from the exposure realized by the current transmittance TR_{current} to the exposure realized by the in-change-time transmittance TR_{InTime}, might have an effect on the quality of the frame 80 at a visually perceptible level, is merely an example thereof. The lower limit value of a time at which there is a concern that noise generated accompanying the adjustment to sensitivity, when the sensitivity is adjusted to change from the exposure realized by the current transmittance TR_{current} to the exposure realized by the in-change-time transmittance TR_{InTime}, might have an effect on the quality of the frame 80 at a visually perceptible level may be a higher value within a permissible range. The threshold value TH6 may be a fixed value, and may be a variable value changed according to a given instruction or various conditions. The threshold value TH6 may be a value decided by a user, and may be a value decided according to type of imaging mode.

Negative determination is made at step ST304 when the change time T3 is not less than the threshold value TH6 (namely, in cases in which the change time T3 is the threshold value TH6 or greater), and the exposure control processing transitions to step ST24 illustrated in FIG. 14D. Thus, the processing of step ST24 and the processing of step ST26 illustrated in FIG. 14D is executed in a similar manner to in the first exemplary embodiment, and the processing of step ST42 to step ST46 is executed after the processing of step ST26 has been executed. Negative determination is made at step ST304 when the change time T3 is less than the threshold value TH6, and the exposure control processing transitions to step ST306 illustrated in FIG. 14C.

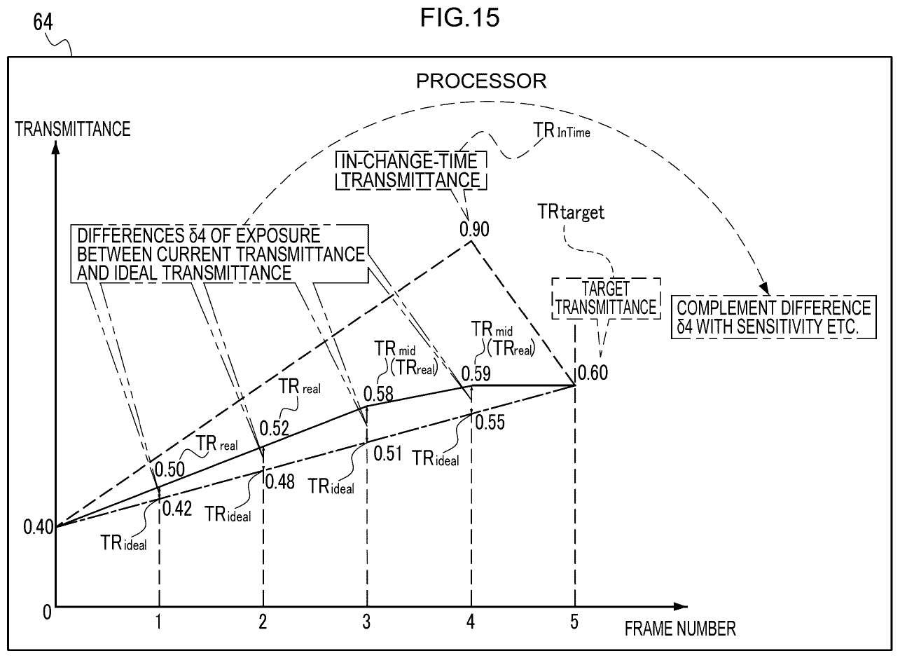

At step ST306 illustrated in FIG. 14C, the processor 64 calculates plural mid transmittances TR_{mid}, and updates the plural realistic transmittances TRᵣₑₐₗ (see FIG. 15). The plural mid transmittances TR_{mid} are plural transmittances such that the time needed when the transmittance of the electronic ND filter 58 is changed from the current transmittance TR_{current} to the target transmittance TR_{target} via the plural mid transmittances TR_{mid} is the threshold value TH1 or lower, and also a maximum value of a difference δ3 to the plural ideal transmittances TR_{ideal} is smaller than the maximum value of the difference δ1. The plural realistic transmittances TRᵣₑₐₗ updated by executing the processing of step ST306 (see FIG. 15) is an example of “plural second realistic transmittances” according to the present disclosure, the plural mid transmittances TR_{mid} are an example of “plural mid transmittances” according to the present disclosure, the maximum value of the difference δ1 is an example of a “first maximum disparity” according to the present disclosure, and the maximum value of the difference δ3 is an example of a “second maximum disparity” according to the present disclosure. The exposure control processing transitions to step ST308 after the processing of step ST306 has been executed.

At step ST308, the processor 64 calculates a change time T4, which is a time needed when the transmittance of the electronic ND filter 58 is changed in the sequence of the current transmittance TR_{current}, the plural realistic transmittances TRᵣₑₐₗ (see FIG. 15), and the target transmittance TR_{target}. The calculation of the change time T4 is performed in a similar manner to the calculation of the change time T1 and the change time T2 as described in the first exemplary embodiment. The change time T4 is calculated using a computation equation having the current transmittance TR_{current}, the plural realistic transmittances TRᵣₑₐₗ (see FIG. 15), and the target transmittance TR_{target} as independent variables, and having the change time T4 as a dependent variable. The exposure control processing transitions to step ST310 after the processing of step ST308 has been executed.

At step ST310, in a similar manner to in the first exemplary embodiment, the processor 64 calculates a needed frame number B3, which is a number of frames needed during the course of the change time T4, based on the change time T4 and the frame rate FR. For example, the needed frame number B3 is calculated by “(change time T4)×(frame rate FR)”. The exposure control processing transitions to step ST312 after the processing of step ST310 has been executed.

In a similar manner to in the first exemplary embodiment, at step ST312 the processor 64 calculates plural divisional exposures EX_{div} based on the needed frame number B3, the target exposure EX_{target}, and the current transmittance TR_{current}. The calculation of the plural divisional exposures EX_{div} is performed in a similar manner to in the first exemplary embodiment. Namely, the plural divisional exposures EX_{div} are calculated using a computation equation having the needed frame number B3, the target exposure EX_{target}, and the current transmittance TR_{current} as independent variables, and having the plural divisional exposures EX_{div} as a dependent variable. The exposure control processing transitions to step ST314 after the processing of step ST312 has been executed.

At step ST314, in a similar manner to in the first exemplary embodiment, by units of the frames 80 within the needed frame number B3, the processor 64 calculates a difference δ4 of exposure between the plural realistic transmittances TRᵣₑₐₗ and the plural ideal transmittances TR_{ideal} (see FIG. 15). Namely, at step ST314 the difference δ4 of exposure between the plural realistic transmittances TRᵣₑₐₗ and the plural ideal transmittances TR_{ideal} is calculated for each of the frames 80 contained in the needed frame number B3. The exposure control processing transitions to step ST316 after the processing of step ST314 has been executed.

At step ST316, in a similar manner to in the first exemplary embodiment, for each of the frames 80 contained in the needed frame number B3 the processor 64 adjusts the sensitivity, which is one of the exposure factors defining the divisional exposures EX_{div}, by an adjustment value according to the difference δ4 (see FIG. 15). The exposure control processing transitions to step ST42 illustrated in FIG. 14D after the processing of step ST316 has been executed.

At step ST42 illustrated in FIG. 14D, the processor 64 then causes the imaging apparatus 10 to perform imaging with an N^{th} frame divisional exposure EX_{div}. For example, when the exposure control processing has transitioned from step ST26 to step ST42, at step ST42 the processor 64 causes the imaging apparatus 10 to perform imaging with the N^{th} frame divisional exposure EX_{div} from out of the plural divisional exposures EX_{div} calculated by execution of the processing of step ST26. However, in cases in which the exposure control processing has transitioned from step ST316 illustrated in FIG. 14C to step ST42, at step ST42 the processor 64 sets the imaging apparatus 10 with a sensitivity adjusted according to the difference δ4 calculated for N^{th} frame, a shutter speed determined for the N^{th} frame, and an aperture value determined for the N^{th} frame, and after setting the electronic ND filter 58 to the N^{th} frame transmittance from out of the current transmittance TR_{current}, the plural realistic transmittances TRᵣₑₐₗ, and the target transmittance TR_{target}, causes the imaging apparatus 10 to perform imaging. Namely, whereas in the first exemplary embodiment the plural divisional exposures EX_{div} corresponding to the current transmittance TR_{current}, the plural realistic transmittances TRᵣₑₐₗ, and the target transmittance TR_{target} are adjusted to align with the plural divisional exposures EX_{div} corresponding to the current transmittance TR_{current}, the plural ideal transmittances TR_{ideal}, and the target transmittance TR_{target} by complementing the difference δ1 using the sensitivity or the like, in the fourth exemplary embodiment the plural divisional exposures EX_{div} corresponding to the current transmittance TR_{current}, the plural realistic transmittances TRᵣₑₐₗ, and the target transmittance TR_{target} are adjusted to align with the plural divisional exposures EX_{div} corresponding to the current transmittance TR_{current}, the plural ideal transmittances TR_{ideal}, and the target transmittance TR_{target} by complementing the difference δ4 using the sensitivity or the like (see FIG. 15).

As described above, in the imaging apparatus 10 according to the present fourth exemplary embodiment, the difference δ4 is calculated based on the plural realistic transmittances TRᵣₑₐₗ that have a smaller fluctuation range than the plural realistic transmittances TRᵣₑₐₗ containing the in-change-time transmittance TR_{InTime} (namely, the plural realistic transmittances TRᵣₑₐₗ including the plural mid transmittances TR_{mid} illustrated in FIG. 15) and based on the plural ideal transmittances TR_{ideal} (see FIG. 15). By the sensitivity or the like being adjusted with adjustment values determined according to the difference δ4, the plural divisional exposures EX_{div} calculated as realistic exposures are adjusted so as to be the plural ideal divisional exposures EX_{div}. This thereby enables the adjustment amount to be suppressed for adjustment using the sensitivity or the like for the plural divisional exposures EX_{div} calculated as the realistic exposures. This thereby enables the generation of problems to be suppressed from occurring that might have arisen due to a large adjustment amounts for adjustment using the sensitivity or the like of the plural divisional exposures EX_{div} calculated as the realistic exposures.

Moreover, in the present fourth exemplary embodiment, in cases in which the change time T3 is less than the threshold value TH6, the difference δ4 is calculated based on the plural realistic transmittances TRᵣₑₐₗ (namely, the plural realistic transmittances TRᵣₑₐₗ containing the plural mid transmittances TR_{mid} illustrated in FIG. 15) that have a smaller fluctuation range than the plural realistic transmittances TRᵣₑₐₗ containing the in-change-time transmittance TR_{InTime}, and based on the plural ideal transmittances TR_{ideal} (see FIG. 15). The plural divisional exposures EX_{div} calculated as the realistic exposures are then adjusted so as to be the plural ideal divisional exposures EX_{div} by adjustment of the sensitivity or the like with the adjustment values determined according to the difference δ4. This thereby enables a situation to be suppressed from occurring in which the adjustment amount, for adjusting the divisional exposures EX_{div} using the sensitivity or the like, increases due to the change time T3 being too short.

### Fifth Exemplary Embodiment

The first exemplary embodiment has been described for an embodiment in which there is a presumption that the aperture value is fixed, however conceivably there are cases in which the aperture value is changed to achieve the target exposure EX_{target} (namely, cases in which the aperture 40C is driven), and cases in which the change time T1 does not fall within a drive time of the aperture 40C (namely, within the time needed from the start of driving the aperture 40C to driving completion). Thus in the present fifth exemplary embodiment, an example will be described of an embodiment in which the threshold value TH1 is made the drive time of the aperture 40C when the change time T1 does not fall within the drive time of the aperture 40C.

Note that the same reference numerals are appended in the present fifth exemplary embodiment to configuration elements the same as those of the first exemplary embodiment, and explanation thereof will be omitted. Moreover, in the present fifth exemplary embodiment, description follows regarding main differences to the first exemplary embodiment.

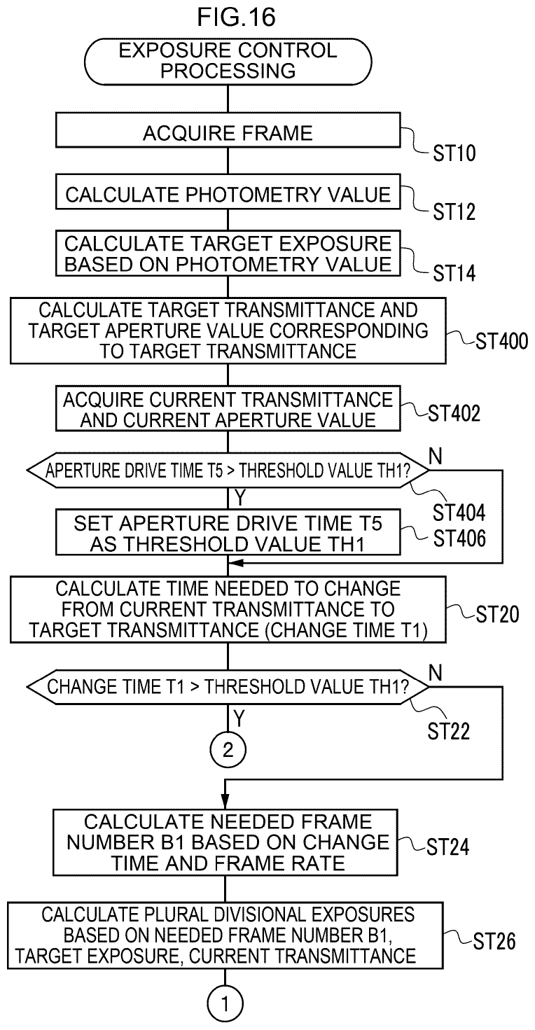

In the present fifth exemplary embodiment, description follows regarding an example of exposure control processing according to the present fifth exemplary embodiment, with reference to the flowchart illustrated in FIG. 16. However, the flowchart illustrated in FIG. 15 contains plural steps that are duplicates of the flowchart illustrated in FIG. 11A to FIG. 11B as described in the first exemplary embodiment, and so the same step numbers are appended below to any out of the plural steps contained in the flowchart illustrated in FIG. 15 that are the same as steps in the flowchart illustrated in FIG. 11A to FIG. 11B described in the first exemplary embodiment, and explanation thereof will be omitted.

The flowchart illustrated in FIG. 15 differs from the flowchart illustrated in FIG. 11A and FIG. 11B in the inclusion of step ST400 to step ST406 instead of step ST16 and step ST18.

At step ST400 illustrated in FIG. 16, the processor 64 calculates a target transmittance TR_{target} corresponding to a target exposure EX_{target}, and a target aperture value corresponding to the target exposure EX_{target}. For example, the target transmittance TR_{target} and the target aperture value are calculated using a computation equation having the shutter speed, sensitivity, and target exposure EX_{target} as independent variables, and having the target transmittance TR_{target} and the target aperture value as dependent variables. The exposure control processing transitions to step ST402 after the processing of step ST400 has been executed.

At step ST402, the processor 64 acquires a current transmittance TR_{current} and a current aperture value. The exposure control processing transitions to step ST404 after the processing of step ST402 has been executed.

At step ST404, the processor 64 determines whether or not an aperture drive time T5 has exceeded the threshold value TH1. The aperture drive time T5 is a time to drive the aperture 40C in order to implement the target aperture value (in other words, a time needed from starting driving the aperture 40C to completing driving), namely, a time that the aperture 40C is driven from the current aperture value to change to the target aperture value. The aperture drive time T5 is calculated based on the current aperture value acquired at step ST402 and on the target aperture value calculated at step ST400. For example, the calculation of the aperture drive time T5 is performed using a computation equation having the current aperture value and the target aperture value as independent variables, and having the aperture drive time T5 as a dependent variable.

The exposure control processing transitions to step ST20 when the aperture drive time T5 does not exceed the threshold value TH1 at step ST404. The exposure control processing transitions to step ST406 when the aperture drive time T5 exceeds the threshold value TH1 at step ST404.

At step ST406, the processor 64 sets the aperture drive time T5 as the threshold value TH1. Namely, the value of the threshold value TH1 at the current point in time is changed to the aperture drive time T5. Although an example is given here of an embodiment in which the value of the threshold value TH1 at the current point in time is changed to the aperture drive time T5, the value of the threshold value TH1 at the current point in time may be changed to a higher value of the aperture drive time T5 within a permissible range. The higher value of the aperture drive time T5 within a permissible range may be a fixed value, or may be a variable value changed according to a given instruction and/or various conditions. The exposure control processing transitions to step ST20 after the processing of step ST406 has been executed.

By adopting such an approach, the change time T1 falls within the aperture drive time T5, and so problems that arise due to the change time T1 not falling within the aperture drive time T5 can be suppressed from occurring.

### Sixth Exemplary Embodiment

Although in the above exemplary embodiments examples have been given of embodiments in which various differences (for example, the difference δ1, δ2, δ3, and δ4) are calculated, any disparity between two comparison targets may be employed, and instead of a difference a proportion may be employed. Moreover, although in the above exemplary embodiments examples of embodiments have been given in which a difference and a threshold value are compared, a threshold value corresponding to a proportion may be employed instead of a threshold value corresponding to a difference in cases in which a proportion, instead of a difference, and a threshold value are compared.

Although the first to the sixth exemplary embodiments illustrate examples of a time needed to change the transmittance of the electronic ND filter 58, namely, a change time (for example, the change times T1, T2, T3, and T4), a number of frames may be employed as the change time. Namely, a number of frames is encompassed in the meaning of change time.

Although the first to the sixth exemplary embodiments illustrate examples of various maximum values (a maximum value of the difference δ1, a maximum value of the difference δ3, and the like), these various maximum values also mean a maximum value within a predetermined range.

Although the first to the sixth exemplary embodiments illustrate examples of monotonous change, monotonous change means, for example, a linear change, an exponential function change, or the like. Moreover, examples of monotonous change include a monotonous increase and a monotonous decrease.

Although the first to the sixth exemplary embodiments illustrate examples of exposure control processing for cases in which live-view image imaging is performed, the present disclosure is not limited thereto and, for example, the exposure control processing described above is applicable, for example, to cases in which continuous imaging is performed, such as cases of recording imaging of video images being performed, cases of rapid shooting with a constant imaging interval being performed, or cases of rapid shooting with different imaging intervals being performed.

Although in the first to the sixth exemplary embodiments examples of embodiments have been described in which an exposure control processing program PG is stored on the storage 66, the present disclosure is not limited thereto. For example, the exposure control processing program PG may be stored on a portable, computer-readable, non-transitory storage medium such as an SSD or USB memory. The exposure control processing program PG stored on the non-transitory storage medium may be installed to the system controller 12 of the imaging apparatus 10. The processor 64 executes the exposure control processing according to the exposure control processing program PG.

Moreover, the exposure control processing program PG may be stored on a storage device of another computer, server device, or the like connected to the imaging apparatus 10 over a network, with the exposure control processing program PG then downloaded on request from the imaging apparatus 10 so as to be installed on the system controller 12.

Note that the entire exposure control processing program PG is not necessarily stored on the storage device such as another computer, server device, or the like connected to the imaging apparatus 10 or on the storage 66, and part of the exposure control processing program PG may be stored thereon.

Although the system controller 12 is built into the imaging apparatus 10 illustrated in FIG. 1 and FIG. 2, the present disclosure is not limited thereto and, for example, the system controller 12 may be provided externally to the imaging apparatus 10.

Although in the first to the sixth exemplary embodiments examples are illustrated with the system controller 12, the present disclosure is not limited thereto, and the present disclosure may be applied to a device including an ASIC, FPGA, and/or a PLD instead of the system controller 12. Instead of the system controller 12, a combination of a hardware configuration and a software configuration may be employed.

The following types of processors may be employed as the hardware resource for executing the exposure control processing described in the first to the sixth exemplary embodiments. Examples of processors include a CPU, which is a general-purpose processor that functions as the hardware resource for executing the exposure control processing according to the first to the sixth exemplary embodiments by, for example, executing software, namely a program. Examples of processors also include a custom electrical circuit, which is an example of a processor including a circuit configuration with a customized design for executing specific processing, such as, for example, an FPGA, PLD, or ASIC. Such processors may also have in-built or connected memory, with the processors executing the exposure control processing according to the first to the sixth exemplary embodiments using the memory.

The hardware resource for executing the exposure control processing according to the first to the sixth exemplary embodiments may be configured from a single type out of these various processor types, or may be configured by combining two or more processors of the same or different types (for example, by combining plural FPGAs or combining a CPU with an FPGA). The hardware resource for executing the exposure control processing according to the first to the sixth exemplary embodiments may also be a single processor.

Examples of configurations of a single processor include, firstly, a configuration of a single processor resulting from combining one or more CPU and software, in an embodiment in which this processor functions as a hardware resource for executing the exposure control processing according to the first to the sixth exemplary embodiments. Secondly, as typified by a SoC or the like, there is also an embodiment that uses a processor realized by a single IC chip to function as an overall system including plural hardware resources for executing the exposure control processing according to the first to the sixth exemplary embodiments. Adopting such an approach means that the exposure control processing according to the first to the sixth exemplary embodiments is realized using one or more of the various processors described above as hardware resource.

Furthermore, more specifically an electrical circuit that combines circuit elements such as semiconductor elements or the like may be employed as a hardware structure of these various processors. The exposure control processing according to the first to the sixth exemplary embodiments are merely examples thereof. Accordingly, obviously redundant steps may be omitted, new steps may be added, and the processing sequence may be swapped around within a range not departing from the spirit of the present disclosure.

### Seventh Exemplary Embodiment

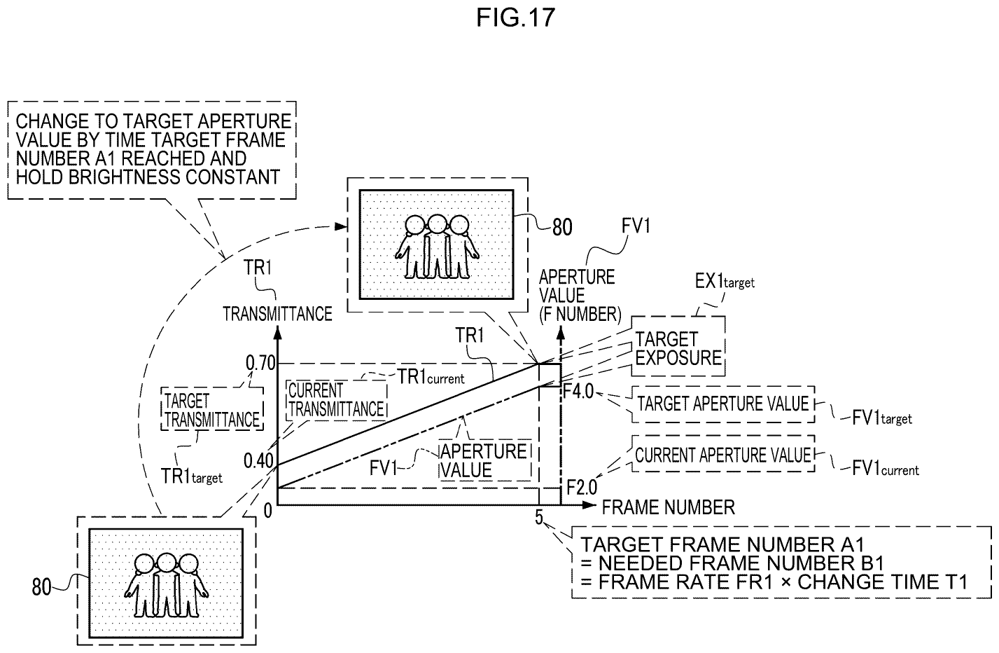

As illustrated in the example of FIG. 17, in cases in which plural frames 80 are obtained by performing live-view image imaging, when an aperture value of the aperture 40C (hereinafter simply referred to as “aperture value”) is changed monotonously from a current aperture value FV1_{current}, which is the current aperture value, toward a target aperture value FV1_{target}, which is a target aperture value, the brightness of the frames 80 is also changed along with changing the aperture value FV1. In such cases, preferably the brightness is held constant in the course of changing, from the current frame 80 to a frame 80 that is target frame number A11 later, this being the number of frames needed to change the aperture value FV1 from the current aperture value FV1_{current} to the target aperture value FV1_{target}. Namely, preferably a target exposure EX1_{target}, which is an exposure being targeted, is maintained while changing from the current aperture value FV1_{current} to the target aperture value FV1_{target}.

One conceivable method to implement this is a method of, during the course of changing from the current frame 80 to the frame 80 that is at the target frame number A11 later, to complement changes in the brightness accompanying changes in the aperture value FV1 by changing a transmittance TR1 of the electronic ND filter 58 so as to match changes to the aperture value FV1, while a shutter speed (for example, a shutter speed of a mechanical shutter when a mechanical shutter is employed, or the shutter speed of an electronic shutter when an electronic shutter is employed), and the sensitivity of the photoelectric conversion element 72 (for example, the ISO sensitivity), are maintained as they are.

In the example illustrated in FIG. 17, to match changes to the aperture value FV1, the transmittance TR1 of the electronic ND filter 58 is changed from the current transmittance TR1_{current}, which is the transmittance TR1 of the electronic ND filter 58 at the timing when the imaging apparatus 10 started exposure computation, to the target transmittance TR1_{target} capable of realizing the target exposure EX1_{target} in order to maintain the brightness of the frames 80 at the target brightness.

Due to the aperture value being changed monotonously (changed linearly in the example illustrated in FIG. 17), the brightness between frames 80 is maintained constant as long as the transmittance TR1 of the electronic ND filter 58 is changed by monotonous change amounts from the current transmittance TR1_{current} to the target transmittance TR1_{target} so to match the changes of the aperture value FV1. However, in order to implement this approach there is a need for the transmittance TR1 of the electronic ND filter 58 to attain the target transmittance TR1_{target} at the point in time when the target frame number A11 matches a needed frame number B11 (=(frame rate FR1 employed for live-view image imaging)×(change time T)), which is the number of frames needed during the course of the change time T (namely, the time needed to change from the current transmittance TR1_{current} to the target transmittance TR1_{target}), and also the target frame number A11 frame 80 has been obtained.

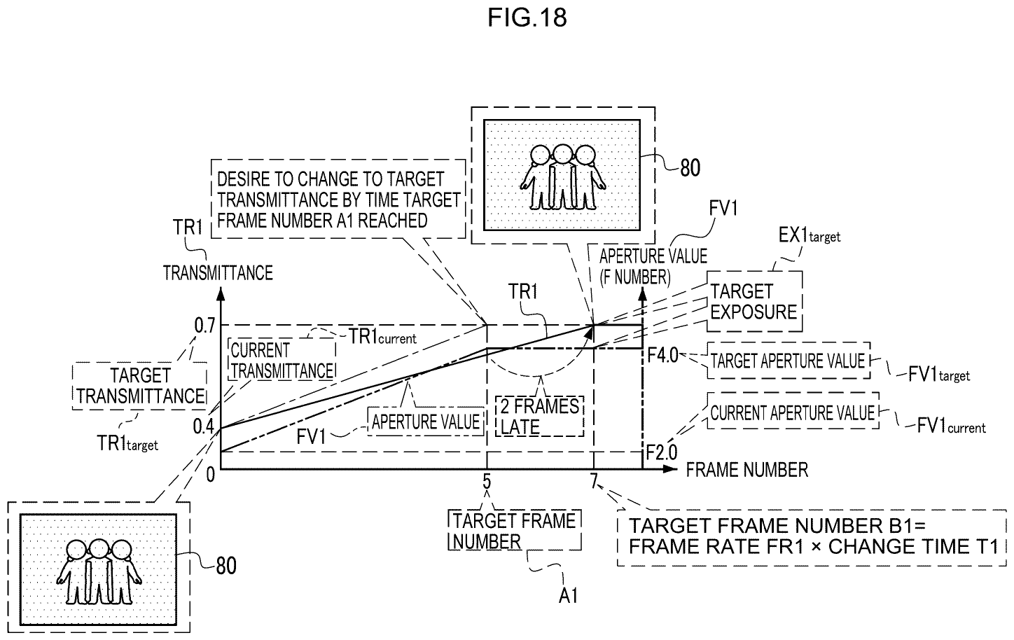

However, as illustrated in the example of FIG. 18, depending on the relationship between the current transmittance TR1_{current} and the target transmittance TR1_{target}, sometimes the needed frame number B11 exceeds the target frame number A11 and, in such cases, the transmittance TR1 of the electronic ND filter 58 does not attain the target transmittance TR1_{target} at the point in time when the target frame number A11 frame 80 is obtained. Thus in such cases in which the time needed to change the aperture value FV1 and the change time T are not aligned with each other, the target exposure EX1_{target} is no longer able to continue to be maintained constant within the target frame number A11. In the example illustrated in FIG. 18, when the transmittance TR1 of the electronic ND filter 58 attains the target transmittance TR1_{target} is late by two frames from the target frame number A11.

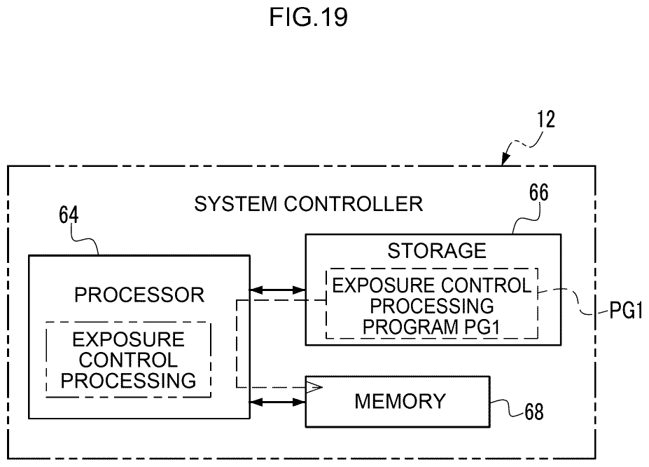

Thus in the present seventh exemplary embodiment, to make the transmittance TR1 of the electronic ND filter 58 track the changes to the aperture value FV1 within the target frame number A11, and to continue maintaining a constant brightness of the frames 80 (in other words in order to continue maintaining the target exposure EX1_{target} constant), exposure control processing is performed by a processor 64 as in the example illustrated in FIG. 19. An exposure control processing program PG1 is stored in the storage 66. The exposure control processing program PG1 is an example of a “program” according to the present disclosure. The processor 64 reads the exposure control processing program PG1 from the storage 66, and executes the exposure control processing program PG1 that has been read by execution in the memory 68. Exposure control processing is implemented by the processor 64 executing the exposure control processing program PG1. Description follows regarding an example of the exposure control processing.

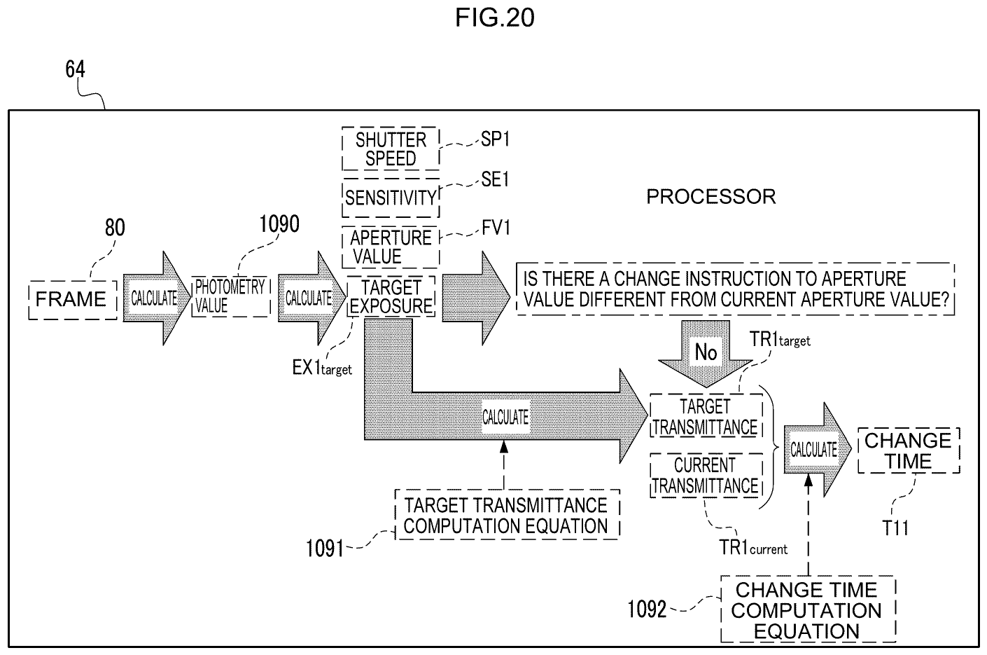

FIG. 20 to FIG. 39 are examples of content of the exposure control processing performed by the processor 64. First, as illustrated in the example of FIG. 20, when a timing to start exposure computation has arrived, the processor 64 calculates a photometry value 1090 indicating an imaging subject brightness based on the frames 80 obtained by performing live-view image imaging. Note that the photometry value 1090 may be measured using an exposure meter (omitted in the drawings).

Based on the photometry value 1090, the processor 64 calculates the target exposure EX1_{target} as an exposure such that the brightness of the frame 80 used to calculate the photometry value 1090 becomes a target brightness. The processor 64 calculates a target transmittance TR1_{target} corresponding to the target exposure EX1_{target}, namely, the target transmittance TR1_{target} capable of realizing the target exposure EX1_{target}. For example, the target transmittance TR1_{target} is calculated based on the shutter speed SP1, the aperture value FV1, and the sensitivity SE1 set on the imaging apparatus 10 at the current point in time, and the target exposure EX1_{target}. The calculation of the target transmittance TR1_{target} is performed using a target transmittance computation equation 1091. The target transmittance computation equation 1091 is a computation equation having the shutter speed SP1, the aperture value FV1, the sensitivity SE1, and the target exposure EX1_{target} as independent variables, and having the target transmittance TR1_{target} as a dependent variable.

The processor 64 determines whether or not an instruction to change to an aperture value FV1 different from the aperture value FV1 at the current point in time, namely an aperture value change instruction that is an instruction to change the aperture value FV1 from a current aperture value FV1_{current} to a target aperture value FV1_{target} (hereinafter simply referred to as an “aperture value change instruction”), has been given to the imaging apparatus 10. When an aperture value change instruction has not been given to the imaging apparatus 10, the aperture value FV1 at the current point in time, namely the current aperture value FV1_{current}, is maintained. When the current aperture value FV1_{current} is being maintained, as illustrated in the example of FIG. 20 to FIG. 24, control is performed by the processor 64 to monotonously change the exposures applied for the plural frame 80.

As illustrated in the example of FIG. 20, when the current aperture value FV1_{current} is being maintained, the processor 64 acquires the transmittance TR1 set at the current point in time for the electronic ND filter 58, namely the current transmittance TR1_{current}. The processor 64 then uses a change time computation equation 1092 to calculate a change time T11, which is a time to ideally change from the acquired current transmittance TR1_{current} to the calculated target transmittance TR1_{target}. The time to ideally change from the current transmittance TR1_{current} to the calculated target transmittance TR1_{target} means a time to monotonously change from the current transmittance TR1_{current} to the target transmittance TR1_{target}. Monotonously change means to change by a constant change amount (for example, a linear change, an exponential function change, or the like). The change time computation equation 1092 is a computation equation having the target transmittance TR1_{target} and the current transmittance TR1_{current} as independent variables, and having the change time T11 as a dependent variable. In the present seventh exemplary embodiment, the target exposure EX1_{target} is an example of a “target exposure” according to the present disclosure, the current transmittance TR1_{current} is an example of a “first transmittance” according to the present disclosure, and the target transmittance TR1_{target} is an example of a “second transmittance” according to the present disclosure.

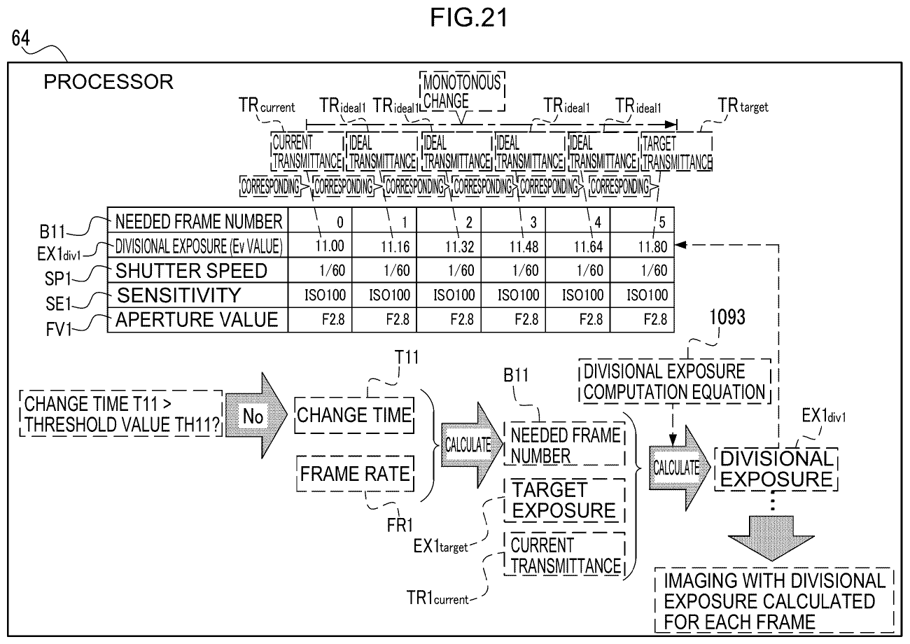

As illustrated in the example of FIG. 21, the processor 64 determines whether or not the change time T11 has exceeded the threshold value TH11. In the present seventh exemplary embodiment, the threshold value TH11 is a value determined based on an ideal wait time to change the transmittance TR1 of the electronic ND filter 58 from the current transmittance TR1_{current} to the target transmittance TR1_{target} (in other words, an ideal time as a time from when the exposure calculation start timing has arrived until the target exposure EX1_{target} is achieved under conditions in which the aperture value FV1, the shutter speed SP1, and the sensitivity SE1 are fixed). The threshold value TH11 may be a fixed value, or may be a variable value changed according to a given instruction and/or various conditions. An example of the threshold value TH11 is an upper limit value of an ideal wait time to change the transmittance TR1 of the electronic ND filter 58 from the current transmittance TR1_{current} to the target transmittance TR1_{target}. Moreover, the threshold value TH11 may be a time decided by a user, may be a time decided according to a type of the imaging mode, and may be a time specified within a range from a few percent to several tens of percent of a maximum time obtained from a table in which times to change the transmittance TR1 of the electronic ND filter 58 are determined (for example, a time equivalent to 50% of a maximum time obtained from a table in which times to change the transmittance TR1 of the electronic ND filter 58 are determined).

In cases in which the change time T11 has not exceeded the threshold value TH11 (in other words, cases in which a magnitude relationship “change time T11<threshold value TH11” is satisfied), namely cases in which the time needed to change the transmittance of the electronic ND filter 58 from the current transmittance TR1_{current} to the target exposure EX1_{target} falls within the ideal time, the processor 64 calculates a frame rate B1, which is the number of frames needed during the course of the change time T11, based on the change time T11 and the frame rate FR1 (for example, a frame rate equivalent to the above frame rate). For example, the frame rate B1 is calculated by “(change time T11)×(frame rate FR1)”.

The processor 64 acquires plural divisional exposures EX1_{div1} based on the target exposure EX1_{target} and the change time T11. Acquiring the plural divisional exposures EX1_{div1} is implemented by the plural divisional exposures EX1_{div1} being calculated based on the target exposure EX1_{target} and the frame rate B1. Calculation of the plural divisional exposures EX1_{div1} is performed using a divisional exposure computation equation 1093. The divisional exposure computation equation 1093 is a computation equation having the current transmittance TR1_{current}, the target exposure EX1_{target}, and the frame rate B1 as independent variables, and having the plural divisional exposures EX1_{div1} as dependent variables. The plural divisional exposures EX1_{div1} are divisional exposures EX1_{div1} of an individual number equivalent to the frame rate B1.

The plural divisional exposures EX1_{div1} are changed monotonously from the divisional exposure EX1_{div1} corresponding to the current transmittance TR1_{current} through to the target exposure EX1_{target}. For example, the plural divisional exposures EX1_{div1} are changed linearly from the divisional exposure EX1_{div1} corresponding to the current transmittance TR1_{current} through to the target exposure EX1_{target}. Note that although an example is given here of linear change, change may be by an exponential function, and may be monotonous change to match changes in the aperture value FV1.

The plural divisional exposures EX1_{div1} correspond to the current transmittance TR1_{current}, the plural ideal transmittances TR1_{ideal1}, and the target transmittance TR1_{target} determined for the course of ideal change from the current transmittance TR1_{current} to the target transmittance TR1_{target} (for example, for the course of changing the transmittance TR1 of the electronic ND filter 58 from the current transmittance TR1_{current} to the target transmittance TR1_{target} by a constant change amount). In the example illustrated in FIG. 21, the current transmittance TR1_{current} corresponds to the frame rate B1 of “0”, the ideal transmittances TR1_{ideal1} correspond respectively to the frame rate B1 of “1”, “2”, “3”, and “4”, and the target transmittance TR1_{target} corresponds to the frame rate B1 of “5”.

The transmittance TR1 of the electronic ND filter 58 is changed based on the current transmittance TR1_{current}, the plural ideal transmittances TR1_{ideal1}, and the target transmittance TR1_{target}. The current transmittance TR1_{current}, the plural ideal transmittances TR1_{ideal1}, and the target transmittance TR1_{target} are changed monotonously from the current transmittance TR1_{current} through to the target transmittance TR1_{target}. In the example illustrated in FIG. 21, the current transmittance TR1_{current}, the plural ideal transmittances TR1_{ideal1}, and the target transmittance TR1_{target} are changed monotonously from the frame rate B1 of “0” through to “5”.

Monotonous change of the frame 80 exposures from the divisional exposure EX1_{div1} corresponding to the current transmittance TR1_{current} through to the target exposure EX1_{target} is implemented by monotonously changing the current transmittance TR1_{current}, the plural ideal transmittances TR1_{ideal1}, and the target transmittance TR1_{target} from the current transmittance TR1_{current} through to the target transmittance TR1_{target} while the shutter speed SP1, the sensitivity SE1, and the aperture value FV1 are in a fixed state. An example in which the current transmittance TR1_{current}, the plural ideal transmittances TR1_{ideal1}, and the target transmittance TR1_{target} are changed monotonously from the current transmittance TR1_{current} through to the target transmittance TR1_{target}, is an example in which the current transmittance TR1_{current}, the plural ideal transmittances TR1_{ideal1}, and the target transmittance TR1_{target} are changed by a constant change amount between frames 80 from the current transmittance TR1_{current} through to the target transmittance TR1_{target}.

The processor 64 performs control to apply the plural divisional exposures EX1_{div1} for the exposures of the plural frames 80 obtained by performing live-view image imaging in the change time T11. For example, the processor 64 causes the imaging apparatus 10 to perform imaging after the divisional exposure EX1_{div1} corresponding to each single frame has been set on the imaging apparatus 10. The setting of the divisional exposure EX1_{div1} means, for example, setting the transmittance TR1 for the electronic ND filter 58 that enables the divisional exposure EX1_{div1} to be realized in a state in which the shutter speed SP1, the aperture value FV1, and the sensitivity SE1 are maintained. Namely, the transmittance TR1 of the electronic ND filter 58 is controlled such that live-view image imaging is performed with the divisional exposure EX1_{div1} calculated for each of the frames 80, while the shutter speed SP1, the aperture value FV1, and the sensitivity SE1 are maintained.

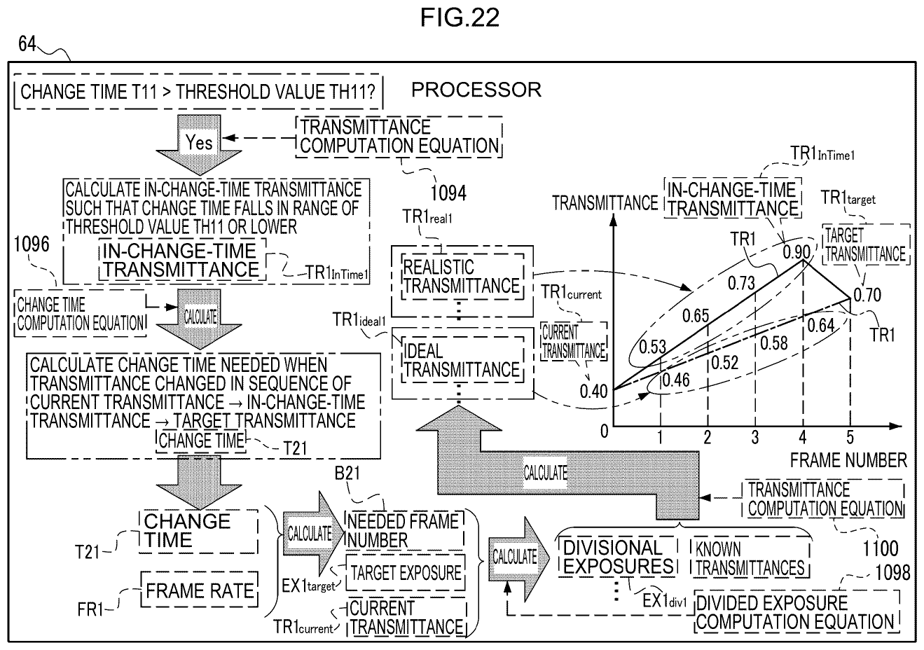

However, as illustrated in the example of FIG. 22, in cases in which the change time T11 has exceeded the threshold value TH11, namely cases in which the time needed to change the transmittance TR1 of the electronic ND filter 58 from the current transmittance TR1_{current} to the target exposure EX1_{target} does not fall within an ideal time, the processor 64 uses a transmittance computation equation 1094 to calculate an in-change-time transmittance TR1_{InTime1} as the transmittance TR1 of the electronic ND filter 58, this being a transmittance TR1 for which the change time T11 falls in the range of the threshold value TH11 or lower. The transmittance computation equation 1094 is a calculation equation having the change time T11, the threshold value TH11, the current transmittance TR1_{current}, and the target transmittance TR1_{target} as independent variables, and having the in-change-time transmittance TR1_{InTime1} as a dependent variable.

The processor 64 uses a change time computation equation 1096 to calculate a change time T21, which is a time needed to change the transmittance TR1 of the electronic ND filter 58 from the current transmittance TR1_{current} to the target transmittance TR1_{target} via the in-change-time transmittance TR1_{InTime1}. The change time computation equation 1096 is a calculation equation having the current transmittance TR1_{current}, the in-change-time transmittance TR1_{InTime1}, and the target transmittance TR1_{target} as independent variables, and having the change time T21 as a dependent variable.

The processor 64 calculates a needed frame number B21, which is a number of frames needed for the course of the change time T21, based on the change time T21 and the frame rate FR1. For example, the needed frame number B21 is calculated by “(change time T21)×(frame rate FR1)”.

The processor 64 calculates plural divisional exposures EX1_{div1} based on the needed frame number B21, the target exposure EX1_{target}, and the current transmittance TR1_{current}. The calculation of the plural divisional exposures EX1_{div1} is performed using a divisional exposure computation equation 1098.

The divisional exposure computation equation 1098 is a computation equation having the needed frame number B21, the target exposure EX1_{target}, and the current transmittance TR1_{current} as independent variables, and having the plural divisional exposures EX1_{div1} as dependent variables. The plural divisional exposures EX1_{div1} are divisional exposures EX1_{div1} of an individual number equivalent to the needed frame number B21.

The processor 64 calculates the plural ideal transmittances TR1_{ideal1} and plural realistic transmittances TR1ᵣₑₐₗ₁ based on the plural divisional exposures EX1_{div1} and known transmittances. The known transmittances referred to here mean the current transmittance TR1_{current}, the target transmittance TR1_{target}, and the in-change-time transmittance TR1_{InTime1}. The calculation of the plural ideal transmittances TR1_{ideal1} and the plural realistic transmittances TR1ᵣₑₐₗ₁ is performed using a transmittance computation equation 1100. The transmittance computation equation 1100 is a computation equation having the plural divisional exposures EX1_{div1}, the current transmittance TR1_{current}, the target transmittance TR1_{target}, and the in-change-time transmittance TR1_{InTime1} as independent variables, and having the plural ideal transmittances TR1_{ideal1} and the plural realistic transmittances TR1ᵣₑₐₗ₁ as dependent variables.

The plural realistic transmittances TR1ᵣₑₐₗ₁ are plural transmittances TR1 determined the course of realistically changing the transmittance TR1 of the electronic ND filter 58 from the current transmittance TR1_{current} to the target transmittance TR1_{target} when the change time T21 is the threshold value TH11 or lower. Reference here to realistically changing means a change of the transmittance TR1 such that the change of the transmittance TR1 of the electronic ND filter 58 from the current transmittance TR1_{current} to the target transmittance TR1_{target} is able to be achieved within the time of the threshold value TH11 or lower. In cases in which the transmittance TR1 of the electronic ND filter 58 is realistically changed, priority is given to the transmittance TR1 of the electronic ND filter 58 changing from the current transmittance TR1_{current} to the target transmittance TR1_{target} within the time of the threshold value TH11 or lower, and so the transmittance TR1 of the electronic ND filter 58 is not changed monotonously by a constant change amount.

The plural realistic transmittances TR1ᵣₑₐₗ₁ are set for the electronic ND filter 58 in cases in which the change time T11 has exceeded the threshold value TH11 and live-view image imaging is performed. This approach is adopted because were the plural ideal transmittances TR1_{ideal1} to be set for the electronic ND filter 58 irrespective of the change time T11 having exceeded the threshold value TH11 when live-view image imaging is performed, then the change from the current transmittance TR1_{current} to the target transmittance TR1_{target} would not be completed within a time of the threshold value TH11 or lower.

The example illustrated in FIG. 22 is an example of plural transmittances TR1 determined the course of realistically changing the transmittance TR1 of the electronic ND filter 58 from the current transmittance TR1_{current} to the target transmittance TR1_{target}, with the change time T21 of the threshold value TH11 or lower, namely an example of plural realistic transmittances TR1ᵣₑₐₗ₁, for plural transmittances TR1 determined the course of changing from the current transmittance TR1_{current} to the target transmittance TR1_{target} via the in-change-time transmittance TR1_{InTime1} with the change time T21 of the threshold value TH11 or lower. In the example illustrated in FIG. 22, the in-change-time transmittance TR1_{InTime1} is determined such that the change time T21 between the current transmittance TR1_{current} and the target transmittance TR1_{target} is the threshold value TH11 or lower. Plural realistic transmittances TR1ᵣₑₐₗ₁ are determined based on the current transmittance TR1_{current} and the in-change-time transmittance TR1_{InTime1}. Namely, in the example illustrated in FIG. 22, the plural transmittances TR1 to change monotonously from the current transmittance TR1_{current} through to the in-change-time transmittance TR1_{InTime1} (for example, plural transmittances TR1 to change linearly) are determined as the plural realistic transmittances TR1ᵣₑₐₗ₁ containing the in-change-time transmittance TR1_{InTime1}.

The current transmittance TR1_{current} and the plural realistic transmittances TR1ᵣₑₐₗ₁ are changed monotonously from the current transmittance TR1_{current} through to the in-change-time transmittance TR_{InTime1}. In the example illustrated in FIG. 22, the current transmittance TR1_{current} and the plural realistic transmittances TR1ᵣₑₐₗ₁ are changed linearly from the current transmittance TR1_{current} through to the in-change-time transmittance TR_{InTime1}.

The processor 64 changes the transmittance TR1 of the electronic ND filter 58 according to the current transmittance TR1_{current}, the plural realistic transmittances TR1ᵣₑₐₗ₁, and the target transmittance TR1_{target}. However, were the transmittance TR1 of the electronic ND filter 58 to be changed according to the current transmittance TR1_{current}, the plural realistic transmittances TR1ᵣₑₐₗ₁, and the target transmittance TR1_{target} while the shutter speed SP1, the aperture value FV1, and the sensitivity SE1 are maintained as they are, then the change in brightness between frames 80 would be larger than cases in which the transmittance TR1 of the electronic ND filter 58 is changed according to the current transmittance TR1_{current}, the plural ideal transmittances TR1_{ideal1}, and the target transmittance TR1_{target} while the shutter speed SP1, the aperture value FV1, and the sensitivity SE1 are maintained as they are.

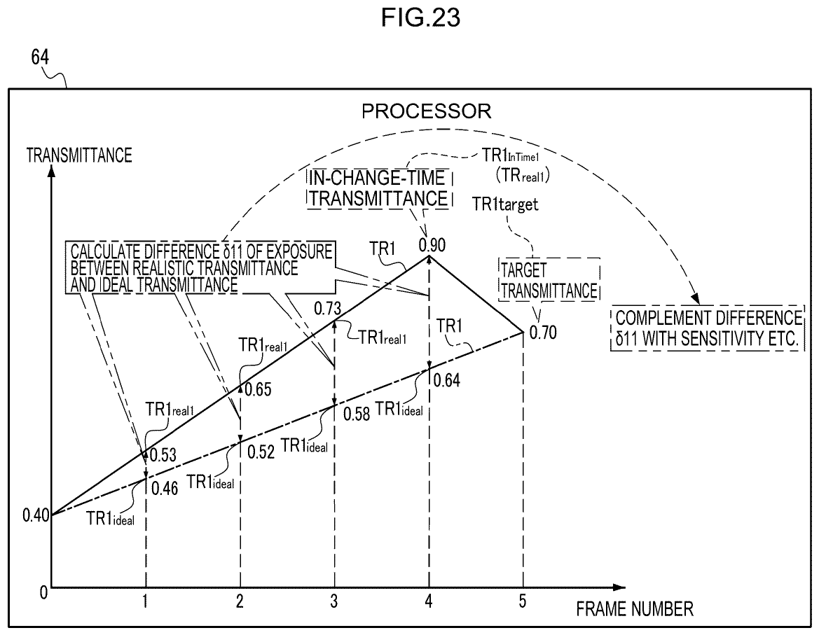

Thus in the present seventh exemplary embodiment a configuration is adopted such that the brightness between frames 80 is changed at the same level to cases in which the transmittance TR1 of the electronic ND filter 58 is changed according to the current transmittance TR1_{current}, the plural ideal transmittances TR1_{ideal1}, and the target transmittance TR1_{target} while the shutter speed SP1, the aperture value FV1, and the sensitivity SE1 are maintained as they are, even though the transmittance TR1 of the electronic ND filter 58 is changed according to the current transmittance TR1_{current}, the plural realistic transmittances TR1ᵣₑₐₗ₁, and the target transmittance TR1_{target}. In this configuration, first as illustrated in the example in FIG. 23, the processor 64 calculates differences 611 of exposure between the plural realistic transmittances TR1ᵣₑₐₗ₁ and the plural ideal transmittances TR1_{ideal1} by unit of the frames 80 obtained in the needed frame number B21. The difference δ11 is an indicator indicating a magnitude of change in brightness between frames 80. In other words, the difference δ11 is an expression of a degree of divergence from the ideal brightness of the frames 80 (namely, an extent to which exposures realized by the realistic transmittances TR1ᵣₑₐₗ₁ diverge from the exposures realized by the ideal transmittances TR1_{ideal1}).

The exposure is also defined by the shutter speed SP1, the aperture value FV1, and the sensitivity SE1, in addition to by the transmittance TR1 of the electronic ND filter 58, and so the difference δ11 can be made zero by adjusting the shutter speed SP1, the aperture value FV1, and/or the sensitivity SE1. The processor 64 accordingly adjusts the plural divisional exposures EX1_{div1} corresponding to the current transmittance TR1_{current}, the plural realistic transmittances TR1ᵣₑₐₗ₁, and the target transmittance TR1_{target} (namely, each of the divisional exposures EX1_{div1} during the course of changing from the current transmittance TR1_{current} to the target transmittance TR1_{target}) based on the difference δ11. In other words, by complementing the difference δ11 with the shutter speed SP1, the aperture value FV1, and/or the sensitivity SE1, the processor 64 performs adjustment to match the plural divisional exposures EX1_{div1} corresponding to the current transmittance TR1_{current}, the plural realistic transmittances TR1ᵣₑₐₗ₁, and the target transmittance TR1_{target}, to the plural divisional exposures EX1_{div1} corresponding to the current transmittance TR1_{current}, the plural ideal transmittances TR1_{ideal1}, and the target transmittance TR1_{target}. To express this in yet another way, for each of the frames 80 contained in the needed frame number B21, the shutter speed SP1, the aperture value FV1, and/or the sensitivity SE1 are adjusted using adjustment values corresponding to the difference δ11 (for example, adjustment values determined according to the difference δ11) such that the divisional exposures EX1_{div1} realized by the realistic transmittances TR1ᵣₑₐₗ₁ become the divisional exposures EX1_{div1} realized by the ideal transmittances TR1_{ideal1}.

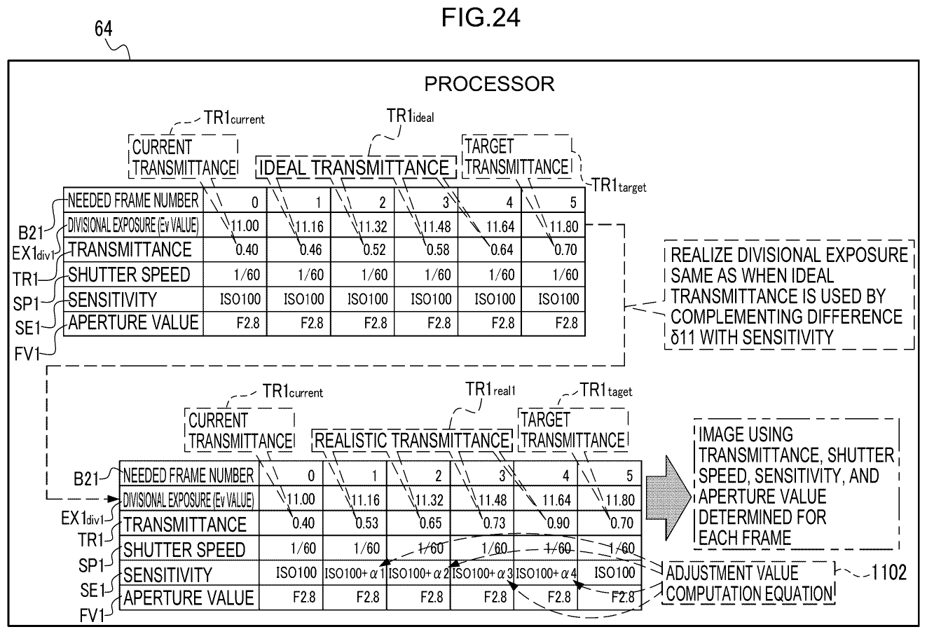

When live-view image imaging is performed using the plural realistic transmittances TR1ᵣₑₐₗ₁ as the transmittance TR1 of the electronic ND filter 58, for example as illustrated in FIG. 24, the difference δ11 is complemented by adjusting the sensitivity SE1 with adjustment values for adjusting the sensitivity SE1 of a1 to a4.

Due to the sensitivity SE1 being adjusted with the adjustment values α1 to α4 according to the difference δ11 in this manner, even though the transmittance TR1 of the electronic ND filter 58 is changed according to the current transmittance TR1_{current}, the plural realistic transmittances TR1ᵣₑₐₗ₁, and the target transmittance TR1_{target}, the divisional exposures EX1_{div1} are realized at the same level to cases in which the plural realistic transmittances TR1ᵣₑₐₗ₁ are employed as the transmittance TR1 of the electronic ND filter 58, while the shutter speed SP1, the aperture value FV1, and the sensitivity SE1 are maintained as they are.

The respective adjustment values α1 to α4 are determined uniquely according to the difference δ11 calculated by frame 80 unit. For example, the adjustment values α1 to α4 are calculated by using an adjustment value computation equation 1102 in which the difference δ11 is an independent variable and adjustment values to adjust the sensitivity SE1 are dependent variables. Note that although an example is given here of an embodiment for adjusting the sensitivity SE1 according to the difference δ11, this is merely an example thereof, and a configuration may be adopted in which the shutter speed SP1 and/or the aperture value FV1 is adjusted according to the difference δ11. The adjustment values of the shutter speed SP1 and/or the aperture value FV1 may be calculated by employing a computation equation similar to that of the adjustment value computation equation 1102 in such cases.

In cases in which the live-view image imaging is performed in the change time T21, the processor 64 sets the imaging apparatus 10 with the sensitivity SE1 adjusted according to the difference δ11 calculated by frame 80 unit as described above, the shutter speed SP1 determined for each of the frames 80, and the aperture value FV1 determined for each of the frames 80. The processor 64 also sets the current transmittance TR1_{current}, the plural realistic transmittances TR1ᵣₑₐₗ₁, and the target transmittance TR1_{target} as the transmittances TR1 of the electronic ND filter 58. In live-view image imaging in the change time T21, the plural divisional exposures EX1_{div1} to change monotonously are accordingly applied for the exposures of the plural frames 80 by setting the sensitivity SE1 adjusted according to the difference δ11 calculated by frame 80 unit, the shutter speed SP1 determined for each of the frames 80, the aperture value FV1 determined for each of the frames 80, the current transmittance TR1_{current}, the plural realistic transmittances TR1ᵣₑₐₗ₁, and the target transmittance TR1_{target} in this manner.

Note that in the present seventh exemplary embodiment, the live-view image imaging is an example of “imaging with the imaging apparatus” according to the present disclosure. Moreover, in the present seventh exemplary embodiment, the frame rate FR1 is an example of a “preset frame rate” according to the present disclosure.

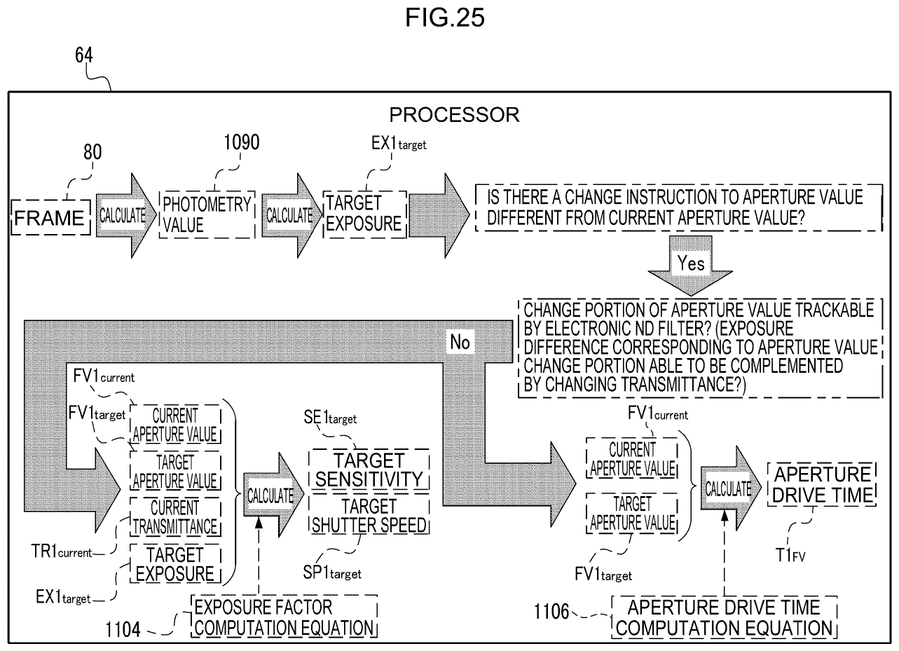

In the example illustrated in FIG. 20 to FIG. 24, an example is illustrated of an embodiment in which control to monotonously change the exposures applied for the plural frames 80 is performed by the processor 64 when the current aperture value FV1_{current} is maintained. However, in cases in which the current aperture value FV1_{current} is changed to the target aperture value FV1_{target}, control is performed by the processor 64 to hold the exposures applied to the plural frames 80 constant, as illustrated in FIG. 25 to FIG. 39.

As illustrated in the example of FIG. 25, the processor 64 determines whether or not an aperture value change instruction has been given to the imaging apparatus 10. When an aperture value change instruction has been given to the imaging apparatus 10, control is started by the processor 64 to change the aperture value FV1 of the aperture 40C from the current aperture value FV1_{current} to the target aperture value FV1_{target}.

As illustrated in the example of illustrated in FIG. 25, in cases in which the aperture value FV1 of the aperture 40C is changed from the current aperture value FV1_{current} to the target aperture value FV1_{target}, the processor 64 determines whether or not a change portion of the aperture value FV1 (as an example, a change amount from the current aperture value FV1_{current} to the target aperture value FV1_{target}) is trackable with the electronic ND filter 58. Namely, determination is made as to whether or the transmittance TR1 of the electronic ND filter 58 can be made transmittances TR1 capable of complementing brightness as it changes accompanying changes of the aperture value FV1 (in other words, whether or not an exposure difference corresponding to the change portion of the aperture value FV1 is able to be complemented by changing the transmittance TR1 of the electronic ND filter 58). In the present seventh exemplary embodiment, the transmittance TR1 of the electronic ND filter 58 is an example of a “transmittance of an electronic dimmer filter” according to the present disclosure.

FIG. 25 to FIG. 27 illustrate an example of control content to change the aperture value FV1 of the aperture 40C from the current aperture value FV1_{current} to the target aperture value FV1_{target} in cases in which the change portion of the aperture value FV1 is not trackable with the electronic ND filter 58.

As illustrated in the example of FIG. 25, in cases in which the change portion of the aperture value FV1 is not trackable with the electronic ND filter 58, the processor 64 calculates a target sensitivity SE1_{target} and a target shutter speed SP1_{target} based on the current aperture value FV1_{current}, the target aperture value FV1_{target}, the current transmittance TR1_{current}, and the target exposure EX1_{target}. The target sensitivity SE1_{target} means a sensitivity SE1 that is able to realize the target exposure EX1_{target} together with other exposure factors (examples thereof being the current aperture value FV1_{current}, the target aperture value FV1_{target}, the current transmittance TR1_{current}, and the target shutter speed SP1_{target}). The target shutter speed SP1_{target} means a shutter speed SP1 that is able to realize the target exposure EX1_{target} together with other exposure factors (examples thereof being the current aperture value FV1_{current}, the target aperture value FV1_{target}, the current transmittance TR1_{current}, and the target sensitivity SE1_{target}).

The calculation of the target sensitivity SE1_{target} and the target shutter speed SP1_{target} is performed using an exposure factor computation equation 1104. The exposure factor computation equation 1104 is a computation equation having the current aperture value FV1_{current}, the target aperture value FV1_{target}, the current transmittance TR1_{current}, and the target exposure EX1_{target} as independent variables, and having the target sensitivity SE1_{target} and the target shutter speed SP1_{target} as dependent variables. Note that in the present seventh exemplary embodiment, exposure factor means one factor defining the exposure. The exposure is defined by plural exposure factors, and examples of the plural exposure factors include the transmittance TR1, the aperture value FV1, the sensitivity SE1, and the shutter speed SP1.

In cases in which the aperture value FV1 of the aperture 40C is changed from the current aperture value FV1_{current} to the target aperture value FV1_{target}, the processor 64 calculates a drive time of the aperture 40C, namely an aperture drive time T1_{FV}, based on the current aperture value FV1_{current} and the target aperture value FV1_{target}. The aperture drive time T1_{FV} is a time needed to change the aperture value FV1 of the aperture 40C from the current aperture value FV1_{current} to the target aperture value FV1_{target}. The calculation of the aperture drive time T1_{FV} is performed using an aperture drive time computation equation 1106. The aperture drive time computation equation 1106 is a computation equation having the current aperture value FV1_{current} and the target aperture value FV1_{target} as independent variables, and having the aperture drive time T1_{FV} as a dependent variable. Note that in the present seventh exemplary embodiment, the aperture drive time T1_{FV} is an example of an “aperture drive time” according to the present disclosure.

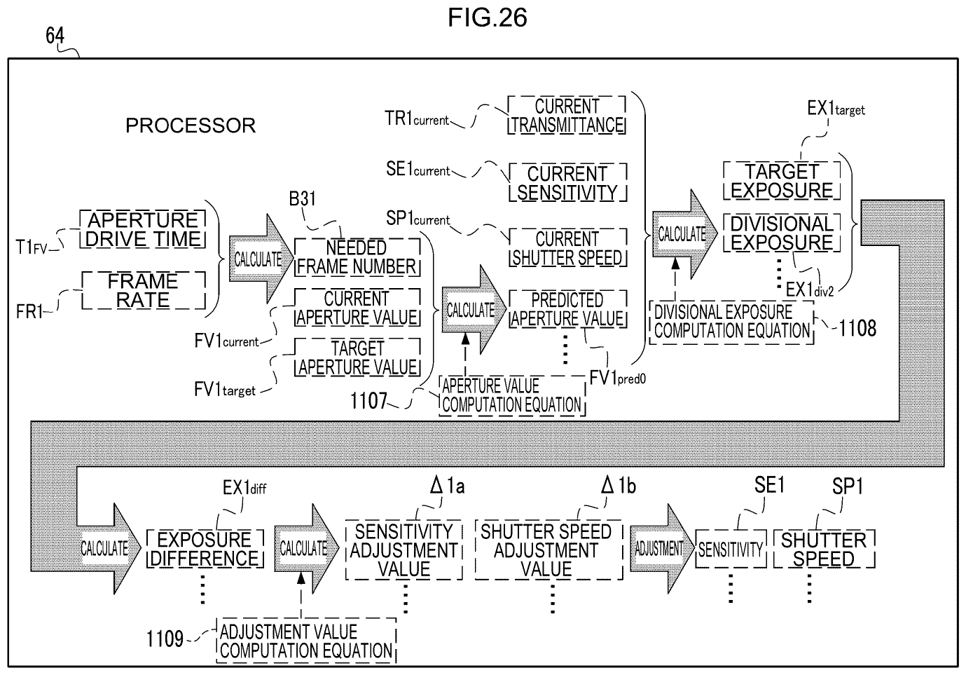

As illustrated in the example of FIG. 26, based on the aperture drive time T1_{FV} and the frame rate FR1, the processor 64 calculates the number of frames corresponding to the aperture drive time T1_{FV}, namely a needed frame number B31, which is a number of frames obtained by live-view image imaging during the course of the aperture drive time T1_{FV}. For example, the needed frame number B31 is calculated by “(aperture drive time T1_{FV})×(frame rate FR1)”. Note that in the present seventh exemplary embodiment, the needed frame number B31 is an example of a “second frame number”, a “fourth frame number”, and a “sixth frame number” according to the present disclosure.

The processor 64 calculates plural predicted aperture values FV1_{pred0} based on the needed frame number B31, the current aperture value FV1_{current}, and the target aperture value FV1_{target}. The respective plural predicted aperture values FV1_{pred0} are each a value predicted for the aperture value FV1 employed for the respective frames 80 obtained from the current aperture value FV1_{current} to the target aperture value FV1_{target}. The current aperture value FV1_{current} and the target aperture value FV1_{target} are included in the plural predicted aperture values FV1_{pred0}. Calculation of the plural predicted aperture values FV1_{pred0} is performed using an aperture value computation equation 1107. The aperture value computation equation 1107 is a computation equation having the needed frame number B31, the current aperture value FV1_{current}, and the target aperture value FV1_{target} as independent variables, and having the plural predicted aperture values FV1_{pred0} as dependent variables.

The processor 64 calculates plural divisional exposures EX1_{div2} based on the current transmittance TR1_{current}, a current sensitivity SE1_{current}, a current shutter speed SP1_{current}, and the plural predicted aperture values FV1_{pred0}. The current sensitivity SE1_{current} is the sensitivity SE1 set on the imaging apparatus 10 at the current point in time. The current shutter speed SP1_{current} is the shutter speed SP1 set on the imaging apparatus 10 at the current point in time. The individual number of the plural divisional exposures EX1_{div2} is the same as the individual number of the plural predicted aperture values FV1_{pred0}. The plural divisional exposures EX1_{div2} are each an exposure applied to respective plural frames 80 obtained during the course of the aperture drive time T1_{FV}, and are exposures predicted from the current transmittance TR1_{current}, the current sensitivity SE1_{current}, the current shutter speed SP1_{current}, and the plural predicted aperture values FV1_{pred0}. The calculation of the plural divisional exposures EX1_{div2} is performed using a divisional exposure computation equation 1108. The divisional exposure computation equation 1108 is a computation equation having the current transmittance TR1_{current}, the current sensitivity SE1_{current}, the current shutter speed SP1_{current}, and the plural predicted aperture values FV1_{pred0} as independent variables, and having the plural divisional exposures EX1_{div2} as dependent variables.

The processor 64 calculates plural exposure differences EX1_{diff} based on the target exposure EX1_{target} and the plural divisional exposures EX1_{div2}. The plural exposure differences EX1_{diff} are each a difference between the target exposure EX1_{target} and the respective plural divisional exposures EX1_{div2}. Although an example is given here of a difference, any indicator indicating the disparity between the target exposure EX1_{target} and the divisional exposures EX1_{div2} may be employed, and a proportion may be employed therefor.

The processor 64 calculates plural sensitivity adjustment values Δ1a and shutter speed adjustment values Δ1b based on the plural exposure differences EX1_{diff}. The number of individual plural sensitivity adjustment values Δ1a is the same as the plural exposure differences EX1_{diff}. The number of individual plural shutter speed adjustment values Δ1b is also the same as the plural exposure differences EX1_{diff}. The plural sensitivity adjustment values Δ1a are adjustment values employed for adjusting the current sensitivity SE1_{current} to obtain sensitivities SE1 needed to hold a constant brightness for the plural frames 80 obtained during the course of the aperture drive time T1_{FV}. Moreover, the shutter speed adjustment values Δ1b are adjustment values employed for adjusting the current shutter speed SP1_{current} to obtain a shutter speed SP1 needed to hold a constant brightness for the plural frames 80 obtained during the course of the aperture drive time T1_{FV} constant. The calculation of the plural sensitivity adjustment values Δ1a and the shutter speed adjustment values Δ1b is performed using an adjustment value computation equation 1109. The adjustment value computation equation 1109 is a computation equation having the plural exposure differences EX1_{diff} as independent variables, and having the plural sensitivity adjustment values Δ1a and the plural shutter speed adjustment values Δ1b as dependent variables.

The processor 64 adjusts the current sensitivity SE1_{current} using the plural sensitivity adjustment values Δ1a. The same individual number of already adjusted sensitivities SE1 are accordingly obtained to the plural sensitivity adjustment values Δ1a. The processor 64 adjusts the current sensitivity SE1_{current} using the plural shutter speed adjustment values Δ1b. The same individual number of already adjusted shutter speed SP1 are accordingly obtained to the plural shutter speed adjustment values Δ1b.

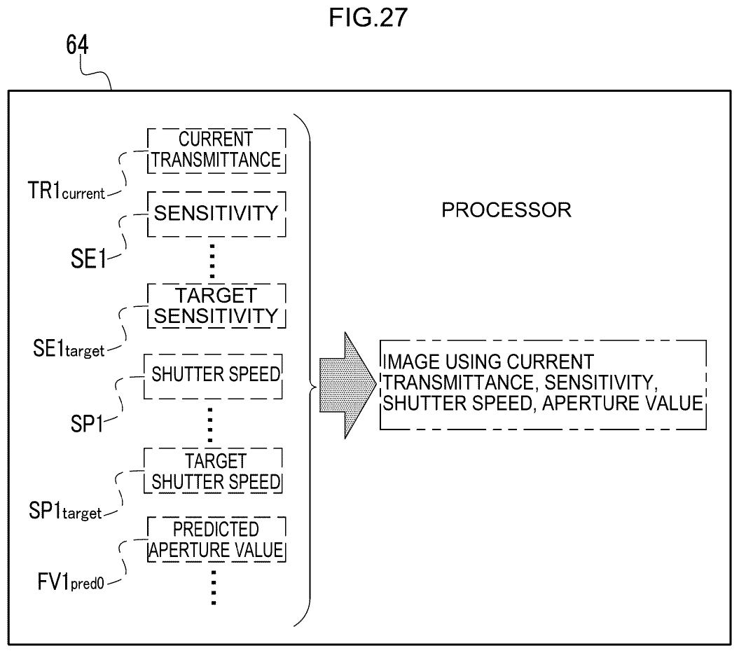

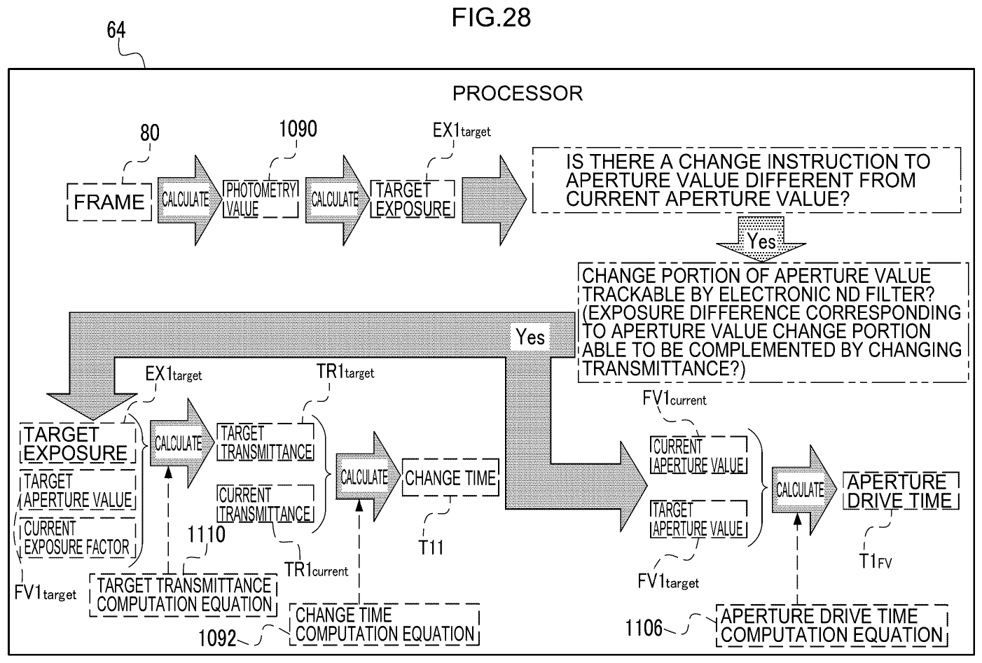

The exposures of the plural frames 80 obtained by performing the live-view image imaging when the live-view image imaging is performed in the aperture drive time T1_{FV} are determined by the plural sensitivities SE1 already adjusted with the plural sensitivity adjustment values Δ1a obtained based on the current transmittance TR1_{current} and the aperture drive time T1_{FV}, by the target sensitivity SE1_{target}, by the plural shutter speeds SP1 already adjusted with the plural shutter speed adjustment values Δ1b, by the target shutter speed SP1_{target}, by the plural predicted aperture values FV1_{pred0}, and by the current transmittance TR1_{current}. For example, as illustrated in the example of FIG. 27, the processor 64 causes the imaging apparatus 10 to perform live-view image imaging, in the aperture drive time T1_{FV}, with the exposures that employed the current transmittance TR1_{current}, the plural sensitivities SE1 already adjusted with the plural sensitivity adjustment values Δ1a, the target sensitivity SE1_{target}, the plural shutter speeds SP1 already adjusted with the plural shutter speed adjustment values Δ1b, the target shutter speed SP1_{target}, and the plural predicted aperture values FV1_{pred0}. The exposures of the plural frames 80 obtained by performing the live-view image imaging in the aperture drive time T1_{FV} are accordingly held constant.

Whereas the example illustrated in FIG. 25 to FIG. 27 is an example of control content for changing the aperture value FV1 of the aperture 40C from the current aperture value FV1_{current} to the target aperture value FV1_{target} for cases in which the change portion of the aperture value FV1 is not trackable with the electronic ND filter 58, FIG. 28 to FIG. 39 illustrate an example of control content for changing the aperture value FV1 of the aperture 40C from the current aperture value FV1_{current} to the target aperture value FV1_{target} for cases in which the change portion of the aperture value FV1 is trackable with the electronic ND filter 58. In the control to change the aperture value FV1 of the aperture 40C from the current aperture value FV1_{current} to the target aperture value FV1_{target} for cases in which the change portion of the aperture value FV1 is trackable with the electronic ND filter 58, the exposure of the plural frames 80 obtained by performing the live-view image imaging is controlled based on the transmittances TR1 and the aperture drive time T1_{FV}.

As in the example illustrated in FIG. 28, in cases in which the change portion of the aperture value FV1 is trackable with the electronic ND filter 58, the processor 64 calculates the aperture drive time T1_{FV} based on the current aperture value FV1_{current} and the target aperture value FV1_{target}. The calculation of the aperture drive time T1_{FV} is performed in a similar manner to in the example illustrated in FIG. 25.

Moreover, in cases in which the change portion of the aperture value FV1 is trackable with the electronic ND filter 58, the processor 64 calculates the target transmittance TR1_{target} corresponding to the target exposure EX1_{target} based on the target exposure EX1_{target}, the target aperture value FV1_{target}, and plural current exposure factors. The current exposure factors referred to here mean exposure factors defining the current exposure. The plural current exposure factors employed here are the current transmittance TR1_{current}, the current aperture value FV1_{current}, the current sensitivity SE1_{current}, and the current shutter speed SP1_{current}. The calculation of the target transmittance TR1_{target} is performed using a target transmittance computation equation 1110. The target transmittance computation equation 1110 is a computation equation having the target exposure EX1_{target}, the target aperture value FV1_{target}, and the plural current exposure factors as independent variables, and having the target transmittance TR1_{target} as a dependent variable.

The processor 64 calculates the change time T11 based on the target transmittance TR1_{target} and the current transmittance TR1_{current}. The calculation of the change time T11 is performed in a similar manner to in the example illustrated in FIG. 20.

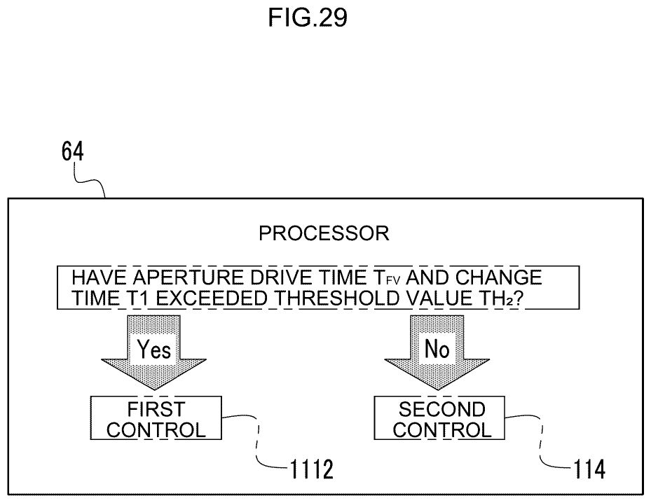

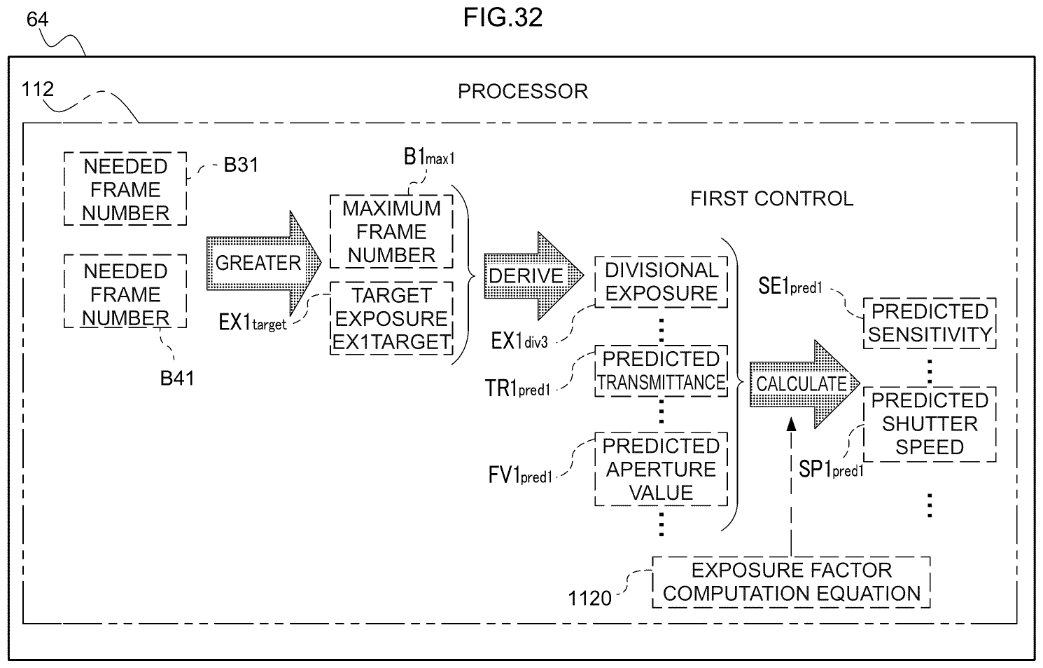

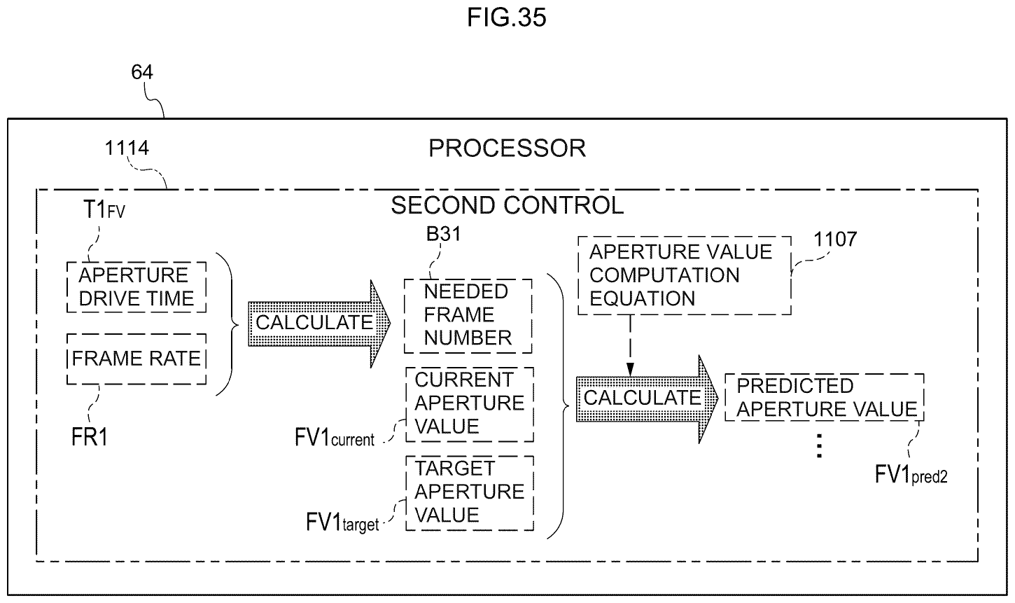

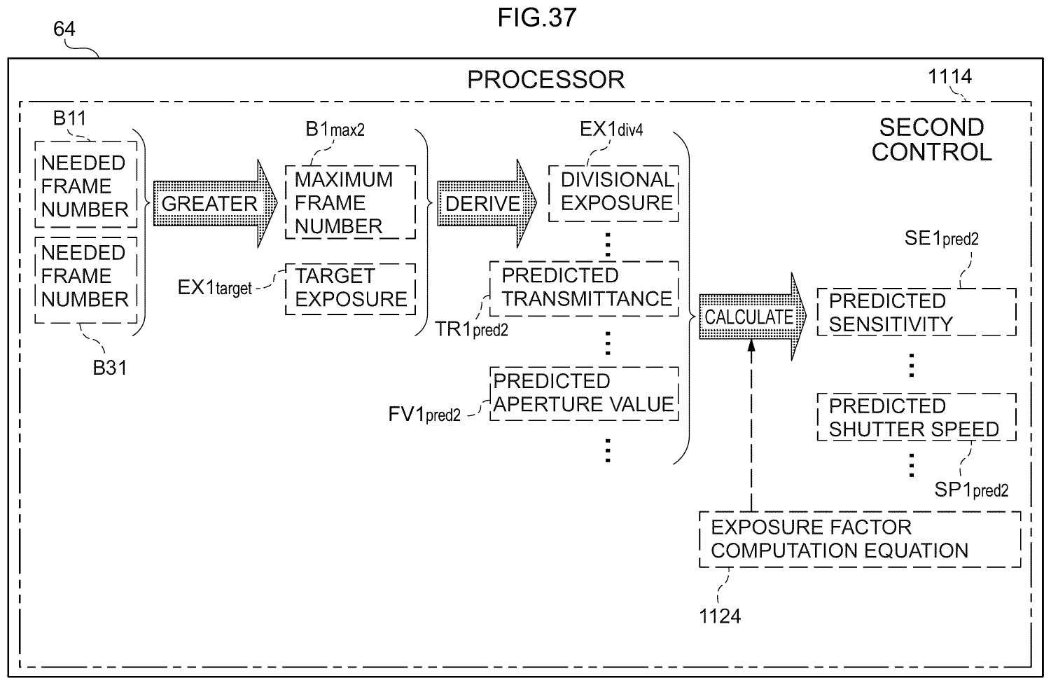

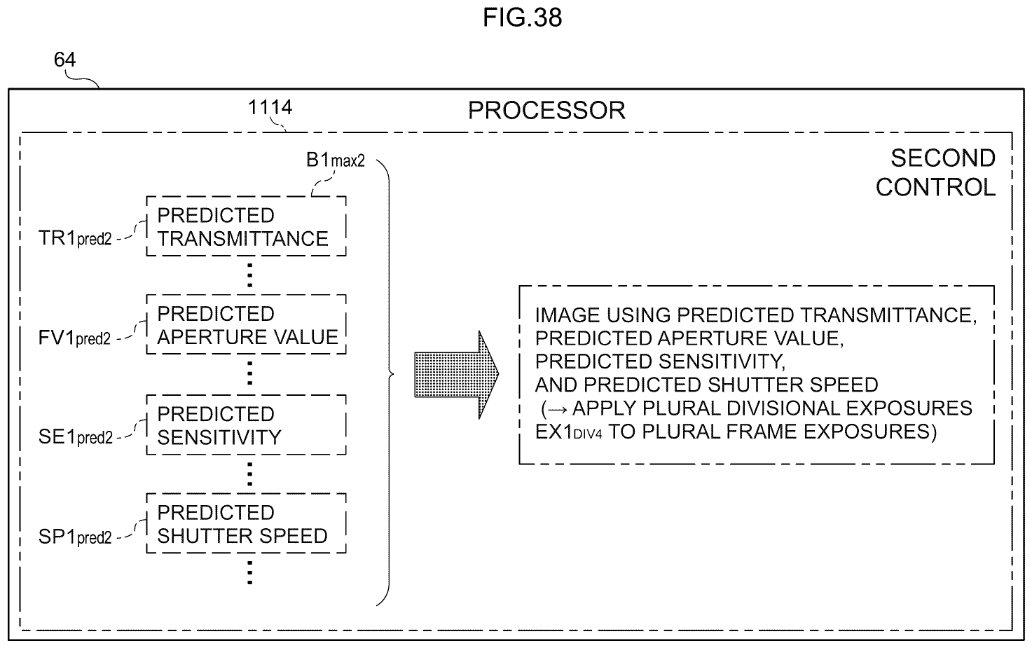

In the present seventh exemplary embodiment, in cases in which the change portion of the aperture value FV1 is trackable with the electronic ND filter 58, plural divisional exposures EX1_{div3} (see FIG. 32) determined according to the aperture drive time T1_{FV} illustrated in FIG. 28 and the change time T11 illustrated in FIG. 28, or plural divisional exposures EX1_{div4} (see FIG. 37), are applied for the exposures of the plural frames 80 obtained by performing live-view image imaging during the course of the aperture drive time T1_{FV}, such that the exposures of the plural frames 80 are controlled. An example of control content to implement this is illustrated in FIG. 29 to FIG. 39. FIG. 29 to FIG. 34 illustrate an example of an embodiment in which the exposures of the plural frames 80 are controlled by the plural divisional exposures EX1_{div3} (see FIG. 32) being applied for the exposures of the plural frames 80 obtained by performing live-view image imaging during the course of the aperture drive time T1_{FV}. FIG. 35 to FIG. 39 illustrate an example of an embodiment in which the exposures of the plural frames 80 are controlled by the plural divisional exposures EX1_{div4} (see FIG. 38) being applied for the exposures of the plural frames 80 obtained by performing live-view image imaging during the course of the aperture drive time T1_{FV}.

As illustrated in the example of FIG. 29, the processor 64 determines whether or not the aperture drive time T1_{FV} and the change time T11 have both exceeded the threshold value TH21. The threshold value TH21 is an ideal wait time to change the transmittance TR1 of the electronic ND filter 58 from the current transmittance TR1_{current} to the target transmittance TR1_{target} (in other words, an ideal time as a time to achieve the target exposure EX1_{target} from the exposure calculation start timing under conditions of the shutter speeds SP1 and the sensitivity SE1 being fixed), and is a value determined based on an ideal wait time to change the aperture value FV1 from the current aperture value FV1_{current} to the target aperture value FV1_{target}. An example of a value that is the ideal wait time for changing the transmittance TR1 of the electronic ND filter 58 from the current transmittance TR1_{current} to the target transmittance TR1_{target} and that is a value determined based on the ideal wait time to change the aperture value FV1 from the current aperture value FV1_{current} to the target aperture value FV1_{target} is an upper limit value that is the greater from out of the upper limit value of an ideal wait time to change the transmittance TR1 of the electronic ND filter 58 from the current transmittance TR1_{current} to the target transmittance TR1_{target}, or an upper limit value of the ideal wait time to change from the current aperture value FV1_{current} to the target aperture value FV1_{target}. The threshold value TH21 may be a fixed value, or may be a variable value changed according to a given instruction and/or various conditions. The threshold value TH21 may be a time decided by a user, may be a time decided according to a type of the imaging mode, and may be a time specified within a range from a few percent to several tens of percent of a maximum time obtained from a table in which times to change the transmittance TR1 of the electronic ND filter 58 are determined (for example, a time equivalent to 50% of a maximum time obtained from a table in which times to change the transmittance TR1 of the electronic ND filter 58 are determined).

The processor 64 performs a first control 1112 in cases in which the aperture drive time T1_{FV} and the change time T11 have both exceeded the threshold value TH21, and the processor 64 performs a second control 1114 in cases in which the aperture drive time T1_{FV} and/or the change time T11 is the threshold value TH21 or lower. Note that in the present seventh exemplary embodiment, the threshold value TH21 is an example of a “first threshold value”, a “third threshold value”, a “fifth threshold value”, and a “seventh threshold value” according to the present disclosure. Moreover, in the present seventh exemplary embodiment, the first control 1112 is an example of a “first control” according to the present disclosure, and the second control 1114 is an example of a “second control” according to the present disclosure.

FIG. 29 to FIG. 34 illustrate an example of content of the first control 1112. The first control 1112 is control to make the time needed to change from the current transmittance TR1_{current} to the target transmittance TR1_{target} be within the aperture drive time T1_{FV}, and includes control to apply the plural divisional exposures EX1_{div3} (see FIG. 32) determined based on a time to realistically change from the current transmittance TR1_{current} to the target transmittance TR1_{target} and on the aperture drive time T1_{FV}, as the exposures for the plural frames 80 obtained by performing live-view image imaging.

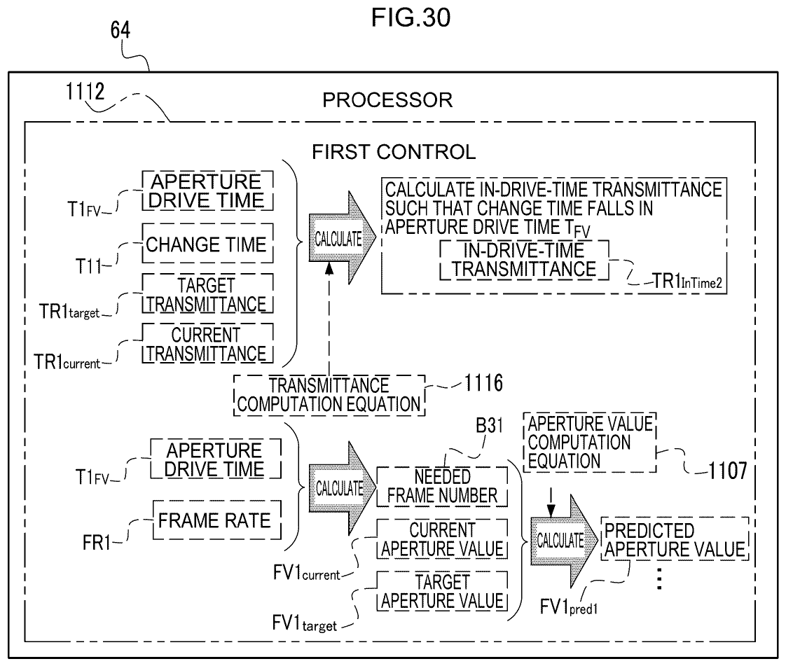

In order to implement the first control 1112, as illustrated in the example of FIG. 30, the processor 64 calculates an in-drive-time transmittance TR1_{InTime2} based on the aperture drive time T1_{FV} (see FIG. 28), the change time T11 (see FIG. 28), the current transmittance TR1_{current}, and the target transmittance TR1_{target}. The in-drive-time transmittance TR1_{InTime2} lies between the current transmittance TR1_{current} and the target transmittance TR1_{target}, and is a transmittance to make a time needed to change the transmittance TR1 of the electronic ND filter 58 from the current transmittance TR1_{current} to the target transmittance TR1_{target} be within the aperture drive time T1_{FV}. The time needed to change the transmittance TR1 of the electronic ND filter 58 from the current transmittance TR1_{current} to the target transmittance TR1_{target} is a time so as to fall within the in-drive-time transmittance TR1_{InTime2} by changing the transmittance of the electronic ND filter 58 from the current transmittance TR1_{current} to the target transmittance TR1_{target} via the in-drive-time transmittance TR1_{InTime2}.

The calculation of the in-drive-time transmittance TR1_{InTime2} is performed using a transmittance computation equation 1116. The transmittance computation equation 1116 is a computation equation having the aperture drive time T1_{FV}, the change time T11, the current transmittance TR1_{current}, and the target transmittance TR1_{target} as independent variables, and having the in-drive-time transmittance TR1_{InTime2} as a dependent variable. Note that in the present seventh exemplary embodiment, the in-drive-time transmittance TR1_{InTime2} is an example of a “third transmittance” and a “fourth transmittance” according to the present disclosure.

The processor 64 calculates a needed frame number B31 based on the aperture drive time T1_{FV} and the frame rate FR1. The calculation of the needed frame number B31 is calculated in a similar manner to in the example illustrated in FIG. 26.

The processor 64 calculates plural predicted aperture values FV1_{pred1} based on the needed frame number B31, the current aperture value FV1_{current}, and the target aperture value FV1_{target}. The plural predicted aperture values FV1_{pred1} are aperture values similar to the plural predicted aperture values FV1_{pred0} illustrated in FIG. 26, and are calculated in a similar manner to in the example illustrated in FIG. 26.

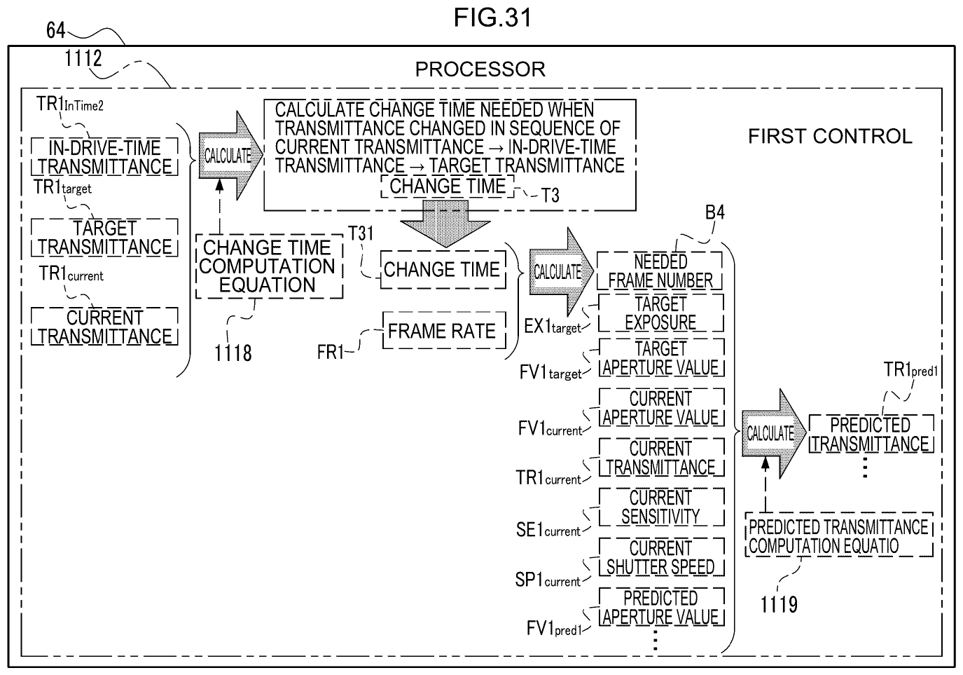

As illustrated in the example of FIG. 31, based on the in-drive-time transmittance TR1_{InTime2}, the current transmittance TR1_{current}, and the target transmittance TR1_{target}, the processor 64 calculates a change time T31, which is a time to realistically change the transmittance TR1 of the electronic ND filter 58 from the current transmittance TR1_{current} to the target transmittance TR1_{target} in the aperture drive time T1_{FV}. In other words, the change time T31 may be referred to as a time needed to change the transmittance TR1 of the electronic ND filter 58 from the current transmittance TR1_{current} to the target transmittance TR1_{target} via the in-drive-time transmittance TR1_{InTime2}. The calculation of the change time T31 is performed using a change time computation equation 1118. The change time computation equation 1118 is a computation equation having the in-drive-time transmittance TR1_{InTime2}, the current transmittance TR1_{current}, and the target transmittance TR1_{target} as independent variables, and having the change time T31 as a dependent variable. Note that in the present seventh exemplary embodiment, the change time T31 is an example of a “realistic change time” according to the present disclosure.

Based on the change time T31 and the frame rate FR1, the processor 64 calculates a needed frame number B41, which is a number of frames corresponding to the change time T31, namely a number of frames needed for the course of the change time T31. For example, the needed frame number B41 is calculated by “(change time T31)×(frame rate FR1)”. Note that in the present seventh exemplary embodiment, the needed frame number B41 is an example of a “first frame number” according to the present disclosure.

The processor 64 calculates plural predicted transmittances TR1_{pred1} based on the needed frame number B41, the target exposure EX1_{target}, the target aperture value FV1_{target}, the current aperture value FV1_{current}, the current transmittance TR1_{current}, the current sensitivity SE1_{current}, the current shutter speed SP1_{current}, and the plural predicted aperture values FV1_{pred1}. The plural predicted transmittances TR1_{pred1} are transmittances determined for the course of realistically changing from the current transmittance TR1_{current} to the target transmittance TR1_{target} in the change time T31. Reference here to realistically changing means changing the transmittance TR1 so as to enable a change of the transmittance TR1 of the electronic ND filter 58 from the current transmittance TR1_{current} to the target transmittance TR1_{target} to be achieved in the aperture drive time T1_{FV}. When the transmittance TR1 of the electronic ND filter 58 is realistically changed, priority is given to making the change of the transmittance TR1 of the electronic ND filter 58 from the current transmittance TR1_{current} to the target transmittance TR1_{target} in the aperture drive time T1_{FV}, and so the transmittance TR1 of the electronic ND filter 58 is not changed monotonously by constant change amounts from the current transmittance TR1_{current} through to the target transmittance TR1_{target}.

Moreover, each of the respective plural predicted transmittances TR1_{pred1} is an exposure applied to the respective plural frames 80 obtained during the course of the change time T31, and is a transmittance TR1 predicted from the needed frame number B41, the target exposure EX1_{target}, the target aperture value FV1_{target}, the current aperture value FV1_{current}, the current transmittance TR1_{current}, the current sensitivity SE1_{current}, the current shutter speed SP1_{current}, and the plural predicted aperture values FV1_{pred1}.

Calculation of the plural predicted transmittances TR1_{pred1} is performed using a predicted transmittance computation equation 1119. The predicted transmittance computation equation 1119 is a computation equation having the needed frame number B41, the target exposure EX1_{target}, the target aperture value FV1_{target}, the current aperture value FV1_{current}, the current transmittance TR1_{current}, the current sensitivity SE1_{current}, the current shutter speed SP1_{current}, and the plural predicted aperture values FV1_{pred1} as independent variables, and having the plural predicted transmittances TR1_{pred1} as dependent variables.

The plural predicted aperture values FV1_{pred1} are plural aperture values FV1 calculated based on the needed frame number B31, and so the plural predicted transmittances TR1_{pred1} may also be referred to as being plural transmittances TR1 determined based on the needed frame number B31 and the needed frame number B41.

The needed frame number B41 is calculated based on the change time T31. The change time T31 is a time needed to change the transmittance TR1 of the electronic ND filter 58 from the current transmittance TR1_{current} to the target transmittance TR1_{target} via the in-drive-time transmittance TR1_{InTime2}. Accordingly, the plural predicted transmittances TR1_{pred1} may also be referred to as plural transmittances determined based on the current transmittance TR1_{current} and the in-drive-time transmittance TR1_{InTime2}.

Note that in the present seventh exemplary embodiment, the plural predicted transmittances TR1_{pred1} are an example of “plural first realistic transmittances” according to the present disclosure.

As illustrated in the example of FIG. 32, the processor 64 calculates plural divisional exposures EX1_{div3} derived based on a maximum frame number B1ₘₐₓ₁ and the target exposure EX1_{target}, wherein the greater from out of the needed frame number B31 or the needed frame number B41 is employed as the maximum frame number B1ₘₐₓ₁. The plural divisional exposures EX1_{div3} are the same values as each other in order that the brightness of the plural frames 80 obtained by performing live-view image imaging is held constant. Namely, the processor 64 allocates an exposure that is the same value as the target exposure EX1_{target} as the divisional exposures EX1_{div3} for each of the frames 80 of the maximum frame number B1ₘₐₓ₁.

Note that although an example is given here of the maximum frame number B1ₘₐₓ₁, an average value of the needed frame number B31 and the needed frame number B41 may be employed instead of the maximum frame number B1ₘₐxi.

The processor 64 calculates plural predicted sensitivities SE1_{pred1} and plural predicted shutter speeds SP1_{pred1} based on the plural divisional exposures EX1_{div3}, the plural predicted transmittances TR1_{pred1}, and the plural predicted aperture values FV1_{pred1}.

The divisional exposures EX1_{div3} are defined by the plural exposure factors. The plural exposure factors defining the divisional exposures EX1_{div3} means the predicted transmittances TR1_{pred1}, the predicted aperture values FV1_{pred1}, the predicted sensitivities SE1_{pred1}, and the predicted shutter speeds SP1_{pred1}.

Each of the plural predicted sensitivities SE1_{pred1} calculated based on the plural divisional exposures EX1_{div3}, the plural predicted transmittances TR1_{pred1}, and the plural predicted aperture values FV1_{pred1} is a value predicted for the sensitivity SE1 employed for the respective frames 80 obtained from the current aperture value FV1_{current} to the target aperture value FV1_{target}. The plural predicted shutter speeds SP1_{pred1} calculated based on the plural divisional exposures EX1_{div3}, the plural predicted transmittances TR1_{pred1}, and the plural predicted aperture values FV1_{pred1} are values predicting the shutter speeds SP1 employed for each of the frames 80 obtained from the current aperture value FV1_{current} to the target aperture value FV1_{target}.

The calculation of the plural predicted sensitivities SE1_{pred1} and the plural predicted shutter speeds SP1_{pred1} is performed using an exposure factor computation equation 1120. The exposure factor computation equation 1120 is a computation equation having the plural divisional exposures EX1_{div3}, the plural predicted transmittances TR1_{pred1}, and the plural predicted aperture values FV1_{pred1} as independent variables, and having the plural predicted sensitivities SE1_{pred1} and the plural predicted shutter speeds SP1_{pred1} as dependent variables.

In this manner, the plural predicted sensitivities SE1_{pred1} and the plural predicted shutter speeds SP1_{pred1} are calculated based on the plural divisional exposures EX1_{div3}. The plural divisional exposures EX1_{div3} employed to calculate the plural predicted sensitivities SE1_{pred1} and the plural predicted shutter speeds SP1_{pred1} are calculated based on the target exposure EX1_{target}. Accordingly, the plural predicted sensitivities SE1_{pred1} and the plural predicted shutter speeds SP1_{pred1} may also be referred to as exposure factors set in the imaging apparatus 10 to match the target exposure EX1_{target}.

In cases in which live-view image imaging is performed in the change time T31, the exposure of the plural frames 80 obtained by performing live-view image imaging are determined by the plural predicted transmittances TR1_{pred1}, the plural predicted aperture values FV1_{pred1}, the plural predicted sensitivities SE1_{pred1}, and the plural predicted shutter speeds SP1_{pred1} defining the plural divisional exposures EX1_{div3}.

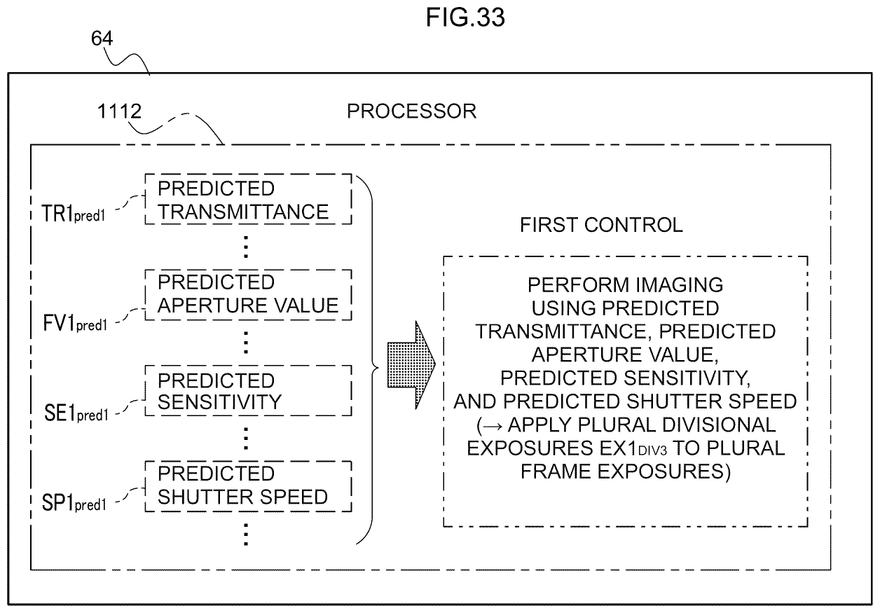

For example, as illustrated in FIG. 33, the processor 64 causes the imaging apparatus 10 to perform live-view image imaging in the change time T31 with the exposures that employed the plural predicted transmittances TR1_{pred1}, the plural predicted aperture values FV1_{pred1}, the plural predicted sensitivities SE1_{pred1}, and the plural predicted shutter speeds SP1_{pred1}. Thus, the plural divisional exposures EX1_{div3} are applied for the exposures of the plural frames 80 obtained by performing live-view image imaging in the change time T31. As a result thereof, the exposures of the plural frames 80 obtained by performing live-view image imaging in the course of the change time T31 are held constant.

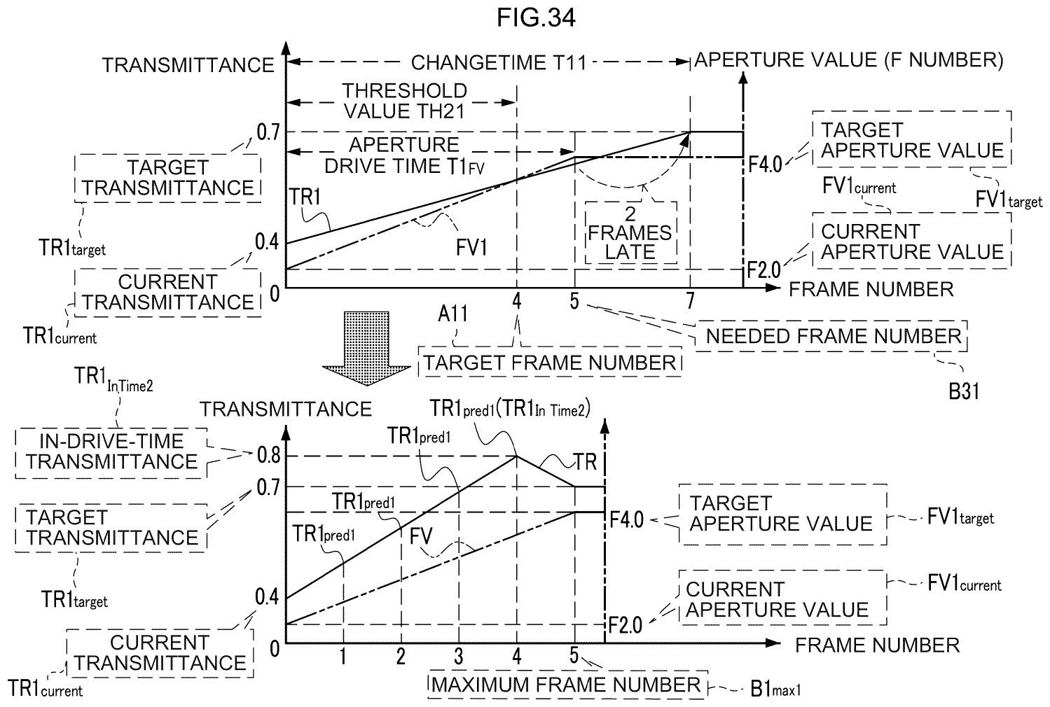

As illustrated in the example in FIG. 34, if the first control 1112 described above is not performed, then the needed frame number B31 exceeds a target frame number A111, which is a number of frames needed during the course of the threshold value TH21, in cases in which both the aperture drive time T1_{FV} and the change time T11 have exceeded the threshold value TH21. Moreover, depending on the relationship between the current transmittance TR1_{current} and the target transmittance TR1_{target}, an amount of time that exceeds the aperture drive time T1_{FV} is needed to change the transmittance TR1 of the electronic ND filter 58 from the current transmittance TR1_{current} to the target transmittance TR1_{target}. This means that the change time T11 does not fall within the aperture drive time T1_{FV}. Thus, in the present seventh exemplary embodiment, due to the first control 1112 described above being performed by the processor 64, as illustrated in the example in FIG. 34, the transmittance TR1 of the electronic ND filter 58 is changed from the current transmittance TR1_{current} to the target transmittance TR1_{target} via the plural predicted transmittances TR1_{pred1} including the in-drive-time transmittance TR1_{InTime2} (namely, the plural transmittances TR1 determined such that change of the transmittance TR1 of the electronic ND filter 58 from the current transmittance TR1_{current} to the target transmittance TR1_{target} is achieved in the aperture drive time T1_{FV}). This thereby enables the change of the transmittance of the electronic ND filter 58 from the current transmittance TR1_{current} to the target transmittance TR1_{target} to be achieved in the aperture drive time T1_{FV}.

Moreover, while the transmittance TR1 of the electronic ND filter 58 is being changed from the current transmittance TR1_{current} to the target transmittance TR1_{target}, plural exposure factors including the plural predicted transmittances TR1_{pred1} are determined such that the target exposure EX1_{target} is maintained (see FIG. 30 to FIG. 33), and the plural exposure factors are applied for the exposures of the plural frames 80 obtained by performing live-view image imaging in the change time T31. This thereby enables the brightness to be held constant for the plural frames 80 obtained by live-view image imaging in the change time T31.

FIG. 35 to FIG. 39 illustrate an example of content of the second control 1114. The second control 1114 includes control to apply the plural divisional exposures EX1_{div4}, determined based on the time to ideally change from the current transmittance TR1_{current} to the target transmittance TR1_{target} and on the aperture drive time T1_{FV}, for the exposures of the plural frames 80 obtained by performing live-view image imaging.

In order to implement the second control 1114, as illustrated in the example of FIG. 35, the processor 64 calculates the needed frame number B31 based on the aperture drive time T1_{FV} and the frame rate FR1. The needed frame number B31 is calculated in a similar manner to the example illustrated in FIG. 26. The processor 64 calculates the plural predicted aperture values FV1_{pred2} based on the needed frame number B31, the current aperture value FV1_{current}, and the target aperture value FV1_{target}. The plural predicted aperture values FV1_{pred2} are calculated in a similar manner to the calculation of the plural predicted aperture values FV1_{pred2} in the example illustrated in FIG. 30.

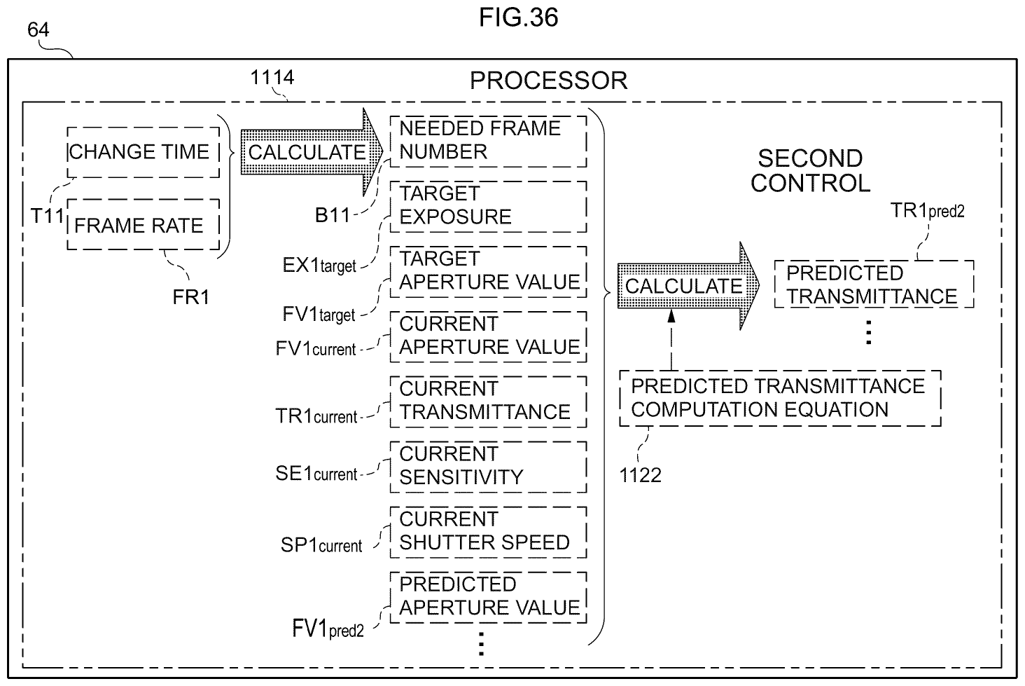

As illustrated in the example of FIG. 36, the processor 64 calculates a frame rate B1 based on the change time T11 and the frame rate FR1. The frame rate B1 is a number of frames corresponding to the change time T11, namely a number of frames obtained by live-view image imaging during the course of the change time T11. The frame rate B1 is calculated in a similar manner to the in the example illustrated in FIG. 21. Note that in the present exemplary embodiment, the change time T11 is an example of an “ideal change time” according to the present disclosure, the frame rate B1 is an example of a “first frame number” and a “third frame number” according to the present disclosure.

The processor 64 calculates plural predicted transmittances TR1_{pred2} based on the frame rate B1, the target exposure EX1_{target}, the target aperture value FV1_{target}, the current aperture value FV1_{current}, the current transmittance TR1_{current}, the current sensitivity SE1_{current}, the current shutter speed SP1_{current}, and the plural predicted aperture values FV1_{pred2}. The plural predicted transmittances TR1_{pred2} are transmittances determined the course of ideal change from the current transmittance TR1_{current} to the target transmittance TR1_{target} in the change time T11.

The calculation of the plural predicted transmittances TR1_{pred2} is performed using a predicted transmittance computation equation 1122. The predicted transmittance computation equation 1122 is a computation equation having the frame rate B1, the target exposure EX1_{target}, the target aperture value FV1_{target}, the current aperture value FV1_{current}, the current transmittance TR1_{current}, the current sensitivity SE1_{current}, the current shutter speed SP1_{current}, and the plural predicted aperture values FV1_{pred2} as independent variables, and having the plural predicted transmittances TR1_{pred2} as dependent variables. The plural predicted aperture values FV1_{pred2} are plural aperture values FV1 calculated based on the needed frame number B31, and so the plural predicted transmittances TR1_{pred2} may also be referred to as plural transmittances TR1 determined based on the frame rate B1 and the needed frame number B31. Note that in the present seventh exemplary embodiment, the plural predicted transmittances TR1_{pred2} are an example of “plural ideal transmittances” according to the present disclosure.

As illustrated in the example of FIG. 37, the processor 64 derives plural divisional exposures EX1_{div4} based on the maximum frame number B1ₘₐₓ₂ and the target exposure EX1_{target}, wherein the greater from out of the needed frame number B11 or the needed frame number B31 is employed as a maximum frame number B1ₘₐₓ₂. The plural divisional exposures EX1_{div4} are the same values as each other such that the brightness is held constant for the plural frames 80 obtained by performing live-view image imaging. Namely, the processor 64 allocates exposures that are the same value as the target exposure EX1_{target} as the divisional exposures EX1_{div4} for the respective frames 80 of the maximum frame number B1ₘₐₓ₂.

Note that although an example is given here of the maximum frame number B1ₘₐₓ₂, an average value of the needed frame number B11 and the needed frame number B31 may be employed instead of the maximum frame number B1ₘₐₓ₂.

The processor 64 calculates the plural predicted sensitivities SE1_{pred2} and the plural predicted shutter speeds SP1_{pred2} based on the plural divisional exposures EX1_{div4}, the plural predicted transmittances TR1_{pred2}, and the plural predicted aperture values FV1_{pred2}.

The divisional exposures EX1_{div4} are defined by plural exposure factors. The plural exposure factors defining the divisional exposures EX1_{div4} mean the predicted transmittances TR1_{pred2}, the predicted aperture values FV1_{pred2}, the predicted sensitivities SE1_{pred2}, and the predicted shutter speeds SP1_{pred2}.

The respective plural predicted sensitivities SE1_{pred2} calculated based on the plural divisional exposures EX1_{div4}, the plural predicted transmittances TR1_{pred2}, and the plural predicted aperture values FV1_{pred2} are each a value predicting the sensitivity SE1 using each of the frames 80 obtained from the current aperture value FV1_{current} to the target aperture value FV1_{target}. The plural predicted shutter speeds SP1_{pred2}, which are calculated based on the plural divisional exposures EX1_{div4}, the plural predicted transmittances TR1_{pred2}, and the plural predicted aperture values FV1_{pred2} are predicted values of the shutter speed SP1 to be used for each of the frames 80 obtained during the transition from the current aperture value FV1_{current} to the target aperture value FV1_{target}.

The calculation of the plural predicted sensitivities SE1_{pred2} and the plural predicted shutter speeds SP1_{pred2} is performed using an exposure factor computation equation 1124. The exposure factor computation equation 1124 is a computation equation having the plural divisional exposures EX1_{div4}, the plural predicted transmittances TR1_{pred2}, and the plural predicted aperture values FV1_{pred2} as independent variables, and having the plural predicted sensitivities SE1_{pred2} and the plural predicted shutter speeds SP1_{pred2} as dependent variables.

In this way, the plural predicted sensitivities SE1_{pred2} and the plural predicted shutter speeds SP1_{pred2} are accordingly calculated based on the plural divisional exposures EX1_{div4}. The plural divisional exposures EX1_{div4} employed to calculate the plural predicted sensitivities SE1_{pred2} and the plural predicted shutter speeds SP1_{pred2} are calculated based on the target exposure EX1_{target}. Accordingly, the plural predicted sensitivities SE1_{pred2} and the plural predicted shutter speeds SP1_{pred2} may also be referred to as exposure factors set in the imaging apparatus 10 to match the target exposure EX1_{target}.

In cases in which live-view image imaging is performed in the change time T11, the exposures of the plural frames 80 obtained by performing the live-view image imaging are determined by the plural predicted transmittances TR1_{pred2}, the plural predicted aperture values FV1_{pred2}, the plural predicted sensitivities SE1_{pred2}, and the plural predicted shutter speeds SP1_{pred2} defining the plural divisional exposures EX1_{div4}.

For example, as illustrated in FIG. 38, the processor 64 causes the imaging apparatus 10 to perform live-view image imaging in the change time T11 with the exposures that have employed the plural predicted transmittances TR1_{pred2}, the plural predicted aperture values FV1_{pred2}, the plural predicted sensitivities SE1_{pred2}, and the plural predicted shutter speeds SP1_{pred2}. Therefore, the plural divisional exposures EX1_{div4} are applied for the exposures of the plural frames 80 obtained by performing live-view image imaging in the change time T11. As a result thereof, the exposures of the plural frames 80 obtained by performing live-view image imaging for the course of the change time T11 are maintained constant.

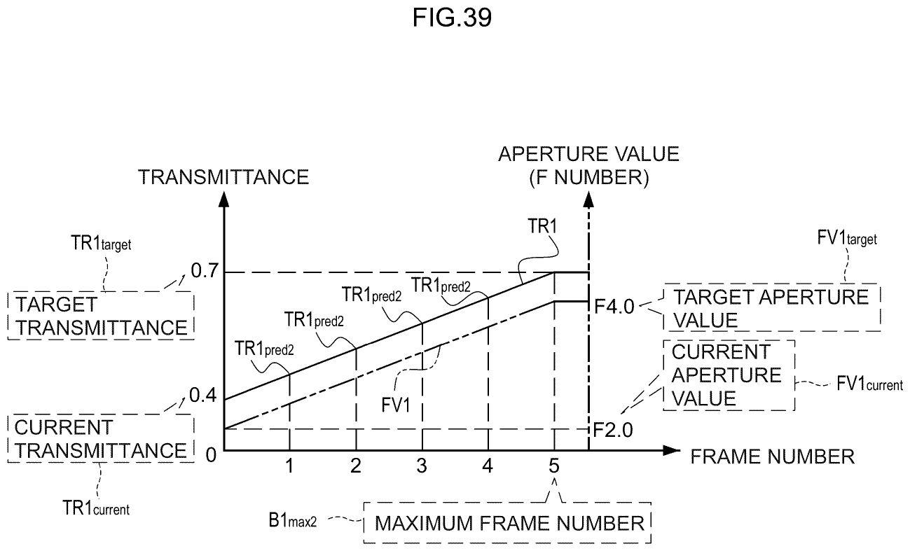

In the present seventh exemplary embodiment, by the second control 1114 being performed by the processor 64, as illustrated in the example of FIG. 39, in the change time T11, the aperture value of the aperture 40C is changed from the current aperture value FV1_{current} to the target aperture value FV1_{target}, and the transmittance TR1 of the electronic ND filter 58 is changed from the current transmittance TR1_{current} to the target transmittance TR1_{target} along the plural predicted transmittances TR1_{pred2} (namely, transmittances TR1 that change monotonously). Moreover, so that the target exposure EX1_{target} is maintained, plural exposure factors are determined including the plural predicted transmittances TR1_{pred2} (see FIG. 35 to FIG. 38), and the plural exposure factors are applied for the exposures of the plural frames 80 obtained by performing live-view image imaging in the change time T11. This thereby enables the brightness of the plural frames 80 obtained by performing live-view image imaging in the change time T11 to be held constant.

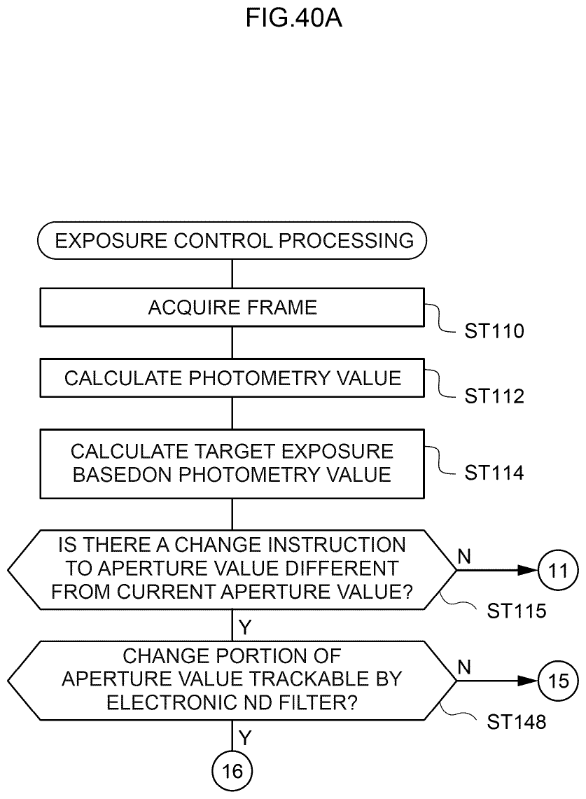

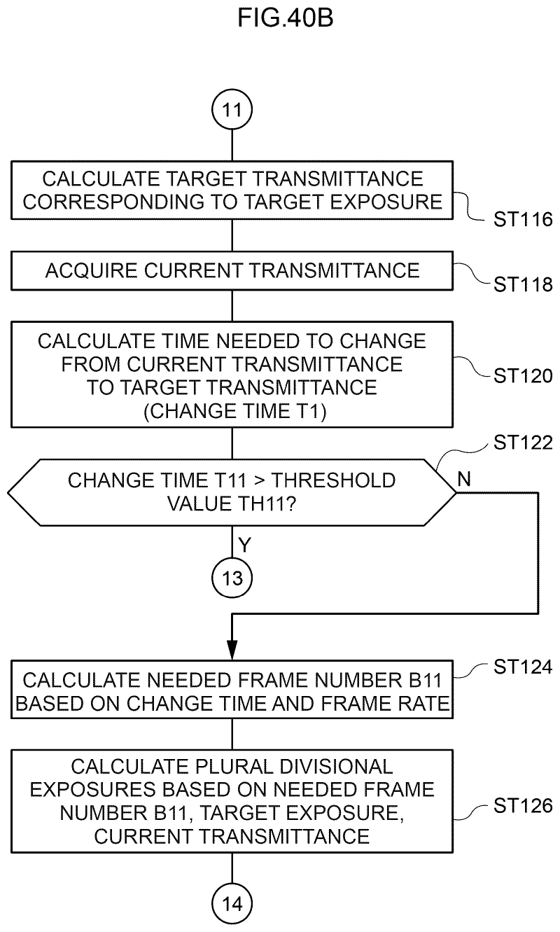

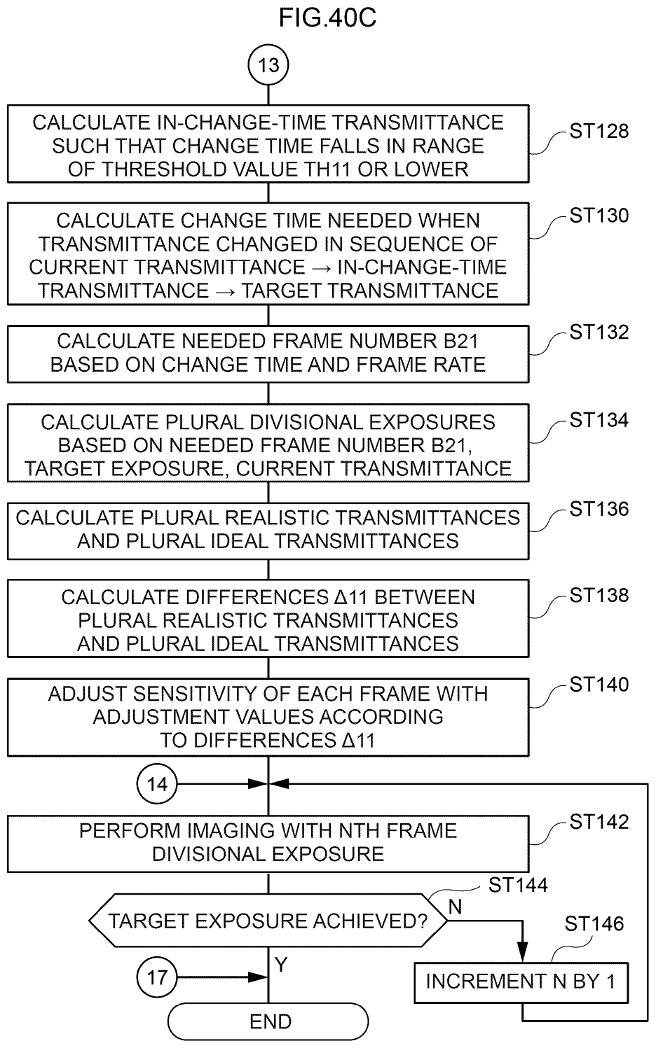

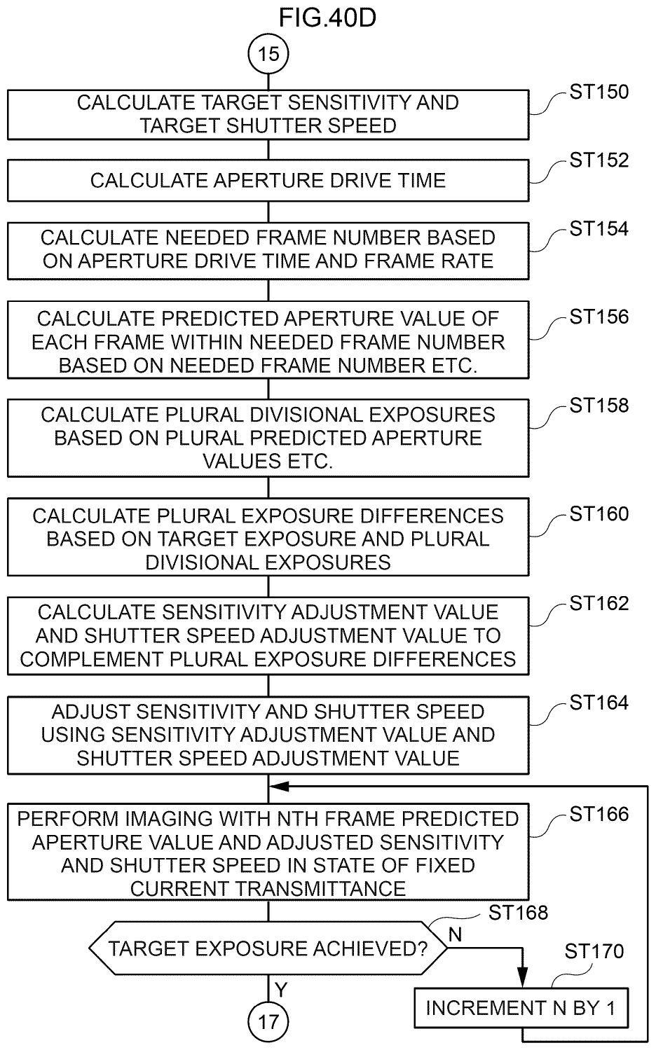

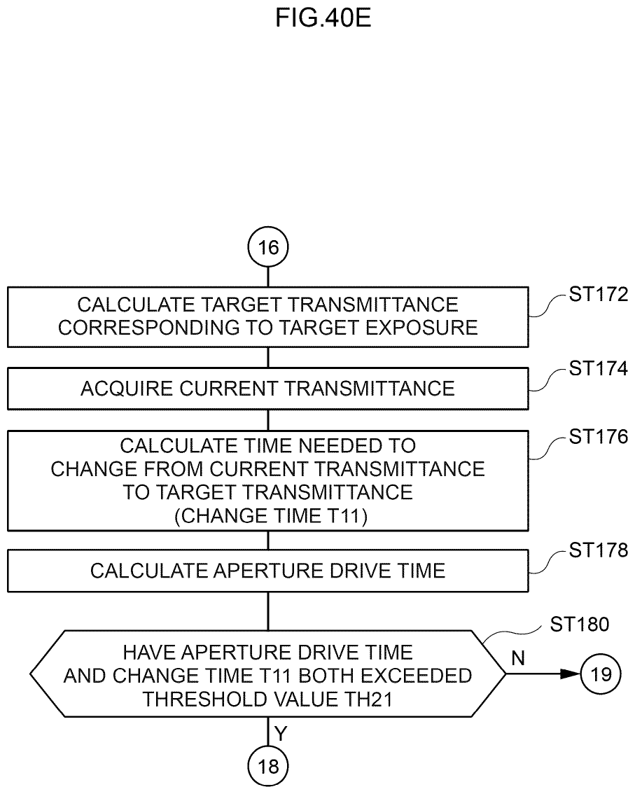

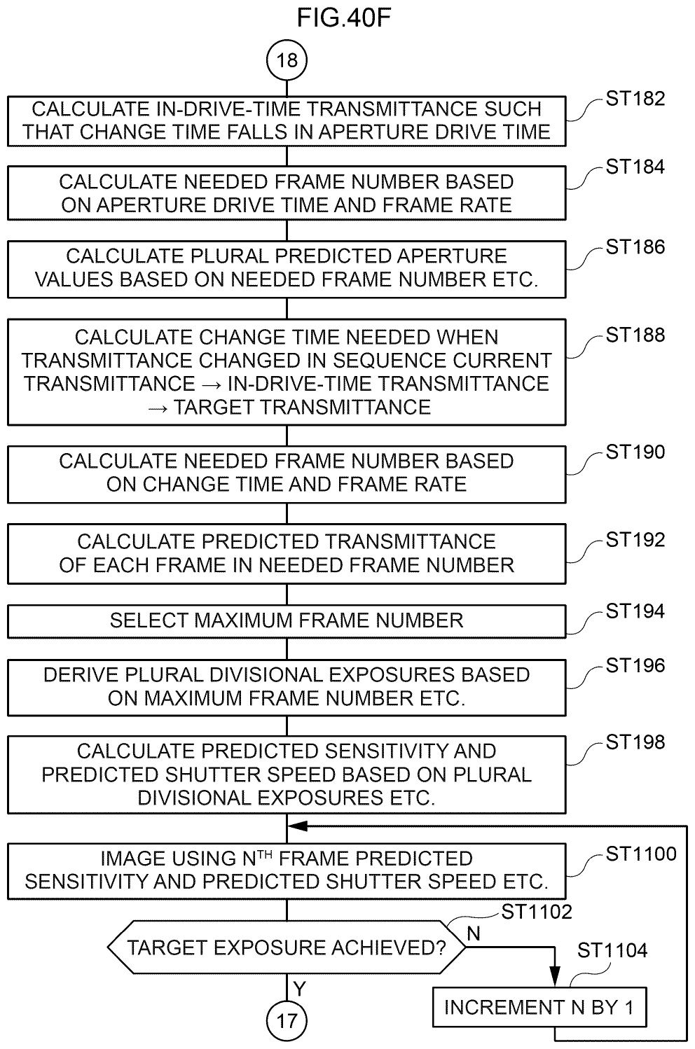

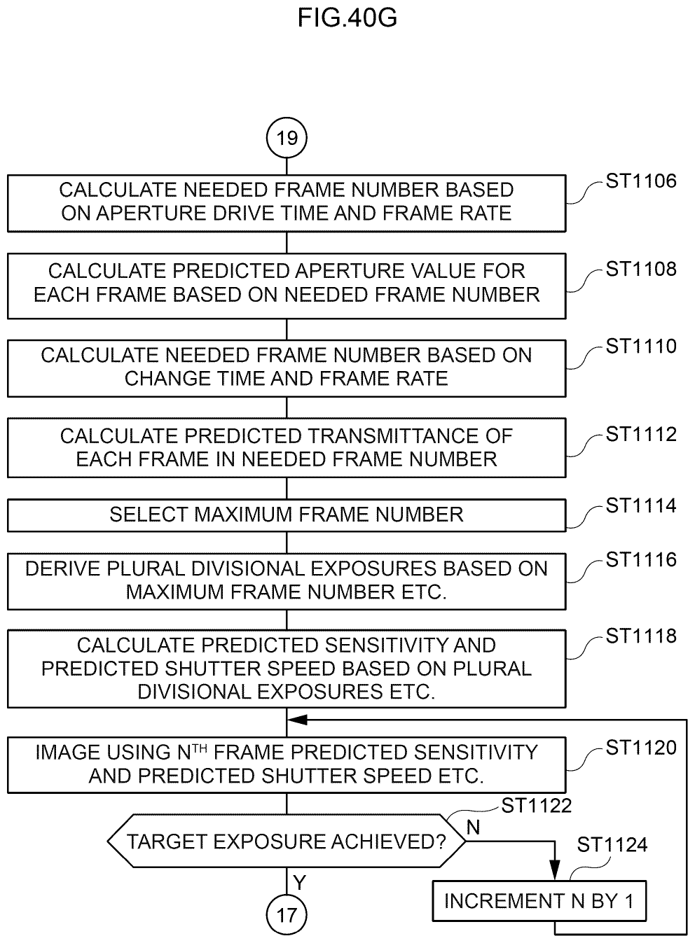

Next, description follows regarding operation of the imaging apparatus 10, with reference to FIG. 40A to FIG. 40G. In FIG. 40A to FIG. 40G, an example is illustrated of a flow of exposure control processing executed by the processor 64 under conditions in which, in cases in which an exposure calculation start timing has arrived for performing live-view image imaging with the current transmittance TR1_{current} set as the transmittance TR1 of the electronic ND filter 58 (in other words, a timing specified in advance as the timing to adjust the exposure of the frames 80 obtained by performing live-view image imaging). The flow of the exposure control processing illustrated in FIG. 40A to FIG. 40G is an example of a “control method” according to the present disclosure.

In the exposure control processing illustrated in FIG. 40A, firstly, at step ST110 the processor 64 acquires a frame 80 generated by performing live-view image imaging. The exposure control processing transitions to step ST112 after the processing of step ST110 has been executed.

At step ST112, the processor 64 calculates a photometry value 1090 based on the frame 80 acquired at step ST110. The exposure control processing transitions to step ST114 after the processing of step ST112 has been executed.

At step ST114, based on the photometry value 1090, the processor 64 calculates the target exposure EX1_{target} as an exposure such that the brightness of the frame 80 employed to calculate the photometry value 1090 is the target brightness. The exposure control processing transitions to step ST115 after the processing of step ST114 has been executed.

At step ST115, the processor 64 determines whether or not an aperture value change instruction has been given to the imaging apparatus 10. Negative determination is made at step ST115 in cases in which an aperture value change instruction has not been given to the imaging apparatus 10, and the exposure control processing transitions to step ST116 illustrated in FIG. 40B. Affirmative determination is made at step ST115 in cases in which an aperture value change instruction has been given to the imaging apparatus 10, and the exposure control processing transitions to step ST148.

At step ST116 illustrated in FIG. 40B, the processor 64 calculates the target transmittance TR1_{target} corresponding to the target exposure EX1_{target}. The exposure control processing transitions to step ST118 after the processing of step ST116 has been executed.

At step ST118, the processor 64 acquires the current transmittance TR1_{current} set for the electronic ND filter 58 at the current point in time. The exposure control processing transitions to step ST120 after the processing of step ST118 has been executed.

At step ST120, the processor 64 calculates a time needed for ideally changing the transmittance TR1 of the electronic ND filter 58 from the current transmittance TR1_{current} to the target transmittance TR1_{target}, namely calculates the change time T11. The exposure control processing transitions to step ST122 after the processing of step ST120 has been executed.

At step ST122, the processor 64 determines whether or not the change time T11 has exceeded the threshold value TH11. Negative determination is made at step ST122 when the change time T11 has not exceeded the threshold value TH11, and the exposure control processing transitions to step ST124. Affirmative determination is made at step ST122 when the change time T11 has exceeded the threshold value TH11, and the exposure control processing transitions to step ST128 illustrated in FIG. 40C.

At step ST124, the processor 64 calculates a frame rate B1 based on the change time T11 and the frame rate FR1. The exposure control processing transitions to step ST126 after the processing of step ST124 has been executed.

At step ST126, the processor 64 calculates the plural divisional exposures EX1_{div1} based on the frame rate B1, the target exposure EX1_{target}, and the current transmittance TR1_{current}. The exposure control processing transitions to step ST142 illustrated in FIG. 40C after the processing of step ST126 has been executed.

At step ST128 illustrated in FIG. 40C, the processor 64 calculates, as the transmittance TR1 of the electronic ND filter 58, the in-change-time transmittance TR1_{InTime1}, which is a transmittance TR1 such that the change time T11 falls within the range of the threshold value TH11 or lower, based on the change time T11, the threshold value TH11, the current transmittance TR1_{current}, and the target transmittance TR1_{target}. The exposure control processing transitions to step ST130 after the processing of step ST128 has been executed.

At step ST130, the processor 64 calculates a time needed to change the transmittance TR1 of the electronic ND filter 58 from the current transmittance TR1_{current} to the target transmittance TR1_{target} via the in-change-time transmittance TR1_{InTime1}, namely calculates the change time T21, based on the current transmittance TR1_{current}, the in-change-time transmittance TR1_{InTime1}, and the target transmittance TR1_{target}. The exposure control processing transitions to step ST132 after the processing of step ST130 has been executed.

At step ST132, the processor 64 calculates the needed frame number B21 based on the change time T21 and the frame rate FR1. The exposure control processing transitions to step ST134 after the processing of step ST132 has been executed.

At step ST134, the processor 64 calculates the plural divisional exposures EX1_{div1} based on the needed frame number B21, the target exposure EX1_{target}, and the current transmittance TR1_{current}. The exposure control processing transitions to step ST136 after the processing of step ST134 has been executed.

At step ST136, the processor 64 calculates the plural realistic transmittances TR1ᵣₑₐₗ₁ and the plural ideal transmittances TR1_{ideal1} based on the plural divisional exposures EX1_{div1}, the current transmittance TR1_{current}, the target transmittance TR1_{target}, and the in-change-time transmittance TR1_{InTime1}. The exposure control processing transitions to step ST138 after the processing of step ST136 has been executed.

At step ST138, the processor 64 calculates the exposure differences 611 between the plural realistic transmittances TR1ᵣₑₐₗ₁ and the plural ideal transmittances TR1_{ideal1} by frame 80 unit in the needed frame number B21. Namely, at step ST138, the exposure differences 611 between the realistic transmittances TR1ᵣₑₐₗ₁ and the ideal transmittances TR1_{ideal1} are calculated for each of the frames 80 contained in the needed frame number B21. The exposure control processing transitions to step ST140 after the processing of step ST138 has been executed.

At step ST140, for each of the frames 80 contained in the needed frame number B21, the processor 64 adjusts the sensitivity SE1, which is one of the exposure factors defining the divisional exposures EX1_{div1}, by an adjustment value according to the difference δ11. The exposure control processing transitions to step ST142 after the processing of step ST140 has been executed.

At step ST142, the processor 64 then causes the imaging apparatus 10 to perform imaging with an N^{th} frame divisional exposure EX1_{div1}, wherein N is a natural number having an initial value of “1”. For example, when the exposure control processing has transitioned from step ST126 to step ST142, at step ST142 the processor 64 causes the imaging apparatus 10 to perform imaging with the N^{th} frame of the divisional exposures EX1_{div1} from out of the plural divisional exposures EX1_{div1} calculated by execution of the processing of step ST126. However, in cases in which the exposure control processing has transitioned from step ST140 to step ST142, at step ST142 the processor 64 sets the imaging apparatus 10 with a sensitivity SE1 adjusted according to the difference δ11 calculated for N^{th} frame, the shutter speed SP1 determined for the N^{th} frame, and the aperture value FV1 determined for the N^{th} frame, and causes the imaging apparatus 10 to perform the N^{th} frame imaging after setting the electronic ND filter 58 to the N^{th} frame transmittance TR1 from out of the current transmittance TR1_{current}, the plural realistic transmittances TR1ᵣₑₐₗ₁, and the target transmittance TR1_{target}. The exposure control processing transitions to step ST144 after the processing of step ST142 has been executed.

At step ST144, the processor 64 determines whether or not the N^{th} frame exposure has attained the target exposure EX1_{target}. Negative determination is made at step ST144 and the exposure control processing transitions to step ST146 in cases in which the N^{th} frame exposure has not attained the target exposure EX1_{target}. At step ST146, the processor 64 increments N by “1”. The exposure control processing transitions to step ST142 after the processing of step ST146 has been executed. Affirmative determination is made at step ST144 in cases in which the N^{th} frame exposure has attained the target exposure EX1_{target}, and the exposure control processing is ended.

At step ST148 illustrated in FIG. 40A, the processor 64 determines whether or not the change portion of the aperture value FV1 is trackable with the electronic ND filter 58. Negative determination is made at step ST148 when the change portion of the aperture value FV1 is not trackable with the electronic ND filter 58, and the exposure control processing transitions to step ST150 illustrated in FIG. 40D. Affirmative determination is made at step ST148 when the change portion of the aperture value FV1 is trackable with the electronic ND filter 58, and the exposure control processing transitions to step ST172 illustrated in FIG. 40E.

At step ST150 illustrated in FIG. 40D, the processor 64 calculates the target sensitivity SE1_{target} and the target shutter speed SP1_{target} based on the current aperture value FV1_{current}, the target aperture value FV1_{target}, the current transmittance TR1_{current}, and the target exposure EX1_{target}. The exposure control processing transitions to step ST152 after the processing of step ST150 has been executed.

At step ST152, the processor 64 calculates an aperture drive time T1_{FV} based on the current aperture value FV1_{current} and the target aperture value FV1_{target}. The exposure control processing transitions to step ST154 after the processing of step ST152 has been executed.

At step ST154, the processor 64 calculates a needed frame number B31 based on the aperture drive time T1_{FV} and the frame rate FR1. The exposure control processing transitions to step ST156 after the processing of step ST154 has been executed.

At step ST156, the processor 64 calculates plural live predicted aperture values FV1_{pred0} based on the needed frame number B31, the current aperture value FV1_{current}, and the target aperture value FV1_{target}. The exposure control processing transitions to step ST158 after the processing of step ST156 has been executed.

At step ST158, the processor 64 calculates plural divisional exposures EX1_{div2} based on the current transmittance TR1_{current}, the current sensitivity SE1_{current}, the current shutter speed SP1_{current}, and the plural predicted aperture values FV1_{pred0}. The exposure control processing transitions to step ST160 after the processing of step ST158 has been executed.

At step ST160, the processor 64 calculates plural exposure differences EX1_{diff} based on the target exposure EX1_{target} and the plural divisional exposures EX1_{div2}. The exposure control processing transitions to step ST162 after the processing of step ST160 has been executed.

At step ST162, based on the plural exposure differences EX1_{diff}, the processor 64 calculates plural sensitivity adjustment values Δ1a and plural shutter speed adjustment values Δ1b for complementing the plural exposure differences EX1_{diff}. The exposure control processing transitions to step ST164 after the processing of step ST162 has been executed.

At step ST164, the processor 64 adjusts the current sensitivity SE1_{current} using the plural sensitivity adjustment values Δ1a. Moreover, the processor 64 also adjusts the current shutter speed SP1_{current} using the plural shutter speed adjustment values Δ1b. The exposure control processing transitions to step ST166 after the processing of step ST164 has been executed.

At step ST166, the processor 64 causes the imaging apparatus 10 to perform N^{th} frame imaging with the exposure using the current transmittance TR1_{current}, the already adjusted N^{th} frame sensitivity SE1, the already adjusted N^{th} frame shutter speed SP1, and the N^{th} frame predicted aperture value FV1_{pred0}. The exposure control processing transitions to step ST168 after the processing of step ST166 has been executed.

At step ST168, the processor 64 determines whether or not the N^{th} frame exposure has attained the target exposure EX1_{target}. Negative determination is made at step ST168 when the N^{th} frame exposure has not attained the target exposure EX1_{target}, and the exposure control processing transitions to step ST170. At step ST170 the processor 64 increments N by “1”. The exposure control processing transitions to step ST166 after the processing of step ST170 has been executed. Affirmative determination is made at step ST168 when the N^{th} frame exposure has attained the target exposure EX1_{target}, and the exposure control processing is ended.

At step ST172 illustrated in FIG. 40E, the processor 64 calculates a target transmittance TR1_{target} corresponding to the target exposure EX1_{target} based on the target exposure EX1_{target}, the target aperture value FV1_{target}, and the plural current exposure factors. The exposure control processing transitions to step ST174 after the processing of step ST172 has been executed.

At step ST174, the processor 64 acquires the current transmittance TR1_{current}. The exposure control processing transitions to step ST176 after the processing of step ST174 has been executed.

At step ST176, based on based on the target transmittance TR1_{target} and the current transmittance TR1_{current}, the processor 64 calculates a time needed to ideally change from the current transmittance TR1_{current} to the target transmittance TR1_{target}, namely a change time T11. The exposure control processing transitions to step ST178 after the processing of step ST176 has been executed.

At step ST178, the processor 64 calculates an aperture drive time T1_{FV} based on the current aperture value FV1_{current} and the target aperture value FV1_{target}.

The exposure control processing transitions to step ST180 after the processing of step ST178 has been executed.

At step ST180, the processor 64 determines whether or not the aperture drive time T1_{FV} and the change time T11 have both exceeded the threshold value TH21. Negative determination is made at step ST180 in cases in which the aperture drive time T1_{FV} and the change time T11 have not both exceeded the threshold value TH21 (namely, cases in which the aperture drive time T1_{FV} and/or the change time T11 is the threshold value TH21 or lower), and the exposure control processing transitions to step ST1106 illustrated in FIG. 40G. Affirmative determination is made at step ST180 in cases in which the aperture drive time T1_{FV} and the change time T11 have both exceeded the threshold value TH21, and the exposure control processing transitions to step ST182 illustrated in FIG. 40F.

At step ST182 illustrated in FIG. 40F, based on the aperture drive time T1_{FV}, the change time T11, the target transmittance TR1_{target}, and the current transmittance TR1_{current}, the processor 64 calculates a transmittance such that the time needed to change from current transmittance TR1_{current} to the target transmittance TR1_{target} is in the aperture drive time T1_{FV}, namely an in-drive-time transmittance TR1_{InTime2}. The exposure control processing transitions to step ST184 after the processing of step ST182 has been executed.

At step ST184, the processor 64 calculates the needed frame number B31 based on the aperture drive time T1_{FV} and the frame rate FR1. The exposure control processing transitions to step ST186 after the processing of step ST184 has been executed.

At step ST186, the processor 64 calculates the plural predicted aperture values FV1_{pred1} based on the needed frame number B31, the current aperture value FV1_{current}, and the target aperture value FV1_{target}. The exposure control processing transitions to step ST188 after the processing of step ST186 has been executed.

At step ST188, based on the in-drive-time transmittance TR1_{InTime2}, the current transmittance TR1_{current}, and the target transmittance TR1_{target}, the processor 64 calculates the change time T31, which is the time to realistically change the transmittance TR1 of the electronic ND filter 58 from the current transmittance TR1_{current} to the target transmittance TR1_{target} in the aperture drive time T1_{FV}. The exposure control processing transitions to step ST190 after the processing of step ST188 has been executed.

At step ST190, the processor 64 calculates a needed frame number B41 based on the change time T31 and the frame rate FR1. The exposure control processing transitions to step ST192 after the processing of step ST190 has been executed.

At step ST192, the processor 64 calculates plural predicted transmittances TR1_{pred1} (namely, the predicted transmittances TR1_{pred1} for the respective frames 80 obtained in the needed frame number B41) based on the needed frame number B41, the target exposure EX1_{target}, the target aperture value FV1_{target}, the current aperture value FV1_{current}, the current transmittance TR1_{current}, the current sensitivity SE1_{current}, the current shutter speed SP1_{current}, and the plural predicted aperture values FV1_{pred1}. The exposure control processing transitions to step ST194 after the processing of step ST192 has been executed.

At step ST194, the processor 64 selects the greater from out of the needed frame number B31 or the needed frame number B41 as a maximum frame number B1ₘₐₓ₁. The exposure control processing transitions to step ST196 after the processing of step ST194 has been executed.

At step ST196, the processor 64 derives plural divisional exposures EX1_{div3} based on the maximum frame number B1ₘₐₓ₁ and the target exposure EX1_{target}. The exposure control processing transitions to step ST198 after the processing of step ST196 has been executed.

At step ST198, the processor 64 calculates plural predicted sensitivities SE1_{pred1} and predicted shutter speeds SP1_{pred1} based on the plural divisional exposures EX1_{div3}, the plural predicted transmittances TR1_{pred1}, and the plural predicted aperture values FV1_{pred1}. The exposure control processing transitions to step ST1100 after the processing of step ST198 has been executed.

At step ST1100, the processor 64 causes the imaging apparatus 10 to perform imaging with the exposure using the N^{th} frame predicted transmittances TR1_{pred1}, the N^{th} frame predicted aperture value FV1_{pred1}, the N^{th} frame predicted sensitivities SE1_{pred1}, and the N^{th} frame predicted shutter speeds SP1_{pred1}. The exposure control processing transitions to step ST1102 after the processing of step ST1100 has been executed.

At step ST1102, the processor 64 determines whether or not the N^{th} frame exposure has attained the target exposure EX1_{target}. Negative determination is made at step ST1102 in cases in which the N^{th} frame exposure has not attained the target exposure EX1_{target}, and the exposure control processing transitions to step ST1104. At step ST1104 the processor 64 increments N by “1”. The exposure control processing transitions to step ST1100 after the processing of step ST1104 has been executed. Affirmative determination is made at step ST1102 in cases in which the N^{th} frame exposure has attained the target exposure EX1_{target}, and the exposure control processing is ended.

At step ST1106 as illustrated in FIG. 40G, the processor 64 calculates the needed frame number B31 based on the aperture drive time T1_{FV} and the frame rate FR1. The exposure control processing transitions to step ST1108 after the processing of step ST1106 has been executed.

At step ST1108, the processor 64 calculates the plural predicted aperture values FV1_{pred2} based on the needed frame number B31, the current aperture value FV1_{current}, and the target aperture value FV1_{target}. The exposure control processing transitions to step ST1110 after the processing of step ST186 has been executed.

At step ST1110, the processor 64 calculates the frame rate B1 based on the change time T11 and the frame rate FR1. The exposure control processing transitions to step ST1112 after the processing of step ST1110 has been executed.

At step ST1112, the processor 64 calculates plural predicted transmittances TR1_{pred2} (namely, the predicted transmittances TR1_{pred1} for the respective frames 80 obtained in the frame rate B1) based on the frame rate B1, the target exposure EX1_{target}, the target aperture value FV1_{target}, the current aperture value FV1_{current}, the current transmittance TR1_{current}, the current sensitivity SE1_{current}, the current shutter speed SP1_{current}, and the plural predicted aperture values FV1_{pred1}. The exposure control processing transitions to step ST1114 after the processing of step ST1112 has been executed.

At step ST1114, the processor 64 selects the greater from out of the frame rate B1 or the needed frame number B31 as a maximum frame number B1ₘₐₓ₂. The exposure control processing transitions to step ST1116 after the processing of step ST1114 has been executed.

At step ST1116, the processor 64 derives the plural divisional exposures EX1_{div4} based on the maximum frame number B1ₘₐₓ₂ and the target exposure EX1_{target}. The exposure control processing transitions to step ST1118 after the processing of step ST1116 has been executed.

At step ST1118, the processor 64 calculates the plural predicted sensitivities SE1_{pred2} and the plural predicted shutter speeds SP1_{pred1} based on the plural divisional exposures EX1_{div4}, the plural predicted transmittances TR1_{pred2}, and the plural predicted aperture values FV1_{pred2}. The exposure control processing transitions to step ST1120 after the processing of step ST1118 has been executed.

At step ST1120, the processor 64 causes the imaging apparatus 10 to perform imaging with the exposure employing the N^{th} frame predicted transmittances TR1_{pred2}, the N^{th} frame predicted aperture value FV1_{pred2}, the N^{th} frame predicted sensitivity SE1_{pred2}, and the N^{th} frame predicted shutter speed SP1_{pred2}. The exposure control processing transitions to step ST1122 after the processing of step ST1120 has been executed.

At step ST1122, the processor 64 determines whether or not the N^{th} frame exposure has attained the target exposure EX1_{target}. Negative determination is made at step ST1122 in cases in which the N^{th} frame exposure has not attained the target exposure EX1_{target}, and the exposure control processing transitions to step ST1124. At step ST1124, the processor 64 increments N by “1”. The exposure control processing transitions to step ST1120 after the processing of step ST1124 has been executed. Affirmative determination is made at step ST1122 in cases in which the N^{th} frame exposure has attained the target exposure EX1_{target}, and the exposure control processing is ended.

As described above, in the imaging apparatus 10 according to the present seventh exemplary embodiment, the plural frames 80 are obtained by performing the live-view image imaging based on the frame rate FR1. The plural frames 80 obtained by performing the live-view image imaging are controlled based on the transmittance TR1 of the electronic ND filter 58 and on the aperture drive time T1_{FV}. Accordingly, the brightness of the plural frames 80 obtained by performing the live-view image imaging can be held constant even while the aperture 40C is being driven.

In the imaging apparatus 10 according to the present seventh exemplary embodiment, the plural divisional exposures EX1_{div3} or the plural divisional exposures EX1_{div4} determined according to the relationship between the time needed to change the transmittance TR1 of the electronic ND filter 58 from the current transmittance TR1_{current} to the target transmittance TR1_{target} and the aperture drive time T1_{FV} (namely, exposures determined for the respective frames 80 such that the brightness of each of the frames 80 is constant) are applied for the respective exposures of the plural frames 80 obtained by performing live-view image imaging. Accordingly, the brightness of the plural frames 80 obtained by performing the live-view image imaging can be held constant regardless of whether the time needed to change from the current transmittance TR1_{current} to the target transmittance TR1_{target} falls within the aperture drive time T1_{FV} or not.

Moreover, in the imaging apparatus 10 according to the present seventh exemplary embodiment, the first control 1112 is performed in cases in which the time needed to change from the current transmittance TR1_{current} to the target transmittance TR1_{target} and also the aperture drive time T1_{FV} have both exceeded the threshold value TH21. As a result of the first control 1112 being performed, the time needed to change from the current transmittance TR1_{current} to the target transmittance TR1_{target} is controlled so that it falls within the aperture drive time T1_{FV}, the respective plural divisional exposures EX1_{div3}, which have been determined based on the time to realistically change from the current transmittance TR1_{current} to the target transmittance TR1_{target} (namely, the change time T31) and on the aperture drive time T1_{FV}, are applied to the exposures of the plural frames 80 obtained by performing the live-view image imaging. Accordingly, the brightness of the plural frames 80 obtained by performing the live-view image imaging can be held constant even if the time needed to change from the current transmittance TR1_{current} to the target transmittance TR1_{target}, as well as the aperture drive time T1_{FV}, exceed the threshold value TH21.

Moreover, in the imaging apparatus 10 according to the present seventh exemplary embodiment, the second control 1114 is performed in cases in which the time needed to change from the current transmittance TR1_{current} to the target transmittance TR1_{target} (namely, the change time T11) and/or the aperture drive time T1_{FV} is/are the threshold value TH21 or lower. By performing the second control 1114, each of the plural divisional exposures EX1_{div4}, which are determined based on the time needed to ideally change from the current transmittance TR1_{current} to the target transmittance TR1_{target} (namely, the change time T11) and on the aperture drive time T1_{FV}, is applied to each of the exposures of the plural frames 80 obtained by performing the live-view image imaging. Accordingly, the brightness of the plural frames 80 obtained by performing the live-view image imaging can be held constant even when the time needed to change from the current transmittance TR1_{current} to the target transmittance TR1_{target} and/or the aperture drive time T1_{FV} is/are the threshold value TH21 or lower.

Moreover, in the imaging apparatus 10 according to the present seventh exemplary embodiment, the plural divisional exposures EX1_{div3} are determined based on the greater from out of the needed frame number B31 and the needed frame number B41 (namely, the maximum frame number B1ₘₐₓ₁). The plural divisional exposures EX1_{div3} are accordingly applied for the exposures of more of the plural frames 80 than cases in which the plural divisional exposures EX1_{div3} are determined based on the lesser from out of the needed frame number B31 and the needed frame number B41, enabling the brightness of more of the plural frames 80 to be held constant. Note that the plural divisional exposures EX1_{div3} may be determined based on the average number of frames from the needed frame number B31 and the needed frame number B41, and in such cases the plural divisional exposures EX1_{div3} are also applied for the exposures of more of the plural frames 80 than cases in which the plural divisional exposures EX1_{div3} are determined based on the lesser from out of the needed frame number B31 and the needed frame number B41, enabling the brightness of more of the plural frames 80 to be held constant.

Moreover, in the imaging apparatus 10 according to the present seventh exemplary embodiment, the plural divisional exposures EX1_{div3} are determined based on the plural predicted transmittances TR1_{pred1}, the plural predicted aperture values FV1_{pred1}, the plural predicted sensitivities SE1_{pred1}, and the predicted shutter speeds SP1_{pred1}. Namely, the plural divisional exposures EX1_{div3} are applied for the exposures of the plural frames 80 by performing live-view image imaging after the plural predicted transmittances TR1_{pred1}, the plural predicted aperture values FV1_{pred1}, the plural predicted sensitivities SE1_{pred1}, and the predicted shutter speeds SP1_{pred1} have been set. This thereby enables the brightness to be held constant for the plural frames 80 obtained by performing live-view image imaging.

Moreover, in the imaging apparatus 10 according to the present seventh exemplary embodiment, in the first control 1112 for cases in which the time needed to change from the current transmittance TR1_{current} to the target transmittance TR1_{target} (namely, the change time T11) and also the aperture drive time T1_{FV} have exceeded the threshold value TH21, the in-drive-time transmittance TR1_{InTime2} is determined between the current transmittance TR1_{current} and the target transmittance TR1_{target}, and the plural predicted transmittances TR1_{pred1} are determined based on the current transmittance TR1_{current} and the in-drive-time transmittance TR1_{InTime2}. Moreover, the in-drive-time transmittance TR1_{InTime2} is contained in the plural predicted transmittances TR1_{pred1}. The plural predicted transmittances TR1_{pred1} determine the course of change from the current transmittance TR1_{current} to the target transmittance TR1_{target}. In this manner, due to the plural predicted transmittances TR1_{pred1} including the in-drive-time transmittance TR1_{InTime2} being present in the course of change from the current transmittance TR1_{current} to the target transmittance TR1_{target}, the change from the current transmittance TR1_{current} to the target transmittance TR1_{target} can be achieved earlier than with a monotonous change from the current transmittance TR1_{current} to the target transmittance TR1_{target}. Moreover, due to the plural predicted transmittances TR1_{pred1} being one of the exposure factors defining the plural divisional exposures EX1_{div3}, the plural divisional exposures EX1_{div3} to make the change time from the current transmittance TR1_{current} to the target transmittance TR1_{target} be within the aperture drive time T1_{FV} can be applied for the exposures of the plural frames 80 obtained by performing live-view image imaging.

Moreover, in the imaging apparatus 10 according to the present seventh exemplary embodiment, the plural divisional exposures EX1_{div4} are determined based on the greater of the frame rate B1 and the needed frame number B31 (namely, the maximum frame number B1ₘₐₓ₂). Thus the plural divisional exposures EX1_{div4} are applied to the exposures of larger number of the plural frames 80, compared to the case where they are determined based on the lesser of the frame rate B1 and the needed frame number B31. As a result, the brightness can be maintained more consistently across a larger number of frame 80. Alternatively, the plural divisional exposures EX1_{div4} may be determined based on the average number of frames derived from the frame rate B1 and the needed frame number B31. Even in this case, the plural divisional exposures EX1_{div4} are applied to the exposures of a larger number of frame 80, compared to the case where they are determined based on the lesser of the frame rate B1 and the needed frame number B31, and thus the brightness can be maintained more consistently for a greater number of frames 80.

Moreover, in the imaging apparatus 10 according to the present seventh exemplary embodiment, the plural divisional exposures EX1_{div4} are determined based on the plural predicted transmittances TR1_{pred2}, the plural predicted aperture values FV1_{pred2}, the plural predicted sensitivities SE1_{pred2}, and the predicted shutter speeds SP1_{pred2}. Namely, the plural divisional exposures EX1_{div4} are applied for the exposures of the plural frames 80 by live-view image imaging being performed after setting the plural predicted transmittances TR1_{pred2}, the plural predicted aperture values FV1_{pred2}, the plural predicted sensitivities SE1_{pred2}, and the predicted shutter speeds SP1_{pred2}. This thereby enables the brightness to be held constant for the plural frames 80 obtained by performing live-view image imaging.

In the imaging apparatus 10 according to the present seventh exemplary embodiment, in cases in which the change portion of the aperture value FV1 is not trackable with the electronic ND filter 58, the exposures of the plural frames 80 obtained by performing live-view image imaging in the aperture drive time T1_{FV} are determined by the plural sensitivities SE1 already adjusted with the plural sensitivity adjustment values Δ1a obtained based on the current transmittance TR1_{current} and the aperture drive time T1_{FV}, the target sensitivity SE1_{target}, the plural shutter speeds SP1 already adjusted with the plural shutter speed adjustment values Δ1b, the target shutter speed SP1_{target}, and the plural predicted aperture values FV1_{pred0}, and also by the current transmittance TR1_{current}. For example, in the aperture drive time T1_{FV}, live-view image imaging is performed by the imaging apparatus 10 with exposures that have employed the current transmittance TR1_{current}, the plural sensitivities SE1 already adjusted by the plural sensitivity adjustment values Δ1a, the target sensitivity SE1_{target}, the plural shutter speeds SP1 already adjusted by the plural shutter speed adjustment values Δ1b, the target shutter speed SP1_{target}, and the plural predicted aperture values FV1_{pred0}. The exposures of the plural frames 80 obtained by performing the live-view image imaging in the aperture drive time T1_{FV} are accordingly held constant.

Note that although in the present seventh exemplary embodiment an example is given is of an embodiment in which the plural predicted sensitivities SE1_{pred1} and the plural predicted shutter speeds SP1_{pred1} are calculated based on the plural divisional exposures EX1_{div3}, the plural predicted transmittances TR1_{pred1}, and the plural predicted aperture values FV1_{pred1}, this is merely an example, and a configuration may be adopted in which the plural predicted sensitivities SE1_{pred1} or the plural predicted shutter speeds SP1_{pred1} are calculated. For example, a configuration may be adopted in which the plural predicted shutter speeds SP1_{pred1} are calculated based on the plural divisional exposures EX1_{div3}, the plural predicted transmittances TR1_{pred1}, the plural predicted aperture values FV1_{pred1}, and the current sensitivity SE1_{current}, or a configuration may be adopted in which the plural predicted sensitivities SE1_{pred1} are calculated based on the plural divisional exposures EX1_{div3}, the plural predicted transmittances TR1_{pred1}, the plural predicted aperture values FV1_{pred1}, and the current shutter speed SP1_{current}. The same applies to the plural predicted sensitivities SE1_{pred2} and the plural predicted shutter speeds SP1_{pred2}.

### Eighth Exemplary Embodiment

Whereas in the present seventh exemplary embodiment the processing from step ST172 onward illustrated in FIG. 40E is executed when affirmative determination has been made at step ST148 illustrated in FIG. 40A (namely, in cases in which the change portion of the aperture value FV1 is trackable with the electronic ND filter 58), irrespective of the change portion of the aperture values FV1_{pred1}, for the eighth exemplary embodiment an example of an embodiment will be described in which the processing of step ST150 to step ST170 illustrated in FIG. 40D, or the processing of step ST172 onward illustrated in FIG. 40E, is selectively executed by the processor 64 depending on a condition of the change portion of the aperture value FV1.

Note that the same reference numerals are appended in the present eighth exemplary embodiment to configuration elements the same as those of the seventh exemplary embodiment, and explanation thereof will be omitted. Moreover, description follows regarding main differences in the present eighth exemplary embodiment to the seventh exemplary embodiment.

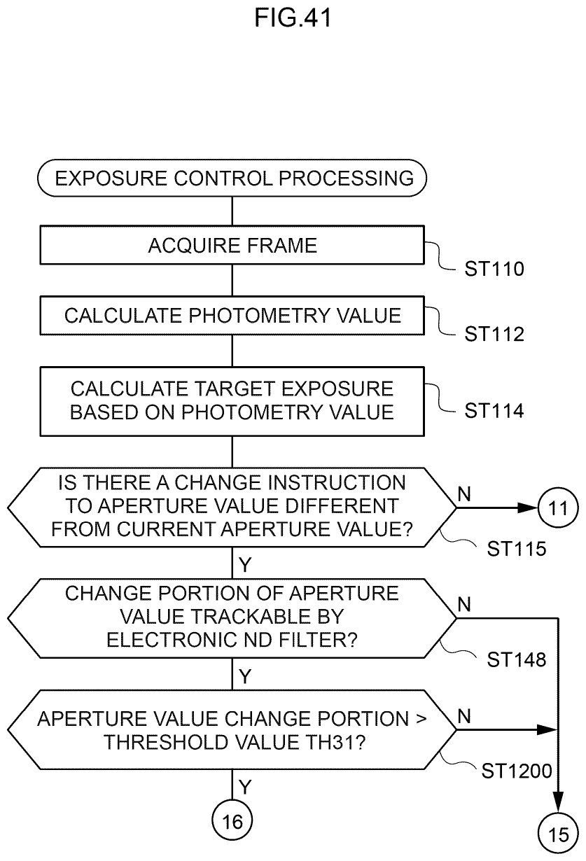

In the present eighth exemplary embodiment, description follows regarding an example of exposure control processing according to the present eighth exemplary embodiment, with reference to the flowchart in FIG. 41. However, the flowchart illustrated in FIG. 41 includes plural steps that are duplicates of the flowchart illustrated in FIG. 40A to FIG. 40G as described in the seventh exemplary embodiment, and so the same step numbers are appended below to any out of the plural steps contained in the flowchart illustrated in FIG. 41 that are the same as steps in the flowchart illustrated in FIG. 40A to FIG. 40G described in the seventh exemplary embodiment, and explanation thereof will be omitted.

The flowchart illustrated in FIG. 41 differs from the flowchart illustrated in FIG. 40A to FIG. 40G in the inclusion of step ST1200 between step ST148 and step ST172 (see FIG. 40E).

At step ST1200 included in the exposure control processing illustrated in FIG. 41, the processor 64 determines whether or not the change portion of the aperture value FV1 employed for determination at step ST148 has exceeded the threshold value TH31. An example of the threshold value TH31 is a value determined based on a period of time in which the transmittance of the electronic ND filter 58 is not able to be changed from the current transmittance TR1_{current} to the target transmittance TR1_{target} via the in-drive-time transmittance TR1_{InTime2}. An example of a value determined based on a period of time in which the transmittance of the electronic ND filter 58 is not able to be changed from the current transmittance TR1_{current} to the target transmittance TR1_{target} via the in-drive-time transmittance TR1_{InTime2} is an upper limit value of a period of time in which the transmittance of the electronic ND filter 58 is not able to be changed from the current transmittance TR1_{current} to the target transmittance TR1_{target} via the in-drive-time transmittance TR1_{InTime2}. An example of the threshold value TH31 is a value determined in advance by experimentation with test equipment and/or computer simulation or the like as an upper limit value to a period of time in which the transmittance of the electronic ND filter 58 is not able to be changed from the current transmittance TR1_{current} to the target transmittance TR1_{target} via the in-drive-time transmittance TR1_{InTime2}. The upper limit value to the period of time in which the transmittance of the electronic ND filter 58 is not able to be changed from the current transmittance TR1_{current} to the target transmittance TR1_{target} via the in-drive-time transmittance TR1_{InTime2} is merely an example, and the upper limit value may be a lower value within a permissible range. Moreover, the threshold value TH31 may be a fixed value, or may be a variable value changed according to a given instruction and/or various conditions. The threshold value TH31 may be a value decided by a user, and may be a value decided according to type of imaging mode.

Affirmative determination is made at step ST1200 when the change portion of the aperture value FV1 used in determination at step ST148 has exceeded the threshold value TH31, and the processing of step ST172 onward illustrated in FIG. 40E is executed by the processor 64. Negative determination is made at step ST1200 when the change portion of the aperture value FV1 used in determination at step ST148 has not exceeded the threshold value TH31 (namely, cases in which the change portion of the aperture value FV1 used in determination at step ST148 is the threshold value TH31 or lower), and the processing of step ST150 to step ST170 illustrated in FIG. 40D is executed by the processor 64. Note that in the present eighth exemplary embodiment, the threshold value TH31 is an example of a “first preset change amount” according to the present disclosure.

In cases in which the change portion of the aperture value FV1 used in determination at step ST148 has exceeded the threshold value TH31, determination is that the transmittance of the electronic ND filter 58 is able to be changed from the current transmittance TR1_{current} to the target transmittance TR1_{target} via the in-drive-time transmittance TR1_{InTime2}. In such cases the processing of step ST172 onward illustrated in FIG. 40E is executed by the processor 64.

In contrast thereto, in cases in which the change portion of the aperture value FV1 used in determination at step ST148 has not exceeded the threshold value TH31 (namely, cases in which the change portion of the aperture value FV1 used in determination at step ST148 is the threshold value TH31 or lower), determination is that the transmittance of the electronic ND filter 58 is not able to be changed from the current transmittance TR1_{current} to the target transmittance TR1_{target} via the in-drive-time transmittance TR1_{InTime2} (namely, that there are not a sufficient number of frames to set the in-drive-time transmittance TR1_{InTime2}). In such cases the processing of step ST150 to step ST170 illustrated in FIG. 40D is performed. The reason for this approach is that processing to set or to use the in-drive-time transmittance TR1_{InTime2} is not contained in the processing of step ST150 to step ST170 illustrated in FIG. 40D.

Adopting such an approach enables the exposures of the plural frames 80 obtained by performing the live-view image imaging in the aperture drive time T1_{FV} to be held constant in cases in which the change portion of the aperture value FV1 used in determination at step ST148 has exceeded the threshold value TH31, and also in cases in which the change portion of the aperture value FV1 used in determination at step ST148 has not exceeded the threshold value TH31.

### Ninth Exemplary Embodiment

In the seventh exemplary embodiment an example has been given of an embodiment in which there is a presumption that the change amount of the aperture value FV1 (namely, the change amount from the current aperture value FV1_{current} to the target aperture value FV1_{target}) is not changed while the exposures of the plural frames 80 obtained by performing live-view image imaging are being controlled (namely, while the exposure control processing is being performed). However, in the present ninth exemplary embodiment an example will be described of an embodiment in which the change amount of the aperture value FV1 is changed while the exposures of the plural frames 80 obtained by performing live-view image imaging are being controlled.

Note that the same reference numerals will be appended in the present ninth exemplary embodiment to configuration elements the same as those of the seventh exemplary embodiment, and explanation thereof will be omitted. Moreover, description follows regarding main differences in the present ninth exemplary embodiment to the seventh exemplary embodiment.

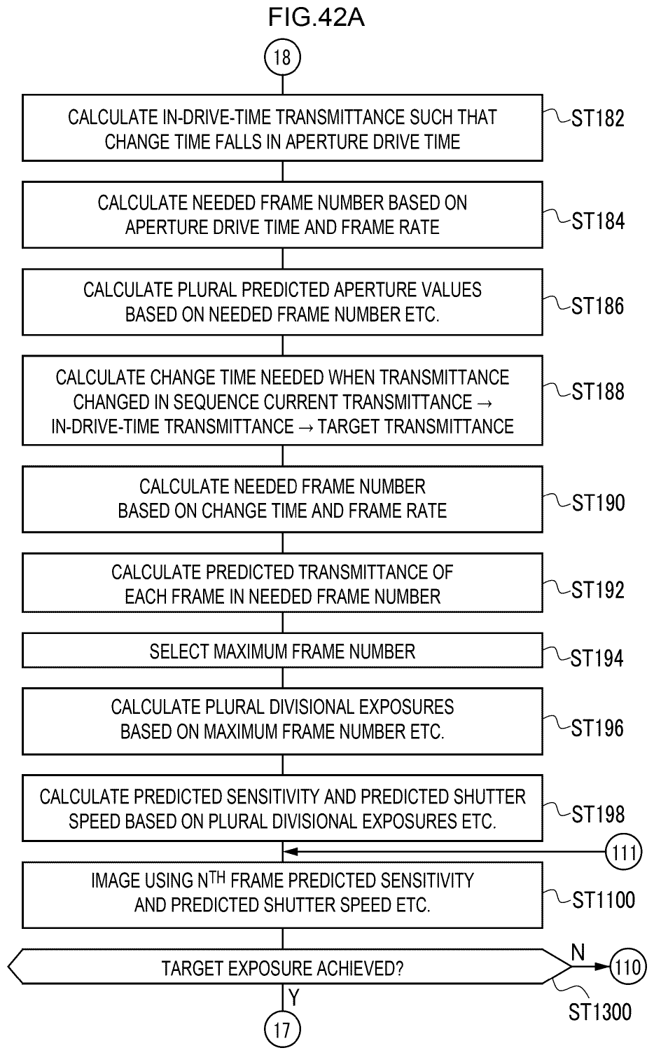

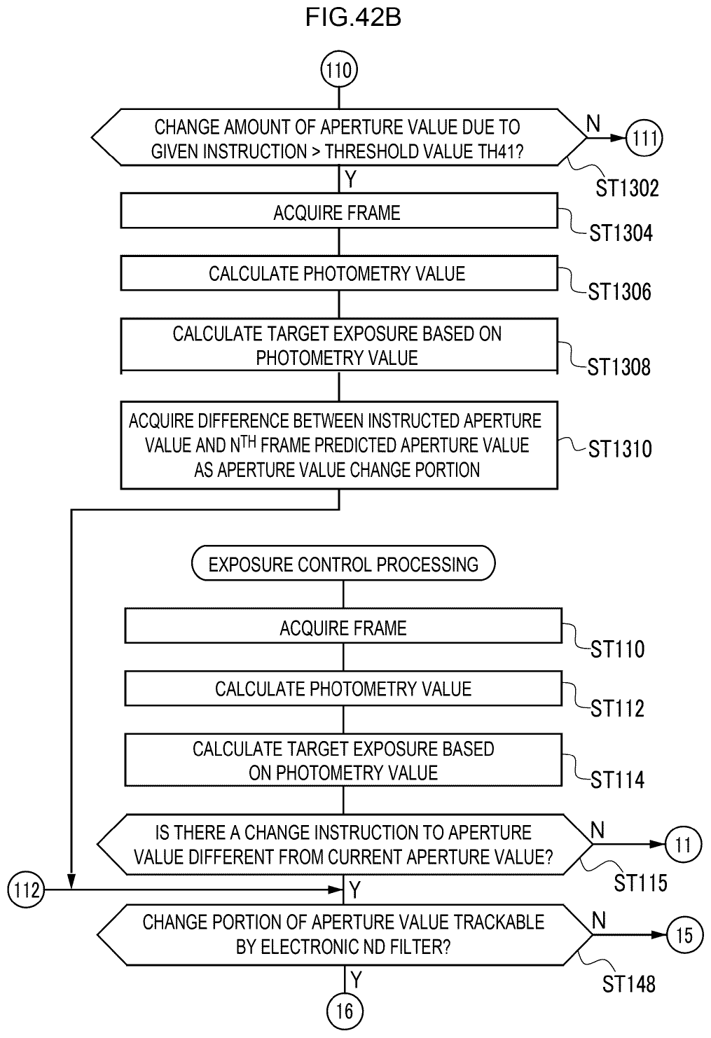

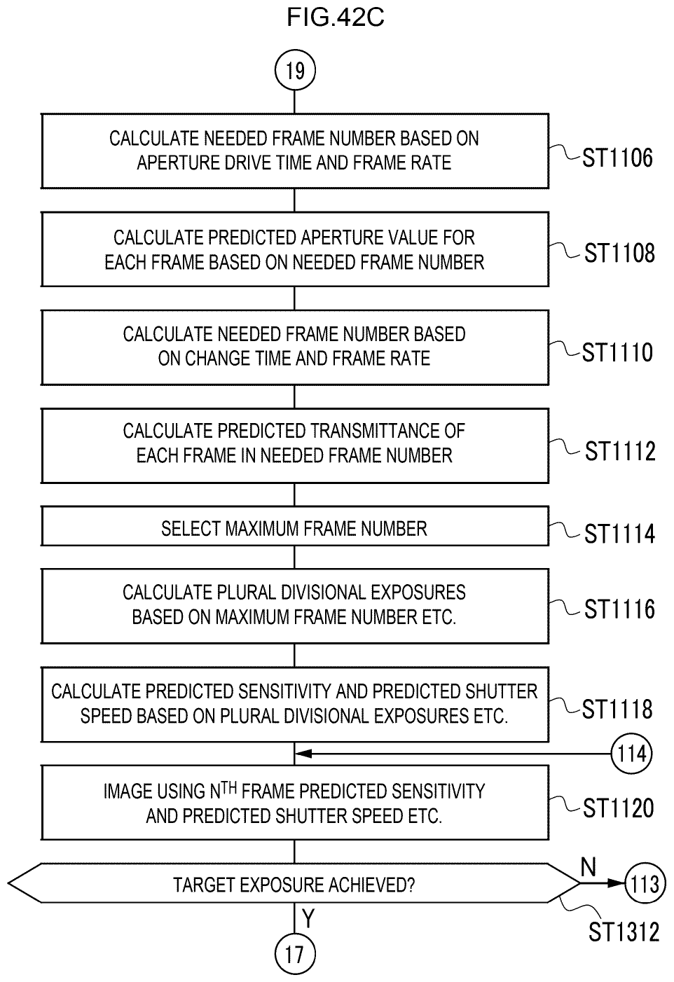

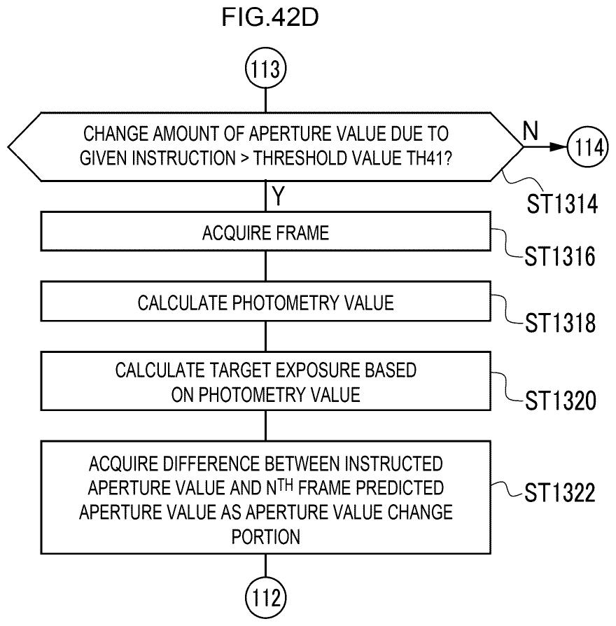

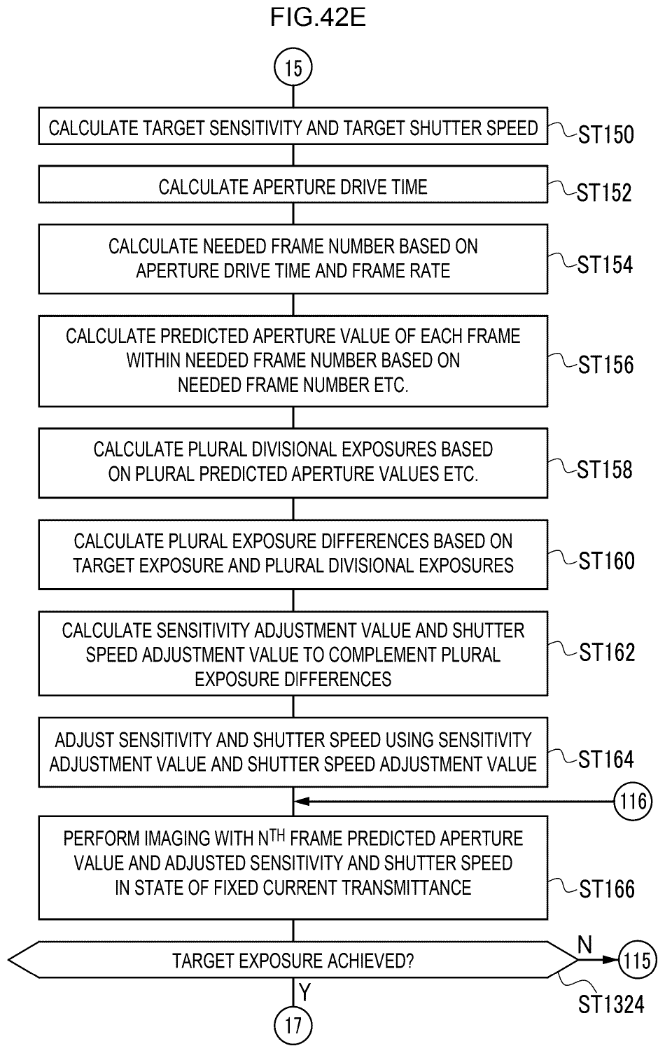

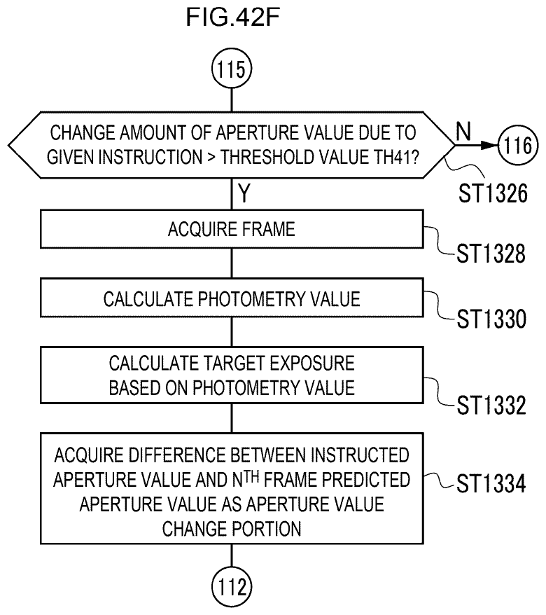

In the present ninth exemplary embodiment, description follows regarding an example of exposure control processing according to the present ninth exemplary embodiment, with reference to the flowchart illustrated in FIG. 42A to FIG. 42F. However, the flowchart illustrated in FIG. 42A to FIG. 42F contains plural steps that are duplicates of the flowchart illustrated in FIG. 40A to FIG. 40G as described in the seventh exemplary embodiment, and so the same step numbers are appended below to any out of the plural steps contained in the flowchart illustrated in FIG. 42A to FIG. 42F that are the same as steps in the flowchart illustrated in FIG. 40A to FIG. 40G described in the seventh exemplary embodiment, and explanation thereof will be omitted.

The flowchart illustrated in FIG. 42A to FIG. 42F differs from the flowchart illustrated in FIG. 40A to FIG. 40G in the inclusion of step ST1300 to step ST1310 (see FIG. 42A and FIG. 42B) instead of step ST1102 and step ST1104, in the inclusion of step ST1312 to step ST1322 (see FIG. 42C and FIG. 42D) instead of step ST1122 and step ST1124, and in the inclusion of step ST1324 to step ST1334 (see FIG. 42E and FIG. 42F) instead of step ST168 and step ST170.

At step ST1300 illustrated in FIG. 42A, the processor 64 determines whether or not the N^{th} frame exposure has attained the target exposure EX1_{target}. Negative determination is made at step ST1200 when the N^{th} frame exposure has not attained the target exposure EX1_{target}, and the exposure control processing transitions to step ST1302 illustrated in FIG. 42B. Affirmative determination is made at step ST1300 when the Nl frame exposure has attained the target exposure EX1_{target}, and the exposure control processing is ended.

At step ST1302 illustrated in FIG. 42B, the processor 64 determines whether or not the change amount of the aperture value FV1 has exceeded the threshold value TH41 due to an instruction to update the target aperture value FV1_{target} being given by a user. In the present ninth exemplary embodiment, the change amount of the aperture value FV1 means a change amount from the current aperture value FV1_{current} to the target aperture value FV1_{target}. In the present ninth exemplary embodiment, for ease of explanation, the following explanation is based on the premise that the change amount of the aperture value FV1 changes due to a new value, different from the target aperture value FV1_{target} as currently set, being specified by the user as a new target aperture value FV1_{target}.

The threshold value TH41 is a value based on a change amount of the aperture value FV1 such that a change of the brightness between frames 80 accompanying changing the change amount of the aperture value FV1 is not able to be visually noticed by the user. An example of a value based on a change amount of the aperture value FV1 such that the change of the brightness between frames 80 accompanying changing the change amount of the aperture value FV1 is not able to be visually noticed by the user is an upper limit value of a change amount of the aperture value FV1 such that the change of the brightness between frames 80 accompanying changing the change amount of the aperture value FV1 is not able to be visually noticed by the user. An example of the threshold value TH41 is a value determined in advance by experimentation with test equipment and/or computer simulation or the like as an upper limit value to the change amount of the aperture value FV1 such that the change of the brightness between frames 80 accompanying changing the change amount of the aperture value FV1 is not able to be visually noticed by the user. The upper limit value of the change amount of the aperture value FV1 such that the change of the brightness between frames 80 accompanying changing the change amount of the aperture value FV1 is not able to be visually noticed by the user is merely an example, and the upper limit value may be a lower value within a permissible range. The threshold value TH41 may be a fixed value, or may be a variable value changed according to a given instruction and/or various conditions. The threshold value TH41 may be a value decided by a user, and may be a value decided according to type of imaging mode.

Negative determination is made at step ST1302 when the change amount of the aperture value FV1 from instruction given by a user has not exceeded the threshold value TH41, and N is incremented by “1”. The exposure control processing transitions to step ST1100 illustrated in FIG. 42A. Affirmative determination is made at step ST1302 when the change amount of the aperture value FV1 from instruction given by a user has exceeded the threshold value TH41, and the exposure control processing transitions to step ST1304.

At step ST1304 to step ST1308, the processor 64 executes the same processing to the processing of step ST110 to step ST114 illustrated in FIG. 40A. The exposure control processing transitions to step ST1310 after the processing of step ST1308 has been executed.

At step ST1310, the processor 64 acquires a difference between a new target aperture value FV1_{target} instructed by the user (namely, an updated target aperture value FV1_{target}) and the N^{th} frame predicted aperture value FV1_{pred1}, as a change portion of the aperture value FV1. Although an example of difference is given here, any indicator indicating a disparity between the new target aperture value FV1_{target} instructed by the user and the N^{th} frame predicted aperture value FV1_{pred1} may be employed, and a proportion may be employed therefor. Note that the difference between the aperture value FV1_{target} instructed by the user and the N^{th} frame predicted aperture value FV1_{pred1} is an example of a “disparity between the aperture value prior to update and the aperture value post update” according to the present disclosure. The exposure control processing transitions to step ST148 after the processing of step ST1310 has been executed. In step ST148 onward, the change portion of the aperture value FV1 acquired at step ST1310 is used in a similar manner to use of the change portion of the aperture value FV as described in the seventh exemplary embodiment. For example, determination is made at step ST148 as to whether or not the change portion of the aperture value FV1 acquired at step ST1310 is trackable with the electronic ND filter 58.

In cases in which the change portion of the aperture value FV1 acquired at step ST1310 is not trackable with the electronic ND filter 58, the processing of step ST150 to step ST170 illustrated in FIG. 40D is executed by the processor 64, and so similarly to in the seventh exemplary embodiment, the exposures of the plural frames 80 obtained by live-view image imaging performed in the aperture drive time T1_{FV} are held constant. Moreover, in cases in which the change portion of the aperture value FV1 acquired at step ST1310 is trackable with the electronic ND filter 58, the processing of step ST172 onward illustrated in FIG. 40E is executed by the processor 64, and so similarly to in the seventh exemplary embodiment, either the divisional exposures EX1_{div1} are applied for the exposures of the respective frames 80 obtained in the maximum frame number B1ₘₐₓ₁, or the divisional exposures EX1_{div2} are applied for the exposures of the respective frames 80 obtained in the maximum frame number B1ₘₐₓ₂. The exposures of the plural frames 80 are accordingly held constant.

At step ST1312 illustrated in FIG. 42C, the processor 64 determines whether or not the N^{th} frame exposure has attained the target exposure EX1_{target}. Negative determination is made at step ST1312 in cases in which the N^{th} frame exposure has not attained the target exposure EX1_{target}, and the exposure control processing transitions to step ST1314 illustrated in FIG. 42D. Affirmative determination is made at step ST1312 in cases in which the N^{th} frame exposure has attained the target exposure EX1_{target}, and the exposure control processing is ended.

At step ST1314 illustrated in FIG. 42D, the processor 64 determines whether or not a change amount of the aperture value FV1 resulting from an instruction to update the target aperture value FV1_{target} being given by a user has exceeded the threshold value TH41. Negative determination is made at step ST1314 when the change amount of the aperture value FV1 resulting from an instruction given by a user has not exceeded the threshold value TH41, and N is incremented by “1”. The exposure control processing then transitions to step ST1120 illustrated in FIG. 42C.

Affirmative determination is made at step ST1314 when the change amount of the aperture value FV1 resulting from an instruction given by a user has exceeded the threshold value TH41, and the exposure control processing transitions to step ST1316.

At step ST1316 to step ST1320, the processor 64 executes the same processing as the processing of step ST110 to step ST114 illustrated in FIG. 40A. The exposure control processing transitions to step ST1322 after the processing of step ST1320 has been executed.

At step ST1322, the processor 64 acquires, as a change portion of the aperture value FV1, a difference between the new target aperture value FV1_{target} instructed by the user (namely, the updated target aperture value FV1_{target}) and the N^{th} frame predicted aperture value FV1_{pred2}. Although an example of difference is given here, any indicator indicating a disparity between the new target aperture value FV1_{target} instructed by the user and the N^{th} frame predicted aperture value FV1_{pred2} may be employed, and a proportion may be employed therefor. Note that the difference between the aperture value FV1_{target} instructed by the user and the N^{th} frame predicted aperture value FV1_{pred2} is an example of a “disparity between the aperture value prior to update and the aperture value post update” according to the present disclosure. The exposure control processing transitions to step ST148 (see FIG. 42B) after the processing of step ST1322 has been executed. From step ST148 onward, the change portion of the aperture value FV1 acquired at step ST1322 is used in a similar manner to how the change portion of the aperture value FV1 is used as described in the seventh exemplary embodiment. For example, at step ST148, determination is made as to whether or not the change portion of the aperture value FV1 acquired at step ST1322 is trackable with the electronic ND filter 58.

In cases in which the change portion of the aperture value FV1 acquired at step ST1322 is not trackable with the electronic ND filter 58, the processing of step ST150 to step ST170 illustrated in FIG. 40D is executed by the processor 64, and so similarly to in the seventh exemplary embodiment, the exposures of the plural frames 80 obtained by live-view image imaging in the aperture drive time T1_{FV} are accordingly maintained constant. Moreover, in cases in which the change portion of the aperture value FV1 acquired at step ST1322 is trackable with the electronic ND filter 58, the processing of step ST172 onward illustrated in FIG. 40E is executed by the processor 64, and so similarly to in the seventh exemplary embodiment, either the divisional exposures EX1_{div1} are applied for the respective exposures of the frames 80 obtained by performing live-view image imaging in the maximum frame number B1ₘₐₓ₁, or the divisional exposures EX1_{div2} are applied for the respective exposures of the plural frames 80 obtained by performing live-view image imaging in the maximum frame number B1ₘₐₓ₂. The exposures of the plural frames 80 are accordingly held constant.

At step ST1324 illustrated in FIG. 42E, the processor 64 determines whether or not the N^{th} frame exposure has attained the target exposure EX1_{target}. Negative determination is made at step ST1324 when the N^{th} frame exposure has not attained the target exposure EX1_{target}, and the exposure control processing transitions to step ST1326 illustrated in FIG. 42F. Affirmative determination is made at step ST1324 when the N^{th} frame exposure has attained the target exposure EX1_{target}, and the exposure control processing is ended.

At step ST1326 illustrated in FIG. 42F, the processor 64 determines whether or not the change amount of the aperture value FV1 resulting from an instruction given by a user to update the target aperture value FV1_{target} has exceeded the threshold value TH41. Negative determination is made at step ST1326 when the change amount of the aperture value FV1 resulting from an instruction given by the user has not exceeded the threshold value TH41, and N is incremented by “1”. The exposure control processing then transitions to step ST166 illustrated in FIG. 42E.

Affirmative determination is made at step ST1326 when the change amount of the aperture value FV1 resulting from an instruction given by the user has exceeded the threshold value TH41, and the exposure control processing transitions to step ST1328.

At step ST1328 to step ST1332, the processor 64 executes processing the same as the processing of step ST110 to step ST114 illustrated in FIG. 40A. The exposure control processing transitions to step ST1334 after the processing of step ST1332 has been executed.

At step ST1334, the processor 64 acquires, as a change portion of the aperture value FV1, a difference between the new target aperture value FV1_{target} instructed by the user (namely, the updated target aperture value FV1_{target}) and the N^{th} frame predicted aperture value FV1_{pred0}. Although an example of difference is given here, any indicator indicating a disparity between the new target aperture value FV1_{target} instructed by the user and the N^{th} frame predicted aperture value FV1_{pred0} may be employed, and a proportion may be employed therefor. Note that the difference between the aperture value FV1 instructed by the user and the N^{th} frame predicted aperture value FV1_{pred0} is an example of a “disparity between the aperture value prior to update and the aperture value post update” according to the present disclosure. The exposure control processing transitions to step ST148 after the processing of step ST1334 has been executed (see FIG. 42B). From step ST148 onward, the change portion of the aperture value FV1 acquired at step ST1334 is used in a similar manner to use of the change portion of the aperture value FV1 as described in the seventh exemplary embodiment. For example, at step ST148, determination is made as to whether or not the change portion of the aperture value FV1 acquired at step ST1334 is trackable with the electronic ND filter 58.

The processing of step ST150 to step ST170 illustrated in FIG. 40D is executed by the processor 64 in cases in which the change portion of the aperture value FV1 acquired at step ST1334 is not trackable with the electronic ND filter 58, and so similarly to in the seventh exemplary embodiment, the exposures of the plural frames 80 obtained by performing the live-view image imaging in the aperture drive time T1_{FV} are maintained constant. Moreover, the processing of step ST172 onward illustrated in FIG. 40E is performed by the processor 64 in cases in which the change portion of the aperture value FV1 acquired at step ST1334 is trackable with the electronic ND filter 58, and so similarly to in the seventh exemplary embodiment, either the divisional exposures EX1_{div1} are applied for the respective exposures of the frames 80 obtained in the maximum frame number B1ₘₐₓ₁, or the divisional exposures EX1_{div2} are applied for the respective exposures of the frames 80 obtained in the maximum frame number B1ₘₐₓ₂. The exposures of the plural frames 80 are accordingly maintained constant.

As described above, in the exposure control processing according to the present ninth exemplary embodiment, the change portion of the aperture value FV1 is acquired at step ST1310, step ST1322, or at step ST1334. Then at step ST148 the trackability of the transmittance TR1 of the electronic ND filter 58 is determined for the change portion of the aperture value FV1. The exposures of the plural frames 80 obtained by performing live-view image imaging are then updated by a method according to the determined trackability (for example, by the processing of step ST150 to step ST170 illustrated in FIG. 40D, or the processing of step ST172 onward illustrated in FIG. 40E). This accordingly means that the exposures of the plural frames 80 are maintained constant even if the change amount of the aperture value FV1 has exceeded the threshold value TH41 due to an instruction to update the target aperture value FV1_{target} being given by the user while the exposure control processing is being performed.

### Tenth Exemplary Embodiment

In the seventh exemplary embodiment an example has been given of an embodiment in which the plural divisional exposures EX1_{div3}, which have been determined irrespective of the degree of disparity between the target transmittance TR1_{target} and the in-drive-time transmittance TR1_{InTime2}, are applied as the exposures of the plural frames 80 obtained by performing the live-view image imaging. However because, for example, a fluctuation range of the exposure factors is greater the larger the difference between the target transmittance TR1_{target} and the in-drive-time transmittance TR1_{InTime2}, problems are liable to occur accompanying an increase in the fluctuation range of the exposure factors. For example, the fluctuation range during the plural predicted transmittances TR1_{pred1} is greater the larger the difference is between the target transmittance TR1_{target} and the in-drive-time transmittance TR1_{InTime2}. As a result, the fluctuations range of other exposure factors that complement the fluctuations among the plural predicted transmittances TR1_{pred1} also increase. For example, there is a possibility that noise generated accompanying fluctuations of the sensitivity SE1 becomes larger the greater the fluctuation range of the sensitivity SE1. Moreover, a larger physical load is imparted to the shutter as the fluctuation range of the shutter speed SP1 gets greater, and this might cause a reduction in shutter lifespan. Moreover, the voltage applied to the electronic ND filter 58 also gets larger as the fluctuation range of the transmittance TR1 of the electronic ND filter 58 gets greater, and this might cause a reduction in lifespan of the electronic ND filter 58. Description follows regarding an example of an embodiment in the present tenth exemplary embodiment in which control is performed to suppress the fluctuation range of exposure factors according to the disparity between the target transmittance TR1_{target} and the in-drive-time transmittance TR1_{InTime2}.

Note that the same reference numerals are appended in the present tenth exemplary embodiment to configuration elements the same as those of the seventh exemplary embodiment, and explanation thereof will be omitted. Moreover, description follows regarding main differences in the present tenth exemplary embodiment to the seventh exemplary embodiment.

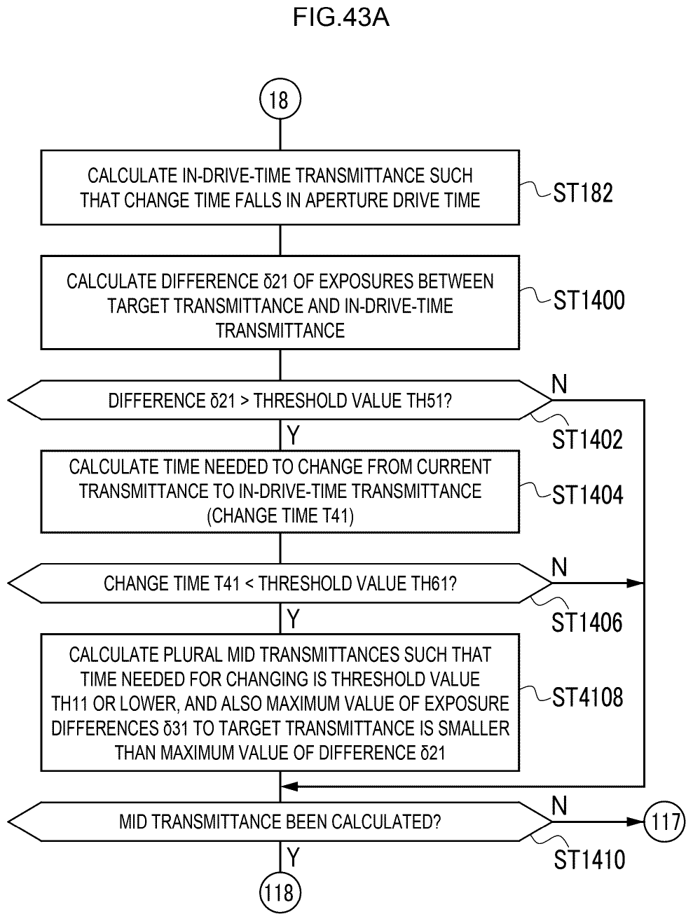

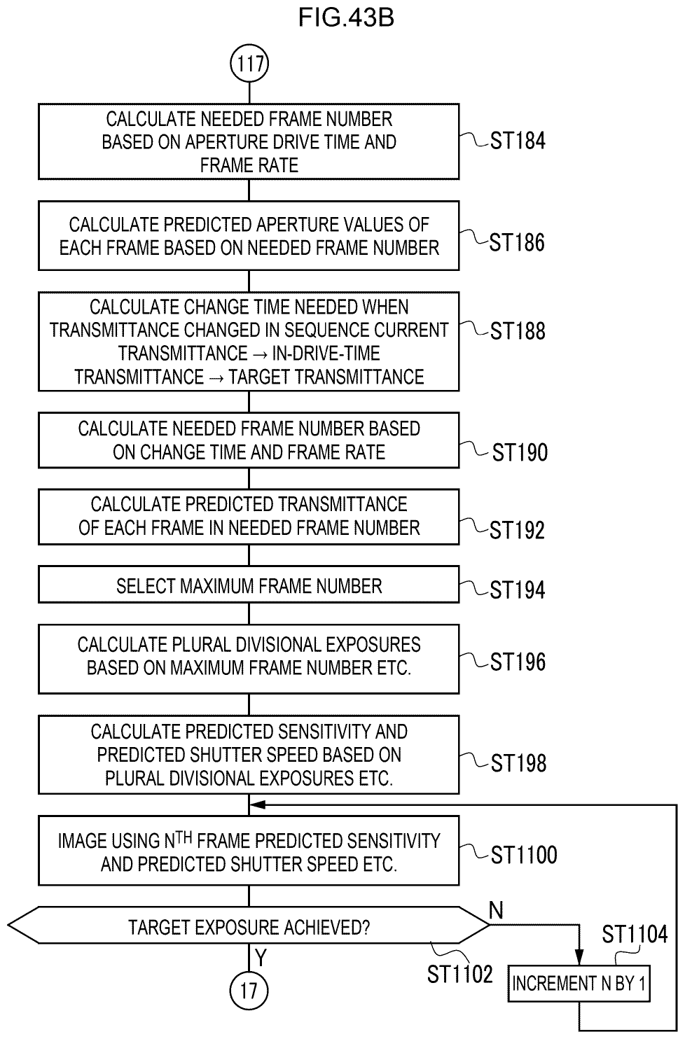

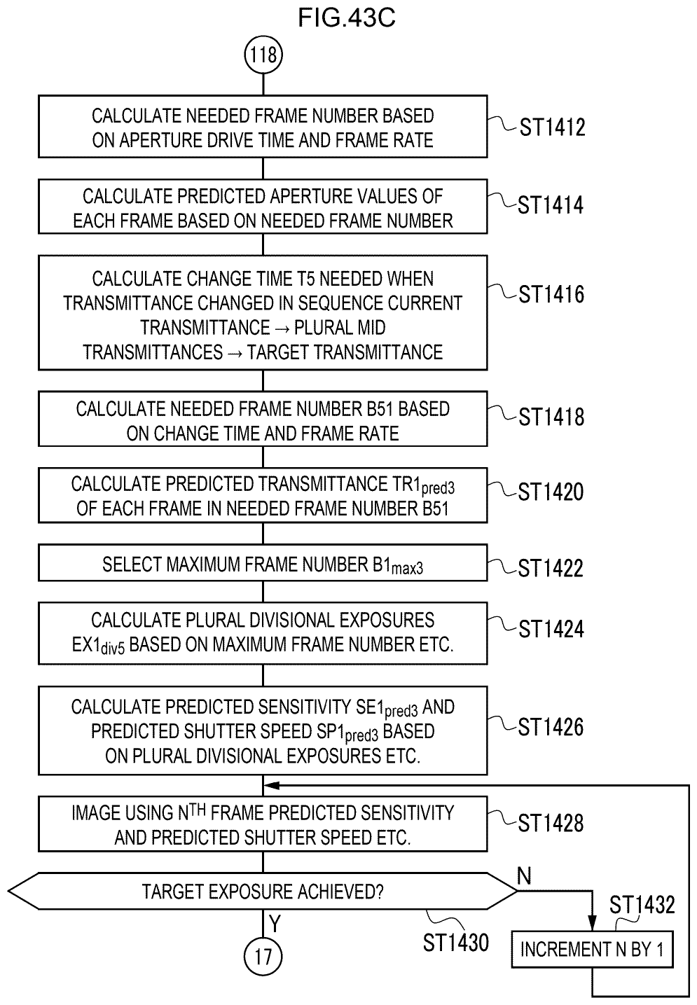

Description follows regarding an example in the present tenth exemplary embodiment of exposure control processing according to the present tenth exemplary embodiment, with reference to the flowchart illustrated in FIG. 43A to FIG. 43C. However, the flowchart illustrated in FIG. 43A to FIG. 43C includes plural steps that are duplicates of the flowchart illustrated in FIG. 40A to FIG. 40G as described in the seventh exemplary embodiment, and so the same step numbers are appended below to any out of the plural steps contained in the flowchart illustrated in FIG. 43A to FIG. 43C that are the same as steps in the flowchart illustrated in FIG. 40A to FIG. 40G described in the seventh exemplary embodiment, and explanation thereof will be omitted.

The flowchart illustrated in FIG. 43A to FIG. 43C differs from the flowchart illustrated in FIG. 40A to FIG. 40G in the inclusion of step ST1400 to step ST1410 between step ST182 and step ST184, and in the inclusion of step ST1412 to step ST1432.

At step ST1400, the processor 64 calculates a difference δ21, which is an absolute value of a difference in exposure between the target transmittance TR1_{target} and the in-drive-time transmittance TR1_{InTime2}. Although an example of the difference δ21 given here is of an example of the absolute value of the difference in exposure between the target transmittance TR1_{target} and the in-drive-time transmittance TR1_{InTime2}, an absolute value of a difference between the target transmittance TR1_{target} and the in-drive-time transmittance TR1_{InTime2} may be employed. The exposure control processing transitions to step ST1402 after the processing of step ST1400 has been executed.

Although difference δ21 has been given as an example, any indicator indicating a disparity between the target transmittance TR1_{target} and the in-drive-time transmittance TR1_{InTime2} may be employed, and a proportion of one out of the target transmittance TR1_{target} or the in-drive-time transmittance TR1_{InTime2} to the other thereof may be employed therefor.

At step ST1402, the processor 64 determines whether or not the difference δ21 has exceeded the threshold value TH51. In the present tenth exemplary embodiment, the difference δ21 is an example of a “first disparity” according to the present disclosure, and the threshold value TH61 is an example of a “preset disparity” according to the present disclosure.

The threshold value TH51 is a value determined based on the difference δ21 such that problems do not arise accompanying fluctuations in the exposure factors (for example, the sensitivity SE1, the shutter speed SP1, and/or the transmittance TR1). An example of a value determined based on the difference δ21 such that problems do not arise accompanying fluctuations in the exposure factors is an upper limit value of the difference δ21 such that problems do not arise accompanying fluctuations in the exposure factors. An example of the threshold value TH51 is a value determined in advance by experimentation with test equipment and/or computer simulation or the like as an upper limit value to the difference δ21 such that problems do not arise accompanying fluctuations in the exposure factors. The upper limit value of the difference δ21 such that problems do not arise accompanying fluctuations in the exposure factors is merely an example, and the upper limit value may be a lower value within a permissible range. The threshold value TH51 may be a fixed value, or may be a variable value changed according to a given instruction and/or various conditions. The threshold value TH51 may be a value decided by a user, and may be a value decided according to type of imaging mode.

Negative determination is made at step ST1402 when the difference δ21 does not exceed the threshold value TH51, and the exposure control processing transitions to step ST1410. Affirmative determination is made at step ST1402 when the difference δ21 has exceeded the threshold value TH51, and the exposure control processing transitions to step ST1404.

At step ST1404, the processor 64 calculates a change time T4, which is a time needed to change from the current transmittance TR1_{current} to the in-drive-time transmittance TR1_{InTime2}. The exposure control processing transitions to step ST1406 after the processing of step ST1404 has been executed.

At step ST1406, the processor 64 determines whether or not the change time T4 is less than a threshold value TH61. In the present tenth exemplary embodiment, the change time T4 is an example of a “transmittance change time” according to the present disclosure, and the threshold value TH61 is an example of an “eighth threshold value” and a “tenth threshold value” according to the present disclosure.

The threshold value TH61 is a value determined based on the change time T4 such that problems do not arise accompanying fluctuations of the exposure factors (for example, the sensitivity SE1, the shutter speed SP1, and/or the transmittance TR1) to change from the exposure realized by the current transmittance TR1_{current} to the exposure realized by the in-change-time transmittance TR1_{InTime1}. An example of a value determined based on the change time T4, such that problems do not arise accompanying fluctuations of the exposure factors to change from the exposure realized by the current transmittance TR1_{current} to the exposure realized by the in-change-time transmittance TR1InTime, is a lower limit value of the change time T4 such that problems do not arise accompanying fluctuations of the exposure factors to change from the exposure realized by the current transmittance TR1_{current} to the exposure realized by the in-change-time transmittance TR_{InTime1}. An example of threshold value TH61 is a value determined in advance by experimentation with test equipment and/or computer simulation or the like as the lower limit value of the change time T4 such that problems do not arise accompanying fluctuations of the exposure factors to change from the exposure realized by the current transmittance TR1_{current} to the exposure realized by the in-change-time transmittance TR1_{InTime1}. The lower limit value of the change time T4 such that problems do not arise accompanying fluctuations of the exposure factors to change from the exposure realized by the current transmittance TR1_{current} to the exposure realized by the in-change-time transmittance TR1_{InTime1} is merely an example, and the lower limit value may be a higher value within a permissible range. The threshold value TH61 may be a fixed value, or may be a variable value changed according to a given instruction and/or various conditions. The threshold value TH61 may be a value decided by a user, and may be a value decided according to type of imaging mode.

Negative determination is made at step ST1406 in cases in which the change time T4 is less than the threshold value TH61, and the exposure control processing transitions to step ST1410. Affirmative determination is made at step ST1406 when the change time T4 is less than the threshold value TH61, and the exposure control processing transitions to step ST1408.

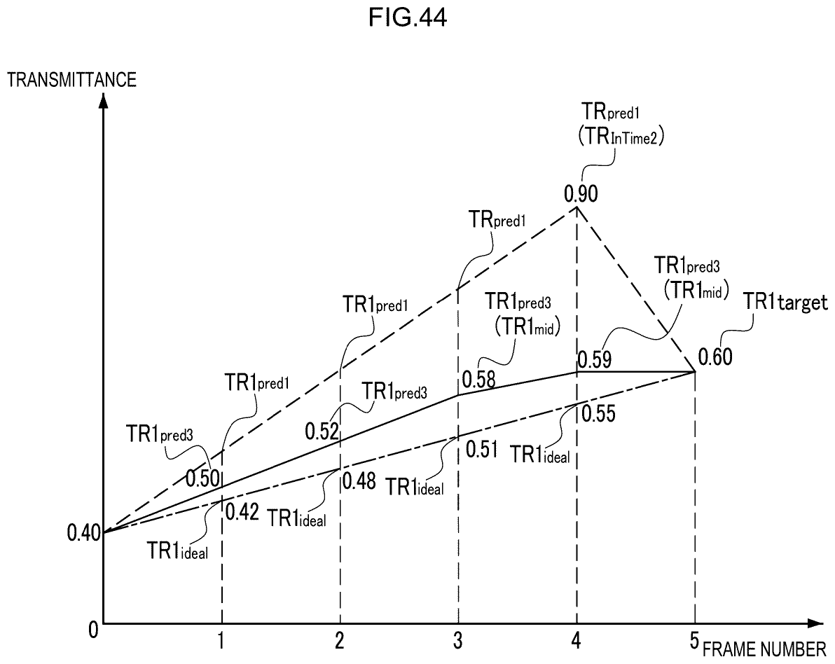

At step ST1408, the processor 64 updates the plural predicted transmittances TR1_{pred1} to the plural predicted transmittances TR1_{pred3} (see FIG. 44) by calculating plural mid transmittances TR1_{mid} (see FIG. 44). The plural predicted transmittances TR1_{pred3} are transmittances TR1 that specify the transition process from the current transmittance TR1_{current} to the target transmittance TR1_{target} via the plural mid transmittances TR1_{mid}, where the time required for the transition from TR1_{current} to TR1_{target} (namely, the change time T31) falls within the aperture drive time T1_{FV}, and these transmittances TR1 are determined accordingly. The plural predicted transmittances TR1_{pred3} are plural transmittances TR1 determined for the course of changing from the current transmittance TR1_{current} to the target transmittance TR1_{target} via the plural mid transmittances TR1_{mid} while a time to change from the current transmittance TR1_{current} to the target transmittance TR1_{target} (namely, the change time T31) falls within the aperture drive time T1_{FV}. The plural mid transmittances TR1_{mid} (two mid transmittances TR1_{mid} in the example illustrated in FIG. 44) are included in the plural predicted transmittances TR1_{pred3}. The plural mid transmittances TR1_{mid} are plural transmittances TR1 such that the time needed when the transmittance TR1 of the electronic ND filter 58 is changed from the current transmittance TR1_{current} to the target transmittance TR1_{target} via the plural mid transmittances TR1_{mid} is the threshold value TH11 or lower, and such that a maximum value of a difference δ31, which is an absolute value of a difference in exposure to the target transmittance TR1_{target}, is smaller than the difference δ21.

Note that although an example is given here of an absolute value of the differences in exposures between the mid transmittances TR1_{mid} and the target transmittance TR1_{target}, an absolute value of the differences between the mid transmittances TR1_{mid} and the target transmittance TR1_{target} may be employed. Moreover, instead of the absolute value of the difference in exposures between the mid transmittances TR1_{mid} and the target transmittance TR1_{target}, any indicator indicating a disparity between the mid transmittances TR1_{mid} and the target transmittance TR1_{target} may be employed, and a proportion of one out of the mid transmittance TR1_{mid} or the target transmittance TR1_{target} to other thereof may be employed therefor.

In the present tenth exemplary embodiment, the plural predicted transmittances TR1_{pred3} obtained by executing the processing of step ST1408 (see FIG. 44) are an example of “plural second realistic transmittances” according to the present disclosure and of “plural third realistic transmittances” according to the present disclosure. The maximum value of the difference δ31 is an example of a “maximum disparity, which is a largest disparity between the plural mid transmittances and the second transmittance” according to the present disclosure.

The exposure control processing transitions to step ST1410 after the processing of step ST1408 has been executed.

At step ST1410, the processor 64 determines whether or not a mid transmittance TR1_{mid} has been calculated at step ST1408. Negative determination is made at step ST1410 when a mid transmittance TR1_{mid} has not been calculated at step ST1408, the exposure control processing transitions to step ST184 illustrated in FIG. 43B, and the processing of step ST184 to step ST1104 is executed by the processor 64 (see FIG. 43B). However, affirmative determination is made at step ST1410 when a mid transmittance TR1_{mid} has been calculated at step ST1408, and the exposure control processing transitions to step ST1412 illustrated in FIG. 43C.

At step ST1412 and step ST1414 illustrated in FIG. 43C, the same processing to that of step ST184 to step ST186 (see FIG. 43B) is executed by the processor 64. The exposure control processing transitions to step ST1416 after the processing of step ST1414 has been executed.

At step ST1416, the processor 64 calculates a change time T5, which is a time needed when the transmittance TR1 of the electronic ND filter 58 is changed in sequence from the current transmittance TR1_{current}, to the plural predicted transmittances TR1_{pred3}, and to the target transmittance TR1_{target}. Calculation of the change time T5 is calculation using a computation equation having the current transmittance TR1_{current}, the plural predicted transmittances TR1_{pred3}, and the target transmittance TR1_{target} as independent variables, and having the change time T5 as a dependent variable. The exposure control processing transitions to step ST1418 after the processing of step ST1416 has been executed.

At step ST1418, the processor 64 calculates a needed frame number B51, which is a number of frames corresponding to the change time T5 based on the change time T5 and the frame rate FR1, namely, a number of frames needed for the course of the change time T5. For example, the needed frame number B51 is calculated by “(change time T5)×(frame rate FR1). The exposure control processing transitions to step ST1420 after the processing of step ST1418 has been executed.

Note that the needed frame number B51 in the present tenth exemplary embodiment is an example of a “fifth frame number” according to the present disclosure.

At step ST1420, based on the needed frame number B51, the target exposure EX1_{target}, the target aperture value FV1_{target}, the current aperture value FV1_{current}, the current transmittance TR1_{current}, the current sensitivity SE1_{current}, the current shutter speed SP1_{current}, and the plural predicted aperture values FV1_{pred3}, the processor 64 calculates plural predicted transmittances TR1_{pred3} (namely, a predicted transmittances TR1_{pred3} for each of the frames 80 obtained in the needed frame number B51). The exposure control processing transitions to step ST1422 after the processing of step ST1420 has been executed.

At step ST1422, the processor 64 selects the greater from out of the needed frame number B31 and the needed frame number B51 as the maximum frame number B1ₘₐₓ₃. The exposure control processing transitions to step ST1424 after the processing of step ST1422 has been executed.

At step ST1424, the processor 64 derives plural divisional exposures EX1_{div5} based on the maximum frame number B1max3 and the target exposure EX1_{target}. The plural divisional exposures EX1_{div5} are the same value as each other in order to hold constant the brightness of the plural frames 80 obtained by performing live-view image imaging. Namely, the processor 64 allocates exposures of the same value to the target exposure EX1_{target} as the divisional exposures EX1_{div5} for each of the frames 80 of the maximum frame number B1max3. In this manner, the plural divisional exposures EX1_{div5} are determined based on the maximum frame number B1max3 and the target exposure EX1_{target}.

Note that although an example is given here of the maximum frame number B1ₘₐₓ₃, an average value of the needed frame number B31 and the needed frame number B51 may be employed instead of the maximum frame number B1ₘₐₓ₃.

At the next step ST1426, the processor 64 calculates plural predicted sensitivities SE1_{pred3} and plural predicted shutter speeds SP1_{pred3} based on the plural divisional exposures EX1_{div5}, the plural predicted transmittances TR1_{pred3}, and the plural predicted aperture values FV1_{pred1}.

The divisional exposures EX1_{div5} are defined by plural exposure factors. The plural exposure factors defining the divisional exposures EX1_{div5} means the predicted transmittances TR1_{pred3}, the predicted aperture values FV1_{pred1}, the predicted sensitivities SE1_{pred1}, and the predicted shutter speeds SP1_{pred3}.

Each of the plural predicted sensitivities SE1_{pred3} calculated based on the plural divisional exposures EX1_{div5}, the plural predicted transmittances TR1_{pred3}, and the plural predicted aperture values FV1_{pred1} are values predicted for the sensitivity SE1 used for each of the frames 80 from the current aperture value FV1_{current} to the target aperture value FV1_{target}. The plural predicted shutter speeds SP1_{pred3} calculated based on the plural divisional exposures EX1_{div5}, the plural predicted transmittances TR1_{pred3}, and the plural predicted aperture values FV1_{pred1} are values predicted for the shutter speed SP1 used in each of the frames 80 obtained from the current aperture value FV1_{current} to the target aperture value FV1_{target}.

Calculation of the plural predicted sensitivities SE1_{pred3} and the plural predicted shutter speeds SP1_{pred3} is performed using a calculation equation having the plural divisional exposures EX1_{div5}, the plural predicted transmittances TR1_{pred3}, and the plural predicted aperture values FV1_{pred1} as independent variables, and having the plural predicted sensitivities SE1_{pred3} and the plural predicted shutter speeds SP1_{pred3} as dependent variables.

In this manner, the plural predicted sensitivities SE1_{pred3} and the plural predicted shutter speeds SP1_{pred3} are calculated based on the plural divisional exposures EX1_{div5}. The plural divisional exposures EX1_{div5} employed to calculate the plural predicted sensitivities SE1_{pred3} and the plural predicted shutter speeds SP1_{pred3} are calculated based on the target exposure EX1_{target}. Therefore, the plural predicted sensitivities SE1_{pred3} and the plural predicted shutter speeds SP1_{pred3} may also be referred to as exposure factors set on the imaging apparatus 10 to match the target exposure EX1_{target}.

At the next step ST1428, the processor 64 causes the imaging apparatus 10 to perform imaging with the exposures using the N^{th} frame predicted transmittance TR1_{pred3}, the N^{th} frame predicted aperture value FV1_{pred1}, the N^{th} frame predicted sensitivity SE1_{pred3}, and the N^{th} frame predicted shutter speed SP1_{pred3}. The exposure control processing transitions to step ST1430 after the processing of step ST1428 has been executed.

At step ST1430, the processor 64 determines whether or not the N^{th} frame exposure has attained the target exposure EX1_{target}. Negative determination is made at step ST1430 when the N^{th} frame exposure has not attained the target exposure EX1_{target}, and the exposure control processing transitions to step ST1432. At step ST1432 the processor 64 increments N by “1”. The exposure control processing transitions to step ST1428 after the processing of step ST1432 has been executed. Affirmative determination is made at step ST1430 when the N^{th} frame exposure has attained the target exposure EX1_{target}, and the exposure control processing is ended.

As described above, in the imaging apparatus 10 according to the present tenth exemplary embodiment, the plural divisional exposures EX1_{div5} are calculated based on the plural predicted transmittance TR1_{pred3} (namely, the plural predicted transmittances TR1_{pred3} including the plural mid transmittances TR1_{mid} illustrated in FIG. 44) having a smaller fluctuation range than the plural predicted transmittances TR1_{pred1} including the in-drive-time transmittance TR1_{InTime2}. The fluctuation range of the plural exposure factors defining the plural divisional exposures EX1_{div5} is smaller than the fluctuation range of the plural exposure factors defining the plural divisional exposures EX1_{div3}. This enables the suppression of problems arising accompanying fluctuations of the plural exposure factors (for example, an increase in noise caused by a large fluctuation range of the sensitivity SE1, or an increase in physical load on the shutter caused by a large fluctuation range of the shutter speed).

In the tenth exemplary embodiment, an example has been given of an embodiment in which the plural predicted sensitivities SE1_{pred3} and the plural predicted shutter speeds SP1_{pred3} are calculated based on the plural divisional exposures EX1_{div5}, the plural predicted transmittances TR1_{pred3}, and the plural predicted aperture values FV1_{pred1}, however this is merely an example, and the plural predicted sensitivities SE1_{pred3} or the plural predicted shutter speeds SP1_{pred3} may be calculated. For example, the plural predicted shutter speeds SP1_{pred3} may be calculated based on the plural divisional exposures EX1_{div5}, the plural predicted transmittances TR1_{pred3}, the plural predicted aperture values FV1_{pred1}, and the current sensitivity SE1_{current}, or the plural predicted sensitivities SE1_{pred3} may be calculated based on the plural divisional exposures EX1_{div5}, the plural predicted transmittances TR1_{pred3}, the plural predicted aperture values FV1_{pred1}, and the current shutter speed SP1_{current}.

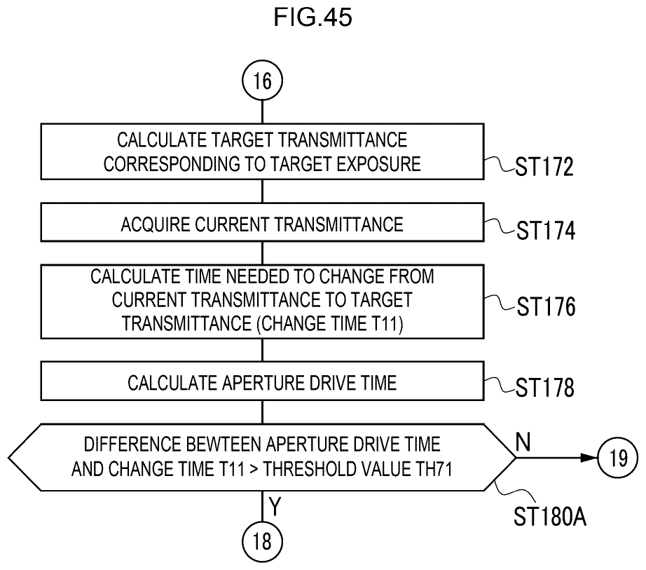

In the seventh to the tenth exemplary embodiments examples has been given of embodiments in which determination is performed at step ST180 included in the exposure control processing as to whether or not the aperture drive time T1_{FV} and the change time T11 have both exceeded the threshold value TH21, however this is merely an example. For example, as illustrated in FIG. 45, the processing of step ST180A may be executed instead of the processing of step ST180. At step ST180A, determination is made as to whether or not a difference between the aperture drive time T1_{FV} and the change time T11 has exceeded a threshold value TH71. An example of the threshold value TH71 is an ideal difference between the time needed to change from the current transmittance TR1_{current} to the target transmittance TR1_{target}, and the aperture drive time T1_{FV}. The threshold value TH71 may be a fixed value, or may be a variable value changed according to a given instruction and/or various conditions.

Affirmative determination is made at step ST180A when the difference between the aperture drive time T1_{FV} and the change time T11 has exceeded the threshold value TH71, and the exposure control processing transitions to step ST182 illustrated in FIG. 40F. Negative determination is made at step ST180A when the difference between the aperture drive time T1_{FV} and the change time T11 has not exceeded the threshold value TH71, and the exposure control processing transitions to step ST1106 illustrated in FIG. 40G. Note that the difference between the aperture drive time T1_{FV} and the change time T11 is an example of a “disparity between a change time and a drive time”, and the threshold value TH71 is an example of a “second threshold value”, a “fourth threshold value”, a “sixth threshold value”, and a “ninth threshold value” according to the present disclosure.

Moreover, although an example of a difference between the aperture drive time T1_{FV} and the change time T11 has been given, a proportion of one from out of the aperture drive time T1_{FV} or the change time T11 to the other thereof may be employed, and an indicator indicating a disparity between the aperture drive time T1_{FV} and the change time T11 may be employed.

Although in the seventh to the tenth exemplary embodiments examples have been given of a time needed to change the transmittance TR1 of the electronic ND filter 58, namely, the change time (for example, the change time T11, T2, T3, T4, or T5), a number of frames may be employed as the change time. Namely, the concept of change time may include a frame number.

Although in the seventh to the tenth exemplary embodiments examples have been given of various maximum values (maximum value of difference δ11, maximum value of difference δ31, and the like), each of the above maximum values given above means a maximum value within a predetermined range.

Although in the seventh to the tenth exemplary embodiments examples have been given of monotonous change, monotonous change means, for example, a linear change, an exponential function change, or the like. Moreover, examples of monotonous change include a monotonous increase and a monotonous decrease.

Although in the seventh to the tenth exemplary embodiments examples have been given of exposure control processing when live-view image imaging is performed, the present disclosure is not limited thereto, and the exposure control processing described above is applicable, for example, to cases in which continuous imaging is performed, such as cases of recording imaging of video images being performed, cases of rapid shooting with a constant imaging interval being performed, or cases of rapid shooting with different imaging intervals being performed.

Although in the seventh to the tenth exemplary embodiments examples of embodiments have been described in which the exposure control processing program PG1 is stored on the storage 66, the present disclosure is not limited thereto. For example, the exposure control processing program PG1 may be stored on a portable, computer-readable, non-transitory storage medium such as an SSD or USB memory. The exposure control processing program PG1 stored on the non-transitory storage medium may be installed to the system controller 12 of the imaging apparatus 10. The processor 64 executes the exposure control processing according to the exposure control processing program PG1.

Moreover, the exposure control processing program PG1 may be stored on a storage device of another computer, server device, or the like connected to the imaging apparatus 10 over a network, with the exposure control processing program PG1 then downloaded on request from the imaging apparatus 10 so as to be installed on the system controller 12.

Note that the entire exposure control processing program PG1 is not necessarily stored on the storage device such as another computer, server device, or the like connected to the imaging apparatus 10 or on the storage 66, and part of the exposure control processing program PG1 may be stored thereon.

Although the system controller 12 is built into the imaging apparatus 10 illustrated in FIG. 1 and FIG. 2, the present disclosure is not limited thereto and, for example, the system controller 12 may be provided externally to the imaging apparatus 10.

Although the seventh to the tenth exemplary embodiments examples are illustrated with the system controller 12, the present disclosure is not limited thereto, and the present disclosure may be applied to a device including an ASIC, FPGA, and/or a PLD instead of the system controller 12. Instead of the system controller 12, a combination of a hardware configuration and a software configuration may be employed.

The following types of processors may be employed as the hardware resource for executing the exposure control processing described in the seventh to the tenth exemplary embodiments. Examples of processors include a CPU, which is a general-purpose processor that functions as the hardware resource for executing the exposure control processing according to the seventh to the tenth exemplary embodiments by, for example, executing software, namely a program. Examples of processors also include a custom electrical circuit, which is an example of a processor including a circuit configuration with a customized design for executing specific processing, such as, for example, an FPGA, PLD, or ASIC. Such processors may also have in-built or connected memory, with the processors executing the exposure control processing according to the seventh to the tenth exemplary embodiments using the memory.

The hardware resource for executing the exposure control processing according to the seventh to the tenth exemplary embodiments may be configured from a single type out of these various processor types, or may be configured by combining two or more processors of the same or different types (for example, by combining plural FPGAs or combining a CPU with an FPGA). The hardware resource for executing the exposure control processing according to the seventh to the tenth exemplary embodiments may also be a single processor.

Examples of configurations of a single processor include, firstly, a configuration of a single processor resulting from combining one or more CPU and software, in an embodiment in which this processor functions as a hardware resource for executing the exposure control processing according to the seventh to the tenth exemplary embodiments. Secondly, as typified by a SoC or the like, there is also an embodiment that uses a processor realized by a single IC chip to function as an overall system including plural hardware resources for executing the exposure control processing according to the seventh to the tenth exemplary embodiments. Adopting such an approach means that the exposure control processing according to the seventh to the tenth exemplary embodiments is realized using one or more of the various processors described above as hardware resource.

Furthermore, more specifically an electrical circuit that combines circuit elements such as semiconductor elements or the like may be employed as a hardware structure of these various processors. The exposure control processing according to the seventh to the tenth exemplary embodiments are merely examples thereof. This means that obviously redundant steps may be omitted, new steps may be added, and the processing sequence may be swapped around within a range not departing from the spirit of the present disclosure.

### Eleventh Exemplary Embodiment

Switching from one to the other from out of the in-use state and the non-use state is started based on an instruction given to the imaging apparatus 10 by a user, and/or various conditions and the like. When switching from one to the other from out of the in-use state and the non-use state, a plural number of frames worth of time is needed from switching start to switching finish. For example, in cases in which the state is switched from the non-use state to the in-use state, the area where the electronic ND filter 58 overlaps with the effective pixel region of the photoelectric conversion element 72 gradually changes while the switching is in progress. Specifically, the overlapping area gradually expands. On the other hand, in cases in which the state is switched from the in-use state to the non-use state, the area where the electronic ND filter 58 overlaps with the effective pixel region of the photoelectric conversion element 72 gradually changes while the switching is in progress. Specifically, the overlapping area gradually contracts.

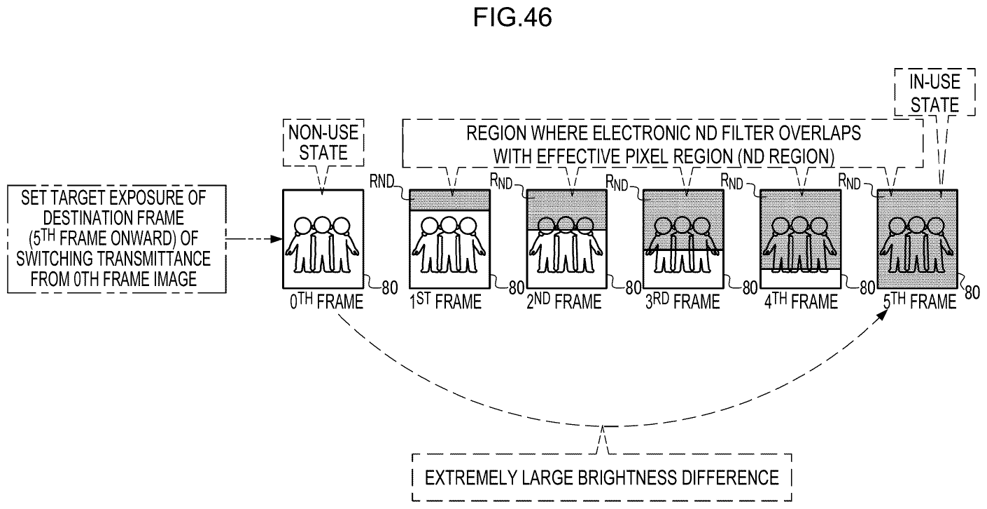

For example, as illustrated in FIG. 46, say that the plural frames 80 obtained by performing live-view image imaging are plural frames 80 including from a 0^{th} frame of the frames 80 to a 5^{th} frame of the frames 80, then in cases of a switch from a non-use state to an in-use state between the 0^{th} frame of the frames 80 to the 5^{th} frame of the frames 80, then in the course of changing from the 0^{th} frame of the frames 80 to the 5^{th} frame of the frames 80, a width of an ND region R_{ND}, which is the region where the electronic ND filter 58 overlaps with the effective pixel region of the photoelectric conversion element 72 (in other words, the range where the electronic ND filter 58 imparts an effect to the frames 80), is changed so as to gradually widen. Accompanying this, the brightness of the frames 80 overall changes between the frames 80. In such cases, a difference between the brightness of 0^{th} frame of the frames 80 and the brightness of the 5^{th} frame of the frames 80 becomes extremely large (for example, a number of times (for example, about twice) the brightness in frame 80 unit. In the example illustrated in FIG. 46, when the difference between the brightness of the 0^{th} frame of the frames 80 and the brightness of the 5^{th} frame of the frames 80 is extremely large, there is a concern regarding this imparting a visually unsettling feeling to the user, a worsening of the appearance of the plural frames 80, and the like. Similar to this can be said of cases in which there is a switch from the in-use state to the non-use state.

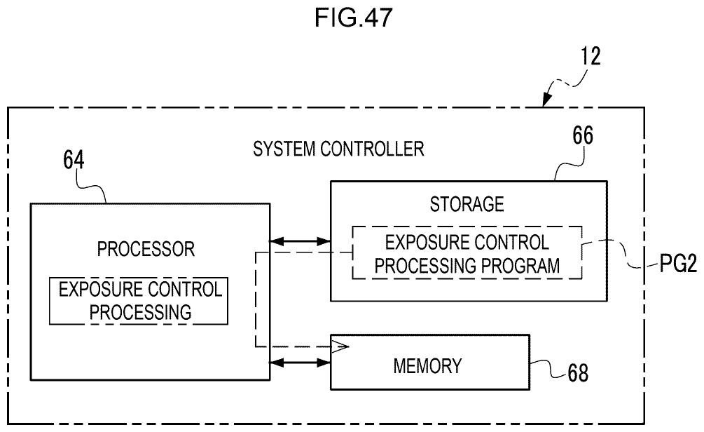

In consideration of the above circumstances, in the present eleventh exemplary embodiment, exposure control processing is performed by the processor 64 as illustrated as an example in FIG. 47. An exposure control processing program PG2 is stored in the storage 66. The exposure control processing program PG2 is an example of a “program” according to the present disclosure. The processor 64 reads the exposure control processing program PG2 from the storage 66, and executes the read exposure control processing program PG2 using the memory 68. The exposure control processing is realized by the processor 64 executing the exposure control processing program PG2. Description follows regarding an example of the exposure control processing.

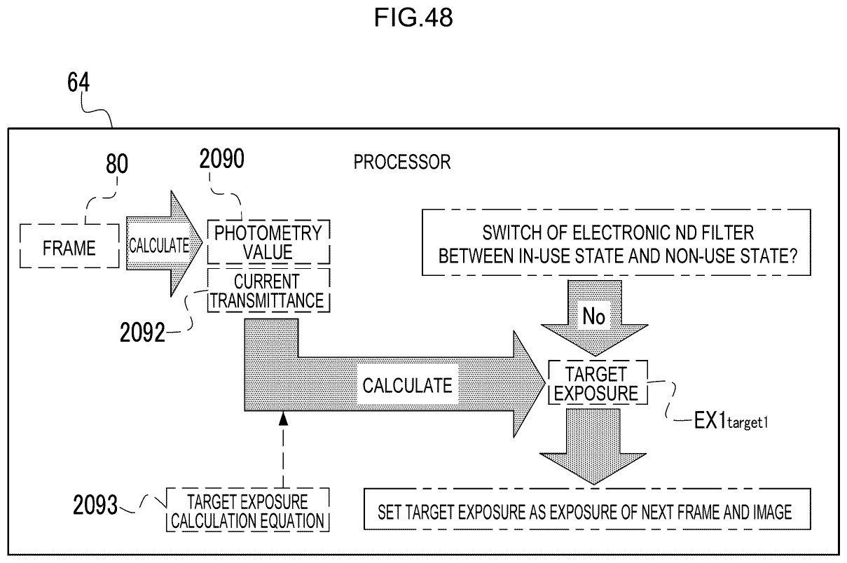

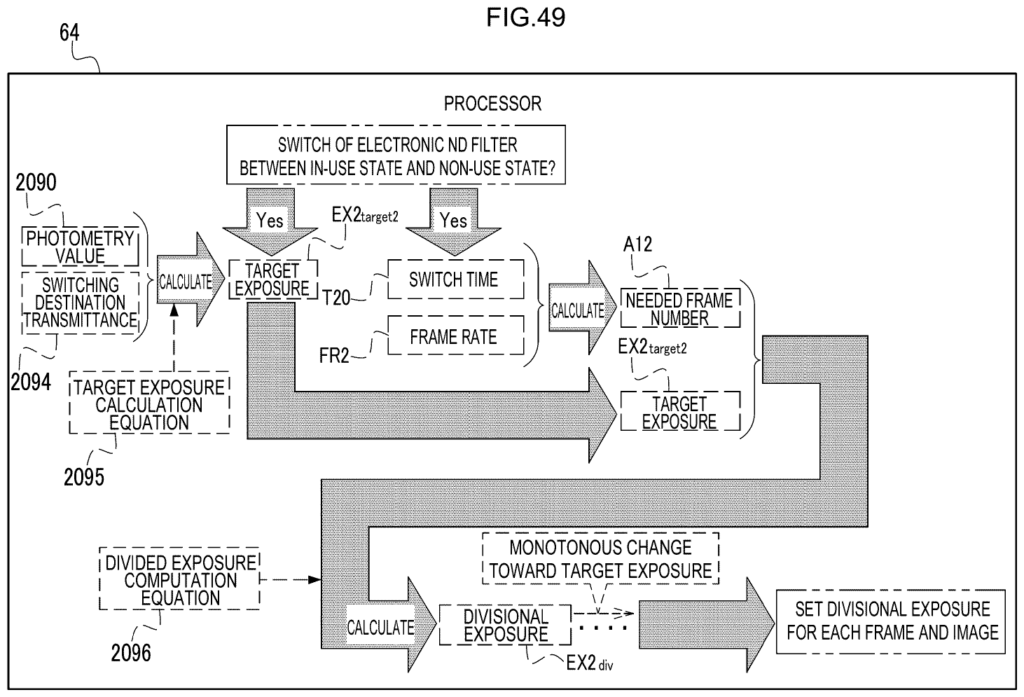

FIG. 48 and FIG. 49 illustrate an example of content of the exposure control processing performed by the processor 64. Firstly, as illustrated in the example in FIG. 48, when an exposure calculation start timing has arrived, the processor 64 computes a photometry value 2090 indicating an imaging subject brightness based on the frames 80 obtained by live-view image imaging. Note that the photometry value 2090 may be measured by an exposure meter (omitted in the drawings).

Moreover, the processor 64 determines whether or not an action to switch from one to the other out of the in-use state or the non-use state has started. In cases in which the action to switch from one to the other out of the in-use state or the non-use state has not started (namely, switching from one to the other out of the in-use state or the non-use state is not being performed), the processor 64 acquires a target exposure EX2_{target1} according to the photometry value 2090. The target exposure EX2_{target1} means an exposure as a target of the next frame (in other words, an exposure set on the imaging apparatus 10 as an appropriate exposure for use in the next frame). The target exposure EX2_{target1} is calculated based on the photometry value 2090, and the current transmittance 2092, which is a current transmittance of the electronic ND filter 58 or the clear glass 60 inserted into the optical path at the current point in time. The calculation of the target exposure EX2_{target1} is performed using a target exposure calculation equation 2093. The target exposure calculation equation 2093 is a computation equation having the photometry value 2090 and the current transmittance 2092 as independent variables, and having the target exposure EX2_{target1} as a dependent variable.

The processor 64 causes the imaging apparatus 10 to perform the next frame imaging after the target exposure EX2_{target1} has been set as the next frame exposure on the imaging apparatus 10.

On the other hand, as illustrated in the example of FIG. 49, in cases in which an action to switch from one to the other from out of the in-use state and the non-use state has started, the processor 64 acquires a target exposure EX2_{target2}, which is an appropriate exposure for setting on the imaging apparatus 10 after switching from one to the other from out of the in-use state and the non-use state. For example, the target exposure EX2_{target2} is calculated based on the photometry value 2090, and the transmittance of the switching destination (in other words, the transmittance after switch from one to the other from out of the in-use state and the non-use state), namely, a switching destination transmittance 2094 that is the transmittance of the electronic ND filter 58 or the clear glass 60 inserted into the optical path at the point in time when the switching from one to the other from out of the in-use state and the non-use state has been completed. The calculation of the target exposure EX2_{target2} is performed using a target exposure calculation equation 2095. The target exposure calculation equation 2095 is a calculation equation having the photometry value 2090 and the switching destination transmittance 2094 as independent variables, and having the target exposure EX2_{target2} as a dependent variable.

Moreover, in cases in which an action to switch from one to the other from out of the in-use state and the non-use state has started, the processor 64 acquires a switching time T20, which is a time needed to switch from one to the other from out of the in-use state and the non-use state. The switching time T20 is measured in advance by experimentation with test equipment. For example, the measured switching time T20 is stored in a predetermined storage area (for example, storage 66), and is acquired from the predetermined storage area by the processor 64.

Based on the switching time T20 and the frame rate FR2 (for example, the frame rate corresponding to the frame rate described above), the processor 64 calculates a needed frame number A12, which is a frame number equivalent to the switching time T20, namely, a frame number obtained in the switching time T20 (namely, a number of frames of the plural frames 80 obtained by performing live-view image imaging in the switching time T20). The needed frame number A12 is calculated by “(switching time T20)×(frame rate FR2)”.

Based on the needed frame number A12 and the target exposure EX2_{target2}, the processor 64 calculates plural divisional exposures EX2_{div} to monotonously change from the exposure currently set on the imaging apparatus 10 (hereafter referred to as the “current exposure”) toward the target exposure EX2_{target2}. The calculation of the plural divisional exposures EX2_{div} is performed using a divisional exposure computation equation 2096. The divisional exposure computation equation 2096 is a calculation equation having the current exposure, the needed frame number A12, and the target exposure EX2_{target2} as independent variables, and having the plural divisional exposures EX2_{div} as dependent variables.

The plural divisional exposures EX2_{div} are plural exposures to monotonously change from the current exposure toward the target exposure EX2_{target2}. The plural divisional exposures EX2_{div} are plural exposures applied for the exposures of the plural frames 80 obtained by performing live-view image imaging in the switching time T20, and monotonously change is sequentially applied for the exposures of the plural frames 80 obtained by performing live-view image imaging in the switching time T20. Monotonously change means, for example, linear change. Note that linear change is merely an example, and monotonously change may be by exponential function change or the like.

The respective plural divisional exposures EX2_{div} are defined by the shutter speed (for example, the shutter speed of a mechanical shutter when a mechanical shutter is employed, or the shutter speed of an electronic shutter when an electronic shutter is employed), the aperture value (namely, the F number) of the aperture 40C, and the sensitivity of the photoelectric conversion element 72 (for example, the ISO sensitivity). This means that monotonous change of the plural divisional exposures EX2_{div} toward the target exposure EX2_{target2} is implemented by controlling the shutter speed, the aperture value of the aperture 40C (hereinafter simply referred to as “aperture value”), and/or the sensitivity of the photoelectric conversion element 72 (hereinafter simply referred to as “sensitivity”).

The processor 64 causes the imaging apparatus 10 to perform imaging after the corresponding divisional exposures EX2_{div} have been set on the imaging apparatus 10 for each single frame such that the exposures of the plural frames 80 obtained by performing live-view image imaging in the switching time T20 are the plural divisional exposures EX2_{div}. The exposures of the plural frames 80 obtained by performing live-view image imaging in the switching time T20 are accordingly changed monotonously toward the target exposure EX2_{target2}.

Note that in the present eleventh exemplary embodiment, the switching time T20 is an example of a “switching time” according to the present disclosure, the frame rate FR2 is an example of a “preset frame rate” according to the present disclosure, the needed frame number A12 is an example of a “first frame number” according to the present disclosure, the target exposure EX2_{target2} is an example of a “target exposure” according to the present disclosure, the plural frames 80 obtained by performing live-view image imaging are an example of “plural frames” according to the present disclosure, and the plural divisional exposures EX2_{div} are an example of “plural divisional exposures” according to the present disclosure.

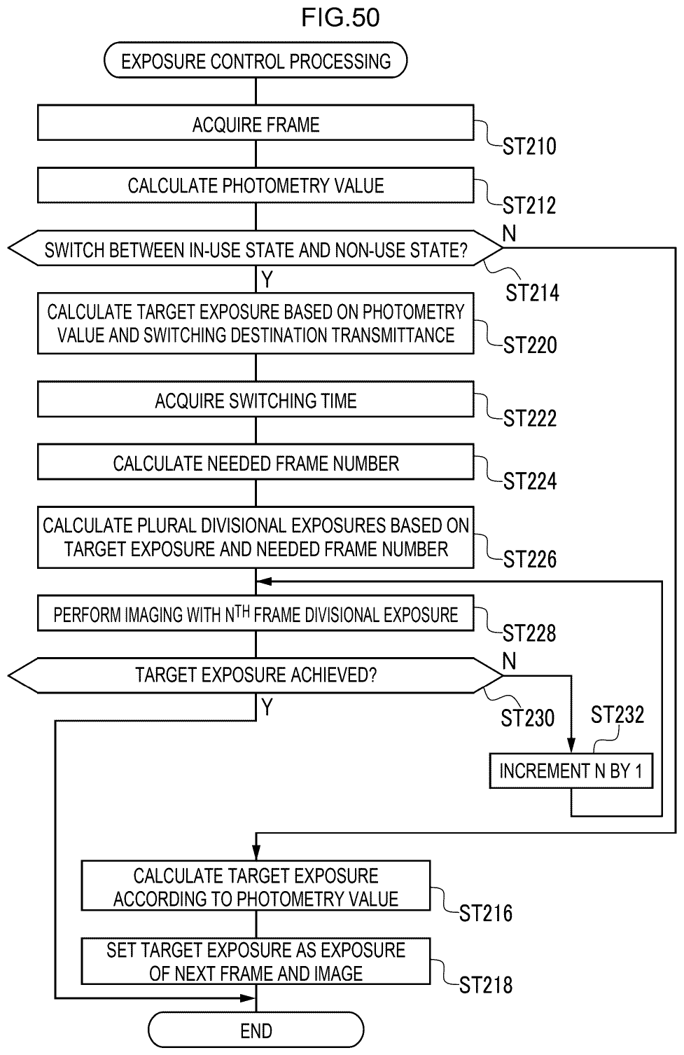

Next, description follows regarding operation of the imaging apparatus 10, with reference to FIG. 50. In FIG. 50, an example is illustrated of a flow of exposure control processing executed by the processor 64 when performing live-view image imaging in a condition in which an exposure calculation start timing has arrived (in other words, a timing specified in advance as the timing to adjust the exposure of the frames 80 obtained by performing live-view image imaging). The flow of exposure control processing illustrated in FIG. 50 is an example of a “control method” according to the present disclosure.

In the exposure control processing illustrated in FIG. 50, firstly, at step ST210 the processor 64 acquires a frame 80 generated by performing live-view image imaging. The exposure control processing transitions to step ST212 after the processing of step ST210 has been executed.

At step ST212, the processor 64 calculates a photometry value 2090 based on the frame 80 acquired at step ST210. The exposure control processing transitions to step ST214 after the processing of step ST212 has been executed.

At step ST214, the processor 64 determines whether or not an action to switch from one to the other out of the in-use state or the non-use state has started. Negative determination is made at step ST214 when an action to switch from one to the other out of the in-use state or the non-use state has not started, and the exposure control processing transitions to step ST216. Affirmative determination is made at step ST214 when an action to switch from one to the other out of the in-use state or the non-use state has started, and the exposure control processing transitions to step ST220.

At step ST216, the processor 64 calculates the target exposure EX2_{target1} according to the photometry value 2090. The exposure control processing transitions to step ST218 after the processing of step ST216 has been executed.

At step ST218, the processor 64 causes the imaging apparatus 10 to perform imaging of the next frame after setting the target exposure EX2_{target1} as the exposure of the next frame on the imaging apparatus 10. The exposure control processing is ended after the processing of step ST218 has been executed.

At step ST220, the processor 64 calculates a target exposure EX2_{target2} based on the photometry value 2090 and the switching destination transmittance 2094. The exposure control processing transitions to step ST222 after the processing of step ST220 has been executed.

The processor 64 acquires the switching time T20 at step ST222. The exposure control processing transitions to step ST224 after the processing of step ST222 has been executed.

At step ST224, the processor 64 calculates the needed frame number A12 based on the switching time T20 and the frame rate FR2. The exposure control processing transitions to step ST226 after the processing of step ST224 has been executed.

At step ST226, the processor 64 calculates the plural divisional exposures EX2_{div} based on the needed frame number A12 and the target exposure EX2_{target2}. The exposure control processing transitions to step ST228 after the processing of step ST226 has been executed.

At step ST228, the processor 64 causes the imaging apparatus 10 to perform imaging with an N^{th} frame divisional exposure EX2_{div} from out of the plural divisional exposures EX2_{div} calculated by executing the processing of step ST226, wherein N is a natural number having an initial value of “1”. At step ST228, the processor 64 causes the imaging apparatus 10 to perform imaging after the shutter speed, aperture value, and sensitivity defining the N^{th} frame divisional exposure EX2_{div} have been set on the imaging apparatus 10. After the processing of step ST228 has been executed, the exposure control processing transitions to step ST230.

At step ST230, the processor 64 determines whether or not the N^{th} frame exposure has attained the target exposure EX2_{target2}. Negative determination is made at step ST230 when the N^{th} frame exposure has not attained the target exposure EX2_{target2}, and the exposure control processing transitions to step ST232. At step ST232, the processor 64 increments N by “1”. The exposure control processing transitions to step ST228 after the processing of step ST232 has been executed. Affirmative determination is made at step ST230 when the N^{th} frame exposure has attained the target exposure EX2_{target2}, and the exposure control processing is ended.

As described above, in the imaging apparatus 10 according to the present eleventh exemplary embodiment, in cases in which switching from one to the other out of the in-use state or the non-use state, the target exposure EX2_{target2} to be set on the imaging apparatus 10 after switching is calculated. Control of the exposure of plural frames 80 obtained by performing live-view image imaging in the switching time T20 is performed so as to monotonously change from the current exposure toward the target exposure EX2_{target2}. As a result, the exposures of the plural frames 80 obtained by performing live-view image imaging within the switching time T20 gradually and monotonically change from the current exposure to the target exposure EX2_{target2}. Accordingly, during the process of bringing the exposures of the plural frames 80, which are obtained by performing live-view image imaging while transitioning from either the in-use state to the non-use state or vice versa, to the target exposure EX2_{target2}, abrupt changes in brightness between the plural frames 80 can be suppressed.

Moreover, in the imaging apparatus 10 according to the present eleventh exemplary embodiment, the clear glass 60 is inserted onto the optical path and the electronic ND filter 58 is removed from the optical path in the non-use state. The optical path length of the electronic ND filter 58 and the optical path length of the clear glass 60 are the same as each other. Accordingly, because the clear glass 60 is inserted onto the optical path even though the electronic ND filter 58 is removed from the optical path when in the non-use state, an optical path length can be maintained the same as that when the electronic ND filter 58 is inserted onto the optical path. However, the electronic ND filter 58 is inserted onto the optical path and the clear glass 60 is removed from the optical path when in the in-use state. The optical path length of the electronic ND filter 58 and the optical path length of the clear glass 60 are the same as each other. Therefore, because the electronic ND filter 58 is inserted onto the optical path even though the clear glass 60 is removed from the optical path when in the in-use state, an optical path length can be maintained the same as that when the clear glass 60 is inserted onto the optical path.

### Twelfth Exemplary Embodiment

Although in the eleventh exemplary embodiment described above, an example has been given of an embodiment in which the plural divisional exposures EX2_{div} are monotonically changed in the order in which they are applied to the plural frames 80 obtained by performing live-view image imaging within the switching time T20, in the present twelfth exemplary embodiment an example will be described of an embodiment in which divisional exposures EX2_{div} adjusted according to the width of the ND region R_{ND} of each of the frames 80 are applied as the exposures of the corresponding frames 80.

Note that the same reference numerals are appended in the present twelfth exemplary embodiment to configuration elements the same as those of the eleventh exemplary embodiment, and explanation thereof will be omitted. Moreover, description follows regarding main differences in the present twelfth exemplary embodiment to the eleventh exemplary embodiment.

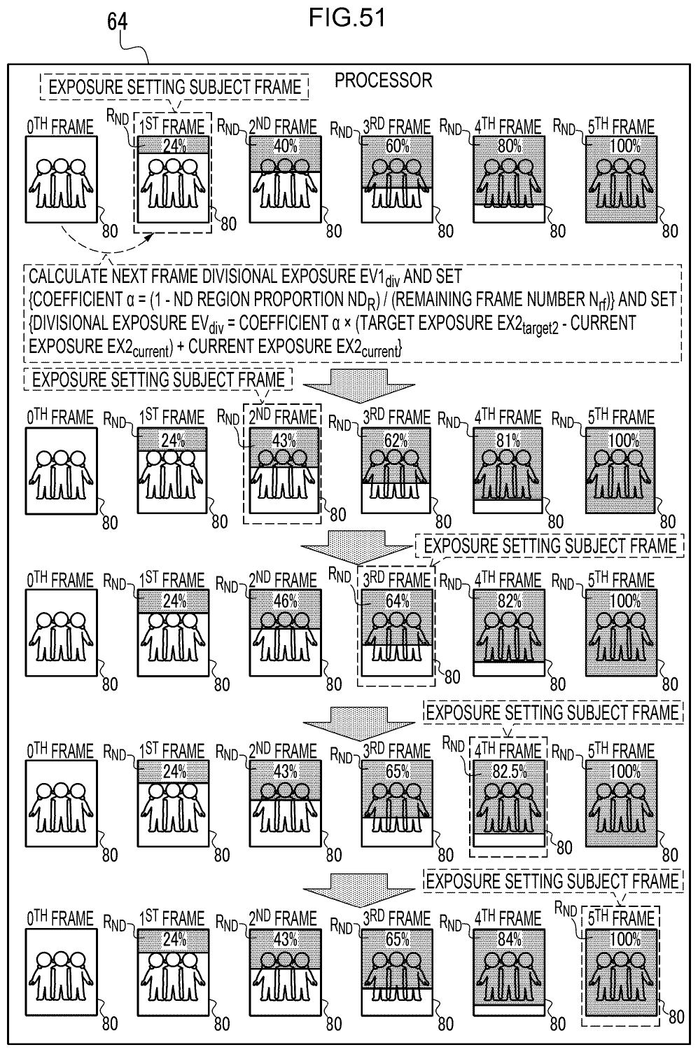

As illustrated as an example in FIG. 51, the plural frames 80 obtained by performing the live-view image imaging in the switching time T20 include from the 0^{th} frame of the frames 80 in the non-use state (namely, a frame 80 having a proportion of ND region R_{ND} to effective pixel region of 0%) to the 5^{th} frame of the frames 80 in the in-use state (namely, a frame 80 having a proportion of ND region R_{ND} to effective pixel region of 100%).

In cases in which the plural frames 80 obtained by performing live-view image imaging are being obtained, the processor 64 calculates a divisional exposure EX2_{div} to be applied to the next frame, which is the frame 80 to be obtained next after the frame 80 set with the current exposure (in other words, an exposure setting subject frame), based on the target exposure EX2_{target2}, a current exposure EX2current, which is the exposure currently set on the imaging apparatus 10, an ND region proportion ND_{R}, which is a proportion of the ND region R_{ND} with respect to the effective pixel region (in other words a proportion of the ND region R_{ND} for the frame 80), and a remaining frame number N_{rf} (namely, a number of frames obtained during a remaining time from the current frame, which is the frame 80 obtained at the current point in time, until switch from one to the other from out of the in-use state and the non-use state is complete). The processor 64 then sets the imaging apparatus 10 with the calculated divisional exposure EX2_{div} as the exposure of the next frame.

The divisional exposure EX2_{div} applied to the next frame is as stipulated by the following Equation (1) and Equation (2) determined under a presumption that the ND region proportion ND_{R} changes at a constant change amount from the frame 80 set with the current exposure EX2current through to the frame 80 at the point in time when the switching from the non-use state to the in-use state is complete. Namely, the processor 64 calculates the divisional exposure EX2_{div} applied to the next frame using the following Equation (1) and Equation (2).

(Divisional exposure EX2_{div})=(coefficient α)×(target exposure EX2_{target2}−current exposure EX2_{current})+current exposure EX2_{current} (1).

(Coefficient α)=(1−ND region proportion ND_{R})/(remaining frame number N_{rf}) (2)

In the example illustrated in FIG. 51, when the 1^{st} frame is the exposure setting subject frame, at the 0^{th} frame, the remaining frame number N_{rf} is “5” (the number of frames obtained from the current point in time to the time switch to the in-use state is complete is “5”), and so under the presumption that the ND region proportion ND_{R} will change at a constant change amount for the remaining 5 frames, the processor 64 calculates plural divisional exposures EX2_{div} from the next frame (namely, the 1^{st} frame) to the 5^{th} frame. At the 0^{th} frame, the divisional exposure EX2_{div} of the next frame (namely, the 1^{st} frame) is calculated with an estimated ND region proportion ND_{R} of 20%, and the calculated divisional exposure EX2_{div} is set as the exposure of the next frame (namely, the 1^{st} frame).

When 1^{st} frame imaging is performed at the divisional exposure EX2_{div} set as described above, the remaining frame number N_{rf} is “4”. After the 1^{st} frame imaging has been performed, say the 1^{st} frame ND region proportion ND_{R} at the point in time when calculation of the divisional exposure EX2_{div} to be applied for the exposure of the 2^{nd} frame of the frames 80, which is the next exposure setting subject frame, is 24%, then the plural divisional exposures EX2_{div} are re-calculated from the next frame (namely, the 2^{nd} frame) to the 5^{th} frame under the assumption that the non-ND region (namely, the region of the frame 80 other than the ND region R_{ND}) of 76% is changed uniformly into the ND region R_{ND} for the remaining four frames. At the 1^{st} frame, the divisional exposure EX2_{div} of the next frame (namely, the 2^{nd} frame) is calculated with the ND region proportion ND_{R} estimated at 43%, and the calculated divisional exposure EX2_{div} is set as the exposure of the next frame (namely, the 2^{nd} frame).

When the 2^{nd} frame imaging is performed with the divisional exposure EX2_{div} set as described above, then the remaining frame number N_{rf} is “3”. After the 2^{nd} frame imaging has been performed, say the 2^{nd} frame ND region proportion ND_{R} has become 46% at the point in time when calculating the divisional exposure EX2_{div} to be applied for the next exposure setting subject frame, in this case for the exposure of the 3^{rd} frame 80, the plural divisional exposures EX2_{div} are re-calculated from the next frame (namely, the 3^{rd} frame) to the 5^{th} frame under the assumption that the non-ND region of 54% is changed uniformly into the ND region R_{ND} for the remaining three frames. At the 2^{nd} frame, the divisional exposure EX2_{div} of the next frame (namely, the 3^{rd} frame) was calculated with the ND region proportion ND_{R} estimated at 64%, and the calculated divisional exposure EX2_{div} set as the exposure of the next frame (namely, the 3^{rd} frame).

When imaging of the 3^{rd} frame is performed with the divisional exposure EX2_{div} set as described above, the remaining frame number N_{rf} is “2”. After the imaging of the 3^{rd} frame has been performed, say the 3^{rd} frame ND region proportion ND_{R} has become 65% at the point in time when calculating the divisional exposure EX2_{div} to be applied for the exposure of the next exposure setting subject frame, in this case the 4^{th} frame 80, the plural divisional exposures EX2_{div} are re-calculated from the next frame (namely, the 4^{th} frame) to the 5^{th} frame under the assumption that the non-ND region of 35% is changed uniformly into the ND region R_{ND} for the remaining two frames. At the 3^{rd} frame, the divisional exposure EX2_{div} of the next frame (namely, the 4^{th} frame) was calculated with the ND region proportion ND_{R} estimated at 82.5%, and the calculated divisional exposure EX2_{div} set as the exposure of the next frame (namely, the 4^{th} frame).

When imaging of the 4^{th} frame is performed with the divisional exposure EX2_{div} set as described above, the remaining frame number N_{rf} is “1”. After the 4^{th} frame imaging has been performed, in cases in which the 4^{th} frame ND region proportion ND_{R} has become 84% at the point in time when calculating the divisional exposure EX2_{div} to be applied for the exposure of the next exposure setting subject frame, in this case the 5^{th} frame 80, the divisional exposure EX2_{div} is re-calculated for the next frame (namely, the 5^{th} frame) under the assumption that the non-ND region of 16% is changed into the ND region R_{ND} for the remaining one frame. At the 4^{th} frame, the divisional exposure EX2_{div} of next frame (namely, the 5^{th} frame) is calculated with the ND region proportion ND_{R} estimated at 100%, and the calculated divisional exposure EX2_{div} is set as the exposure of the next frame (namely, the 5^{th} frame).

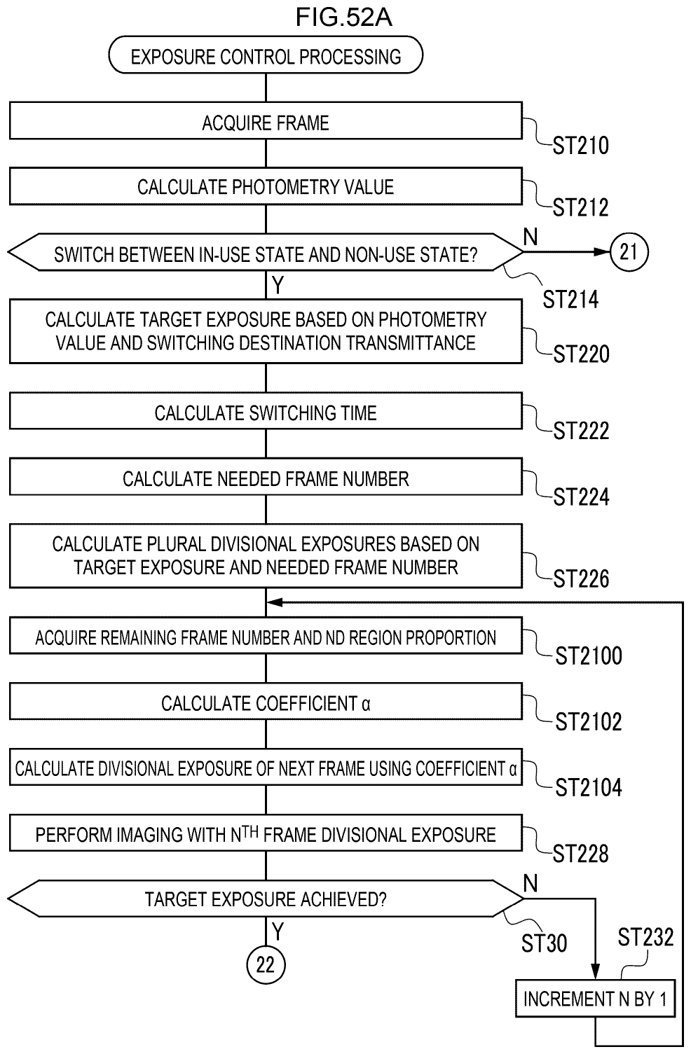

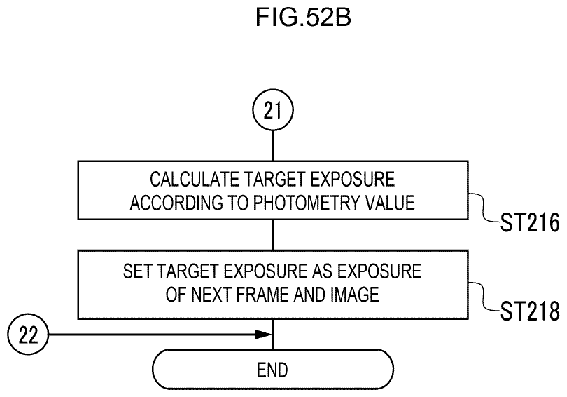

Next, description follows regarding an example of a flow of exposure control processing according to the present twelfth exemplary embodiment, with reference to FIG. 52A and FIG. 52B. However, the flowchart illustrated in FIG. 52A and FIG. 52B contains plural steps that are duplicates of the flowchart illustrated in FIG. 50 as described in the eleventh exemplary embodiment, and so the same step numbers are appended below to any out of the plural steps contained in the flowchart illustrated in FIG. 52A and FIG. 52B that are the same as steps in the flowchart illustrated in FIG. 50 described in the eleventh exemplary embodiment, and explanation thereof will be omitted.

The flowchart illustrated in FIG. 52A and FIG. 52B differs from the flowchart illustrated in FIG. 50 in that the step ST2100 to step ST2104 are included between the step ST226 and step ST228. Note that in the flowchart illustrated in FIG. 52A and FIG. 52B, the exposure control processing transitions to step ST216 illustrated in FIG. 52B when negative determination is made at step ST214, and processing of step ST216 and processing of step ST218 similar to those of the eleventh exemplary embodiment are executed in sequence by the processor 64.

At step ST2100 illustrated in FIG. 52A, the processor 64 acquires the remaining frame number N_{f} and the ND region proportion ND_{R}. The ND region proportion ND_{R} is calculated based on the remaining frame number N_{rf}. The calculation of the ND region proportion ND_{R} is performed using a calculation equation having the remaining frame number N_{rf} as an independent variable, and having the ND region proportion ND_{R} as a dependent variable. The exposure control processing transitions to step ST2102 after the processing of step ST2102 has been executed.

At step ST2102, the processor 64 calculates a coefficient α based on the remaining frame number N_{f}, the current frame number, and the ND region proportion ND_{R}. The coefficient α is calculated using above Equation (2). The exposure control processing transitions to step ST2104 after the processing of step ST2102 has been executed.

At step ST2104 the processor 64 calculates a divisional exposure EX2_{div} of the next frame based on the coefficient α, the target exposure EX2_{target2}, and the current exposure EX2current. The calculation of the divisional exposure EX2_{div} of the next frame is calculated using above Equation (1). The exposure control processing transitions to step ST228 after the processing of step ST2104 has been executed.

As described above, in the imaging apparatus 10 according to the present twelfth exemplary embodiment, the divisional exposure EX2_{div} calculated based on the target exposure EX2_{target2}, the current exposure EX2current, the ND region proportion ND_{R}, and the remaining frame number N_{rf} is applied for the respective exposures of the plural frames 80 obtained by performing live-view image imaging. Accordingly, divisional exposures EX2_{div} can be applied for the respective exposures of the plural frames 80 obtained by performing live-view image imaging that are more appropriate to the ND region proportion ND_{R} and the remaining frame number N_{rf} than cases in which divisional exposures EX2_{div} that have been calculated without considering the ND region proportion ND_{R} and the remaining frame number N_{rf} are applied for the respective exposures of the plural frames 80 obtained by performing live-view image imaging. As a result thereof, this enables sudden change of brightness between the plural frames 80 obtained by live-view image imaging to be more effectively suppressed from occurring.

### Thirteenth Exemplary Embodiment

In the eleventh exemplary embodiment, an example has been described of an embodiment in which the divisional exposures EX2_{div} to be applied for the respective exposures of the plural frames 80 obtained by performing live-view image imaging is calculated irrespective of whether or not the target exposure EX2_{target2} lies outside an exposure range trackable by switching from one to the other out of the in-use state or the non-use state, and these calculated divisional exposures EX2_{div} are applied for the exposures of the corresponding frames 80. However, in the present thirteenth exemplary embodiment, an example will be described of an embodiment in which different processing is executed depending on whether or not the target exposure EX2_{target2} lies outside the exposure range trackable by switching from one to the other out of the in-use state or the non-use state.

Note that the same reference numerals are appended in the present thirteenth exemplary embodiment to configuration elements the same as those of the eleventh exemplary embodiment, and explanation thereof will be omitted. Moreover, description follows regarding main differences in the present thirteenth exemplary embodiment to the eleventh exemplary embodiment.

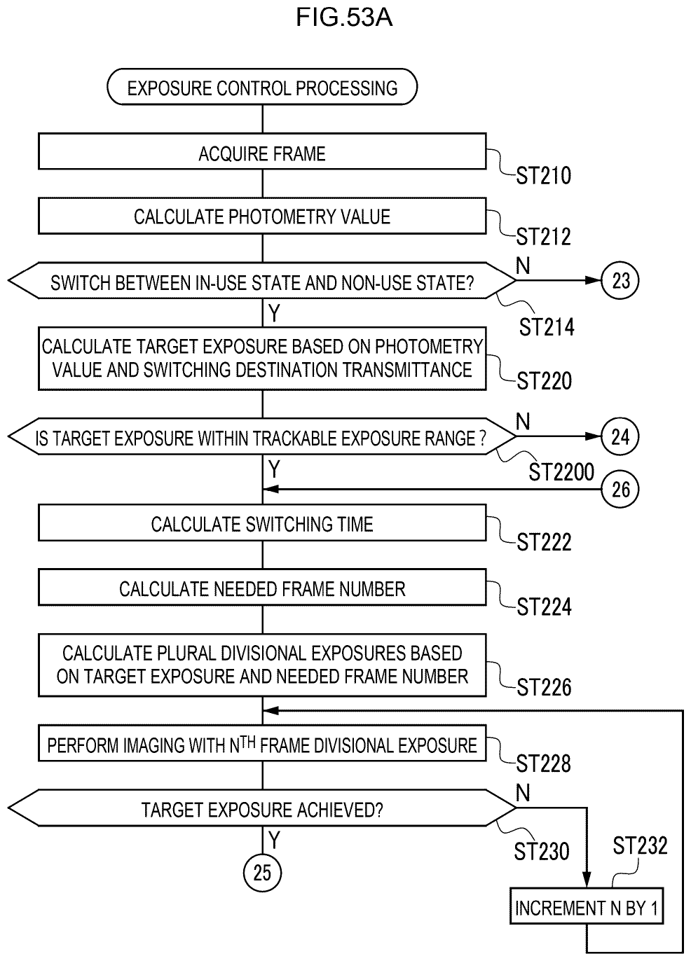

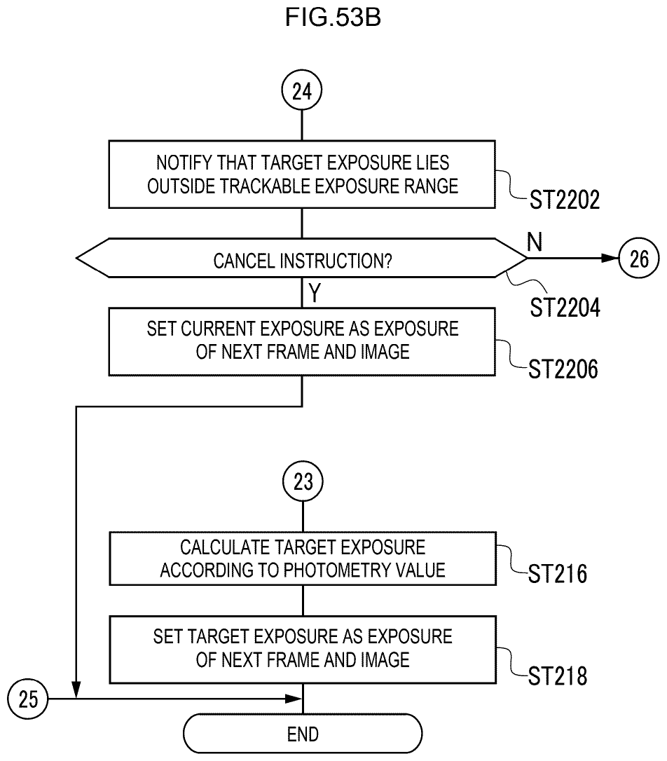

In the present thirteenth exemplary embodiment, description follows regarding an example of exposure control processing according to the present thirteenth exemplary embodiment, with reference to the flowchart illustrated in FIG. 53A and FIG. 53B. However, the flowchart illustrated in FIG. 53A and FIG. 53B contains plural steps that are duplicates of the flowchart illustrated in FIG. 50 as described in the eleventh exemplary embodiment, and so the same step numbers are appended below to any out of the plural steps contained in the flowchart illustrated in FIG. 53A and FIG. 53B that are the same as steps in the flowchart illustrated in FIG. 50 described in the eleventh exemplary embodiment, and explanation thereof will be omitted.

The flowchart illustrated in FIG. 53A and FIG. 53B differs from the flowchart illustrated in FIG. 50 in the inclusion of step ST2200 between the step ST220 and the step ST222, and the inclusion of step ST2202 to step ST2206. The exposure control processing transitions to step ST216 illustrated in FIG. 53B when negative determination is made at step ST214 illustrated in FIG. 53A.

At step ST2200 illustrated in FIG. 53A, the processor 64 determines whether or not the target exposure EX2_{target2} calculated at step ST220 is in the exposure range trackable by switching from one to the other out of the in-use state or the non-use state. Affirmative determination is made at step ST2200 when the target exposure EX2_{target2} calculated at step ST220 is in the exposure range trackable by switching from one to the other out of the in-use state or the non-use state, and the exposure control processing transitions to step ST222. Negative determination is made at step ST2200 when the target exposure EX2_{target2} calculated at step ST220 lies outside the exposure range trackable by switching from one to the other out of the in-use state or the non-use state, and the exposure control processing transitions to step ST2202 illustrated in FIG. 53B.

At step ST2202 illustrated in FIG. 53B, the processor 64 gives an alarm or a notification to the user that the target exposure EX2_{target2} lies outside the exposure range trackable by switching from one to the other out of the in-use state or the non-use state. For example, the processor 64 gives an alarm or a notification to the user that the target exposure EX2_{target2} lies outside the exposure range trackable by switching from one to the other out of the in-use state or the non-use state by displaying visible information (for example, text and/or an image) on the display 28 that the target exposure EX2_{target2} lies outside the exposure range trackable by switching from one to the other out of the in-use state or the non-use state. The exposure control processing transitions to step ST2204 after the processing of step ST2202 has been executed.

Note that although an example is given here of an embodiment in which visible information is displayed on the display 28, this is merely an example, and a configuration may be adopted so as to display visible information on a display of a device (for example a smart device or the like) connected to the external I/F 50. Moreover, a configuration may be adopted in which information indicating that the target exposure EX2_{target2} lies outside the exposure range trackable by switching from one to the other out of the in-use state or the non-use state is output as audio from a speaker, or information indicating that the target exposure EX2_{target2} lies outside the exposure range trackable by switching from one to the other out of the in-use state or the non-use state may be stored in the storage 66, and/or in a device or the like connected to the external I/F 50.

At step ST2204, the processor 64 determines whether or not a cancel instruction to cancel switching from one to the other out of the in-use state or the non-use state has been given from outside (for example, by a user). Negative determination is made at step ST2204 when no cancel instruction to cancel switching from one to the other out of the in-use state or the non-use state has been given from outside, and the exposure control processing transitions to step ST222 illustrated in FIG. 53A. Affirmative determination is made at step ST2204 when a cancel instruction to cancel switching from one to the other out of the in-use state or the non-use state has been given from outside, and the exposure control processing transitions to step ST2206.

At step ST2206, the processor 64 causes the imaging apparatus 10 to perform imaging after the current exposure EX2_{current} has been set as the exposure of the next frame. The current exposure EX2_{current} being set as the exposure of the next frame means that the exposure currently set on the imaging apparatus 10 is maintained. The exposure control processing is ended after the processing of step ST2206 has been executed.

As described above, in the present thirteenth exemplary embodiment, when the target exposure EX2_{target2} lies outside the exposure range trackable by switching from one to the other out of the in-use state or the non-use state, an alarm or a notification is given to a user that the target exposure EX2_{target2} lies outside the exposure range trackable by switching from one to the other out of the in-use state or the non-use state. This thereby enables the user to be made aware that the target exposure EX2_{target2} lies outside the exposure range trackable by switching from one to the other out of the in-use state or the non-use state.

Moreover, in the present thirteenth exemplary embodiment, when the target exposure EX2_{target2} lies outside the exposure range trackable by switching from one to the other out of the in-use state or the non-use state, control is performed to maintain the exposure currently set on the imaging apparatus 10 in a condition in which a cancel instruction has been given from outside to cancel switching from one to the other out of the in-use state or the non-use state. This thereby enables the brightness of the frames 80 to be suppressed from becoming an inappropriate brightness against the wishes of a user when the target exposure EX2_{target2} lies outside the exposure range trackable by switching from one to the other out of the in-use state or the non-use state.

### Fourteenth Exemplary Embodiment

In the eleventh exemplary embodiment an example has been give of an embodiment in which imaging is performed using the plural divisional exposures EX2_{div} already calculated even in cases in which there has been a significant increase or decrease in the change amount of the brightness of the imaging target (in other words, the imaging subject) while the plural divisional exposures EX2_{div} are applied in sequence for the exposures of the plural frames 80 obtained by performing live-view image imaging. However, in the present fourteenth exemplary embodiment, explanation follows regarding an example of an embodiment in which different processing to that of the eleventh exemplary embodiment is executed when there is a significant increase or decrease in the change amount of the brightness of the imaging subject while the plural divisional exposures EX2_{div} are being applied in sequence for the plural frames 80 obtained by performing live-view image imaging.

Note that the same reference numerals are appended in the present fourteenth exemplary embodiment to configuration elements the same as those of the eleventh exemplary embodiment, and explanation thereof will be omitted. Moreover, description follows regarding main differences in the present fourteenth exemplary embodiment to the eleventh exemplary embodiment.

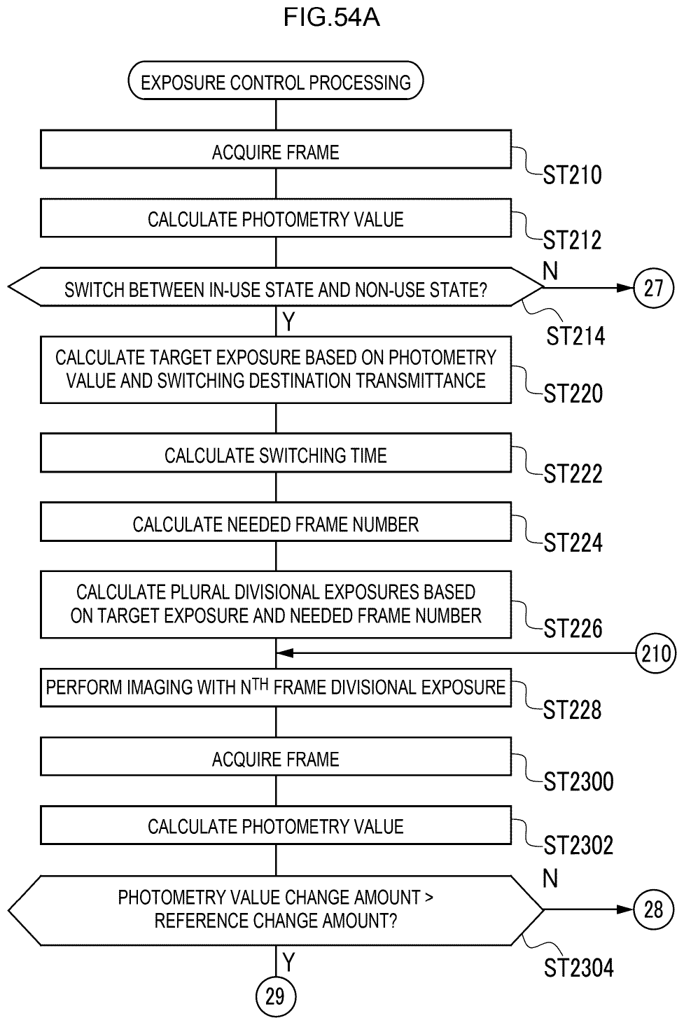

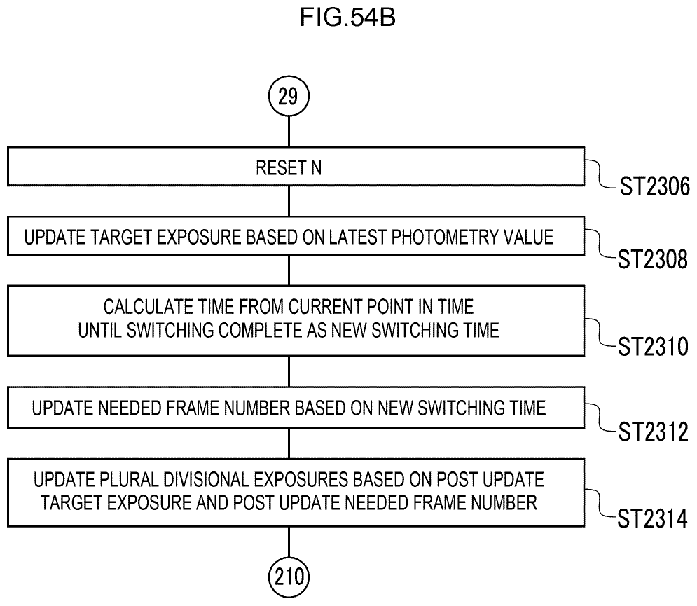

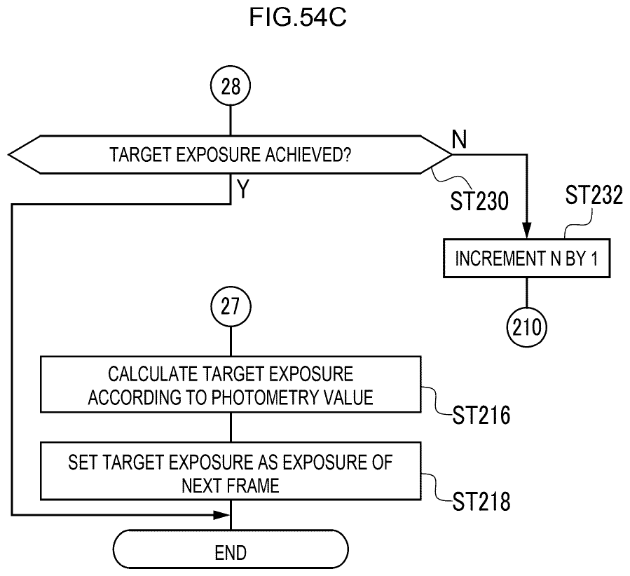

In the present fourteenth exemplary embodiment, description follows regarding an example of exposure control processing according to the present fourteenth exemplary embodiment, with reference to the flowchart illustrated in FIG. 54A to FIG. 54C. However, the flowchart illustrated in FIG. 54A to FIG. 54C includes plural steps that are duplicates of the flowchart illustrated in FIG. 50 as described in the eleventh exemplary embodiment, and so the same step numbers are appended below to any out of the plural steps contained in the flowchart illustrated in FIG. 54A to FIG. 54C that are the same as steps in the flowchart illustrated in FIG. 50 described in the eleventh exemplary embodiment, and explanation thereof will be omitted.

The flowchart illustrated in FIG. 54A to FIG. 54C differs from the flowchart illustrated in FIG. 50 in the inclusion of step ST2300 to step ST2314 between step ST228 and step ST230.

At step ST2300 illustrated in FIG. 54A, the processor 64 acquires a frame 80 generated by performing live-view image imaging. The exposure control processing transitions to step ST2302 after the processing of step ST2300 has been executed.

At step ST2302, the processor 64 calculates a photometry value 2090 based on the frame 80 acquired at step ST2300. The exposure control processing transitions to step ST2304 after the processing of step ST2302 has been executed.

At step ST2304, the processor 64 determines whether or not the change amount of brightness of the imaging subject has exceeded a reference change amount. The change amount of brightness of the imaging subject means, for example, a change amount from the photometry value 2090 calculated at step ST212, to the photometry value 2090 calculated at the step ST2302. An example of the reference change amount is a value determined in advance by experimentation with test equipment and/or computer simulation or the like as an upper limit value of the photometry value change amount such that a visually unsettling feeling is not imparted to a user. The upper limit value of the photometry value change amount may be a lower value such that a visually unsettling feeling is not imparted to a user (for example, an average, a median, a mode, or the like of photometry value change amount not imparting a visually unsettling feeling to the user). Moreover, the reference change amount may be a fixed value, or may be a variable value changed according to an instruction given by a user and/or various conditions (for example, the frame rate FR2, or imaging mode or the like).

Negative determination is made at step ST2304 when the change amount of the brightness of the imaging subject has not exceeded the reference change amount, and the exposure control processing transitions to step ST230 illustrated in FIG. 54C. The exposure control processing is ended when affirmative determination is made at step ST230 illustrated in FIG. 54C. The exposure control processing transitions to step ST232 when negative determination is made at step ST230 illustrated in FIG. 54C. The exposure control processing transitions to step ST228 illustrated in FIG. 54A after the processing of step ST232 has been executed.

Affirmative determination is made at step ST2304 when the change amount of brightness of the imaging subject has exceeded the reference change amount, and the exposure control processing transitions to step ST2306 illustrated in FIG. 54B.

At step ST2306, the processor 64 resets N to the initial value. The exposure control processing transitions to step ST2308 after the processing of step ST2306 has been executed.

At step ST2308, the processor 64 updates the target exposure EX2_{target2} by calculating a new target exposure EX2_{target2} based on the latest photometry value 2090. The exposure control processing transitions to step ST2310 after the processing of step ST2308 has been executed.

At step ST2310, the processor 64 calculates, as a new switching time T20, a time from the current point in time to when switching from one to the other from out of the in-use state and the non-use state is complete. The exposure control processing transitions to step ST2312 after the processing of step ST2310 has been executed.

At step ST2312, the processor 64 updates the needed frame number A12 by calculating a new needed frame number A12 based on the new switching time T20 and the frame rate FR2. The post update needed frame number A12 is a frame number corresponding to a remaining time from the current frame to when the switching from one to the other from out of the in-use state and the non-use state is complete (namely, a number of frames obtained in the remaining time until the switching from one to the other from out of the in-use state and the non-use state is complete). In the present fourteenth exemplary embodiment, the post update needed frame number A12 is an example of a “second frame number” and a “third frame number” according to the present disclosure. The exposure control processing transitions to step ST2314 after the processing of step ST2312 has been executed.

At step ST2314, the processor 64 updates the plural divisional exposures EX2_{div} by re-calculating the plural divisional exposures EX2_{div} based on the new target exposure EX2_{target2} calculated at step ST2308 (namely, the post update target exposure EX2_{target2}) and the new needed frame number A12 calculated at step ST2312. The exposure control processing transitions to step ST228 illustrated in FIG. 54A after the processing of step ST2314 has been executed.

As described above, in the imaging apparatus 10 according to the present fourteenth exemplary embodiment, the target exposure EX2_{target2} is updated in cases in which the change amount of brightness of the imaging subject has exceeded the reference change amount during the plural divisional exposures EX2_{div} being sequentially applied for the exposures of the plural frames 80 obtained by performing live-view image imaging, and the plural divisional exposures EX2_{div} are updated based on the post update target exposure EX2_{target2} and the post update needed frame number A12. Then the plural post update divisional exposures EX2_{div} are respectively applied as the exposures of the corresponding frames 80. Accordingly, a sudden change in brightness between the plural frames 80 obtained by performing the live-view image imaging can be suppressed from occurring even when the change amount of brightness of the imaging subject has exceeded the reference change amount while the plural divisional exposures EV_{div} are being sequentially applied for the exposures of the plural frames 80 obtained by performing live-view image imaging.

### Fifteenth Exemplary Embodiment

In the eleventh exemplary embodiment described above an example has been give of an embodiment in which there is a presumption that the target exposure EX2_{target2} is not changed during sequential application of the plural divisional exposures EX2_{div} for the plural frames 80 obtained by performing live-view image imaging. However, in the present fifteenth exemplary embodiment description follows regarding an example of an embodiment in which the exposures of the plural frames 80 are changed while the plural divisional exposures EX2_{div} are being sequentially applied for the exposures of the plural frames 80 obtained by performing live-view image imaging.

Note that the same reference numerals are appended in the present fifteenth exemplary embodiment to configuration elements the same as those of the fourteenth exemplary embodiment, and explanation thereof will be omitted. Moreover, description follows regarding main differences in the present fifteenth exemplary embodiment to the fourteenth exemplary embodiment.

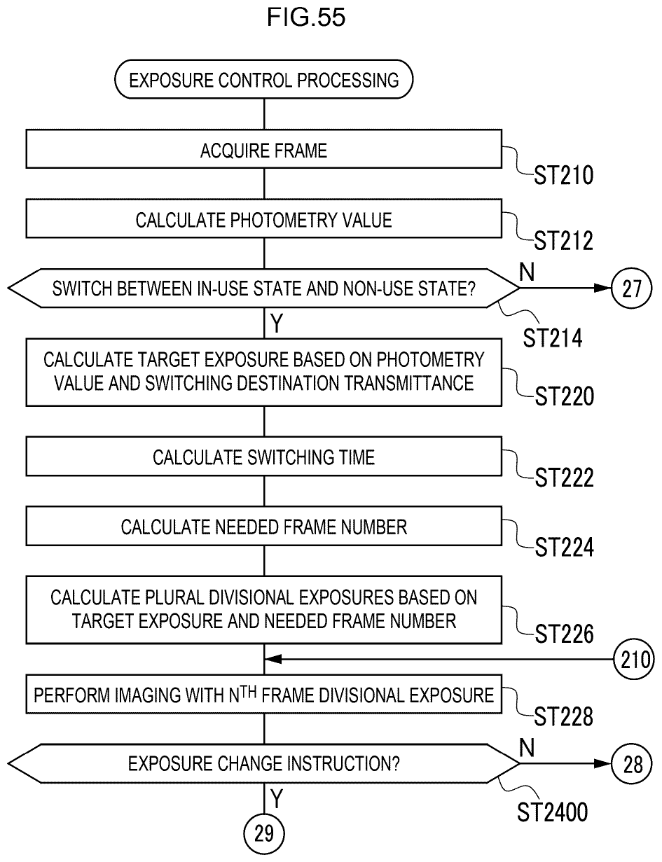

In the present fifteenth exemplary embodiment, description follows regarding an example of exposure control processing according to the present fifteenth exemplary embodiment, with reference to the flowchart illustrated in FIG. 55. However, the flowchart illustrated in FIG. 55 includes plural steps that are duplicates of the flowchart illustrated in FIG. 54A to FIG. 54C as described in the fourteenth exemplary embodiment, and so the same step numbers are appended below to any out of the plural steps contained in the flowchart illustrated in FIG. 55 that are the same as steps in the flowchart illustrated in FIG. 54A to FIG. 54C described in the fourteenth exemplary embodiment, and explanation thereof will be omitted.

The flowchart illustrated in FIG. 55 differs from the flowchart illustrated in FIG. 54A to FIG. 54C in the inclusion of step ST2402 instead of step ST2304.

At step ST2402 illustrated in FIG. 55, the processor 64 determines whether or not an exposure change instruction, which is an instruction to change the target exposure EX2_{target2}, has been given from outside (for example, from a user). Negative determination is made at step ST2400 in cases in which an exposure change instruction has not been given from outside, and processing transitions to step ST230 illustrated in FIG. 54C. Affirmative determination is made at step ST2400 in cases in which an exposure change instruction has been given from outside, processing transitions to step ST2306 illustrated in FIG. 54B, and the processing from step ST2306 onward illustrated in FIG. 54B is executed by the processor 64. Note that in the present fifteenth exemplary embodiment, the exposure change instruction is an example of a “change instruction” according to the present disclosure.

As described above, in the imaging apparatus 10 according to the present fifteenth exemplary embodiment, the target exposure EX2_{target2} is updated in cases in which an exposure change instruction has been given from outside while the plural divisional exposures EX2_{div} are being sequentially applied for the exposures of the plural frames 80 obtained by performing live-view image imaging, and plural divisional exposures EX2_{div} are updated based on the post update target exposure EX2_{target2} and on the post update needed frame number A12. The plural post update divisional exposures EX2_{div} are then respectively applied as the exposures of the corresponding frames 80. Accordingly, sudden changes in the brightness between the plural frames 80 obtained by performing live-view image imaging can be suppressed from occurring even if an exposure change instruction is given from outside while the plural divisional exposures EV_{div} are being sequentially applied for the exposures of the plural frames 80 obtained by performing live-view image imaging.

Although the switching time T20 is given as an example in the eleventh exemplary embodiment to the fifteenth exemplary embodiment, a frame number may be employed as the switching time T20. Namely, the concept of change time may include the number of frames.

Although the eleventh to the fifteenth exemplary embodiments illustrate examples of monotonous change, the monotonous change means, for example, a linear change, an exponential function change, or the like. Moreover, examples of monotonous change include a monotonous increase and a monotonous decrease.

Although the eleventh to the fifteenth exemplary embodiments illustrate examples of exposure control processing for cases in which live-view image imaging is performed, the present disclosure is not limited thereto and, for example, the exposure control processing described above is applicable, for example, to cases in which continuous imaging is performed, such as cases of recording imaging of video images being performed, cases of rapid shooting with a constant imaging interval being performed, or cases of rapid shooting with different imaging intervals being performed.

Although in the eleventh to the fifteenth exemplary embodiments examples of embodiments have been described in which an exposure control processing program PG2 is stored on the storage 66, the present disclosure is not limited thereto. For example, the exposure control processing program PG2 may be stored on a portable, computer-readable, non-transitory storage medium such as an SSD or USB memory. The exposure control processing program PG2 stored on the non-transitory storage medium may be installed to the system controller 12 of the imaging apparatus 10. The processor 64 executes the exposure control processing according to the exposure control processing program PG2.

Moreover, the exposure control processing program PG2 may be stored on a storage device of another computer, server device, or the like connected to the imaging apparatus 10 over a network, with the exposure control processing program PG2 then downloaded on request from the imaging apparatus 10 so as to be installed on the system controller 12.

Note that the entire exposure control processing program PG2 is not necessarily stored on the storage device such as another computer, server device, or the like connected to the imaging apparatus 10 or on the storage 66, and part of the exposure control processing program PG2 may be stored thereon.

Although the system controller 12 is built into the imaging apparatus 10 illustrated in FIG. 1 and FIG. 2, the present disclosure is not limited thereto and, for example, the system controller 12 may be provided externally to the imaging apparatus 10.

Although in the eleventh to the fifteenth exemplary embodiments examples are illustrated with the system controller 12, the present disclosure is not limited thereto, and the present disclosure is applicable to a device including an ASIC, FPGA, and/or a PLD instead of the system controller 12. Instead of the system controller 12, a combination of a hardware configuration and a software configuration may be employed.

The following types of processors may be employed as the hardware resource for executing the exposure control processing described in the eleventh to the fifteenth exemplary embodiments. Examples of processors include a CPU, which is a general-purpose processor that functions as the hardware resource for executing the exposure control processing according to the eleventh to the fifteenth exemplary embodiments by, for example, executing software, namely a program. Examples of processors also include a custom electrical circuit, which is an example of a processor including a circuit configuration with a customized design for executing specific processing, such as, for example, an FPGA, PLD, or ASIC. Such processors may also have in-built or connected memory, with the processors executing the exposure control processing according to the eleventh to the fifteenth exemplary embodiments using the memory.

The hardware resource for executing the exposure control processing according to the eleventh to the fifteenth exemplary embodiments may be configured from a single type out of these various processor types, or may be configured by combining two or more processors of the same or different types (for example, by combining plural FPGAs or combining a CPU with an FPGA). The hardware resource for executing the exposure control processing according to the eleventh to the fifteenth exemplary embodiments may also be a single processor.

Examples of configurations of a single processor include, firstly, a configuration of a single processor resulting from combining one or more CPU and software, in an embodiment in which this processor functions as a hardware resource for executing the exposure control processing according to the eleventh to the fifteenth exemplary embodiments. Secondly, as typified by a SoC or the like, there is also an embodiment that uses a processor realized by a single IC chip to function as an overall system including plural hardware resources for executing the exposure control processing according to the eleventh to the fifteenth exemplary embodiments. Adopting such an approach means that the exposure control processing according to the eleventh to the fifteenth exemplary embodiments is realized using one or more of the various processors described above as hardware resource.

Furthermore, more specifically an electrical circuit that combines circuit elements such as semiconductor elements or the like may be employed as a hardware structure of these various processors. The exposure control processing according to the eleventh to the fifteenth exemplary embodiments are merely examples thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

The following supplements are also disclosed in relation to the embodiments described above.

### Supplement 1

A control device including
a processor, the processor:
acquiring plural divisional exposures determined based on a change time needed to change a transmittance of an electronic dimmer filter mounted to an imaging apparatus from a first transmittance to a second transmittance capable of realizing a target exposure of the imaging apparatus, and the target exposure; and
adjusting the divisional exposures in a course of changing from the first transmittance to the second transmittance from out of the plural divisional exposures by adjustment based on plural ideal transmittances determining a course of an ideal change from the first transmittance to the second transmittance with the change time of the first threshold value or lower and on plural first realistic transmittances determining a course of a realistic change from the first transmittance to the second transmittance with the change time of the first threshold value or lower.

### Supplement 2

The control device of Supplement 1, wherein:
the plural divisional exposures adjusted based on the plural ideal transmittances and the plural first realistic transmittances are applied for exposures of plural frames obtained by imaging with the imaging apparatus performed at least within the change time.

### Supplement 3

The control device of Supplement 2, wherein:
adjustment for the divisional exposures in the course of changing from the first transmittance to the second transmittance from out of the plural divisional exposures is implemented by at least one of plural exposure factors regulating the divisional exposures being adjusted by the frame unit based on a disparity between the ideal transmittances and the first realistic transmittances.

### Supplement 4

The control device of Supplement 3, wherein:
adjustment for the divisional exposures in the course of changing from the first transmittance to the second transmittance from out of the plural divisional exposures is implemented by at least one of the plural exposure factors regulating the divisional exposures being adjusted by the frame unit based on the disparity such that an exposure realized by the first realistic transmittance is an exposure realized by the ideal transmittance.

### Supplement 5

The control device of any one of Supplement 1 to Supplement 4, wherein in cases in which the change time has exceeded a first threshold value,
the processor adjusts the divisional exposures in the course of changing from the first transmittance to the second transmittance from out of the plural divisional exposures based on the plural ideal transmittances and the plural first realistic transmittances.

### Supplement 6

The control device of Supplement 5, wherein:
in cases in which the change time has exceeded a first threshold value, a third transmittance is determined between the first transmittance and the second transmittance to make the change time the first threshold value or lower;
the plural first realistic transmittances are determined based on the first transmittance and the third transmittance; and
in cases in which the change time has exceeded the first threshold value and also a number of times a state in which a disparity between the first transmittance and the second transmittance falls within a preset range has continued for a specific number of times, the processor changes the first threshold value to a value larger than a value set at a current point in time.

### Supplement 7

The control device of Supplement 6, wherein;
in cases in which the change time has exceeded the first threshold value and also a number of times the state in which the disparity between the first transmittance and the second transmittance falls within the preset range has continued for the specific number of times,
the processor changes the first threshold value to a maximum value of the change time obtained within the specific number of times.

### Supplement 8

The control device of any one of Supplement 1 to Supplement 4, wherein:
in cases in which the change time has exceeded the first threshold value and also a number of times a state in which a disparity between the first transmittance and the second transmittance falls within a preset range has continued for a specific number of times, the plural divisional exposures are maintained; and
in cases in which the change time has exceeded the first threshold value and also a number of times a state in which a disparity between the first transmittance and the second transmittance falls within the preset range is less than the specific number of times,
a third transmittance is determined between the first transmittance and the second transmittance to make the change time the first threshold value or lower, and the plural first realistic transmittances are determined based on the first transmittance and the third transmittance.

### Supplement 9

The control device of any one of Supplement 1 to Supplement 8, wherein:
in cases in which the change time is the first threshold value or lower,
the processor changes the transmittance based on the plural ideal transmittances.

### Supplement 10

The control device of any one of Supplement 1 to Supplement 9, wherein:
in cases in which the change time is a first threshold value or lower,
the processor monotonous changes the plural divisional exposures by monotonously changing the plural ideal transmittances between the first transmittance and the second transmittance.

### Supplement 11

The control device of any one of Supplement 1 to Supplement 10, wherein:
the imaging apparatus includes a movable aperture; and
in cases in which a drive time of the aperture when driving the aperture to realize the target exposure exceeds the first threshold value,
the processor changes the first threshold value to a value of the drive time or greater.

### Supplement 12

A control device including:
a processor, wherein
   based on a transmittance of an electronic dimmer filter mounted to an imaging apparatus including a movable aperture and on a drive time of the aperture, the processor controls exposures of plural frames obtained by imaging performed with the imaging apparatus.

### Supplement 13

The control device of Supplement 12, wherein;
the processor controls exposures of the plural frames by applying plural divisional exposures determined according to a relationship between a change time needed to change the transmittance from a first transmittance to a second transmittance able to realize a target exposure of the imaging apparatus and a drive time of the aperture by application for the exposures of the plural frames.

### Supplement 14

The control device of Supplement 13, wherein:
first control is performed in cases in which the change time and the drive time have exceeded a first threshold value; and
the first control is control to make the change time within the drive time, and is control to apply plural first divisional exposures determined based on a realistic change time, which is a time to realistically change from the first transmittance to the second transmittance, and the drive time by application to exposures of the plural frames as the plural divisional exposures.

### Supplement 15

The control device of Supplement 13, wherein:
a second control is performed in cases in which the change time and/or the drive time is a first threshold value or lower; and
the second control is control to apply plural second divisional exposures determined based on an ideal change time, which is a time to ideally change from the first transmittance to the second transmittance, and the drive time, by application to exposures of the plural frames as the plural divisional exposures.

### Supplement 16

The control device of Supplement 13, wherein:
a first control is performed in cases in which a disparity between the change time and the drive time has exceeded a second threshold value; and
the first control is control to make the change time within the drive time, and is control to apply plural first divisional exposures determined based on a realistic change time, which is a time to realistically change from the first transmittance to the second transmittance, and the drive time by application to exposures of the plural frames as the plural divisional exposures.

### Supplement 17

The control device of Supplement 13, wherein:
second control is performed in cases in which a disparity between the change time and the drive time is a second threshold value or lower; and
the second control is control to apply plural second divisional exposures determined based on an ideal change time, which is a time to ideally change from the first transmittance to the second transmittance, and the drive time, by application to exposures of the plural frames as the plural divisional exposures.

### Supplement 18

The control device of Supplement 14, wherein:
the plural first divisional exposures are determined based on a frame number determined on the basis of a first frame number, which is a frame number corresponding to the realistic change time, and of a second frame number, which is a frame number corresponding to the drive time, and on the target exposure.

### Supplement 19

The control device of Supplement 18, wherein:
the plural first divisional exposures are determined based on plural first realistic transmittances determining a course of realistically changing from the first transmittance to the second transmittance within the realistic change time, on an aperture value of the aperture, and on a sensitivity and/or shutter speed set in the imaging apparatus to match the target exposure.

### Supplement 20

The control device of Supplement 19, wherein:
in cases in which the change time and the drive time have exceeded a third threshold value,
a third transmittance is determined between the first transmittance and the second transmittance to make the change time within the drive time; and
the plural first realistic transmittances are determined based on the first transmittance and the third transmittance.

### Supplement 21

The control device of Supplement 19, wherein:
in cases in which a disparity between the change time and the drive time have exceeded a fourth threshold value,
a third transmittance is determined between the first transmittance and the second transmittance to make the change time within the drive time; and
the plural first realistic transmittances are determined based on the first transmittance and the third transmittance.

### Supplement 22

The control device of Supplement 15, wherein:
the plural second divisional exposures are determined based on a frame number determined on the basis of a third frame number, which is a frame number corresponding to the ideal change time, and of a fourth frame number, which is a frame number corresponding to the drive time, and on the target exposure.

### Supplement 23

The control device of Supplement 22, wherein:
the plural second divisional exposures are determined based on plural ideal transmittances determining a course of an ideal change from the first transmittance to the second transmittance within the ideal change time, on an aperture value of the aperture, and on a sensitivity and/or shutter speed set in the imaging apparatus to match the target exposure.

### Supplement 24

The control device of Supplement 13, wherein:
in cases in which the change time and the drive time have exceeded a fifth threshold value, and also a first disparity, which is a disparity between a fourth transmittance and the second transmittance to make the change time within the drive time, has exceeded a preset disparity,
the divisional exposures of a course of changing from the first transmittance to the second transmittance from out of the plural divisional exposures are determined based on plural second realistic transmittances determined a course of changing from the first transmittance to the second transmittance via plural mid transmittances with the change time within the drive time; and
a maximum disparity, which is a largest disparity between the plural mid transmittances and the second transmittance, is smaller than the first disparity.

### Supplement 25

The control device of Supplement 13, wherein:
in cases in which a disparity between the change time and the drive time has exceeded a sixth threshold value and also a first disparity, which is a disparity between a fourth transmittance and the second transmittance to make the change time within the drive time, has exceeded a preset disparity,
the divisional exposures of a course of changing from the first transmittance to the second transmittance from out of the plural divisional exposures are determined based on plural second realistic transmittances determining a course of changing from the first transmittance to the second transmittance via plural mid transmittances with the change time within the drive time; and
a maximum disparity, which is a largest disparity between the plural mid transmittances and the second transmittance, is smaller than the first disparity.

### Supplement 26

The control device of Supplement 25, wherein:
in cases in which the change time and the drive time have exceeded a seventh threshold value, the first disparity has exceeded the preset disparity, and also a transmittance change time that is time needed to change from the first transmittance to the fourth transmittance is less than an eighth threshold value,
the divisional exposures of a course of changing from the first transmittance to the second transmittance from out of the plural divisional exposures are determined based on the plural second realistic transmittances.

### Supplement 27

The control device of Supplement 25, wherein:
in cases in which a disparity between the change time and the drive time has exceeded a ninth threshold value, the first disparity has exceeded the preset disparity, and also a transmittance change time that is time needed to change from the first transmittance to the fourth transmittance is less than a tenth threshold value,
the divisional exposures of a course of changing from the first transmittance to the second transmittance from out of the plural divisional exposures are determined based on the plural second realistic transmittances.

### Supplement 28

The control device of Supplement 26, wherein:
the plural divisional exposures are determined based on a frame number determined on a basis of a fifth frame number, which is a frame number needed to change from the first transmittance to the second transmittance via the plural second realistic transmittances, and of a sixth frame number, which is a frame number corresponding to the drive time, and based on the target exposure.

### Supplement 29

The control device of Supplement 28, wherein:
the plural divisional exposures are determined based on plural third realistic transmittances determining a course of changing from the first transmittance to the second transmittance via the plural mid transmittances with the change time within the drive time, on an aperture value of the aperture, and on a sensitivity and/or shutter speed set in the imaging apparatus to match the target exposure.

### Supplement 30

The control device of Supplement 13, wherein:
in cases in which the transmittance is not able to track changes in aperture value of the aperture,
exposures of the plural frames are determined based on the first transmittance and the drive time.

### Supplement 20

The control device of Supplement 13, wherein:
in cases in which the transmittance is not able to track changes in aperture value of the aperture and also a change amount of the aperture value is a first preset change amount or lower,
exposures of the plural frames are determined based on the first transmittance and the drive time.

### Supplement 21

The control device of Supplement 13, wherein:
in cases in which a change amount of the aperture value has exceeded a second preset change amount due to the aperture value being updated while exposures of the plural frames are being controlled,
exposures of the plural frames are updated by a method according to trackability of the transmittance with respect to a disparity between the aperture value prior to update and the aperture value post update.

### Supplement 22

The control device of Supplement 12, wherein:
the plural frames are obtained by the imaging performed based on a preset frame rate.

### Supplement 23

An imaging apparatus including:
the control device of any one of Supplement 12 to Supplement 22; and an image sensor employed in the imaging.

### Supplement 24

A control method including:
based on a transmittance of an electronic dimmer filter mounted to an imaging apparatus including a movable aperture and on a drive time of the aperture, controlling exposures of plural frames obtained by imaging performed with the imaging apparatus.

### Supplement 25

A program that causes a computer to execute processing including:
based on a transmittance of an electronic dimmer filter mounted to an imaging apparatus including a movable aperture and on a drive time of the aperture, controlling exposures of plural frames obtained by imaging performed with the imaging apparatus.

### Supplement 26

A control device including a processor,
the processor performing control of:
in cases in which there is switching from one to the other from out of an in-use state in which an electronic dimmer filter mounted to an imaging apparatus is used or a non-use state in which the electronic dimmer filter is not used, acquiring a target exposure of the imaging apparatus after switching; and
monotonously changing exposures of plural frames obtained by imaging performed by the imaging apparatus at least in a switching time needed for switching from the one to the other by changing toward the target exposure.

### Supplement 27

The control device of Supplement 26, wherein:
plural divisional exposures determined based on a first frame number, which is a frame number corresponding to the switching time, and on the target exposure are applied for exposures of the plural frames.

### Supplement 28

The control device of Supplement 27, wherein:
the divisional exposures are determined based on the target exposure, an exposure currently set on the imaging apparatus, a proportion with respect to the frame of a range where the electronic dimmer filter has an effect on the frame, and a remaining frame number corresponding to a remaining time until completion of the switching.

### Supplement 29

A control device of Supplement 27 or Supplement 28, wherein:
the divisional exposures are determined based on the target exposure, an exposure currently set on the imaging apparatus, a proportion with respect to the frame of a range where the electronic dimmer filter has an effect on the frame, and a remaining frame number corresponding to a remaining time until completion of the switching.

### Supplement 30

The control device of any one of supplement 27 to supplement 29, wherein:
the plural frames are obtained by the imaging performed based on a preset frame rate; and the first frame number is determined based on the switching time and the preset frame rate.

### Supplement 31

The control device of any one of Supplement 27 to Supplement 30, wherein:
in cases in which a change amount of brightness of an imaging subject has exceeded a reference change amount while the plural divisional exposures are being applied in sequence for the exposures of the plural frames,
the target exposure is updated; and
the plural divisional exposures are updated based on a second frame number, which is a frame number corresponding to a remaining time until completion of the switching, and on the updated target exposure.

### Supplement 32

The control device of any one of Supplement 27 to Supplement 31, wherein:
in cases in which a change instruction to change the target exposure has been given from outside while the plural divisional exposures are being applied in sequence for the exposures of the plural frames,
the target exposure is updated; and
the plural divisional exposures are updated based on a third frame number, which is a frame number corresponding to a remaining time until completion of the switching, and on the updated target exposure.

### Supplement 33

The control device of any one of Supplement 26 to Supplement 32, wherein:
in cases in which the target exposure lies outside an exposure range trackable by the switching,
a notification or alarm is given that the target exposure lies outside the exposure range.

### Supplement 34

The control device of any one of Supplement 26 to Supplement 33, wherein:
in cases in which the target exposure lies outside an exposure range trackable by the switching,
an exposure currently set on the imaging apparatus is maintained in a condition in which a cancel instruction to cancel the switching has been given from outside.

### Supplement 35

The control device of any one of Supplement 26 to Supplement 34, wherein:
the electronic dimmer filter is inserted onto an optical path of the imaging apparatus in the in-use state; and
the electronic dimmer filter is removed from the optical path in the non-use state.

### Supplement 36

The control device of Supplement 35, wherein:
the imaging apparatus includes a translucent filter having an optical path length equivalent to the optical path length of the electronic dimmer filter;
the electronic dimmer filter and the translucent filter are inserted and removed selectively from the optical path;
in the in-use state the electronic dimmer filter is inserted onto the optical path and the translucent filter is removed from the optical path; and
in the non-use state the translucent filter is inserted onto the optical path and the electronic dimmer filter is removed from the optical path.

### Supplement 37

An imaging apparatus including:
the control device of any one of Supplement 26 to Supplement 36; and an image sensor employed in the imaging.

### Supplement 38

A control method including performing control of:
in cases in which there is switching from one to the other from out of an in-use state in which an electronic dimmer filter mounted to an imaging apparatus is used or a non-use state in which the electronic dimmer filter is not used, acquiring a target exposure of the imaging apparatus after switching; and
monotonously changing exposures of plural frames obtained by imaging performed by the imaging apparatus at least in a switching time needed for switching from the one to the other by changing toward the target exposure.

### Supplement 39

A program that causes a computer to execute processing including performing control of:
in cases in which there is switching from one to the other from out of an in-use state in which an electronic dimmer filter mounted to an imaging apparatus is used or a non-use state in which the electronic dimmer filter is not used, acquiring a target exposure of the imaging apparatus after switching; and
monotonously changing exposures of plural frames obtained by imaging performed by the imaging apparatus at least in a switching time needed for switching from the one to the other by changing toward the target exposure.

### Supplement 40

The control device of Supplement 28, wherein the proportion is equivalent to a proportion with respect to an effective pixel region of the imaging apparatus of a region where the effective pixel region and the electronic dimmer filter overlap.

### Supplement 41

A control device of a Supplement 28 or a Supplement 29, wherein the divisional exposures are calculated using Equation (1) and Equation (2),
Equation (1) being

(divisional exposure)=(coefficient)×{(target exposure set on imaging apparatus)−(exposure currently set on imaging apparatus)}+(exposure currently set on imaging apparatus), and
Equation (2) being

(coefficient)={1−(proportion of range where the electronic dimmer filter has an effect on a frame)/(a frame number obtained in a remaining time until completion of switch from one to the other out of in-use state or non-use state)

### Supplement 42

The control device of any one of Supplement 26 to Supplement 36, wherein:
the in-use state is a state in which the electronic dimmer filter is used in an effective pixel region of the imaging apparatus.

### Supplement 43

A control device including a processor, wherein the processor performs control of:
in cases in which there is switching from one to the other from out of an in-use state in which an electronic dimmer filter mounted to an imaging apparatus is used or a non-use state in which the electronic dimmer filter is not used, acquiring a target exposure of the imaging apparatus after switching; and
monotonously changing exposures of plural frames obtained by imaging performed by the imaging apparatus at least in a switching time needed for switching from the one to the other by changing toward the target exposure.

### Supplement 44

The control device of Supplement 43, wherein:
plural divisional exposures determined based on a first frame number, which is a frame number corresponding to the switching time, and on the target exposure are applied for exposures of the plural frames.

### Supplement 45

The control device of Supplement 44, wherein
the plural divisional exposures monotonically change in sequence as they are applied to the exposures of the plural frames.

### Supplement 46

A control device of Supplement 44, wherein:
the divisional exposures are determined based on the target exposure, an exposure currently set on the imaging apparatus, a proportion with respect to the frame of a range where the electronic dimmer filter has an effect on the frame, and a remaining frame number which represents the number of frames corresponding to a remaining time until completion of the switching.

### Supplement 47

The control device of Supplement 44, wherein:
the plural frames are obtained by the imaging performed based on a preset frame rate; and
the first frame number is determined based on the switching time and the preset frame rate.

### Supplement 48

The control device of Supplement 44, wherein:
in cases in which a change amount of brightness of an imaging subject has exceeded a reference change amount while the plural divisional exposures are being applied in sequence for the exposures of the plural frames,
the target exposure is updated; and
the plural divisional exposures are updated based on the second frame number and the updated target exposure, where the second frame number is the number of frames corresponding to the remaining time until the switching is completed.

### Supplement 49

The control device of Supplement 44, wherein:
in cases in which a change instruction to change the target exposure has been given from outside while the plural divisional exposures are being applied in sequence for the exposures of the plural frames,
the target exposure is updated; and
the plural divisional exposures are updated based on a third frame number, which is a frame number corresponding to a remaining time until completion of the switching, and the updated target exposure.

### Supplement 50

The control device of Supplement 43, wherein:
in cases in which the target exposure lies outside an exposure range trackable by the switching,
a notification or alarm is given that the target exposure lies outside the exposure range.

### Supplement 51

The control device of Supplement 43, wherein:
in cases in which the target exposure lies outside an exposure range trackable by the switching,
the exposure currently set on the imaging apparatus is maintained in a condition that a cancel instruction to cancel the switching has been given from outside.

### Supplement 52

The control device of Supplement 43, wherein:
in the in-use state the electronic dimmer filter is inserted onto an optical path of the imaging apparatus; and
in the non-use state the electronic dimmer filter is removed from the optical path.

### Supplement 53

The control device of Supplement 52, wherein:
the imaging apparatus includes a translucent filter having optical path equivalent to an optical path length of the electronic dimmer filter;
the electronic dimmer filter and the translucent filter are inserted and removed selectively from the optical path;
in the in-use state the electronic dimmer filter is inserted onto the optical path and the translucent filter is removed from the optical path; and
in the non-use state the translucent filter is inserted onto the optical path and the electronic dimmer filter is removed from the optical path.

### Supplement 54

An imaging apparatus including:
the control device of any one of Supplement 43 to Supplement 53; and
an image sensor employed in the imaging.

### Supplement 55

A control method including performing control of:
in cases in which there is switching from one to the other from out of an in-use state in which an electronic dimmer filter mounted to an imaging apparatus is used or a non-use state in which the electronic dimmer filter is not used, acquiring a target exposure of the imaging apparatus after switching; and
monotonously changing exposures of plural frames obtained by imaging performed by the imaging apparatus at least in a switching time needed for switching from the one to the other by changing toward the target exposure.

### Supplement 56

A program that causes a computer to execute processing including performing control of:
in cases in which there is switching from one to the other from out of an in-use state in which an electronic dimmer filter mounted to an imaging apparatus is used or a non-use state in which the electronic dimmer filter is not used, acquiring a target exposure of the imaging apparatus after switching; and
monotonously changing exposures of plural frames obtained by imaging performed by the imaging apparatus at least in a switching time needed for switching from the one to the other by changing toward the target exposure.

What is claimed is:

1. A control device comprising
a processor, wherein the processor is configured to:
acquire a plurality of divisional exposures determined based on a change time and a target exposure of an imaging apparatus; and
perform control of applying the plurality of divisional exposures for exposures of a plurality of frames obtained by imaging with the imaging apparatus performed at least within the change time,
wherein the change time is a time required for a transmittance of an electronic dimming filter mounted to the imaging apparatus to change from a first transmittance to a second transmittance capable of realizing the target exposure.

2. The control device of claim 1, wherein:
the plurality of frames is obtained by the imaging being performed based on a preset frame rate;
a number of frames of the plurality of frames is determined based on the change time and the preset frame rate; and
the plurality of divisional exposures is determined based on the target exposure and the number of frames.

3. The control device of claim 1, wherein:
in cases in which the change time has exceeded a first threshold value,
the divisional exposures corresponding to the process of changing from the first transmittance to the second transmittance, among the plurality of divisional exposures, are adjusted based on a plurality of ideal transmittances and a plurality of first realistic transmittances,
wherein the plurality of ideal transmittances define a course for an ideal change from the first transmittance to the second transmittance with the change time of the first threshold value or lower, and
the plurality of first realistic transmittances define a course for a realistic change from the first transmittance to the second transmittance with the change time of the first threshold value or lower.

4. The control device of claim 3, wherein the first threshold value is a value determined based on an ideal wait time to change from the first transmittance to the second transmittance.

5. The control device of claim 3, wherein in cases in which the change time has exceeded the first threshold value:
a third transmittance is determined between the first transmittance and the second transmittance to make the change time the first threshold value or lower; and
the plurality of first realistic transmittances is determined based on the first transmittance and the third transmittance.

6. The control device of claim 5, wherein:
for cases in which the change time exceeds the first threshold value and also a number of times a state arises in which a disparity between the first transmittance and the second transmittance lies within a preset range has continued for a specific number of times, the first threshold value is a value larger than a value set at a current point in time.

7. The control device of claim 6, wherein for cases in which the change time exceeds the first threshold value and also a number of times a state arises in which the disparity lies within the preset range has continued for the specific number of times, the first threshold value is a value determined based on a plurality of the change times obtained within the specific number of times.

8. The control device of claim 5, wherein in cases in which the change time exceeds the first threshold value and also a number of times a state arises in which the disparity between the first transmittance and the second transmittance lies within the preset range has continued for a specific number of times, the plurality of divisional exposures is maintained.

9. The control device of claim 5, wherein the plurality of first realistic transmittances determines a course of changing from the first transmittance and the second transmittance for cases of changing from the first transmittance to the second transmittance via the third transmittance with the change time of the first threshold value or lower.

10. The control device of claim 5, wherein:
in cases in which the change time exceeds the first threshold value and also a first maximum disparity, which is a largest disparity between the plurality of ideal transmittances and the plurality of first realistic transmittances, has exceeded a preset disparity:
the divisional exposures corresponding to the process of changing from the first transmittance to the second transmittance, among the plurality of divisional exposures, are adjusted based on the plurality of ideal transmittances and a plurality of second realistic transmittances,
wherein the plurality of second realistic transmittances define a course for changing from the first transmittance to the second transmittance via a plurality of mid transmittances with the change time of the first threshold value or lower, and
a second maximum disparity, which is the largest disparity between the plurality of mid transmittances and the plurality of ideal transmittances, is smaller than the first maximum disparity.

11. The control device of claim 10, wherein:
in cases in which the first maximum disparity exceeds the preset disparity and also a transmittance change time, which is a time needed to change from the first transmittance to the third transmittance, is less than a second threshold value,
among the plurality of divisional exposures, the divisional exposures of a course of changing from the first transmittance to the second transmittance are adjusted based on the plurality of ideal transmittances and the plurality of second realistic transmittances.

12. The control device of claim 3, wherein:
among the plurality of divisional exposures, adjustment for the divisional exposures in the course of changing from the first transmittance to the second transmittance is realized by at least one out of a plurality of exposure factors defining the divisional exposures being adjusted based on a disparity between the ideal transmittance and the first realistic transmittance.

13. The control device of claim 3, wherein in cases in which the change time is the first threshold value or lower the transmittance is changed based on the plurality of ideal transmittances.

14. The control device of claim 3, wherein:
in cases in which the change time is the first threshold value or lower, the plurality of divisional exposures correspond to the plurality of ideal transmittances.

15. The control device of claim 3, wherein the plurality of ideal transmittances changes monotonously between the first transmittance and the second transmittance.

16. The control device of claim 3, wherein:
in cases in which the change time is the first threshold value or lower,
the plurality of divisional exposures changes monotonously from the divisional exposure corresponding to the first transmittance through to the target exposure.

17. The control device according to claim 3, wherein:
the imaging apparatus includes a movable aperture; and
for cases of driving the aperture to realize the target exposure, in cases in which the drive time of the aperture exceeds the first threshold value, the first threshold value is a value equal to or greater than the drive time.

18. An imaging apparatus comprising:
the control device of claim 1; and
an image sensor employed in the imaging.

19. A control method comprising performing:
acquiring a plurality of divisional exposures determined based on a change time and a target exposure of an imaging apparatus; and
applying the plurality of divisional exposures for exposures of a plurality of frames obtained by imaging with the imaging apparatus performed at least within the change time,
wherein the change time is a time required for a transmittance of an electronic dimming filter mounted to the imaging apparatus to change from a first transmittance to a second transmittance capable of realizing the target exposure.

20. A computer readable non-transitory storage medium stored with a program that causes a computer to execute processing comprising performing:
acquiring a plurality of divisional exposures determined based on a change time and a target exposure of an imaging apparatus; and
applying the plurality of divisional exposures for exposures of a plurality of frames obtained by imaging with the imaging apparatus performed at least within the change time,
wherein the change time is a time required for a transmittance of an electronic dimming filter mounted to the imaging apparatus to change from a first transmittance to a second transmittance capable of realizing the target exposure.
